(19) United States
(12) Patent Application Publication
(10) Pub. No.: US 2026/0121975 A1
(43) Pub. Date: Apr. 30, 2026

(54) PLURALITY OF NETWORK ROUTERS FOR PERFORMING COLLECTTIVE OPERATIONS AND ACCELERATOR SYSTEM INCLUDING THE NETWORK ROUTERS

(71) Applicant: SK hynix Inc., Icheon-si (KR)

(72) Inventors: Gu Hyun KIM, Icheon-si (KR); Chang Hyun KIM, Icheon-si (KR); Gyeong Cheol SHIN, Icheon-si (KR)

(21) Appl. No.: 19/249,203

(22) Filed: Jun. 25, 2025

(30) Foreign Application Priority Data
Oct. 31, 2024 (KR) 10-2024-0152273

(51) Int. Cl. H04L 45/00; H04L 47/70; H04L 47/722

(52) U.S. Cl. CPC H04L 45/70; H04L 47/722; H04L 47/829

(57) ABSTRACT

A plurality of network routers include a first network router and a second network router. The second network router includes a receiver configured to receive a collective packet in a first direction from the first network router, a network controller configured to receive the collective packet from the receiver, and to output the collective packet through a first path or a second path based on a packet type of the collective packet, a buffer circuit configured to receive the collective packet transmitted through the second path from the network controller and to store the collective packet in one or more distinct buffers according to the packet type, a reduce operation circuit configured to receive the collective packet from the buffer circuit and to perform a reduce operation using the received collective packet, and a sender configured to output a first output packet in a first direction.

### CROSS-REFERENCE TO RELATED APPLICATIONS

The present application claims priority under 35 U.S.C § 119 (a) to Korean Application No. 10-2024-0152273, filed on Oct. 31, 2024 in the Korean Intellectual Property Office, which is incorporated herein by reference in its entirety.

### BACKGROUND

### 1. Technical Field

Various embodiments of the present teachings relate to a plurality of network routers and an accelerator system including the network routers and, more particularly, to a plurality of network routers for performing collective operations and an accelerator system including the network routers.

### 2. Related Art

Large Language Model (LLM) systems are complex artificial intelligence (AI) models designed to understand and generate human-like text based on vast amounts of training data. These models leverage deep learning techniques, particularly neural networks, to analyze linguistic patterns and generate coherent and contextually appropriate text. The primary characteristic of LLMs lies in their scale, allowing them to capture complex linguistic structures and nuances by learning from datasets containing billions of words.

The architecture of LLMs typically consists of multiple layers of artificial neural network units. Transformer architectures, in particular, have gained prominence due to their ability to handle long-range dependencies within text. Recently, efforts have been made to perform AI computations based on LLMs in accelerator systems where AI accelerators communicate through network routers. Accordingly, there is a need to improve network communication functions among AI accelerators in an accelerator system to efficiently execute AI computations based on LLMs.

### SUMMARY

A plurality of network routers according to an embodiment of the present disclosure may include a first network router and a second network router. The second network router may include a receiver configured to receive a collective packet in a first direction from the first network router, a network controller configured to receive the collective packet from the receiver, and to output the collective packet through a first path or a second path based on a packet type of the collective packet, a buffer circuit configured to receive the collective packet transmitted through the second path from the network controller and to store the collective packet in one or more distinct buffers according to the packet type, a reduce operation circuit configured to receive the collective packet from the buffer circuit and to perform a reduce operation using the received collective packet, and a sender configured to output a first output packet in a first direction. The first network router and the second network router may be interconnected in a one-dimensional torus topology.

A network router according to an embodiment of the present disclosure may include a receiver configured to receive a first input packet along a first direction, and a second input packet along a second direction, and to output a packet of either the first input packet and the second input packet as a collective packet, a network controller configured to receive the collective packet from the receiver, and to output the collective packet via either a first path or a second path based on a packet type of the collective packet, a buffer circuit configured to receive the collective packet transmitted via the second path from the network controller and to store the collective packet in one or more distinct buffers according to the packet type, and a reduce operation circuit configured to receive the collective packet from the buffer circuit and to perform a reduce operation using the collective packet.

A network router according to an embodiment of the present disclosure may include a first router circuit that receives a first input packet along a first direction and outputs a first output packet along the first direction, and a second router circuit that receives a second input packet along a second direction and outputs a second output packet along the second direction. The first router circuit may include a first receiver configured to receive the first input packet and output the first input packet as a first collective packet, a first network controller configured to receive the first collective packet output from the first receiver and to output the first collective packet through a first path or a second path based on a packet type of the first collective packet, a first buffer circuit configured to store the first collective packet, transmitted through the second path from the first network controller, in one or more distinct first buffers according to the packet type of the first collective packet, and a first reduce operation circuit configured to receive the first collective packet stored in the first buffer circuit and to perform a first reduce operation using the received first collective packet. And the second router circuit may include a second receiver configured to receive the second input packet and output the second input packet as a second collective packet, a second network controller configured to receive the second collective packet output from the second receiver and to output the second collective packet through a third path or a fourth path based on a packet type of the second collective packet, a second buffer circuit configured to store the second collective packet, transmitted through the fourth path from the second network controller, in one or more distinct second buffers according to the packet type of the second collective packet, and a second reduce operation circuit configured to receive the second collective packet stored in the second buffer circuit and to perform a second reduce operation using the received second collective packet.

A network router according to an embodiment of the present disclosure may include a receiver configured to receive a collective packet along a first direction, a network controller configured to receive the collective packet output from the receiver and to output the collective packet through a first path or a second path based on a packet type of the collective packet, a buffer circuit configured to store the collective packet, transmitted via the second path from the network controller, in one or more distinct buffers according to the packet type of the collective packet, and a reduce operation circuit configured to receive the collective packet stored in the buffer circuit and to perform a reduce operation using the received collective packet.

An accelerator system according to an embodiment of the present disclosure may include a plurality of accelerators. Each of the plurality of accelerators includes a network router configured to perform a collective operation. The network router may include a receiver configured to receive a first input packet from a first network router along a first direction, receive a second input packet from a second network router along a second direction, and output one of the first input packet or the second input packet as a collective packet, a network controller configured to receive the collective packet output from the receiver and to output the collective packet through a first path or a second path based on a packet type of the collective packet, a buffer circuit configured to store the collective packet, transmitted through the second path from the network controller, in one or more distinct buffers according to the packet type of the collective packet, and a reduce operation circuit configured to receive the collective packet stored in the buffer circuit and to perform a reduce operation using the received collective packet.

An accelerator system according to an embodiment of the present disclosure may include a plurality of accelerators. Each of the plurality of accelerators includes a network router configured to perform a collective operation. The network router may include a first router circuit configured to receive a first input packet along a first direction and to output a first output packet along the first direction, and a second router circuit configured to receive a second input packet along a second direction and to output a second output packet along the second direction. The first router circuit may include a first receiver configured to receive the first input packet and to output the first input packet as a first collective packet, a first network controller configured to receive the first collective packet output from the first receiver and to output the first collective packet through a first path or a second path based on a packet type of the first collective packet, a first buffer circuit configured to store the first collective packet, transmitted through the second path from the first network controller, in one or more distinct first buffers according to the packet type of the first collective packet, and a first reduce operation circuit configured to receive the first collective packet stored in the first buffer circuit and to perform a first reduce operation using the received first collective packet. And the second router circuit may include a second receiver configured to receive the second input packet and to output the second input packet as a second collective packet, a second network controller configured to receive the second collective packet output from the second receiver and to output the second collective packet through a third path or a fourth path based on a packet type of the second collective packet, a second buffer circuit configured to store the second collective packet, transmitted through the fourth path from the second network controller, in one or more distinct second buffers according to the packet type of the second collective packet, and a second reduce operation circuit configured to receive the second collective packet stored in the second buffer circuit and to perform a second reduce operation using the received second collective packet.

An accelerator system according to an embodiment of the present disclosure may include a plurality of accelerators. Each of the plurality of accelerators includes a network router configured to perform a collective operation. And the network router may include a receiver configured to receive a collective packet along a first direction, a network controller configured to receive the collective packet output from the receiver and to output the collective packet through a first path or a second path based on a packet type of the collective packet, a buffer circuit configured to store the collective packet, transmitted via the second path from the network controller, in one or more distinct buffers according to the packet type, and a reduce operation circuit configured to receive the collective packet stored in the buffer circuit and to perform a reduce operation using the received collective packet.

### BRIEF DESCRIPTION OF THE DRAWINGS

FIG. 1 is a block diagram illustrating an example of an accelerator system according to an embodiment of the present disclosure.

FIG. 2 is a block diagram illustrating an example of an accelerator included in the accelerator system of FIG. 1.

FIG. 3 is a diagram illustrating a network router according to an embodiment of the present disclosure.

FIGS. 4A and 4B are diagrams illustrating a send operation in the accelerator system of FIG. 1 including the network router of FIG. 3.

FIG. 5 is a diagram illustrating the operation of a second network router in a second step of the send operation shown in FIG. 4A.

FIG. 6 is a diagram illustrating the operation of a first network router in a second step of the send operation shown in FIG. 4A.

FIG. 7 is a diagram illustrating the operation of a fourth network router in a third step of the send operation shown in FIG. 4B.

FIGS. 8A and 8B are diagrams illustrating a broadcast operation in the accelerator system of FIG. 1 including the network router of FIG. 3.

FIG. 9 is a diagram illustrating the operation of a second network router in a second step of the broadcast operation shown in FIG. 8A.

FIG. 10 is a diagram illustrating the operation of a third network router in a second step of the broadcast operation shown in FIG. 8A.

FIG. 11 is a diagram illustrating the operation of a third network router in a third step of the broadcast operation shown in FIG. 8B.

FIGS. 12A and 12B are diagrams illustrating a gather operation in the accelerator system of FIG. 1 including the network router of FIG. 3.

FIGS. 13A and 13B are diagrams illustrating the operation of a third network router in a second step of the gather operation shown in FIG. 12A.

FIGS. 14A to 14C are diagrams illustrating the operation of a second network router in a second step of the gather operation shown in FIG. 12A.

FIGS. 15A and 15B are diagrams illustrating an all-gather operation in the accelerator system of FIG. 1 including the network router of FIG. 3.

FIGS. 16A and 16B are diagrams illustrating the operation of a second network router in a second step of the all-gather operation shown in FIG. 15A.

FIGS. 17A and 17B are diagrams illustrating the operation of a second network router in a third step of the all-gather operation shown in FIG. 15B.

FIG. 18 is a diagram illustrating the operation of a second network router in a fourth step of the all-gather operation shown in FIG. 15B.

FIGS. 19A and 19B are diagrams illustrating a scatter operation in the accelerator system of FIG. 1 including the network router of FIG. 3.

FIG. 20 is a diagram illustrating the operation of a second network router in a second step of the scatter operation shown in FIG. 19A.

FIGS. 21A and 21B are diagrams illustrating an example of a reduce operation in the accelerator system of FIG. 1 including the network router of FIG. 3.

FIGS. 22A and 22B are diagrams illustrating the operation of a second network router in a second step of the reduce operation shown in FIG. 21A.

FIGS. 23A and 23B are diagrams illustrating the operation of a third network router in a second step of the reduce operation shown in FIG. 21A.

FIGS. 24A and 24B are diagrams illustrating the operation of a second network router in a third step of the reduce operation shown in FIG. 21B.

FIGS. 25A to 25B are diagrams illustrating another example of the reduce operation in the accelerator system of FIG. 1 including the network router of FIG. 3.

FIGS. 26A and 26B are diagrams illustrating a reduce-scatter operation in the accelerator system of FIG. 1 including the network router of FIG. 3.

FIGS. 27A to 27D are diagrams illustrating the operation of a second network router in a second step of the reduce-scatter operation shown in FIG. 26A.

FIGS. 28A to 28C are diagrams illustrating the operation of a second network router in a fourth step of the reduce-scatter operation shown in FIG. 26B.

FIGS. 29A to 29C are diagrams illustrating an all-reduce operation in the accelerator system of FIG. 1 including the network router of FIG. 3.

FIG. 30 is a block diagram illustrating another example of a network router according to the present disclosure.

FIG. 31A is a diagram illustrating an example of a first router circuit included in the network router of FIG. 30.

FIG. 31B is a diagram illustrating an example of a second router circuit included in the network router of FIG. 30.

FIG. 32A is a diagram illustrating the operation of the first router circuit of the network router of FIG. 30 receiving two transmission target packets along a first direction and a second direction.

FIG. 32B is a diagram illustrating the operation of the second router circuit of the network router of FIG. 30 receiving two transmission target packets along a first direction and a second direction.

FIGS. 33A through 33D are diagrams illustrating the operation of the first router circuit and the second router circuit of the network router of FIG. 30 that transmits two reduce packets and receives two reduce-pass packets along a first direction and a second direction.

FIG. 34 is a diagram illustrating another example of a network router according to the present disclosure.

FIGS. 35A and 35B are diagrams illustrating a broadcast operation in the accelerator system of FIG. 1 including the network router of FIG. 34.

FIG. 36 is a diagram illustrating the operation of a third network router in a second step of the broadcast operation shown in FIG. 35A.

FIG. 37 is a diagram illustrating the operation of a fourth network router in a third step of the broadcast operation shown in FIG. 35B.

FIG. 38 is a block diagram illustrating another example of a network router according to the present disclosure.

FIG. 39A is a diagram illustrating an example of a first router circuit included in the network router of FIG. 38.

FIG. 39B is a diagram illustrating an example of a second router circuit included in the network router of FIG. 38.

FIG. 40 is a block diagram illustrating another example of an accelerator system according to the present disclosure.

FIG. 41 is a block diagram illustrating an accelerator included in the accelerator system of FIG. 40.

FIG. 42 is a block diagram illustrating another example of a network router according to the present disclosure.

FIGS. 43A and 43B are diagrams illustrating a broadcast operation in the accelerator system of FIG. 40 including the network router of FIG. 42.

FIGS. 44A and 44B are diagrams illustrating a gather operation in the accelerator system of FIG. 40 including the network router of FIG. 42.

FIGS. 45A and 45B are diagrams illustrating the operation of a third network router in a second step of the gather operation shown in FIG. 44A.

FIG. 46 is a diagram illustrating the operation of a second network router in a second step of the gather operation shown in FIG. 44A.

FIGS. 47A and 47B are diagrams illustrating an all-gather operation in the accelerator system of FIG. 40 including the network router of FIG. 42.

FIGS. 48A and 48B are diagrams illustrating the operation of a second network router in a second step of the all-gather operation shown in FIG. 47A.

FIGS. 49A and 49B are diagrams illustrating the operation of a second network router in a third step of the all-gather operation shown in FIG. 47B.

FIG. 50 is a diagram illustrating the operation of a second network router in a fourth step of the all-gather operation shown in FIG. 47B.

FIGS. 51A and 51B are diagrams illustrating a scatter operation in the accelerator system of FIG. 40 including the network router of FIG. 42.

FIGS. 52A and 52B are diagrams illustrating a reduce operation in the accelerator system of FIG. 40 including the network router of FIG. 42.

FIG. 53 is a diagram illustrating the operation of a fourth network router in a second step of the reduce operation shown in FIG. 52A.

FIG. 54 is a diagram illustrating the operation of a second network router in a fourth step of the reduce operation shown in FIG. 52B.

FIGS. 55A and 55B are diagrams illustrating a reduce-scatter operation in the accelerator system of FIG. 40 including the network router of FIG. 42.

FIGS. 56A and 56B are diagrams illustrating the operation of a first network router in a second step of the reduce-scatter operation shown in FIG. 55A.

FIGS. 57A to 57C are diagrams illustrating an all-reduce operation in the accelerator system of FIG. 40 including the network router of FIG. 42.

FIG. 58 is a block diagram illustrating another example of a network router according to the present disclosure.

FIGS. 59A and 59B are diagrams illustrating a broadcast operation in the accelerator system of FIG. 40 including the network router of FIG. 58.

FIG. 60 is a block diagram illustrating another example of an accelerator system according to the present disclosure.

FIG. 61 is a block diagram illustrating yet another example of an accelerator system according to the present disclosure.

### DETAILED DESCRIPTION

In the following description of embodiments, it will be understood that the terms “first” and “second” are intended to identify elements, but not used to define a particular number or sequence of elements. In addition, when an element is referred to as being located “on,” “over,” “above,” “under,” or “beneath” another element, it is intended to mean relative positional relationship, but not used to limit certain cases for which the element directly contacts the other element, or at least one intervening element is present between the two elements. Accordingly, the terms such as “on,” “over,” “above,” “under,” “beneath,” “below,” and the like that are used herein are for the purpose of describing particular embodiments only and are not intended to limit the scope of the present disclosure.

Further, when an element is referred to as being “connected” or “coupled” to another element, the element may be electrically or mechanically connected or coupled to the other element directly, or may be electrically or mechanically connected or coupled to the other element indirectly with one or more additional elements between the two elements. Moreover, when a parameter is referred to as being “predetermined,” it may be intended to mean that a value of the parameter is determined in advance of when the parameter is used in a process or an algorithm. The value of the parameter may be set when the process or the algorithm starts or may be set during a period in which the process or the algorithm is executed.

Various embodiments of the present disclosure will be described hereinafter in detail with reference to the accompanying drawings. However, embodiments described herein are for illustrative purposes only and are not intended to limit the scope of the present disclosure.

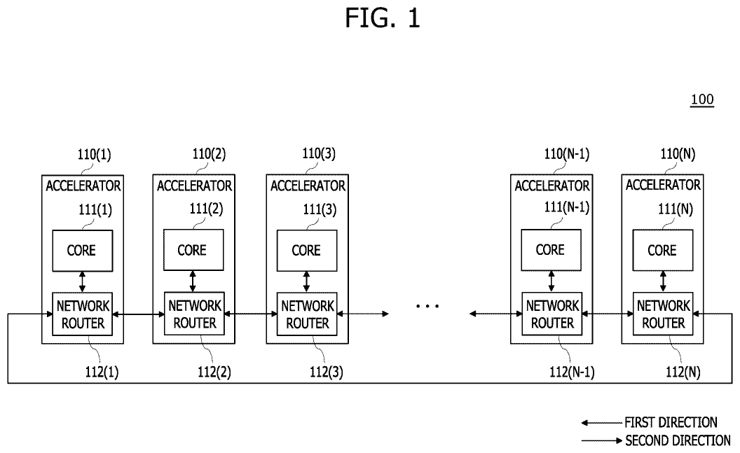

FIG. 1 is a block diagram illustrating an example of an accelerator system according to an embodiment of the present disclosure.

Referring to FIG. 1, an accelerator system 100 includes a plurality of accelerators, for example, first through N-th accelerators 110(1) to 110(N). In this example, the accelerator system 100 includes “N” accelerators, where “N” is a natural number equal to or greater than 2. However, this is merely one example, and the accelerator system 100 may include more than “N” accelerators. Each of the first through N-th accelerators 110(1) to 110(N) includes a corresponding core and a corresponding network router. For instance, the first accelerator 110(1) includes a first core 111(1) and a first network router 112(1). The second accelerator 110(2) includes a second core 111(2) and a second network router 112(2). Likewise, the N-th accelerator 110(N) includes an N-th core 111(N) and an N-th network router 112(N). Each of the accelerators 110(1) to 110(N) has a unique identifier (ID), meaning that they can be distinguished from one another based on their respective IDs. In this specification, it is assumed that each of the network routers 112(1) to 112(N) has the same ID as the corresponding accelerator 110(1) to 110(N) to which it belongs.

The first through N-th cores 111(1) to 111(N) may be configured to perform artificial intelligence (AI) computations. In other words, the cores 111(1) to 111(N) may include hardware specialized for AI tasks involving large-scale data processing and computation. In one example, the cores 111(1) to 111(N) may perform operations such as convolutional neural network (CNN) operations, fully connected layer (FCL) operations, and transformer operations. In one embodiment, each of the cores 111(1) to 111(N) may include at least one Processing-In-Memory (PIM) device and a control device for controlling the PIM device. The cores 111(1) to 111(N) may transmit data to the respective network routers 112(1) to 112(N). Additionally, the cores 111(1) to 111(N) may also receive data from the respective network routers 112(1) to 112(N).

In one embodiment, the first through N-th network routers 112(1) to 112(N) may be interconnected in a one-dimensional torus topology, which combines a mesh structure and a linear structure. In this case, the network routers 112(1) to 112(N) constitute nodes of the one-dimensional torus topology. Accordingly, each of the network routers 112(1) to 112(N) is connected to two neighboring network routers. That is, the interconnection structure of the network routers 112(1) to 112(N) forms a closed loop. Communication between the network routers 112(1) to 112(N) is performed bidirectionally, that is, in a first direction and a second direction, which are opposite to each other.

As illustrated in FIG. 1, the first network router 112(1) of the first accelerator 110(1) is connected to the second network router 112(2) of the second accelerator 110(2) and the N-th network router 112(N) of the N-th accelerator 110(N). The first network router 112(1) communicates bidirectionally with the second network router 112(2) and the N-th network router 112(N). The second network router 112(2) of the second accelerator 110(2) is connected to the first network router 112(1) of the first accelerator 110(1) and the third network router 112(3) of the third accelerator 110(3). The second network router 112(2) communicates bidirectionally with the first network router 112(1) and the third network router 112(3). The third network router 112(3) of the third accelerator 110(3) is connected to the second network router 112(2) of the second accelerator 110(2) and a fourth network router (not shown) of a fourth accelerator (not shown). The third network router 112(3) communicates bidirectionally with the second network router 112(2) and the fourth network router (not shown). The (N−1)-th network router 112(N−1) of the (N−1)-th accelerator 110(N−1) is connected to the (N−2)-th network router (not shown) of the (N−2)-th accelerator (not shown) and the N-th network router 112(N) of the N-th accelerator 110(N). The (N−1)-th network router 112(N−1) communicates bidirectionally with the (N−2)-th network router (not shown) and the N-th network router 112(N). The N-th network router 112(N) of the N-th accelerator 110(N) is connected to the (N−1)-th network router 112(N−1) of the (N−1)-th accelerator 110(N−1) and the first network router 112(1) of the first accelerator 110(1). The N-th network router 112(N) communicates bidirectionally with the (N−1)-th network router 112(N−1) and the first network router 112(1). The first through N-th network routers 112(1) to 112(N) included in the accelerator system 100 may be configured to perform collective operations that operate across multiple processes, such as “one-to-many” or “many-to-many” operations. The collective operations may include data movement operations for transferring data and collective computation operations that involve performing collective calculations. In the following description, a reduce operation is provided as an example of a collective computation. Accordingly, the terms “collective computation” and “reduce operation” may be interpreted interchangeably. Hereinafter, a packet transmitted between network routers for the purpose of a collective operation may be referred to as a collective packet. In one embodiment, the data movement operations may include send operations, broadcast operations, gather operations, scatter operations, and all-gather operations. The collective computation operations may include reduce operations, reduce-scatter operations, and all-reduce operations.

The send operation of the data movement operations refers to an operation in which a collective packet stored in a source accelerator, which includes a source network router, is transmitted from the source network router to the network router of a target accelerator. The broadcast operation of the data movement operations refers to an operation in which a collective packet stored in a source accelerator is transmitted from the source network router to the network routers of all other target accelerators. The gather operation of the data movement operations refers to an operation in which collective packets distributed and stored across all accelerators are collected at a target network router of a target accelerator. The all-gather operation of the data movement operations refers to an operation in which collective packets distributed and stored across all accelerators are gathered and shared with the network routers of all the accelerators. The scatter operation of the data movement operations refers to an operation in which collective packets stored in a source accelerator are distributed and transmitted to the network routers of all accelerators.

The reduce operation of the collective computation operations refers to an operation in which a reduce computation is performed on collective packets that are distributed and stored across all accelerators, and a reduce result packet generated as a result of the reduce computation is stored in a target accelerator via a target network router. The reduce-scatter operation of the collective computation operations refers to an operation in which a reduce computation is performed on collective packets that are distributed and stored across all accelerators, and a portion of the reduce result packets generated by the reduce computation is distributed and returned to the network routers of other accelerators. The all-reduce operation of the collective computation operations refers to an operation in which a reduce computation is performed on collective packets that are distributed and stored across all accelerators, and the reduce result packets generated by the reduce computation are transmitted through all network routers and stored in all accelerators.

A collective packet transmitted between network routers may include data used for the collective operation and a header containing information related to the collective operation. In one embodiment, the information contained in the header may include a packet type that defines the type of collective operation for which the data is used, and a destination indicating where the collective packet should be delivered. If the transmission of the collective packet is performed bidirectionally, the header may further include the transmission direction of the collective packet. In one embodiment, the packet type of the collective packet used in the collective operation may be set to one of a transmission packet, an all-gather packet, or a reduce packet. Hereinafter, the terms “collective packet” and “data” will be used interchangeably to have the same meaning. For example, “an operation on a collective packet” may be interpreted as “an operation on the data contained in the collective packet.”

In the send operation, broadcast operation, gather operation, and scatter operation, the collective packets transmitted between network routers may all be treated as transmission packets. In the all-gather operation, the collective packets transmitted between network routers may be treated as all-gather packets. The reduce operation, reduce-scatter operation, and all-reduce operation include reduce computations using reduce packets. During these operations, a partial sum packet may be generated as an intermediate result of the reduce computation. The partial sum packet may be used as an operand in subsequent reduce computations. The partial sum packets generated during the reduce, reduce-scatter, and all-reduce operations may be treated as reduce packets. In the reduce operation, a reduce result packet may be generated as the final result of the reduce computation. The reduce result packet is no longer used as an operand in subsequent reduce operations and may be treated as a transmission packet. In the reduce-scatter operation, a reduce-scatter result packet may be generated as the final result of the reduce computation, which is also no longer used as an operand in subsequent reduce operations. The reduce-scatter result packet may also be treated as a transmission packet. In the all-reduce operation, an all-reduce result packet may be generated as the final result of the reduce computation, and it is no longer used as an operand in other reduce operations. The all-reduce result packet may be treated as an all-gather packet.

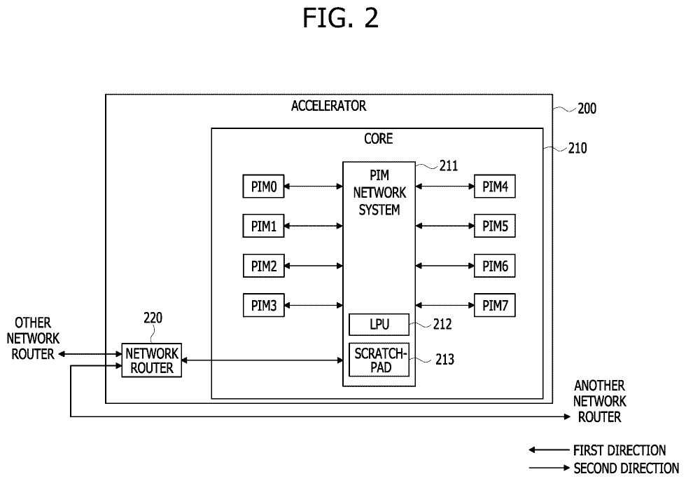

FIG. 2 is a block diagram illustrating an example of an accelerator included in the accelerator system of FIG. 1.

Referring to FIG. 2, the accelerator 200 may include a core 210 and a network router 220. The core 210 may include a PIM (Processing-In-Memory) network system 211 and a plurality of PIM devices, specifically, PIM0 through PIM7. In this example, the core 210 includes a specific number of PIM devices; however, this is merely one example, and the core 210 may include a different number of PIM devices in other implementations. Although not shown in the figure, each of the PIM devices PIM0 through PIM7 may include a plurality of memory circuits, such as memory banks, and a plurality of processing circuits, such as multiply-accumulate (MAC) operators.

The PIM network system 211 may be configured to manage the traffic of signals and data to and from the PIM devices PIM0 through PIM7. The PIM network system 211 may transmit signals and data to, or receive signals and data from, the PIM devices PIM0 through PIM7 via signal/data lines. Although not shown in the figure, the PIM network system 211 may include at least one PIM controller for controlling the PIM devices PIM0 through PIM7. In one embodiment, the PIM network system 211 may include a local processing unit (LPU) 212 and a scratch-pad 213. The local processing unit (LPU) 212 may perform local processing operations within the PIM network system 211. In one example, the local processing operations of the LPU 212 may be triggered by specific requests within the PIM network system 211. The scratch-pad 213 functions as local memory. In one example, the scratch-pad 213 may be implemented using SRAM (Static Random-Access Memory). The scratch-pad 213 may store data used during computation operations performed by the PIM devices PIM0 through PIM7 or may store result data generated as a result of such operations. Additionally, the scratch-pad 213 may store data required for local processing operations in the LPU 212, and may also store result data generated from the local processing operations performed by the LPU 212.

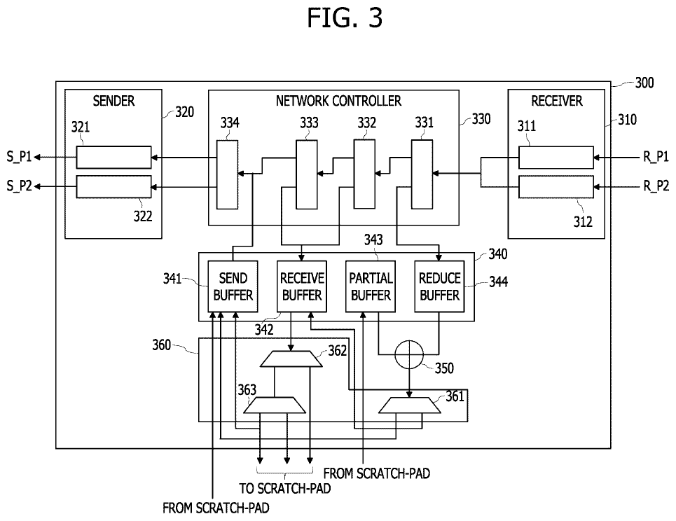

FIG. 3 is a diagram illustrating a network router according to an embodiment of the present disclosure. The description of the network router according to this example is equally applicable to the first through N-th network routers 112(1) to 112(N) shown in FIG. 1 and to the network router 220 shown in FIG. 2.

Referring to FIG. 3, a network router 300 may receive a first receive packet R_P1 along a first direction and a second receive packet R_P2 along a second direction. Additionally, the network router 300 may output a first send packet S_P1 along the first direction and a second send packet S_P2 along the second direction. The network router 300 may receive a packet from, or transmit a packet to, a scratch-pad (e.g., element 213 of FIG. 2) coupled to the network router 300. The network router 300 may be configured to perform collective operations such as data movement operations and reduce computation operations. In one embodiment, the network router 300 may include a receiver 310, a sender 320, a network controller 330, a buffer circuit 340, a reduce operation circuit 350, and a selective output circuit 360.

The receiver 310 may receive packets transmitted from other network routers. The receiver 310 may include a plurality of receive buffers for storing packets received from other network routers, for example, a first receiver buffer 311 and a second receiver buffer 312. The receiver 310 stores a first receive packet R_P1, which is input from another network router along the first direction, in the first receiver buffer 311. The receiver 310 stores a second receive packet R_P2, which is input from another network router along the second direction, in the second receiver buffer 312. The receiver 310 may output the first receive packet R_P1 stored in the first receiver buffer 311 or the second receive packet R_P2 stored in the second receiver buffer 312 to the network controller 330. In one embodiment, when both the first receive packet R_P1 and the second receive packet R_P2 are received simultaneously along the first and second directions, respectively, the first receiver buffer 311 and the second receiver buffer 312 will each store R_P1 and R_P2. In such a case, the receiver 310 may output the first packet R_P1 stored in the first receiver buffer 311 and the second receive packet R_P2 stored in the second receiver buffer 312 in a predefined priority order, such that the packet with higher priority is output first, and the packet with lower priority is output afterward.

In one embodiment, the receiver 310 may receive one of a transmission packet, an all-gather packet, or a reduce packet from another network router. A transmission packet transmitted from another network router to the receiver 310 of the network router 300 may be a target packet having the network router 300 as its destination (i.e., a transmission target packet), or a pass packet having a different network router as its destination (i.e., a transmission pass packet). An all-gather packet transmitted from another network router to the receiver 310 of the network router 300 may be a target packet having the network router 300 as its destination (i.e., an all-gather target packet), or a pass packet having a different network router as its destination (i.e., an all-gather pass packet). A reduce packet transmitted from another network router to the receiver 310 of the network router 300 may be a target packet having the network router 300 as its destination (i.e., a reduce target packet), or a pass packet having a different network router as its destination (i.e., a reduce pass packet).

The sender 320 may receive a packet output from the network controller 330. The sender 320 may include a plurality of send buffers for storing packets transmitted from the network controller 330, such as a first sender buffer 321 and a second sender buffer 322. The sender 320 stores a first send packet S_P1, which is to be output along the first direction from the network router 300, in the first sender buffer 321. The sender 320 stores a second send packet S_P2, which is to be output along the second direction from the network router 300, in the second sender buffer 322. The sender 320 may output the first send packet S_P1 stored in the first sender buffer 321 along the first direction from the network router 300, and may output the second send packet S_P2 stored in the second sender buffer 322 along the second direction from the network router 300.

In one embodiment, the sender 320 may receive a transmission packet, an all-gather packet, and a reduce packet from the network controller 330. Specifically, the sender 320 may receive a transmission pass packet, which is input from another network router to the receiver 310 of the network router 300, via the network controller 330. The sender 320 may receive a transmission packet, an all-gather packet, and a reduce packet that are input from the scratch-pad coupled to the network router 300 into the buffer circuit 340, via the network controller 330. The sender 320 may receive an all-gather pass packet, which is input from another network router to the receiver 310 of the network router 300 and transferred to the buffer circuit 340 and the selective output circuit 360, via the buffer circuit 340 and the network controller 330. The sender 320 may receive a partial sum pass packet, a reduce result pass packet, a reduce-scatter result pass packet, and an all-reduce result pass packet, which are output from the reduce operation circuit 350 and transferred to the selective output circuit 360, via the buffer circuit 340 and the network controller 330. In one example, when both a first send packet R_S1 and a second send packet R_S2 are received from the network controller 330 at the same time, the first send packet S_P1 and the second send packet S_P2 are stored in the first sender buffer 321 and the second sender buffer 322, respectively. In such a case, the sender 320 may perform simultaneous output of the first send packet R_S1 from the first sender buffer 321 and the second send packet R_S2 from the second sender buffer 322.

The network controller 330 receives a packet output from the receiver 310 and controls the transmission path of the packet within the network router 300 based on the type of the received packet. The network controller 330 may generate control signals for controlling the operation of the network router 300. For example, the network controller 330 may be configured to transmit commands to the buffer circuit 340 in order to control the operation of the buffer circuit 340. In one embodiment, when a transmission pass packet is received from the receiver 310, the network controller 330 transmits the transmission pass packet to the sender 320. When a reduce packet, an all-gather packet, or a transmission target packet is received from the receiver 310, the network controller 330 transmits the reduce packet, the all-gather packet, or the transmission target packet to the buffer circuit 340.

In one embodiment, the network controller 330 may include a plurality of packet transmission circuits, such as a first packet transmission circuit 331, a second packet transmission circuit 332, a third packet transmission circuit 333, and a fourth packet transmission circuit 334. The first packet transmission circuit 331, the second packet transmission circuit 332, the third packet transmission circuit 333, and the fourth packet transmission circuit 334 may be arranged sequentially in the direction from the receiver 310 to the sender 320. That is, the first packet transmission circuit 331 may be disposed closest to the receiver 310, and the fourth packet transmission circuit 334 may be disposed closest to the sender 320. In one embodiment, each of the first through fourth packet transmission circuits 331, 332, 333, and 334 may include one input terminal and two output terminals, i.e., a first output terminal and a second output terminal.

The input terminal of the first packet transmission circuit 331 is commonly connected to the first receiver buffer 311 and the second receiver buffer 312 of the receiver 310. Accordingly, the first packet transmission circuit 331 may receive the first receive packet R_P1 output from the first receiver buffer 311 or the second receive packet R_P2 output from the second receiver buffer 312 through the input terminal. The first output terminal of the first packet transmission circuit 331 is connected to the input terminal of the second packet transmission circuit 332. The second output terminal of the first packet transmission circuit 331 is connected to the buffer circuit 340. In one embodiment, when a transmission packet or an all-gather packet is input to the input terminal of the first packet transmission circuit 331, the first packet transmission circuit 331 transmits the transmission packet or the all-gather packet to the input terminal of the second packet transmission circuit 332 through the first output terminal. When a reduce packet is input to the input terminal of the first packet transmission circuit 331, the first packet transmission circuit 331 transmits the reduce packet to the buffer circuit 340 through the second output terminal.

Since the input terminal of the second packet transmission circuit 332 is connected to the first output terminal of the first packet transmission circuit 331, the second packet transmission circuit 332 may receive a transmission packet or an all-gather packet from the first packet transmission circuit 331 through the input terminal. The first output terminal of the second packet transmission circuit 332 is connected to the input terminal of the third packet transmission circuit 333. The second output terminal of the second packet transmission circuit 332 is connected to the buffer circuit 340. In one embodiment, when a transmission packet is input to the input terminal of the second packet transmission circuit 332, the second packet transmission circuit 332 transmits the transmission packet to the input terminal of the third packet transmission circuit 333 through the first output terminal. When an all-gather packet is input to the input terminal of the second packet transmission circuit 332, the second packet transmission circuit 332 transmits the all-gather packet to the buffer circuit 340 through the second output terminal.

Since the input terminal of the third packet transmission circuit 333 is connected to the first output terminal of the second packet transmission circuit 332, the third packet transmission circuit 333 may receive a transmission packet from the second packet transmission circuit 332 through the input terminal. The first output terminal of the third packet transmission circuit 333 is connected to the input terminal of the fourth packet transmission circuit 334. The second output terminal of the third packet transmission circuit 333 is connected to the buffer circuit 340. In one embodiment, when a transmission pass packet is input to the input terminal of the third packet transmission circuit 333, the third packet transmission circuit 333 transmits the transmission pass packet to the input terminal of the fourth packet transmission circuit 334 through the first output terminal. When a transmission target packet is input to the input terminal of the third packet transmission circuit 333, the third packet transmission circuit 333 transmits the transmission target packet to the buffer circuit 340 through the second output terminal.

The input terminal of the fourth packet transmission circuit 334 is connected not only to the first output terminal of the third packet transmission circuit 333 but also to the buffer circuit 340. Accordingly, the fourth packet transmission circuit 334 may receive a transmission pass packet from the first output terminal of the third packet transmission circuit 333 through the input terminal. The fourth packet transmission circuit 334 may also receive a transmission packet, an all-gather packet, or a reduce packet, which is stored in the scratch-pad and then input from the buffer circuit 340, through the input terminal. Additionally, the fourth packet transmission circuit 334 may receive an all-gather pass packet through the input terminal. The all-gather pass packet is input from another network router, stored in the buffer circuit 340, and then output via the selective output circuit 360. Furthermore, the fourth packet transmission circuit 334 may receive, through the buffer circuit 340, a partial sum pass packet, a reduce result pass packet, a reduce-scatter result pass packet, and an all-reduce result pass packet, which are output from the reduce operation circuit 350 and transferred to the selective output circuit 360.

The first output terminal of the fourth packet transmission circuit 334 is connected to the first sender buffer 321 of the sender 320. The second output terminal of the fourth packet transmission circuit 334 is connected to the second sender buffer 322 of the sender 320. When the transmission direction of the transmission pass packet, which is transferred from the first output terminal of the third packet transmission circuit 333 to the input terminal of the fourth packet transmission circuit 334, is the first direction, the fourth packet transmission circuit 334 transmits the transmission pass packet to the first sender buffer 321 of the sender 320 through the first output terminal. When the transmission direction of the transmission pass packet transferred from the first output terminal of the third packet transmission circuit 333 to the input terminal of the fourth packet transmission circuit 334 is the second direction, the fourth packet transmission circuit 334 transmits the transmission pass packet to the second sender buffer 322 of the sender 320 through the second output terminal.

When the transmission direction of a transmission packet, an all-gather packet, or a reduce packet that is transferred from the scratch-pad coupled to the network router 300 to the input terminal of the fourth packet transmission circuit 334 via the buffer circuit 340 is the first direction, the fourth packet transmission circuit 334 transmits the transmission packet, the all-gather packet, or the reduce packet to the first sender buffer 321 of the sender 320 through the first output terminal. When the transmission direction of the transmission packet, the all-gather packet, or the reduce packet that is transferred from the scratch-pad to the input terminal of the fourth packet transmission circuit 334 via the buffer circuit 340 is the second direction, the fourth packet transmission circuit 334 transmits the transmission packet, the all-gather packet, or the reduce packet to the second sender buffer 322 of the sender 320 through the second output terminal.

When the transmission direction of an all-gather pass packet that is input from another network router to the receiver 310 of the network router 300 and transferred to the input terminal of the fourth packet transmission circuit 334 via the buffer circuit 340, the selective output circuit 360, and the network controller 330 is the first direction, the fourth packet transmission circuit 334 transmits the all-gather pass packet to the first sender buffer 321 of the sender 320 through the first output terminal. [00106] When the transmission direction of an all-gather pass packet that is input from another network router to the receiver 310 of the network router 300 and transferred to the input terminal of the fourth packet transmission circuit 334 via the buffer circuit 340, the selective output circuit 360, and the network controller 330 is the second direction, the fourth packet transmission circuit 334 transmits the all-gather pass packet to the second sender buffer 322 of the sender 320 through the second output terminal.

When the transmission direction of a partial sum pass packet, a reduce result pass packet, a reduce-scatter result pass packet, or an all-reduce result pass packet that is output from the reduce operation circuit 350 and transferred to the input terminal of the fourth packet transmission circuit 334 via the selective output circuit 360 and the buffer circuit 340 is the first direction, the fourth packet transmission circuit 334 transmits the partial sum pass packet, the reduce result pass packet, the reduce-scatter result pass packet, and the all-reduce result pass packet to the first sender buffer 321 of the sender 320 through the first output terminal.

When the transmission direction of a partial sum pass packet, a reduce result pass packet, a reduce-scatter result pass packet, or an all-reduce result pass packet that is output from the reduce operation circuit 350 and transferred to the input terminal of the fourth packet transmission circuit 334 via the selective output circuit 360 and the buffer circuit 340 is the second direction, the fourth packet transmission circuit 334 transmits these packets to the second sender buffer 322 of the sender 320 through the second output terminal.

The buffer circuit 340 may receive packets from the network controller 330, the scratch-pad (element 213 in FIG. 2), and the selective output circuit 360. The buffer circuit 340 may store the packets received from the network controller 330, the scratch-pad, and the selective output circuit 360 in separate storage regions that are distinguished based on the type of packet. In one embodiment, the buffer circuit 340 may include a plurality of storage regions, such as a send buffer 341, a receive buffer 342, a partial buffer 343, and a reduce buffer 344.

The send buffer 341 of the buffer circuit 340 may receive packets from the scratch-pad coupled to the network router 300 and from the selective output circuit 360. Specifically, the send buffer 341 may receive and store transmission packets, all-gather packets, and reduce packets that are to be transmitted to other network routers from the scratch-pad coupled to the network router 300. The send buffer 341 may transmit the stored transmission packets, all-gather packets, and reduce packets to the input terminal of the fourth packet transmission circuit 334 of the network controller 330. The send buffer 341 may also receive and store all-gather pass packets from the selective output circuit 360, and may transmit the stored all-gather pass packets to the input terminal of the fourth packet transmission circuit 334 of the network controller 330. Additionally, the send buffer 341 may receive and store partial sum pass packets, reduce result pass packets, reduce-scatter result pass packets, and all-reduce result pass packets from the selective output circuit 360. The send buffer 341 may transmit these stored packets to the input terminal of the fourth packet transmission circuit 334 of the network controller 330.

The receive buffer 342 of the buffer circuit 340 may receive packets from the second packet transmission circuit 332 and the third packet transmission circuit 333 of the network controller 330, as well as from the selective output circuit 360. Specifically, the receive buffer 342 may receive and store all-gather packets that are input from another network router to the network router 300 and output from the second output terminal of the second packet transmission circuit 332. The receive buffer 342 may receive and store transmission target packets that are input from another network router to the network router 300 and output from the second output terminal of the third packet transmission circuit 333. The receive buffer 342 may also receive and store partial sum target packets, reduce result target packets, reduce-scatter target packets, and all-reduce result target packets that are output from the reduce operation circuit 350 and transferred through the selective output circuit 360. The receive buffer 342 may output the stored packets to the selective output circuit 360. In one example, the packet output operation of the receive buffer 342 may be performed in response to a receive command transmitted from the network controller 330 to the receive buffer 342.

The partial buffer 343 and the reduce buffer 344 of the buffer circuit 340 are configured to receive and store packets used in reduce operations. The partial buffer 343 may receive and store reduce packets from the scratch-pad, which are used as first operand packets in the reduce operation. The reduce packets transferred from the scratch-pad to the partial buffer 343 may be partial sum packets generated by a previous reduce operation and stored in the scratch-pad. The partial buffer 343 may transfer the stored reduce packets to the first input terminal of the reduce operation circuit 350. The reduce buffer 344 may receive and store reduce packets from the first packet transmission circuit 331, which are used as second operand packets in the reduce operation. The reduce packets transferred from the first packet transmission circuit 331 to the reduce buffer 344 may be partial sum packets provided by another network router and used as second operand packets in the reduce operation. The reduce buffer 344 may transfer the stored reduce packets to the second input terminal of the reduce operation circuit 350.

The reduce operation circuit 350 performs collective computations, such as reduce operations. In one example, the reduce operation circuit 350 may be an adder that performs an addition operation as the reduce operation. However, this is merely one example, and the reduce operation circuit 350 may also perform other types of operations, such as multiplication, division, maximum, or minimum value computations. In one embodiment, the reduce operation circuit 350 may include a plurality of input terminals, such as a first input terminal and a second input terminal, and at least one output terminal. The first input terminal of the reduce operation circuit 350 is connected to the partial buffer 343 of the buffer circuit 340. The second input terminal of the reduce operation circuit 350 is connected to the reduce buffer 344 of the buffer circuit 340. The output terminal of the reduce operation circuit 350 is connected to the selective output circuit 360. The reduce operation circuit 350 receives a reduce packet used as a first operand packet for the reduce operation from the partial buffer 343 through the first input terminal. The reduce operation circuit 350 receives a reduce packet used as a second operand packet for the reduce operation from the reduce buffer 344 through the second input terminal. The reduce operation circuit 350 performs the reduce operation such as an addition on the first operand packet and the second operand packet, and generates a partial sum packet, a reduce result packet, a reduce-scatter result packet, and an all-reduce result packet. The reduce operation circuit 350 transmits the generated partial sum packet, reduce result packet, reduce-scatter result packet, and all-reduce result packet to the selective output circuit 360 through the output terminal.

The selective output circuit 360 may receive packets from the reduce operation circuit 350 and from the receive buffer 342 of the buffer circuit 340. Specifically, the selective output circuit 360 receives reduce result packets, reduce-scatter result packets, and all-reduce result packets output from the reduce operation circuit 350. When a reduce result pass packet, a reduce-scatter result pass packet, or an all-reduce result pass packet is received from the reduce operation circuit 350, the selective output circuit 360 transmits the received pass packets to the send buffer 341 of the buffer circuit 340. When a reduce result target packet, a reduce-scatter target packet, or an all-reduce target packet is received from the reduce operation circuit 350, the selective output circuit 360 transmits the received target packets to the receive buffer 342 of the buffer circuit 340.

The selective output circuit 360 receives all-gather packets, transmission target packets, partial sum target packets, reduce result target packets, reduce-scatter result target packets, and all-reduce result target packets output from the receive buffer 342 of the buffer circuit 340. When a transmission target packet, a partial sum target packet, a reduce result target packet, a reduce-scatter result target packet, or an all-reduce result target packet is received from the receive buffer 342, the selective output circuit 360 transmits the corresponding packet to the scratch-pad. When an all-gather packet is received from the receive buffer 342, the selective output circuit 360 transmits the all-gather packet to the scratch-pad or to both the send buffer 341 and the scratch-pad, depending on the destination of the all-gather packet. In one embodiment, when an all-gather target packet is received from the receive buffer 342, the selective output circuit 360 transmits the all-gather target packet to the scratch-pad. When an all-gather pass packet is received from the receive buffer 342, the selective output circuit 360 transmits the all-gather pass packet to both the send buffer 341 and the scratch-pad.

In one embodiment, the selective output circuit 360 may include a plurality of demultiplexers, such as a first, second, and third demultiplexer 361 to 363. In one embodiment, each of the first, second, and third demultiplexers 361 to 363 may be configured as a 1-to-2 demultiplexer, having one input terminal and two output terminals. The input terminal of the first demultiplexer 361 is connected to the output terminal of the reduce operation circuit 350. The first output terminal of the first demultiplexer 361 is connected to the send buffer 341 of the buffer circuit 340. The second output terminal of the first demultiplexer 361 is connected to the receive buffer 342 of the buffer circuit 340. The input terminal of the second demultiplexer 362 is connected to the receive buffer 342 of the buffer circuit 340. The first output terminal of the second demultiplexer 362 is connected to the input terminal of the third demultiplexer 363. The second output terminal of the second demultiplexer 362 is connected to the scratch-pad. The input terminal of the third demultiplexer 363 is connected to the first output terminal of the second demultiplexer 362. The first output terminal of the third demultiplexer 363 is commonly connected to both the scratch-pad (element 213 in FIG. 2) and the send buffer 341 of the buffer circuit 340. The second output terminal of the third demultiplexer 363 is connected to the scratch-pad.

The first demultiplexer 361 receives partial sum packets, reduce result packets, reduce-scatter result packets, and all-reduce result packets from the reduce operation circuit 350 through the input terminal. Depending on the destination of the partial sum packet, reduce result packet, reduce-scatter result packet, or all-reduce result packet transmitted from the reduce operation circuit 350, the first demultiplexer 361 transmits the corresponding packet either to the send buffer 341 or to the receive buffer 342.

In one embodiment, when a partial sum pass packet, a reduce result pass packet, a reduce-scatter result pass packet, or an all-reduce result pass packet is received from the reduce operation circuit 350, the first demultiplexer 361 transmits the corresponding packet to the send buffer 341 through the first output terminal. When a partial sum target packet, a reduce result target packet, a reduce-scatter result target packet, or an all-reduce result target packet is received from the reduce operation circuit 350, the first demultiplexer 361 transmits the corresponding packet to the receive buffer 342 through the second output terminal.

The second demultiplexer 362 receives all-gather packets, transmission target packets, partial sum target packets, reduce result target packets, reduce-scatter result target packets, and all-reduce result target packets from the receive buffer 342 of the buffer circuit 340 through the input terminal. When an all-gather packet is transmitted from the receive buffer 342, the second demultiplexer 362 transmits the all-gather packet to the input terminal of the third demultiplexer 363 through the first output terminal. When a transmission target packet, a partial sum target packet, a reduce result target packet, a reduce-scatter result target packet, or an all-reduce result target packet is transmitted from the receive buffer 342, the second demultiplexer 362 transmits the corresponding packet to the scratch-pad through the second output terminal.

The third demultiplexer 363 receives an all-gather packet from the first output terminal of the second demultiplexer 362 through its input terminal. When an all-gather pass packet is input from the second demultiplexer 362, the third demultiplexer 363 transmits the all-gather pass packet to both the send buffer 341 and the scratch-pad through the first output terminal. When an all-gather target packet is input from the second demultiplexer 362, the third demultiplexer 363 transmits the all-gather target packet to the scratch-pad through the second output terminal.

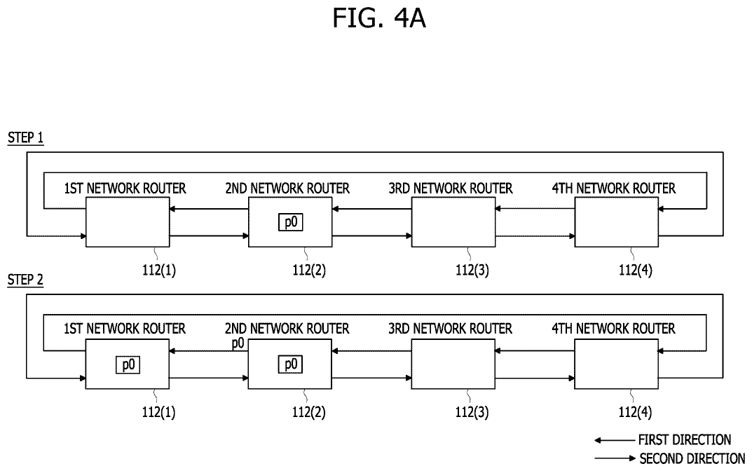

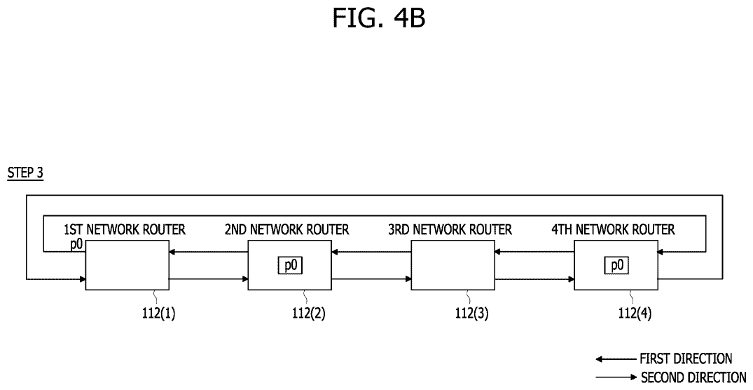

FIGS. 4A and 4B are diagrams illustrating a send operation in the accelerator system of FIG. 1 including the network router of FIG. 3. In the following examples, it is assumed that the first through fourth network routers 112(1)-112(4) are respectively included in the first through fourth accelerators, and that the first through fourth accelerators are coupled in a one-dimensional torus topology, as described with reference to FIG. 1. Additionally, it is assumed that the first through fourth accelerators each include first through fourth scratch-pads, respectively coupled to the corresponding network routers 112(1)-112(4) as described with reference to FIG. 2. For convenience, FIGS. 4A and 4B illustrate only the first through fourth network routers 112(1)-112(4), and the first through fourth accelerators as well as the first through fourth scratch-pads are omitted from the illustrations. In the following examples, the first direction is indicated by the left-pointing arrow in the figures, and the second direction is indicated by the right-pointing arrow in the figures.

Referring to FIG. 4A, in the first step (STEP 1) of the send operation, it is assumed that a first packet p0 is stored in the second scratch-pad, which is coupled to the second network router 112(2), while the first scratch-pad coupled to the first network router 112(1), the third scratch-pad coupled to the third network router 112(3), and the fourth scratch-pad coupled to the fourth network router 112(4) do not have the first packet p0 stored. The send operation may be performed by transmitting the first packet p0 which is stored in the second scratch-pad coupled to the second network router 112(2) to a specified destination. During the send operation, the type of send packet transmitted between the network routers is set as a transmission packet. Based on the destination set in the header of the send packet, the packet is treated either as a transmission pass packet or a transmission target packet. In the following explanation, it is assumed as an example that the destination of the first packet p0 is the fourth scratch-pad coupled to the fourth network router 112(4).

In the second step (STEP 2) of the send operation, the second network router 112(2) transmits the first packet p0, which is stored in the second scratch-pad, toward the first direction to the receiver of the first network router 112(1). The destination of the first packet p0 being transmitted from the second network router 112(2) to the first network router 112(1) is set to the fourth network router 112(4). Accordingly, the first network router 112(1) processes the first packet p0 received from the second network router 112(2) as a transmission pass packet. The first network router 112(1) stores the first packet p0, which is transmitted along the first direction from the second network router 112(2), into the first send buffer of the sender within the first network router 112(1).

Referring to FIG. 4B, in a third step (STEP 3) of the send operation, the first network router 112(1) outputs the first packet p0, which has been stored in the first send buffer of the sender included in the first network router 112(1), along the first direction, and transmits the packet to the receiver of the fourth network router 112(4). Since the destination of the first packet p0 transmitted from the first network router 112(1) is set to the fourth network router 112(4), the fourth network router 112(4) processes the first packet p0 as a transmission target packet. That is, the fourth network router 112(4) stores the first packet p0 which has been transmitted from the first network router 112(1) into the fourth scratch-pad coupled to the fourth network router 112(4).

In the present example, the case has been described in which the first packet p0, which is a transmission packet, is transmitted from the second network router 112(2) to the fourth network router 112(4) in the first direction. However, depending on the packet transmission state among the network routers, the transmission direction of the packet may instead be set to the second direction. In such a case, the second network router 112(2) may transmit the first packet p0 to the third network router 112(3) in the second direction, and subsequently, the third network router 112(3) may transmit the first packet p0 to the fourth network router 112(4) in the second direction.

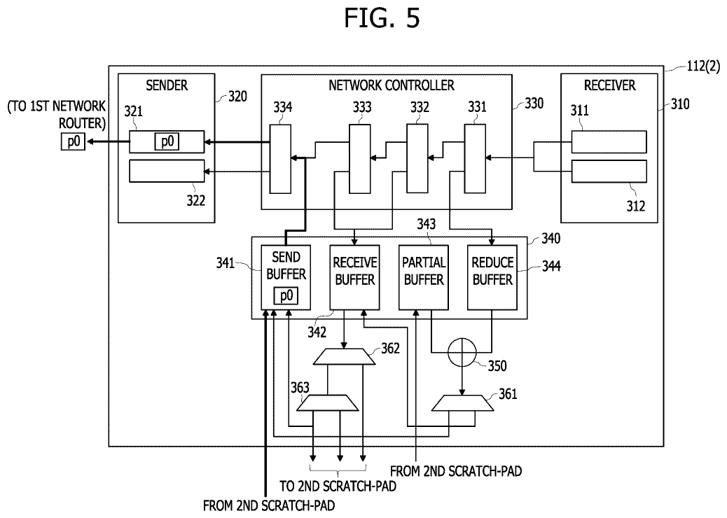

FIG. 5 is a diagram illustrating the operation of a second network router in a second step of the send operation shown in FIG. 4A.

Referring to FIG. 5 in conjunction with FIG. 4A, during the second step (STEP 2) of the send operation, the second network router 112(2) transmits the first packet p0 to the first network router 112(1) along the first direction. As described above with reference to FIG. 4A, the type of the first packet p0 is set as a transmission packet, and the destination of the first packet p0 is set to the fourth network router 112(4). More specifically, the second network router 112(2) reads the first packet p0 stored in the second scratch-pad, and stores the first packet p0 into the send buffer 341 of the buffer circuit 340. The send buffer 341 transmits the first packet p0 to the input terminal of the fourth packet transmission circuit 334 of the network controller 330. Since the transmission direction of the first packet p0 is the first direction, the fourth packet transmission circuit 334 transmits the first packet p0 to the first sender buffer 321 of the sender 320 through the first output terminal. The sender 320 then outputs the first packet p0 stored in the first sender buffer 321 along the first direction to transmit it to the first network router 112(1).

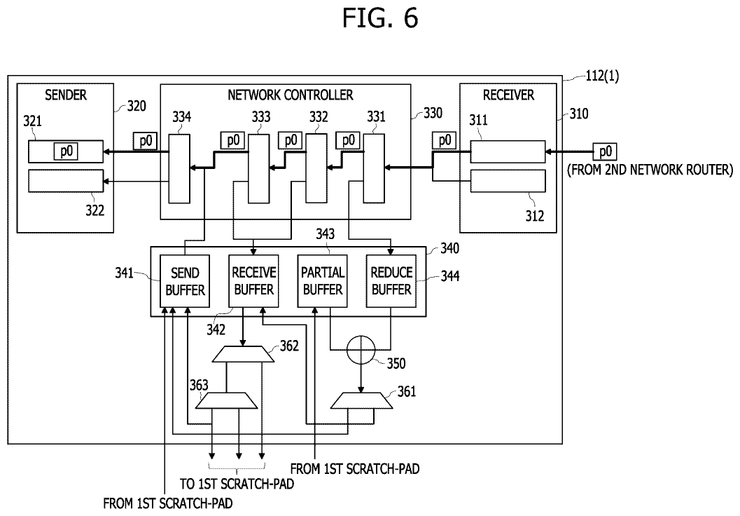

FIG. 6 is a diagram illustrating the operation of a first network router in a second step of the send operation shown in FIG. 4A.

Referring to FIG. 6 in conjunction with FIG. 4A, the first network router 112(1) receives the first packet p0 from the second network router 112(2). Since the transmission direction of the first packet p0 is set to the first direction, the first network router 112(1) stores the first packet p0 in the first receiver buffer 311 of the receiver 310. The receiver 310 outputs the first packet p0 stored in the first receiver buffer 311, and transfers the first packet p0 to the input terminal of the first packet transmission circuit 331 of the network controller 330. Since the first packet p0 is a transmission packet, the first packet transmission circuit 331 outputs the first packet p0 through the first output terminal and transfers it to the input terminal of the second packet transmission circuit 332. The second packet transmission circuit 332 then outputs the first packet p0 through the first output terminal and transfers it to the input terminal of the third packet transmission circuit 333.

Since the destination of the first packet p0 is set to the fourth network router 112(4), and not to the first network router 112(1), that is, since the first packet p0 is a transmission pass packet, the third packet transmission circuit 333 outputs the first packet p0 through the first output terminal and transfers the first packet p0 to the input terminal of the fourth packet transmission circuit 334. Since the transmission direction of the first packet p0 is set to the first direction, the fourth packet transmission circuit 334 outputs the first packet p0 through the first output terminal and stores the first packet p0 in the first sender buffer 321 of the sender 320. Although not explicitly illustrated in the drawing, as described with reference to FIG. 4B, the sender 320, in the third step (STEP 3) of the send operation, transmits the first packet p0 stored in the first sender buffer 321 in the second direction to the fourth network router 112(4).

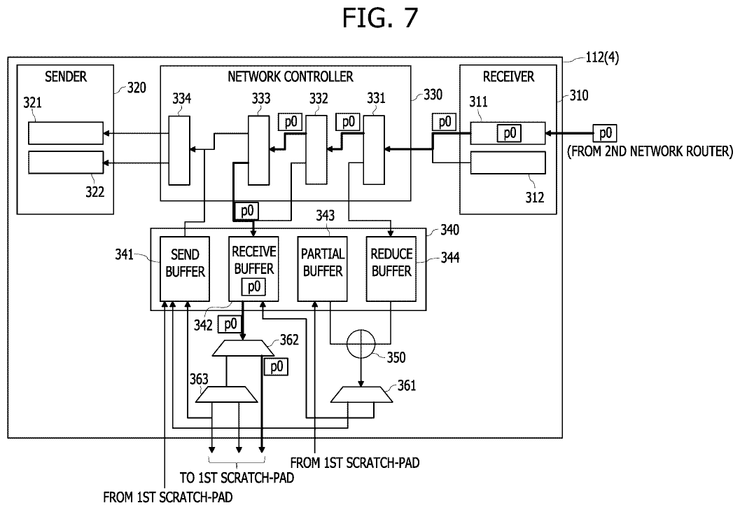

FIG. 7 is a diagram illustrating the operation of a fourth network router in a third step of the send operation shown in FIG. 4B.

Referring to FIG. 7 in conjunction with FIG. 4B, the fourth network router 112(4) receives the first packet p0 from the first network router 112(1). Since the transmission direction of the first packet p0 is the first direction, the fourth network router 112(4) stores the first packet p0 in the first receiver buffer 311 of the receiver 310. The receiver 310 outputs the first packet p0 stored in the first receiver buffer 311 and transfers the first packet p0 to the input terminal of the first packet transmission circuit 331 of the network controller 330. As the first packet p0 is a transmission packet, the first packet transmission circuit 331 outputs the first packet p0 through the first output terminal and transfers the packet to the input terminal of the second packet transmission circuit 332. The second packet transmission circuit 332, in turn, outputs the first packet p0 through the first output terminal and sends the packet to the input terminal of the third packet transmission circuit 333.

As previously described with reference to FIG. 4B, the destination of the first packet p0 is set to the fourth network router 112(4). Therefore, the fourth network router 112(4) treats the first packet p0 as a transmission target packet. Accordingly, the third packet transmission circuit 333 outputs the first packet p0 through the second output terminal and transfers the packet to the receive buffer 342 of the buffer circuit 340. Once the first packet p0 is stored in the receive buffer 342, the network controller 330 sends a receive command to the receive buffer 342. In response to the receive command, the receive buffer 342 transfers the first packet p0 to the input terminal of the second demultiplexer 362. Since the first packet p0 is a transmission target packet, the second demultiplexer 362 outputs the first packet p0 through the second output terminal. The first packet p0 output from the second output terminal of the second demultiplexer 362 is transferred to the fourth scratch-pad, which is coupled to the fourth network router 112(4).

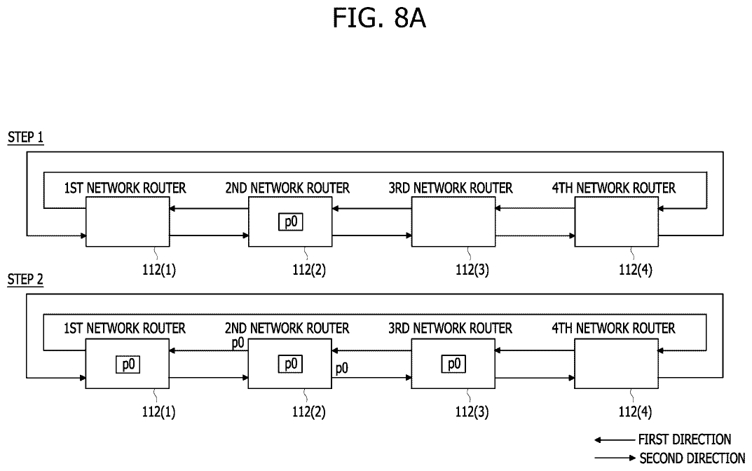

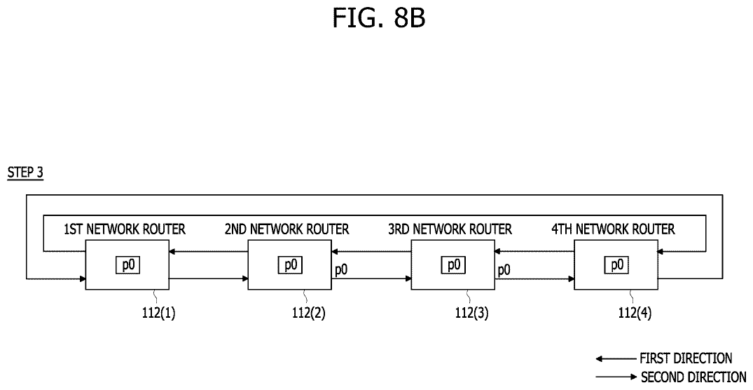

FIGS. 8A and 8B are diagrams illustrating a broadcast operation in the accelerator system of FIG. 1 including the network router of FIG. 3.

Referring to FIG. 8A, in the first step (STEP 1) of a broadcast operation, a first packet p0 is stored in a second scratch-pad coupled to a second network router 112(2). In contrast, a first scratch-pad coupled to a first network router 112(1), a third scratch-pad coupled to a third network router 112(3), and a fourth scratch-pad coupled to a fourth network router 112(4) do not store the first packet p0. The broadcast operation may be performed by transmitting the first packet p0 stored in the second scratch-pad to all of the first network router 112(1), the third network router 112(3), and the fourth network router 112(4). During the broadcast operation, the type of broadcast packet transmitted among network routers is set as a transmission packet. Based on the destination specified in the header of the broadcast packet, the broadcast packet may be processed as either a transmission path packet or a transmission target packet.

In the second step (STEP 2) of the broadcast operation, the second network router 112(2) transmits the first packet p0 stored in the second scratch-pad to the receiver of the first network router 112(1) along the first direction and simultaneously transmits the first packet p0 to the receiver of the third network router 112(3) along the second direction. The first packet p0 transmitted from the second network router 112(2) to the first network router 112(1) has the first network router 112(1) set as its destination. The first network router 112(1) processes the first packet p0 received from the second network router 112(2) as a transmission target packet and stores the first packet p0 in the first scratch-pad. This processing is similar to the process performed by the fourth network router 112(4) for a transmission target packet, as described with reference to FIG. 7. The first packet p0 transmitted from the second network router 112(2) to the third network router 112(3) has the fourth network router 112(4) set as its destination. Therefore, the third network router 112(3) processes the first packet p0 as a transmission path packet and stores the first packet p0 in a sender module included in the third network router 112(3).

Referring to FIG. 8B, in the third step (STEP 3) of the broadcast operation, the second network router 112(2) again transmits the first packet p0 stored in the second scratch-pad to the receiver of the third network router 112(3) along the second direction. The third network router 112(3) transmits the first packet p0, stored in the sender module, to the receiver of the fourth network router 112(4). The first packet p0 transmitted from the second network router 112(2) to the third network router 112(3) has the third network router 112(3) set as its destination. Thus, the third network router 112(3) processes the first packet p0 as a transmission packet and stores the first packet p0 in the third scratch-pad. Since the destination of the first packet p0 transmitted from the third network router 112(3) to the fourth network router 112(4) is set as the fourth network router 112(4), the fourth network router 112(4) processes the first packet p0 as a transmission target packet. That is, the fourth network router 112(4) stores the first packet p0, received from the third network router 112(3), in the fourth scratch-pad. As such, through the execution of STEP 2 and STEP 3 of the broadcast operation, the first packet p0 initially stored in the second scratch-pad coupled to the second network router 112(2) becomes stored in each of the first scratch-pad coupled to the first network router 112(1), the third scratch-pad coupled to the third network router 112(3), and the fourth scratch-pad coupled to the fourth network router 112(4).

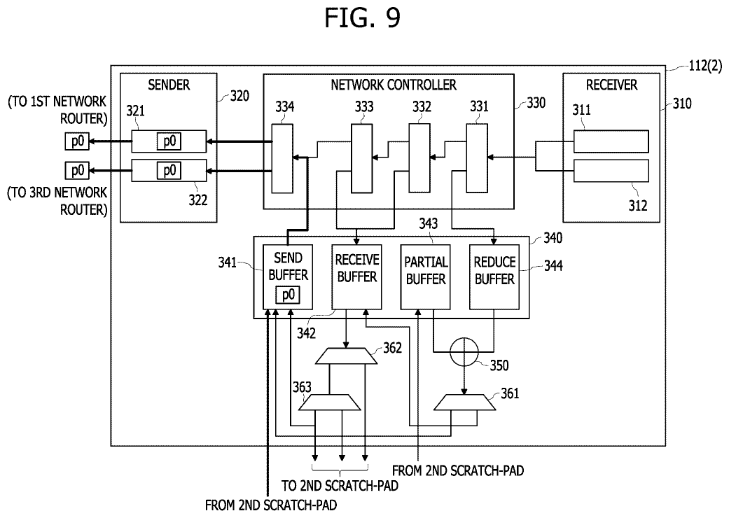

FIG. 9 is a diagram illustrating the operation of a second network router in a second step of the broadcast operation shown in FIG. 8A.

Referring to FIG. 9 in conjunction with FIG. 8A, in the second step (STEP 2) of the broadcast operation, the second network router 112(2) transmits a first packet p0, which is set as a transmission packet type, to both the first network router 112(1) and the third network router 112(3), respectively, along a first direction and a second direction. Specifically, the second network router 112(2) transmits the first packet p0, which is stored in the second scratch-pad, to the send buffer 341 of the buffer circuit 340. The second network router 112(2) then transmits the first packet p0, stored in the send buffer 341, to an input terminal of a fourth packet transmission circuit 334 included in the network controller 330. Since the transmission direction of the first packet p0 input to the fourth packet transmission circuit 334 is the first direction, the fourth packet transmission circuit 334 transmits the first packet p0 through a first output terminal to the first sender buffer 321 included in the sender 320. Subsequently, the second network router 112(2) again transmits the first packet p0, stored in the second scratch-pad, to the send buffer 341 of the buffer circuit 340. The second network router 112(2) then transmits the first packet p0, stored again in the send buffer 341, to the input terminal of the fourth packet transmission circuit 334. Since the transmission direction of the first packet p0 in this instance is the second direction, the fourth packet transmission circuit 334 transmits the first packet p0 through a second output terminal to the second sender buffer 322 included in the sender 320.

The sender 320 transmits the first packet p0, stored in the first sender buffer 321, along the first direction to the first network router 112(1). The sender 320 also transmits the first packet p0, stored in the second sender buffer 322, along the second direction to the third network router 112(3). Since the destination of the first packet p0 transmitted to the first network router 112(1) is the first network router 112(1), the first network router 112(1), which receives the first packet p0 from the second network router 112(2) (not explicitly shown in the drawings), processes the first packet p0 as a transmission target packet. Since the destination of the first packet p0 transmitted to the third network router 112(3) is the fourth network router 112(4), the third network router 112(3), which receives the first packet p0 from the second network router 112(2) (also not shown in the drawings), processes the first packet p0 as a transmission path packet.

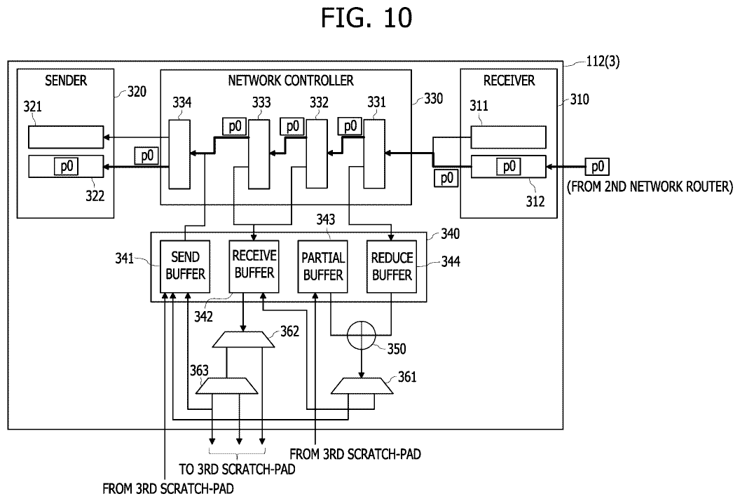

FIG. 10 is a diagram illustrating the operation of a third network router in a second step of the broadcast operation shown in FIG. 8A.

Referring to FIG. 10 in conjunction with FIG. 8A, in the second step (STEP 2) of the broadcast operation, the third network router 112(3) receives a first packet p0 from the second send buffer of the second network router 112(2) along the second direction, as previously described with reference to FIG. 9. Since the transmission of the first packet p0 is performed along the second direction, the third network router 112(3) stores the first packet p0 in the second receiver buffer 312 of the receiver 310. The receiver 310 outputs the first packet p0 stored in the second receiver buffer 312 and transmits the first packet p0 to the input terminal of the first packet transmission circuit 331 included in the network controller 330. Because the first packet p0 is designated as a transmission packet, the first packet transmission circuit 331 outputs the first packet p0 through the first output terminal to the input terminal of the second packet transmission circuit 332. The second packet transmission circuit 332 then outputs the first packet p0 through its first output terminal to the input terminal of the third packet transmission circuit 333. Since the destination of the first packet p0, which is transmitted from the second network router 112(2) to the third network router 112(3), is set to the fourth network router 112(4), the third network router 112(3) processes the first packet p0 as a transmission path packet. Accordingly, the third packet transmission circuit 333 outputs the first packet p0 through its first output terminal to the input terminal of the fourth packet transmission circuit 334. Since the output direction of the first packet p0 is the second direction, the fourth packet transmission circuit 334 transmits the first packet p0 through its second output terminal to the second sender buffer 322 included in the sender 320.

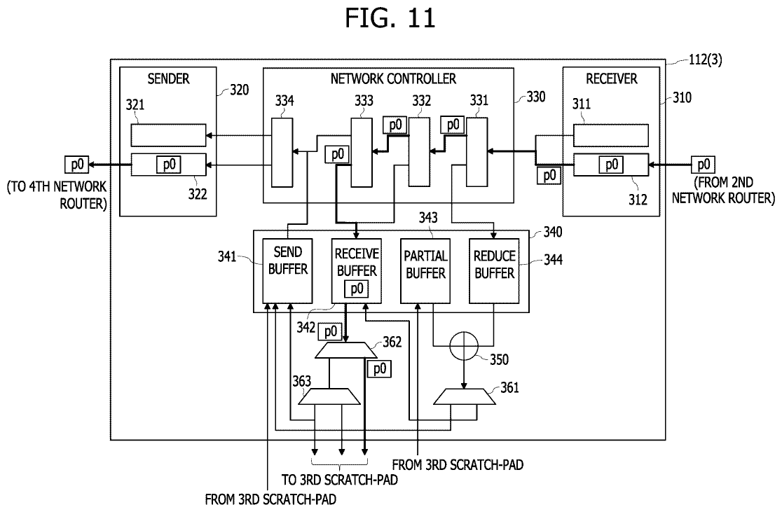

FIG. 11 is a diagram illustrating the operation of a third network router in a third step of the broadcast operation shown in FIG. 8B.

Referring to FIG. 11 in conjunction with FIG. 8B, in the third step (STEP 3) of the broadcast operation, the third network router 112(3) transmits a first packet p0, stored in the second sender buffer 322, to the fourth network router 112(4) along the second direction. Additionally, the third network router 112(3) receives the first packet p0 from the second network router 112(2) along the second direction. Because the transmission direction of the first packet p0 received from the second network router 112(2) is the second direction, the third network router 112(3) stores the first packet p0 received from the second network router 112(2) in the second receiver buffer 312 of the receiver 310.

As previously described with reference to FIG. 8B, since the destination of the first packet p0 transmitted from the second network router 112(2) is set to the third network router 112(3), the third network router 112(3) processes the first packet p0 as a transmission target packet. Specifically, the receiver 310 included in the third network router 112(3) transfers the first packet p0 stored in the second receiver buffer 312 to the input terminal of the first packet transmission circuit 331 of the network controller 330. Since the first packet p0 is a transmission target packet, the first packet transmission circuit 331 outputs the first packet p0 through its first output terminal to the input terminal of the second packet transmission circuit 332. The second packet transmission circuit 332 outputs the first packet p0 through its first output terminal to the input terminal of the third packet transmission circuit 333. The third packet transmission circuit 333 outputs the first packet p0 through its second output terminal to the receive buffer 342 of the buffer circuit 340. Although not explicitly shown in the drawing, once the first packet p0 is transferred to the receive buffer 342, the network controller 330 transmits a receive command to the receive buffer 342. In response to the receive command, the receive buffer 342 transmits the first packet p0 to the input terminal of the second demultiplexer 362. Because the first packet p0 is a transmission target packet, the second demultiplexer 362 outputs the first packet p0 through its second output terminal to the third scratch-pad. In this example, the processing by the third network router 112(3), which treats the first packet p0 received from the second network router 112(2) along the second direction as a transmission target packet, can be similarly applied to the processing of the first packet p0 by the fourth network router 112(4) when the fourth network router 112(4) receives the first packet p0 from the third network router 112(3) in the third step (STEP 3) of the broadcast operation.

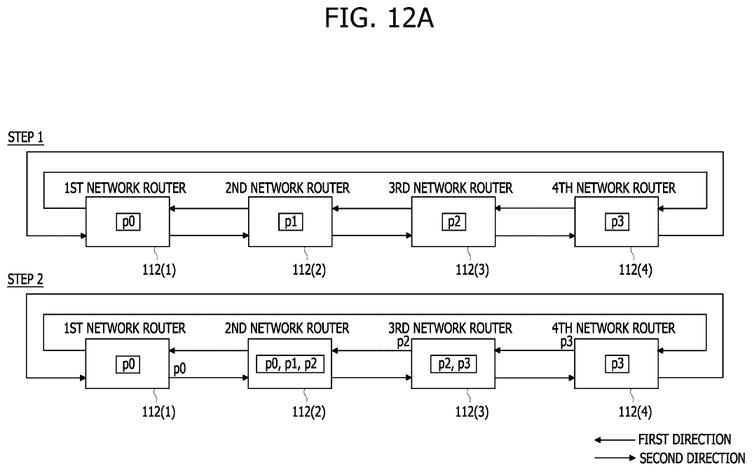

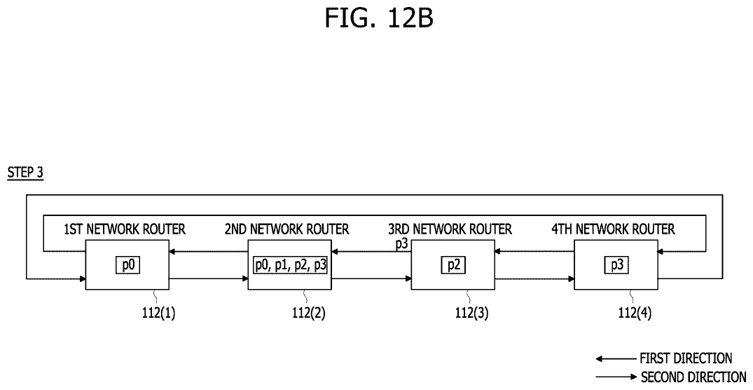

FIGS. 12A and 12B are diagrams illustrating a gather operation in the accelerator system of FIG. 1 including the network router of FIG. 3.

Referring to FIG. 12A, in the first step (STEP 1) of the gather operation, it is assumed that a first packet p0 is stored in the first scratch-pad coupled to the first network router 112(1), a second packet p1 is stored in the second scratch-pad coupled to the second network router 112(2), a third packet p2 is stored in the third scratch-pad coupled to the third network router 112(3), and a fourth packet p3 is stored in the fourth scratch-pad coupled to the fourth network router 112(4). The gather operation may be performed by storing all of the first packet p0, the second packet p1, the third packet p2, and the fourth packet p3 into the second scratch-pad. During the gather operation, the type of packet transmitted between network routers is set to a transmission packet. Based on the destination settings, the gather packets are processed either as transmission path packets or as transmission target packets. In the second step (STEP 2) of the gather operation, the first network router 112(1) transmits the first packet p0, stored in the first scratch-pad, to the receiver of the second network router 112(2) along the second direction. The third network router 112(3) transmits the third packet p2, stored in the third scratch-pad, to the receiver of the second network router 112(2) along the first direction. The fourth network router 112(4) transmits the fourth packet p3, stored in the fourth scratch-pad, to the receiver of the third network router 112(3) along the first direction. The destinations of the first packet p0, the third packet p2, and the fourth packet p3 are all set to the second network router 112(2). Because the destination of both the first packet p0 and the third packet p2 is the second network router 112(2), the second network router 112(2) processes the first packet p0 received from the first network router 112(1) and the third packet p2 received from the third network router 112(3) as transmission target packets. Accordingly, the second network router 112(2) transmits both the first packet p0 and the third packet p2 to the second scratch-pad. Because the destination of the fourth packet p3 is also the second network router 112(2), the third network router 112(3) processes the fourth packet p3, received from the fourth network router 112(4), as a transmission path packet. That is, the third network router 112(3) stores the fourth packet p3, received from the fourth network router 112(4), in the sender 320 of the third network router 112(3).

Referring to FIG. 12B, in the third step (STEP 3) of the gather operation, the third network router 112(3) transmits the fourth packet p3, which is stored in the sender 320, to the second network router 112(2) along the first direction. Since the destination of the fourth packet p3 transmitted from the third network router 112(3) is set to the second network router 112(2), the second network router 112(2) processes the fourth packet p3 received from the third network router 112(3) as a transmission target packet. That is, the second network router 112(2) stores the fourth packet p3 received from the third network router 112(3) into the second scratch-pad. By performing the second step (STEP 2) and the third step (STEP 3) of the gather operation as described above, all of the first packet p0 stored in the first scratch-pad, the second packet p1 stored in the second scratch-pad, the third packet p2 stored in the third scratch-pad, and the fourth packet p3 stored in the fourth scratch-pad are gathered and stored in the second scratch-pad.

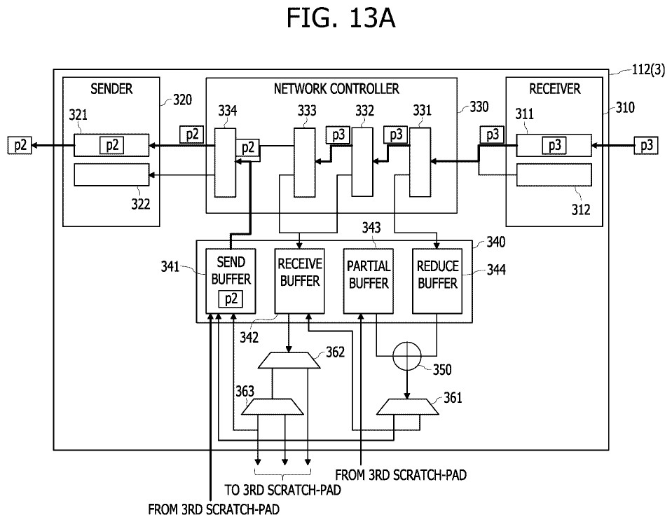

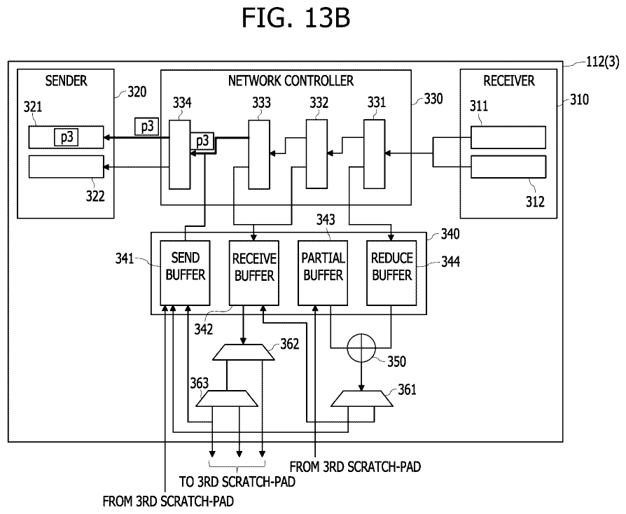

FIGS. 13A and 13B are diagrams illustrating the operation of a third network router in a second step of the gather operation shown in FIG. 12A.

Referring to FIG. 13A in conjunction with FIG. 12A, in the second step (STEP 2) of the gather operation, the third network router 112(3) transmits the third packet p2, stored in the third scratch-pad, to the second network router 112(2) along the first direction, and receives the fourth packet p3 from the fourth network router 112(4) along the first direction. To transmit the third packet p2 to the second network router 112(2), the third network router 112(3) reads the third packet p2 from the third scratch-pad and stores it into the send buffer 341 of the buffer circuit 340. The third network router 112(3) then transmits the third packet p2 stored in the send buffer 341 to the input terminal of the fourth packet transmission circuit 334 of the network controller 330. Since the transmission direction of the third packet p2 is the first direction, the fourth packet transmission circuit 334 outputs the third packet p2 through the first output terminal and transfers it to the first sender buffer 321 of the sender 320. The sender 320 transmits the third packet p2 stored in the first sender buffer 321 to the second network router 112(2) along the first direction. As described with reference to FIG. 12A, the destination of the third packet p2 transmitted from the third network router 112(3) is set to the second network router 112(2).

Meanwhile, since the transmission direction of the fourth packet p3 transmitted from the fourth network router 112(4) is the first direction, the third network router 112(3) stores the fourth packet p3 received from the fourth network router 112(4) into the first receiver buffer 311 of the receiver 310. The receiver 310 transmits the fourth packet p3 stored in the first receiver buffer 311 to the input terminal of the first packet transmission circuit 331 of the network controller 330. Since the fourth packet p3 is a transmission packet, the first packet transmission circuit 331 outputs the fourth packet p3 through the first output terminal and transfers it to the input terminal of the second packet transmission circuit 332. The second packet transmission circuit 332 then outputs the fourth packet p3 through the first output terminal to the input terminal of the third packet transmission circuit 333.

Referring to FIG. 13B in conjunction with FIG. 12A, in the third step (STEP 3) of the gather operation, the fourth packet p3 is a transmission pass packet whose destination is the second network router 112(2), not the third network router 112(3). Accordingly, the third packet transmission circuit 333 outputs the fourth packet p3 through the first output terminal and transmits it to the input terminal of the fourth packet transmission circuit 334. Since the transmission direction of the fourth packet p3 is the first direction, the fourth packet transmission circuit 334 outputs the fourth packet p3 through the first output terminal and transfers it to the first sender buffer 321 of the sender 320. The sender 320 of the third network router 112(3) transmits the fourth packet p3, which is stored in the first sender buffer 321, to the second network router 112(2) during the third step (STEP 3) of the gather operation.

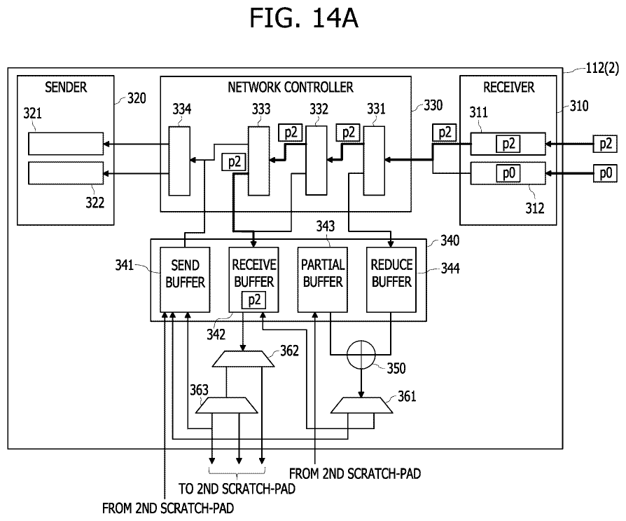

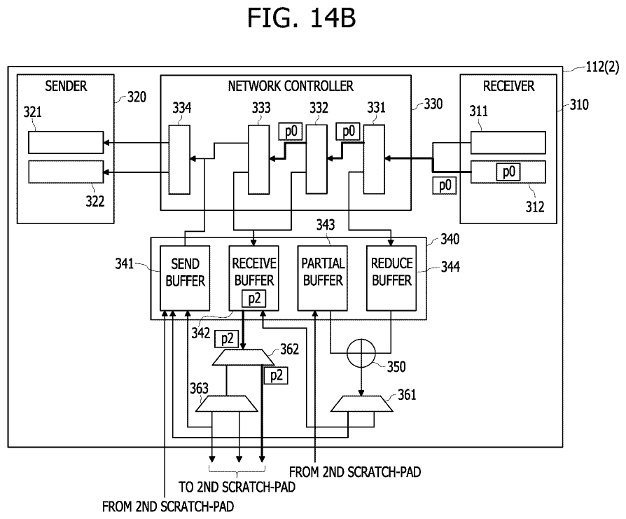

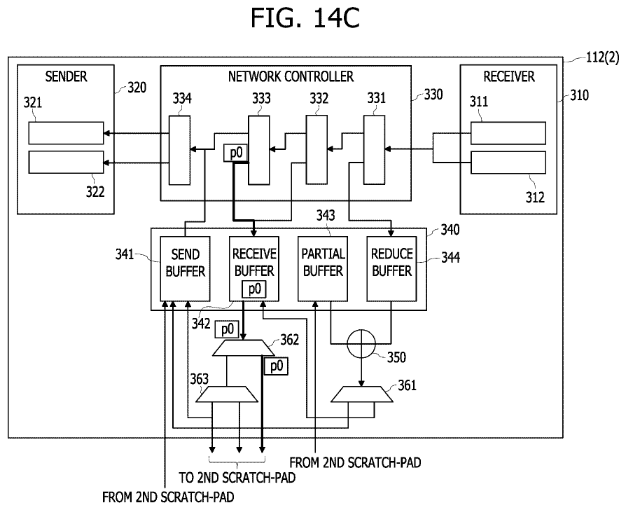

FIGS. 14A to 14C are diagrams illustrating the operation of a second network router in a second step of the gather operation shown in FIG. 12A.

Referring to FIG. 14A in conjunction with FIG. 12A, in the second step (STEP 2) of the gather operation, the second network router 112(2) receives the first packet p0 from the first network router 112(1) and the third packet p2 from the third network router 112(3). Since the transmission direction of the first packet p0 is the second direction, and the transmission direction of the third packet p2 is the first direction, the receiver 310 of the second network router 112(2) stores the first packet p0 in the second receiver buffer 312 and stores the third packet p2 in the first receiver buffer 311. In accordance with a predefined output priority sequence, the receiver 310 transmits the third packet p2 stored in the first receiver buffer 311 to the input terminal of the first packet transmission circuit 331 of the network controller 330. As described with reference to FIG. 12A, because the destination of the third packet p2 transmitted from the third network router 112(3) is set to the second network router 112(2), the second network router 112(2) processes the third packet p2 as a transmission target packet. Accordingly, the first packet transmission circuit 331 transmits the third packet p2 to the input terminal of the second packet transmission circuit 332 via the first output terminal. The second packet transmission circuit 332 transmits the third packet p2 to the input terminal of the third packet transmission circuit 333 via the first output terminal. The third packet transmission circuit 333 transmits the third packet p2 to the receive buffer 342 of the buffer circuit 340 via the second output terminal. Although not shown in the figure, when the third packet p2 is transferred to the receive buffer 342, the network controller 330 of the second network router 112(2) issues a receive command to the receive buffer 342.

Referring to FIG. 14B in conjunction with FIG. 12A, the receive buffer 342, having received the third packet p2 from the third packet transmission circuit 333, transmits the third packet p2 to the input terminal of the second demultiplexer 362 in response to a receive command. Since the third packet p2 is a transmission target packet, the second demultiplexer 362 outputs the third packet p2 through the second output terminal to the second scratch-pad. Meanwhile, the receiver 310 of the second network router 112(2) transmits the first packet p0, which is stored in the second receiver buffer 312, to the input terminal of the first packet transmission circuit 331. Because the first packet p0 is a transmission packet, the first packet transmission circuit 331 transmits the first packet p0 to the input terminal of the second packet transmission circuit 332 via the first output terminal. The second packet transmission circuit 332 then transmits the first packet p0 to the input terminal of the third packet transmission circuit 333 via the first output terminal.

Referring to FIG. 14C in conjunction with FIG. 12A, since the first packet p0 is a transmission target packet whose destination is set to the second network router 112(2), the third packet transmission circuit 333 outputs the first packet p0 through the second output terminal and transmits it to the receive buffer 342 of the buffer circuit 340. Although not illustrated in the figure, when the first packet p0 is transferred to the receive buffer 342, the network controller 330 of the second network router 112(2) transmits a receive command to the receive buffer 342. In response to the receive command, the receive buffer 342, having received the first packet p0 from the third packet transmission circuit 333, transmits the first packet p0 to the input terminal of the second demultiplexer 362. Since the first packet p0 is a transmission target packet, the second demultiplexer 362 outputs the first packet p0 through the second output terminal and transfers it to the second scratch-pad.

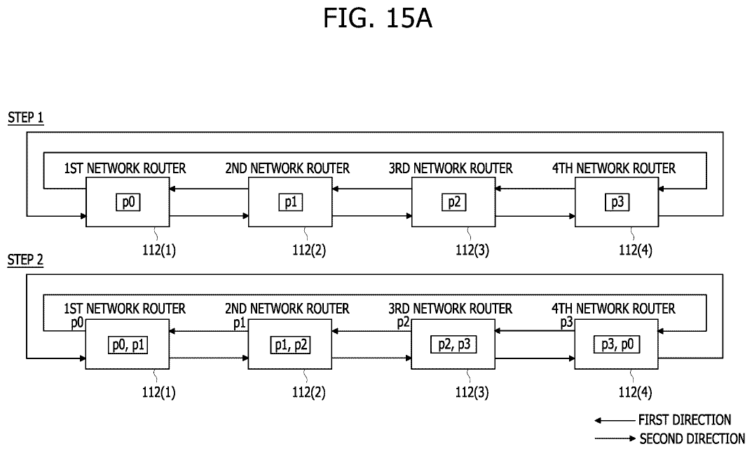

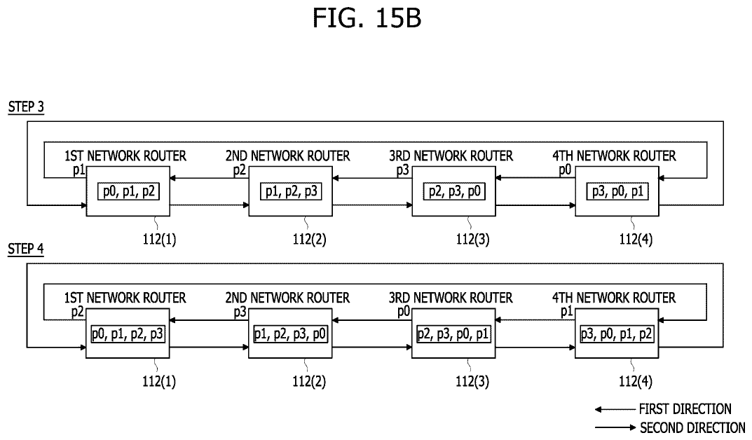

FIGS. 15A and 15B are diagrams illustrating an all-gather operation in the accelerator system of FIG. 1 including the network router of FIG. 3.

Referring to FIG. 15A, in the first step (STEP 1) of the all-gather operation, it is assumed that a first packet p0 is stored in a first scratch-pad coupled to a first network router 112(1), a second packet p1 is stored in a second scratch-pad coupled to a second network router 112(2), a third packet p2 is stored in a third scratch-pad coupled to a third network router 112(3), and a fourth packet p3 is stored in a fourth scratch-pad coupled to a fourth network router 112(4). The all-gather operation may be performed by gathering the first packet p0, the second packet p1, the third packet p2, and the fourth packet p3 into each of the first, second, third, and fourth scratch-pads. During the all-gather operation, the type of packets transmitted between the network routers is set as all-gather packets. Depending on the destination setting, the all-gather packet may be processed cither as an all-gather pass packet or as an all-gather target packet.

In the second step (STEP 2) of the all-gather operation, the first network router 112(1) transmits the first packet p0, stored in the first scratch-pad, in a first direction toward the fourth network router 112(4). The destination of the first packet p0 is set to the second network router 112(2), which is the closest router to 112(1) in the opposite (second) direction. The second network router 112(2) transmits the second packet p1, stored in the second scratch-pad, in the first direction toward the first network router 112(1). The destination of packet p1 is set to the third network router 112(3), which is the closest router to 112(2) in the second direction. The third network router 112(3) transmits the third packet p2, stored in the third scratch-pad, in the first direction toward the second network router 112(2). The destination of the third packet p2 is set to the fourth network router 112(4), which is the closest router to 112(3) in the second direction. The fourth network router 112(4) transmits the fourth packet p3, stored in the fourth scratch-pad, in the first direction toward the third network router 112(3). The destination of the fourth packet p3 is set to the first network router 112(1), which is the closest router to 112(4) in the second direction.

Since the destination of the second packet p1 is set to the third network router 112(3), the first network router 112(1) treats the second packet p1 received from the second network router 112(2) as an all-gather pass packet. Thus, the first network router 112(1) stores the second packet p1 in the sender in the first network router 112(1) and transfers the second packet p1 to first scratch-pad in the first network router 112(1). Since the destination of the third packet p2 is set to the fourth network router 112(4), the second network router 112(2) treats the third packet p2 received from the third network router 112(3) as an all-gather pass packet. Thus, the second network router 112(2) stores the third packet p2 in the sender in the second network router 112(2) and transfers the third packet p2 to the second scratch-pad in the second network router 112(2). Since the destination of the fourth packet p3 is set to the first network router 112(1), the third network router 112(3) treats the fourth packet p3 received from the fourth network router 112(4) as an all-gather pass packet. Thus, the third network router 112(3) stores the fourth packet p3 in the sender in the third network router 112(3) and transfers the fourth packet p3 to the third scratch-pad in the third network router 112(3). Since the destination of the first packet p0 is set to the second network router 112(2), the fourth network router 112(4) treats the first packet p0 received from the first network router 112(1) as an all-gather pass packet. Thus, the fourth network router 112(4) stores the first packet p0 in the sender in the fourth network router 112(4) and transfers the first packet p0 to the fourth scratch-pad in the fourth network router 112(4).

Referring to FIG. 15B, in the third step (STEP 3) of the all-gather operation, the first network router 112(1) transmits the second packet p1, stored in its sender, in the first direction toward the fourth network router 112(4). The second network router 112(2) transmits the third packet p2, stored in its sender, in the first direction toward the first network router 112(1). The third network router 112(3) transmits the fourth packet p3, stored in its sender, in the first direction toward the second network router 112(2). The fourth network router 112(4) transmits the first packet p0, stored in its sender, in the first direction toward the third network router 112(3). As a result of these transmissions, each of the network routers incrementally receives the packet that originated two hops away in the ring topology. This completes the third phase of the ring-based all-gather, wherein each node accumulates an additional distinct packet from a different node.

Since the destination of the third packet p2 is the fourth network router 112(4), the first network router 112(1) processes the third packet p2, received from the second network router 112(2), as an all-gather pass packet. Specifically, the first network router 112(1) stores the third packet p2 in the sender located within the first network router 112(1), and also transfers the third packet p2 to the first scratch-pad. Since the destination of the fourth packet p3 is the first network router 112(1), the second network router 112(2) processes the fourth packet p3, received from the third network router 112(3), as an all-gather pass packet. Specifically, the second network router 112(2) stores the fourth packet p3 in the sender located within the second network router 112(2), and also transfers the fourth packet p3 to the second scratch-pad. Since the destination of the first packet p0 is the second network router 112(2), the third network router 112(3) processes the first packet p0, received from the fourth network router 112(4), as an all-gather pass packet. Specifically, the third network router 112(3) stores the first packet p0 in the sender located within the third network router 112(3), and also transfers the first packet p0 to the third scratch-pad. Since the destination of the second packet p1 is the third network router 112(3), the fourth network router 112(4) processes the second packet p1, received from the first network router 112(1), as an all-gather pass packet. Specifically, the fourth network router 112(4) stores the second packet p1 in the sender located within the fourth network router 112(4), and also transfers the second packet p1 to the fourth scratch-pad.

In the fourth step (STEP 4) of the all-gather operation, the first network router 112(1) transmits the third packet p2, stored in the sender of the first network router 112(1), to the fourth network router 112(4) in the first direction. The second network router 112(2) transmits the fourth packet p3, stored in the sender of the second network router 112(2), to the first network router 112(1) in the first direction. The third network router 112(3) transmits the first packet p0, stored in the sender of the third network router 112(3), to the second network router 112(2) in the first direction. The fourth network router 112(4) transmits the second packet p1, stored in the sender of the fourth network router 112(4), to the third network router 112(3) in the first direction.

Since the destination of the fourth packet p3 is the first network router 112(1), the first network router 112(1) processes the fourth packet p3, received from the second network router 112(2), as an all-gather target packet. In other words, the first network router 112(1) transfers the fourth packet p3 to the first scratch-pad. Since the destination of the first packet p0 is the second network router 112(2), the second network router 112(2) processes the first packet p0, received from the third network router 112(3), as an all-gather target packet. In other words, the second network router 112(2) transfers the first packet p0 to the second scratch-pad. Since the destination of the second packet p1 is the third network router 112(3), the third network router 112(3) processes the second packet p1, received from the fourth network router 112(4), as an all-gather target packet. In other words, the third network router 112(3) transfers the second packet p1 to the third scratch-pad. Since the destination of the third packet p2 is the fourth network router 112(4), the fourth network router 112(4) processes the third packet p2, received from the first network router 112(1), as an all-gather target packet. In other words, the fourth network router 112(4) transfers the third packet p2 to the fourth scratch-pad.

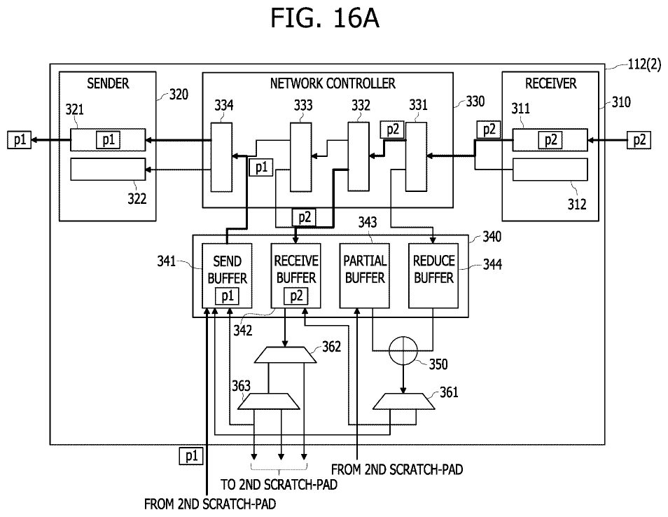

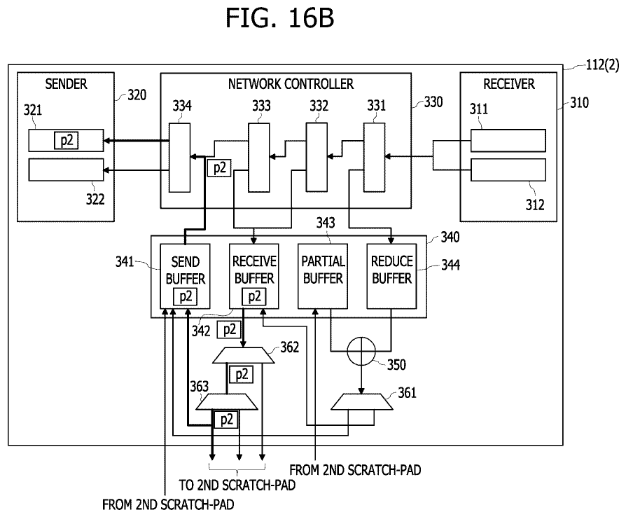

FIGS. 16A and 16B are diagrams illustrating the operation of a second network router in a second step of the all-gather operation shown in FIG. 15A. The description of the operation of the second network router in this example is equally applicable to the operations of the first, third, and fourth network routers in the second step of the all-gather operation.

Referring to FIG. 16A in conjunction with FIG. 15A, in the second step (STEP 2) of the all-gather operation, the second network router 112(2) transmits a second packet p1, which is designated as an all-gather packet, in a first direction to the first network router 112(1), and also receives a third packet p2, which is likewise designated as an all-gather packet, in the first direction from the third network router 112(3). For the transmission of the second packet p1 to the first network router 112(1), the second network router 112(2) reads the second packet p1 from the second scratch-pad and temporarily stores the packet in the send buffer 341 of the buffer circuit 340. The send buffer 341 then transmits the second packet p1 to the input terminal of the fourth packet transmission circuit 334 of the network controller 330. Since the transmission direction of the second packet p1 is the first direction, the fourth packet transmission circuit 334 transmits the second packet p1 to the first sender buffer 321 of the sender 320 via its first output terminal. The sender 320 outputs the second packet p1, stored in the first sender buffer 321, toward the first network router 112(1) in the first direction.

Meanwhile, the receiver 310 of the second network router 112(2) stores a third packet p2, which is transmitted from the third network router 112(3) in the first direction, in a first receiver buffer 311. The receiver 310 transmits the third packet p2 to the input terminal of a first packet transmission circuit 331 included in the network controller 330. Since the third packet p2 is designated as an all-gather packet, the first packet transmission circuit 331 transfers the third packet p2 to the input terminal of a second packet transmission circuit 332 through its first output terminal. The second packet transmission circuit 332 then transfers the third packet p2 to a receive buffer 342 of the buffer circuit 340 via its second output terminal. Although not explicitly illustrated in the drawing, when the third packet p2 is transferred to the receive buffer 342, the network controller 330 of the second network router 112(2) transmits a receive command to the receive buffer 342.

Referring to FIG. 16B in conjunction with FIG. 15A, in response to a receive command, the receive buffer 342 transfers a third packet p2 to the input terminal of a second demultiplexer 362. The second demultiplexer 362 transfers the third packet p2 to the input terminal of a third demultiplexer 363 through its first output terminal. Since the destination of the third packet p2 is set to the fourth network router 112(4), the third packet p2 corresponds to an all-gather pass packet. Accordingly, the third demultiplexer 363 transfers the third packet p2 to both the second scratch-pad and the send buffer 341 of the buffer circuit 340 through its first output terminal. The send buffer 341 transfers the third packet p2 to the input terminal of a fourth packet transmission circuit 334 of the network controller 330. Since the direction in which the third packet p2 is to be transmitted is the first direction, the fourth packet transmission circuit 334 transfers the third packet p2 to the first sender buffer 321 of the sender 320. Although not illustrated in the drawings, during the third step (STEP 3) of the all-gather operation, the sender 320 of the second network router 112(2) transmits the third packet p2 stored in the first sender buffer 321 in the first direction to the first network router 112(1).

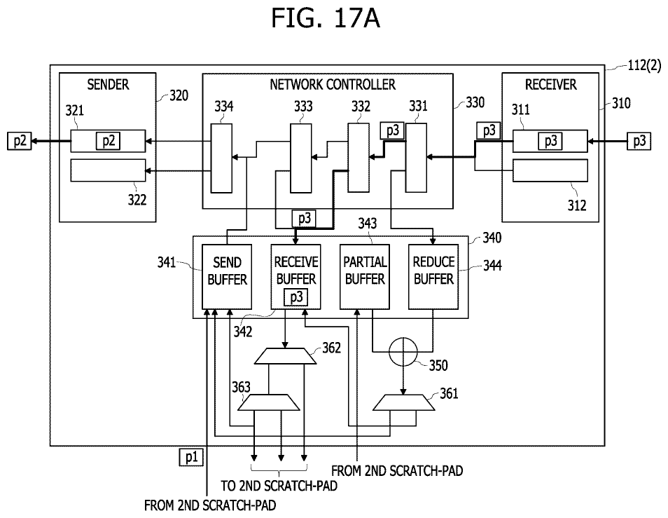

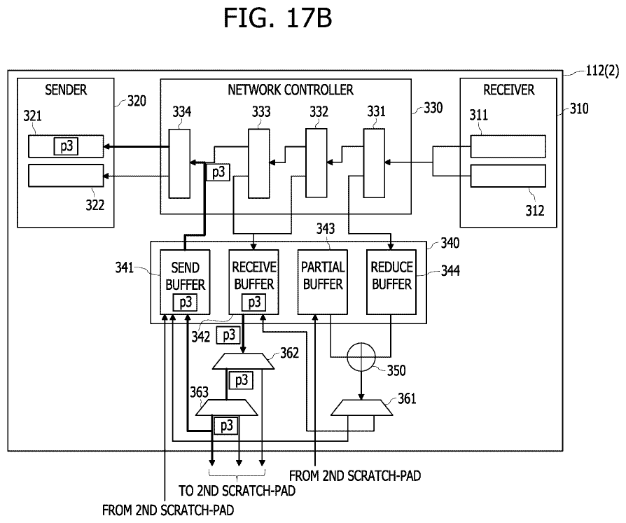

FIGS. 17A and 17B are diagrams illustrating the operation of a second network router in a third step of the all-gather operation shown in FIG. 15B. The description of the operation of the second network router in this example is equally applicable to the operations of the first, third, and fourth network routers in the third step of the all-gather operation.

Referring to FIG. 17A in conjunction with FIG. 15B, during the third step (STEP 3) of the all-gather operation, the second network router 112(2) transmits the third packet p2, which is classified as an all-gather packet, in the first direction toward the first network router 112(1). The second network router 112(2) also receives the fourth packet p3, which is classified as an all-gather packet, from the third network router 112(3) in the first direction. As described with reference to FIGS. 16A and 16B, during the second step (STEP 2) of the all-gather operation, the third packet p2 is stored in the first sender buffer 321 of the sender 320 provided in the second network router 112(2). The sender 320 outputs the third packet p2 stored in the first sender buffer 321, and transmits the third packet p2 in the first direction toward the first network router 112(1).

Upon reception of the fourth packet p3 from the third network router 112(3), the receiver 310 provided in the second network router 112(2) stores the fourth packet p3 in the first receiver buffer 311. The receiver 310 transfers the fourth packet p3 to the input terminal of the first packet transmission circuit 331 included in the network controller 330. Since the fourth packet p3 is classified as an all-gather packet, the first packet transmission circuit 331 transfers the fourth packet p3 to the input terminal of the second packet transmission circuit 332 via the first output terminal. The second packet transmission circuit 332 transfers the fourth packet p3 to the receive buffer 342 included in the buffer circuit 340 via the second output terminal. Although not shown in the drawings, upon completion of the transfer of the fourth packet p3 to the receive buffer 342, the network controller 330 of the second network router 112(2) sends a receive command to the receive buffer 342.

Referring to FIG. 17B in conjunction with FIG. 15B, the receive buffer 342 responds to a receive command by transferring the fourth packet p3 to the input terminal of the second demultiplexer 362. Since the fourth packet p3 is designated as an all-gather packet, the second demultiplexer 362 transfers the fourth packet p3 to the input terminal of the third demultiplexer 363 via the first output terminal. Given that the destination of the fourth packet p3 is the first network router 112(1), the fourth packet p3 corresponds to an all-gather pass packet. Accordingly, the third demultiplexer 363 transfers the fourth packet p3 to the second scratch-pad and also to the send buffer 341 of the buffer circuit 340 via the first output terminal. The send buffer 341 transfers the fourth packet p3 to the input terminal of the fourth packet transmission circuit 334 of the network controller 330. Since the transmission direction of the fourth packet p3 is in the first direction, the fourth packet transmission circuit 334 transfers the fourth packet p3 to the first sender buffer 321 of the sender 320. Although not illustrated in the drawing, during the fourth step (STEP 4) of the all-gather operation, the sender 320 of the second network router 112(2) transmits the fourth packet p3, which is stored in the first sender buffer 321, in the first direction toward the first network router 112(1).

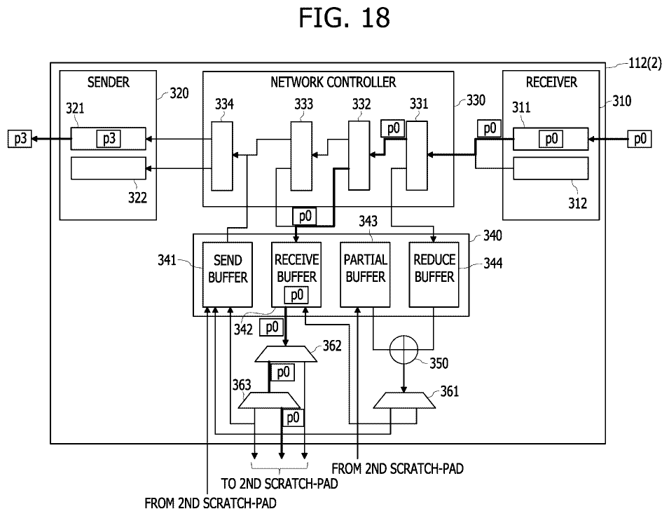

FIG. 18 is a diagram illustrating the operation of a second network router in a fourth step of the all-gather operation shown in FIG. 15B. The description of the operation of the second network router in this example is equally applicable to the operations of the first, third, and fourth network routers in the fourth step of the all-gather operation.

Referring to FIG. 18 in conjunction with FIG. 15B, during the fourth step (STEP 4) of the all-gather operation, the second network router 112(2) transmits the fourth packet p3, designated as an all-gather packet, in the first direction to the first network router 112(1). Additionally, the second network router 112(2) receives the first packet p0, designated as an all-gather packet, in the first direction from the third network router 112(3). As described with reference to FIGS. 17A and 17B, the fourth packet p3 is stored in the first sender buffer 321 of the sender 320 included in the second network router 112(2) during the third step (STEP 3) of the all-gather operation. The sender 320 of the second network router 112(2) outputs the fourth packet p3 stored in the first sender buffer 321 and transmits the fourth packet p3 in the first direction to the first network router 112(1).

Meanwhile, as the first packet p0 is transmitted from the third network router 112(3) in the first direction, the receiver 310 included in the second network router 112(2) stores the first packet p0 in the first receiver buffer 311. The receiver 310 transfers the first packet p0 to an input terminal of the first packet transmission circuit 331 included in the network controller 330. Since the first packet p0 is designated as an all-gather packet, the first packet transmission circuit 331 transmits the first packet p0 to an input terminal of the second packet transmission circuit 332 through a first output terminal. The second packet transmission circuit 332 transfers the first packet p0 to the receive buffer 342 of the buffer circuit 340 through a second output terminal. Although not illustrated in the drawing, when the first packet p0 is transmitted to the receive buffer 342, the network controller 330 of the second network router 112(2) transmits a receive command to the receive buffer 342.

The receive buffer 342, in response to the receive command, transfers the first packet p0 to an input terminal of the second demultiplexer 362. Since the first packet p0 is designated as an all-gather packet, the second demultiplexer 362 transfers the first packet p0 to an input terminal of the third demultiplexer 363 through a first output terminal. Because the destination of the first packet p0 is set to the second network router 112(2), the first packet p0 corresponds to an all-gather target packet. Accordingly, the third demultiplexer 363 transfers the first packet p0 to the second scratch-pad through a second output terminal.

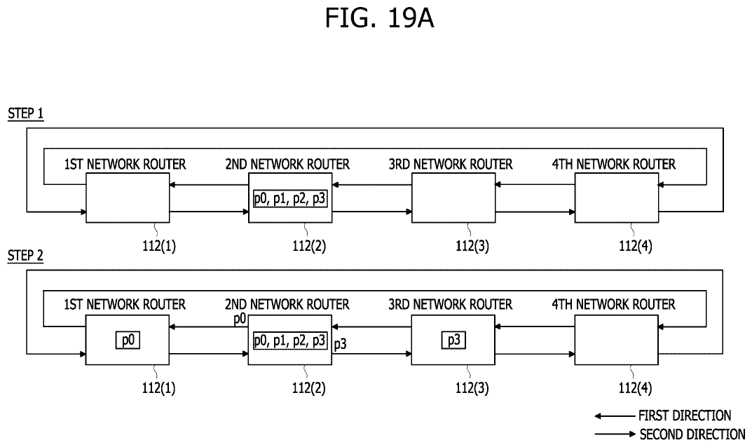

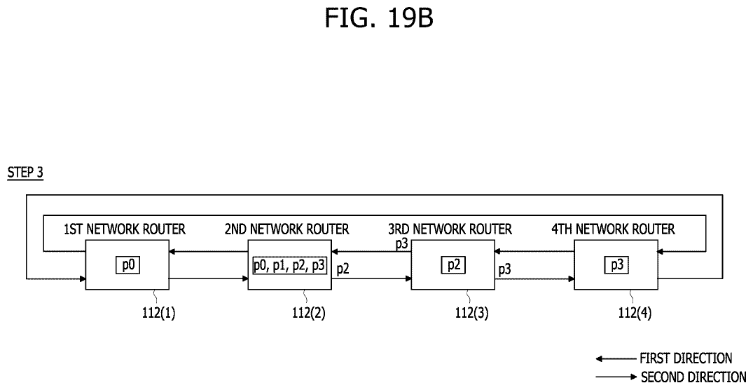

FIGS. 19A and 19B are diagrams illustrating a scatter operation in the accelerator system of FIG. 1 including the network router of FIG. 3.

Referring to FIG. 19A, in a first step (STEP 1) of a scatter operation, a second scratch-pad coupled to a second network router 112(2) stores a first packet p0, a second packet p1, a third packet p2, and a fourth packet p3. In contrast, a first scratch-pad coupled to a first network router 112(1), a third scratch-pad coupled to a third network router 112(3), and a fourth scratch-pad coupled to a fourth network router 112(4) are assumed not to store the first packet p0, the third packet p2, or the fourth packet p3, respectively. The scatter operation may be performed by distributing and storing the first packet p0, the third packet p2, and the fourth packet p3, which are originally stored in the second scratch-pad, to the first scratch-pad, the third scratch-pad, and the fourth scratch-pad, respectively. During the scatter operation, the type of each packet transmitted among the network routers is designated as a transmission packet. Depending on a destination configuration, each scatter packet may be handled as either a transmission path packet or a transmission target packet.

In a second step (STEP 2) of the scatter operation, the second network router 112(2) transmits a first packet p0, stored in the second scratch-pad, to the first network router 112(1) in a first direction. Additionally, the second network router 112(2) transmits a fourth packet p3, also stored in the second scratch-pad, to the third network router 112(3) in a second direction. The destination of the first packet p0 is configured to be the first network router 112(1), and the destination of the fourth packet p3 is configured to be the fourth network router 112(4). Accordingly, the first network router 112(1) processes the first packet p0 received from the second network router 112(2) as a transmission target packet. That is, the first network router 112(1) stores the first packet p0 in the first scratch-pad. This process may be performed in the same manner as the process described with reference to FIG. 7, in which the fourth network router 112(4) processes the first packet p0 as a transmission target packet. Meanwhile, the third network router 112(3) processes the fourth packet p3 received from the second network router 112(2) as a transmission path packet. Specifically, the third network router 112(3) stores the fourth packet p3 in a sender of the third network router 112(3). This process may be performed in the same manner as the process described with reference to FIG. 10, in which the third network router 112(3) processes the first packet p0 as a transmission path packet.

In a third step (STEP 3) of the scatter operation, the second network router 112(2) transmits a third packet p2, which is stored in the second scratch-pad, to the third network router 112(3) in a second direction. In parallel, the third network router 112(3) transmits a fourth packet p3, stored in a sender of the third network router 112(3), to the fourth network router 112(4) in the second direction. The destination of the third packet p2, which is transmitted from the second network router 112(2), is set to the third network router 112(3). Accordingly, the third network router 112(3) processes the third packet p2, received from the second network router 112(2), as a transmission target packet. Specifically, the third network router 112(3) transfers the third packet p2 to the third scratch-pad. This process may be carried out in the same manner as the operation described with reference to FIG. 11, where the third network router 112(3) processes the first packet p0 as a transmission target packet. The fourth packet p3, which is transmitted from the third network router 112(3) to the fourth network router 112(4), has a destination set to the fourth network router 112(4). Therefore, the fourth network router 112(4) processes the fourth packet p3 as a transmission target packet. That is, the fourth network router 112(4) stores the fourth packet p3, received from the third network router 112(3), in the fourth scratch-pad. This operation may also be performed in the same manner as the process described with reference to FIG. 11, where the third network router 112(3) processes the first packet p0 as a transmission target packet.

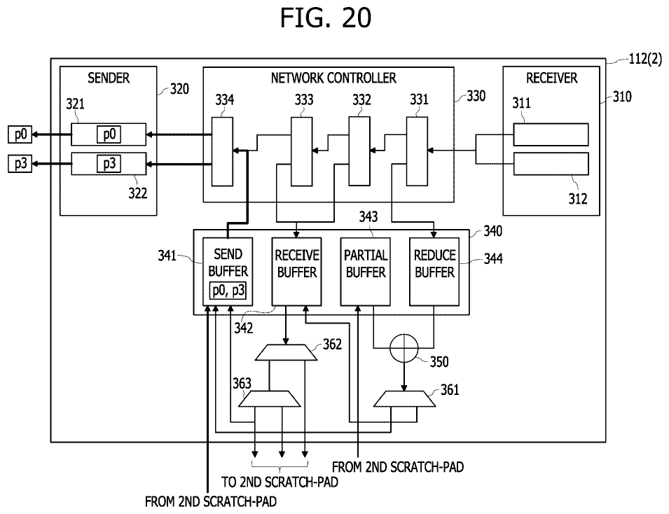

FIG. 20 is a diagram illustrating the operation of a second network router in a second step of the scatter operation shown in FIG. 19A.

Referring to FIG. 20 in conjunction with FIG. 19A, the second network router 112(2) reads a first packet p0 and a fourth packet p3, each configured as a scatter packet, from a second scratch-pad and temporarily stores the first packet p0 and the fourth packet p3 in a send buffer 341 of a buffer circuit 340. The send buffer 341 transfers the first packet p0 to an input terminal of a fourth packet transmission circuit 334 of a network controller 330. The destination of the first packet p0 is set to the first network router 112(1), and a transmission direction is set to a first direction. Accordingly, the fourth packet transmission circuit 334 transmits the first packet p0 to a first sender buffer 321 of a sender 320 via a first output terminal. Subsequently, the send buffer 341 transfers the fourth packet p3 to the input terminal of the fourth packet transmission circuit 334 of the network controller 330. The destination of the fourth packet p3 is set to the fourth network router 112(4), and the transmission direction is set to a second direction. Accordingly, the fourth packet transmission circuit 334 transmits the fourth packet p3 to a second sender buffer 322 of the sender 320 via a second output terminal. The sender 320 outputs the first packet p0, which has been stored in the first sender buffer 321, toward the first network router 112(1) along the first direction. The sender 320 also outputs the fourth packet p3, which has been stored in the second sender buffer 322, toward the third network router 112(3) along the second direction.

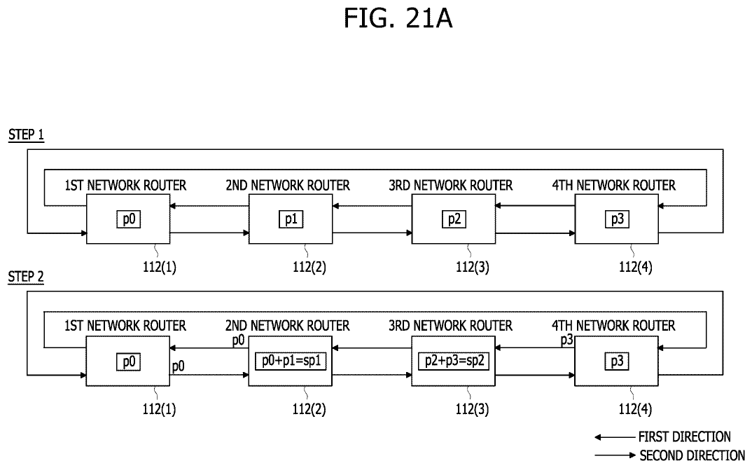

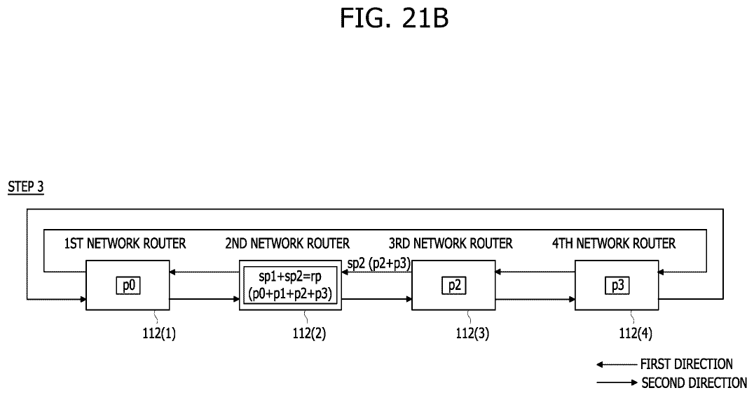

FIGS. 21A and 21B are diagrams illustrating an example of a reduce operation in the accelerator system of FIG. 1 including the network router of FIG. 3.

Referring to FIG. 21A, in a first step (STEP 1) of a reduce operation, a first packet p0 is stored in a first scratch-pad coupled to a first network router 112(1), a second packet p1 is stored in a second scratch-pad coupled to a second network router 112(2), a third packet p2 is stored in a third scratch-pad coupled to a third network router 112(3), and a fourth packet p3 is stored in a fourth scratch-pad coupled to a fourth network router 112(4). For the purposes of explanation, a case in which a root network router for storing reduce result packets is set to the second network router 112(2) is described as an example. The reduce operation can be carried out through various processes.

In one example, the reduce operation may be performed in such a manner that a reduction computation is executed only at the root network router, which is the second network router 112(2). In this case, the reduce operation may be carried out by sequentially transmitting the first packet p0, the third packet p2, and the fourth packet p3 from the first network router 112(1), the third network router 112(3), and the fourth network router 112(4), respectively, to the second network router 112(2), and by sequentially performing reduction computations using the first packet p0, the third packet p2, and the fourth packet p3 at the second network router 112(2) after reception of each corresponding packet.

In another example, the reduce operation may be performed in such a manner that reduction computations, such as addition operations, are also carried out at network routers other than the root network router, which is the second network router 112(2). In this case, the reduce operation may be executed by performing an addition operation between the first packet p0 and the second packet p1 at the second network router 112(2), performing an addition operation between the third packet p2 and the fourth packet p3 at the third network router 112(3), and subsequently performing an additional addition operation at the second network router 112(2) to combine the result of the addition between the first packet p0 and the second packet p1 and the result of the addition between the third packet p2 and the fourth packet p3. Hereinafter, a method in which the reduce computations are distributed and executed across multiple network routers will be described. In the reduction operation according to the present example, the packet type of each packet used as an operand for the reduce computation is set to a reduce packet. Accordingly, the packet type of each partial addition packet generated during the reduce computation is also set to a reduce packet. Furthermore, the packet type of each reduce result packet generated during the reduce computation is set to a transmission packet. Based on the destination setting, each reduce packet and each partial addition packet may be processed as either a reduce pass packet or a reduce target packet, and each reduce result packet may be processed as either a transmission pass packet or a transmission target packet.

In a second step (STEP 2) of the reduce operation, the first network router 112(1) transmits the first packet p0, stored in the first scratch-pad, as a reduce packet toward the second network router 112(2) in the second direction. Additionally, the fourth network router 112(4) transmits the fourth packet p3, stored in the fourth scratch-pad, as a reduce packet toward the third network router 112(3) in the first direction. The destination for both the first packet p0 and the fourth packet p3 is set to the second network router 112(2). Accordingly, the second network router 112(2) processes the first packet p0 as a reduce target packet. The third network router 112(3) processes the fourth packet p3 as a reduce pass packet. Specifically, the second network router 112(2) performs a reduce computation, such as an addition operation, using the first packet p0, received from the first network router 112(1), and the second packet p1 stored in the second scratch-pad, thereby generating a first partial sum packet sp1. Because the first packet p0 is a reduce target packet, the second network router 112(2) processes the first partial sum packet sp1 as a reduce target packet. The second network router 112(2) then transmits the first partial sum packet sp1 to the second scratch-pad. In a similar manner, the third network router 112(3) performs an addition operation using the third packet p2, received from the fourth network router 112(4), and the fourth packet p3 stored in the third scratch-pad, thereby generating a second partial sum packet sp2. Because the fourth packet p3 is a reduce pass packet, the third network router 112(3) processes the second partial sum packet sp2 as a reduce pass packet. The third network router 112(3) stores the second partial sum packet sp2 in the sender of the third network router 112(3).

Referring to FIG. 21B, in a third step (STEP 3) of the reduce operation, the third network router 112(3) transmits the second partial sum packet sp2, which has been generated and stored in the sender during the second step (STEP 2), toward the second network router 112(2) in the first direction. The second network router 112(2) performs an addition operation using the first partial sum packet sp1, which has been generated during the second step (STEP 2) and stored in the second scratch-pad, and the second partial sum packet sp2 received from the third network router 112(3), thereby generating a reduce result packet rp. Since the first partial sum packet sp1 represents the sum of the first packet p0 and the second packet p1, and the second partial sum packet sp2 represents the sum of the third packet p2 and the fourth packet p3, the reduce result packet rp represents the aggregated result of the first packet p0, the second packet p1, the third packet p2, and the fourth packet p3. Because the destination of the second partial sum packet sp2 is set to the second network router 112(2), the second network router 112(2) processes the reduce result packet rp as a reduce result target packet, that is, as a transfer target packet. The second network router 112(2) then transmits the reduce result packet rp to the second scratch-pad.

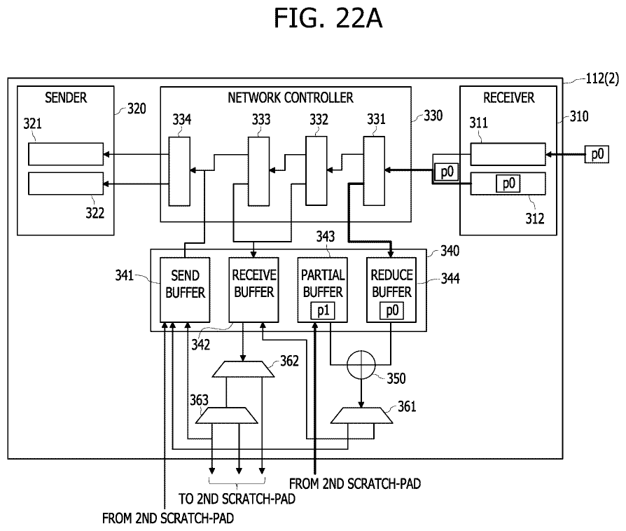

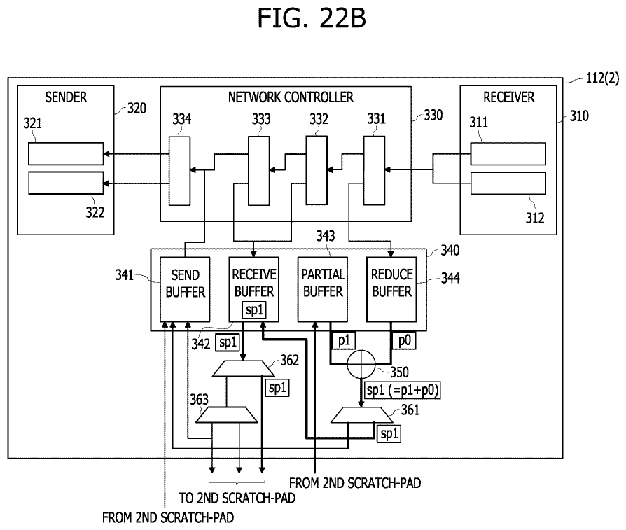

FIGS. 22A and 22B are diagrams illustrating the operation of a second network router in a second step of the reduce operation shown in FIG. 21A.

Referring to FIG. 22A in conjunction with FIG. 21A, in a second step (STEP 2) of the reduce operation, the second network router 112(2) receives the first packet p0, which is a reduce packet, from the first network router 112(1) in the second direction. As previously described with reference to FIG. 21A, the destination of the first packet p0 is set to the second network router 112(2). Since the transfer direction of the first packet p0 is the second direction, the receiver 310 of the second network router 112(2) stores the first packet p0 in the second receiver buffer 312. The receiver 310 transmits the first packet p0, stored in the second receiver buffer 312, to an input terminal of the first packet transmission circuit 331 of the network controller 330. Since the first packet p0 is a reduce packet, the first packet transmission circuit 331 transmits the first packet p0 to the reduce buffer 344 of the buffer circuit 340 via a second output terminal. Upon storage of the first packet p0, which is a reduce packet, in the reduce buffer 344, the second network router 112(2) obtains the second packet p1 from the second scratch-pad. The second packet p1 is also used in the reduce operation and is stored in the partial buffer 343 of the buffer circuit 340. As a result, the partial buffer 343 and the reduce buffer 344 of the buffer circuit 340 respectively store the second packet p1 and the first packet p0.

Referring to FIG. 22B in conjunction with FIG. 21A, the partial buffer 343 transmits the second packet p1 to a first input terminal of the reduce operation circuit 350. The reduce buffer 344 transmits the first packet p0 to a second input terminal of the reduce operation circuit 350. The reduce operation circuit 350 performs a reduce operation, specifically an addition operation, on the second packet p1 and the first packet p0 and generates a first partial sum packet sp1 as a result of the operation p1+p0. The reduce operation circuit 350 transmits the first partial sum packet sp1 to an input terminal of the first demultiplexer 361. As previously described with reference to FIG. 21A, since the first partial sum packet sp1 is a reduce target packet, the first demultiplexer 361 transmits the first partial sum packet sp1 to the receive buffer 342 of the buffer circuit 340 via a second output terminal. Although not shown in the drawing, upon transmission of the first partial sum packet sp1 to the receive buffer 342, the network controller 330 of the second network router 112(2) transmits a receive command to the receive buffer 342. In response to the receive command, the receive buffer 342 transmits the first partial sum packet sp1 to an input terminal of the second demultiplexer 362. Since the first partial sum packet sp1 is a reduce target packet, the second demultiplexer 362 transmits the first partial sum packet sp1 to the second scratch-pad via a second output terminal.

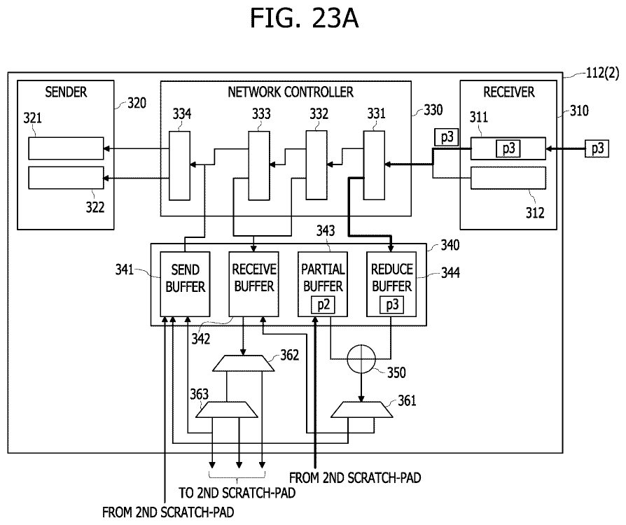

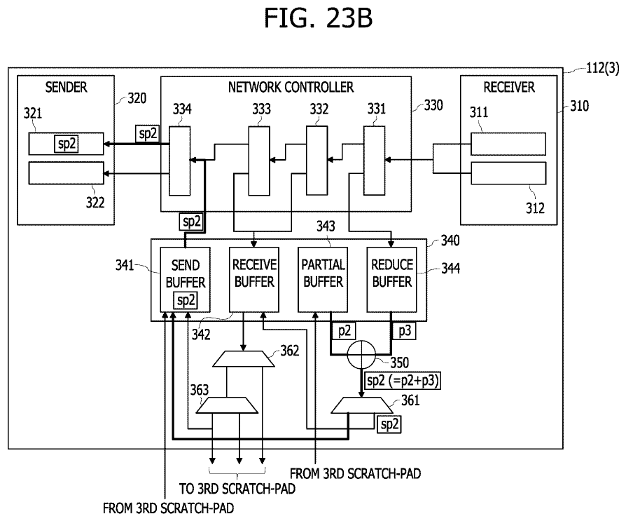

FIGS. 23A and 23B are diagrams illustrating the operation of a third network router in a second step of the reduce operation shown in FIG. 21A.

Referring to FIG. 23A in conjunction with FIG. 21A, during the second step (STEP 2) of the reduce operation, the third network router 112(3) receives a fourth packet p3 from the fourth network router 112(4) along a first direction. As previously described with reference to FIG. 21A, the fourth packet p3 has a destination set to the second network router 112(2), which serves as the root network router. Since the transmission direction of the fourth packet p3 is the first direction, a receiver 310 of the third network router 112(3) stores the fourth packet p3 in a first receiver buffer 311. The receiver 310 transmits the fourth packet p3 stored in the first receiver buffer 311 to an input terminal of a first packet transmission circuit 331 of the network controller 330. Since the fourth packet p3 is a reduce packet, the first packet transmission circuit 331 transfers the fourth packet p3 to a reduce buffer 344 of a buffer circuit 340 via a second output terminal. Upon storage of the reduce packet, namely the fourth packet p3, in the reduce buffer 344, the third network router 112(3) receives a third packet p2 from a third scratch-pad and stores the third packet p2 in a partial buffer 343 of the buffer circuit 340 for use in a reduce operation along with the fourth packet p3. As a result, the partial buffer 343 and the reduce buffer 344 of the buffer circuit 340 respectively store the third packet p2 and the fourth packet p3.

Referring to FIG. 23B in conjunction with FIG. 21A, a partial buffer 343 transfers a third packet p2 to a first input terminal of a reduce operation circuit 350. A reduce buffer 344 transfers a fourth packet p3 to a second input terminal of the reduce operation circuit 350. The reduce operation circuit 350 performs a reduce operation, specifically an addition operation, on the third packet p2 and the fourth packet p3, and generates a second partial sum packet sp2, which is the result of the operation p2+p3. The reduce operation circuit 350 transfers the second partial sum packet sp2 to an input terminal of a first demultiplexer 361. As described with reference to FIG. 21A, the second partial sum packet sp2 is classified as a reduce pass packet. Accordingly, the first demultiplexer 361 transfers the second partial sum packet sp2 to a send buffer 341 of a buffer circuit 340 via a first output terminal. The send buffer 341 transfers the second partial sum packet sp2 to an input terminal of a fourth packet transmission circuit 334 of a network controller 330. Since the transmission direction of the second partial sum packet sp2 is the first direction, the fourth packet transmission circuit 334 transfers the second partial sum packet sp2 to a first sender buffer 321 of a sender 320 via a first output terminal. Although not explicitly illustrated in the drawing, as previously described with reference to FIG. 21B, in the third step (STEP 3) of the reduce operation, the sender 320 of the third network router 112(3) transmits the second partial sum packet sp2 stored in the first sender buffer 321 to the second network router 112(2) along the first direction.

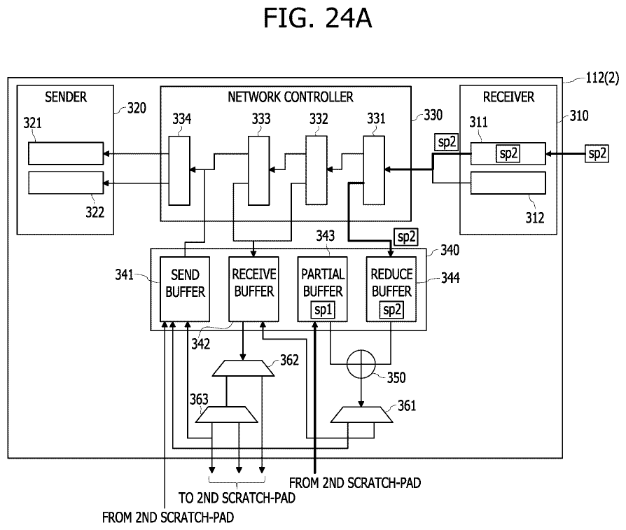

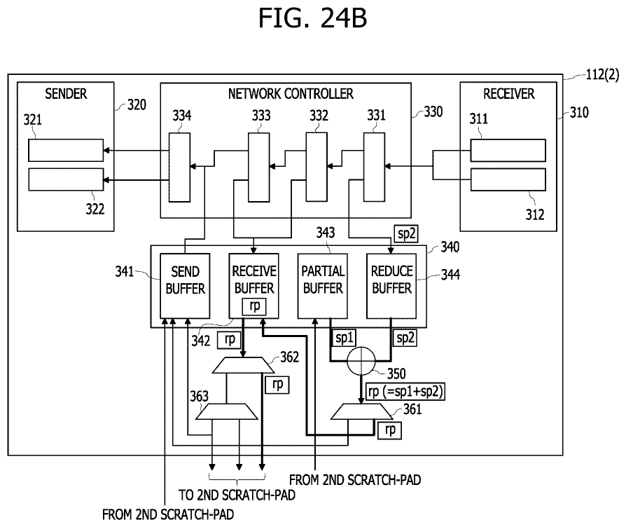

FIGS. 24A and 24B are diagrams illustrating the operation of a second network router in a third step of the reduce operation shown in FIG. 21B.

Referring to FIG. 24A in conjunction with FIG. 21B, in a third step (STEP 3) of a reduce operation, a second network router 112(2) receives a second partial sum packet sp2 from a third network router 112(3) along a first direction. As described with reference to FIG. 21A, the second partial sum packet sp2 has a destination set to the second network router 112(2), which functions as a root network router. Since the transfer direction of the second partial sum packet sp2 is the first direction, a receiver 310 of the second network router 112(2) stores the second partial sum packet sp2 in a first receiver buffer 311. The receiver 310 transfers the second partial sum packet sp2, stored in the first receiver buffer 311, to an input terminal of a first packet transmission circuit 331 of a network controller 330. Since the second partial sum packet sp2 corresponds to a reduce packet, the first packet transmission circuit 331 transfers the second partial sum packet sp2 to a reduce buffer 344 of a buffer circuit 340 via a second output terminal. As the reduce packet sp2 is stored in the reduce buffer 344, the second network router 112(2) transfers a first partial sum packet sp1, which is used together with the second partial sum packet sp2 for a reduce operation, from a second scratch-pad to a partial buffer 343 of the buffer circuit 340. As a result, the partial buffer 343 and the reduce buffer 344 store the first partial sum packet sp1 and the second partial sum packet sp2, respectively.

Referring to FIG. 24B in conjunction with FIG. 21A, a partial buffer 343 transfers a first partial sum packet sp1 to a first input terminal of a reduce operation circuit 350. A reduce buffer 344 transfers a second partial sum packet sp2 to a second input terminal of the reduce operation circuit 350. The reduce operation circuit 350 performs a reduce operation, specifically an addition operation, on the first partial sum packet sp1 and the second partial sum packet sp2 to generate a reduce result packet rp that corresponds to the result of sp1+sp2. The reduce operation circuit 350 transfers the reduce result packet rp to an input terminal of a first demultiplexer 361. As described with reference to FIG. 21B, the reduce result packet rp corresponds to a reduce result target packet. Therefore, the first demultiplexer 361 transfers a seventh packet p6, corresponding to the reduce result packet rp, to a receive buffer 342 of a buffer circuit 340 via a second output terminal. Although not shown in the drawings, when the reduce result packet rp is transferred to the receive buffer 342, a network controller 330 of the second network router 112(2) transfers a receive command to the receive buffer 342. In response to the receive command, the receive buffer 342 transfers the reduce result packet rp to an input terminal of a second demultiplexer 362. Since the reduce result packet rp corresponds to a reduce result target packet, the second demultiplexer 362 transfers the reduce result packet rp to a second scratch-pad via a second output terminal.

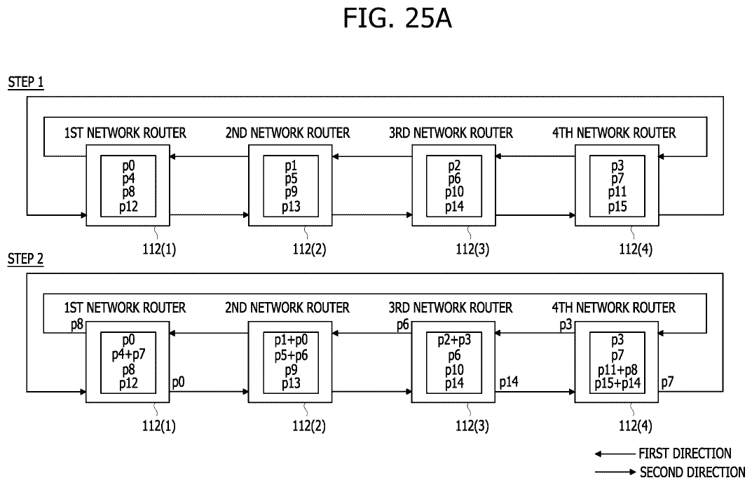

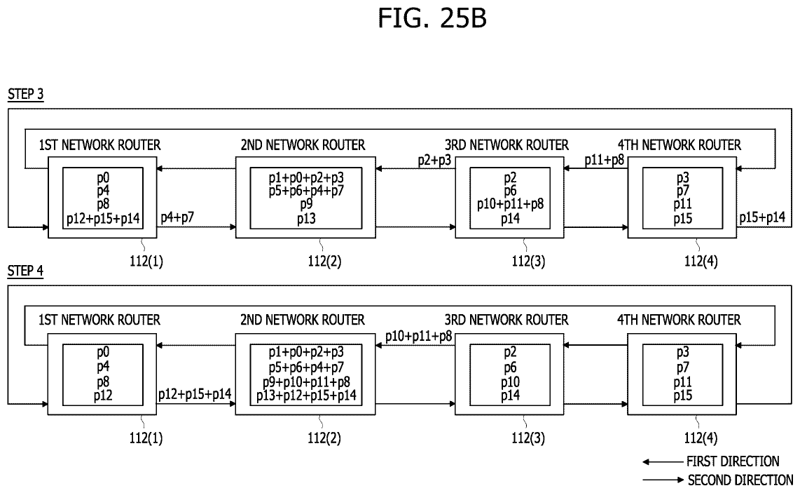

FIGS. 25A to 25B are diagrams illustrating another example of the reduce operation in the accelerator system of FIG. 1 including the network router of FIG. 3.

Referring to FIG. 25A, in a first step (STEP 1) of the reduce operation, a first scratch-pad coupled to a first network router 112(1) stores a first group of packets p0, p4, p8, and p12. A second scratch-pad coupled to a second network router 112(2) stores a second group of packets p1, p5, p9, and p13. A third scratch-pad coupled to a third network router 112(3) stores a third group of packets p2, p6, p10, and p14. A fourth scratch-pad coupled to a fourth network router 112(4) stores a fourth group of packets p3, p7, p11, and p15. In one example, the first group of packets p0, p4, p8, p12 may correspond to elements of the first through fourth rows of a first input vector. The second group of packets p1, p5, p9, p13 may correspond to elements of the first through fourth rows of a second input vector. The third group of packets p2, p6, p10, p14 may correspond to elements of the first through fourth rows of a third input vector. Similarly, the fourth group of packets p3, p7, p11, p15 may correspond to elements of the first through fourth rows of a fourth input vector.

In the present example, the reduce operation may be performed such that a first reduce result packet, corresponding to first through fourth packets p0 through p3 that represent elements in the first row of the first through fourth vector matrices, a second reduce result packet, corresponding to fifth through eighth packets p4 through p7 that represent elements in the second row of the first through fourth vector matrices, a third reduce result packet, corresponding to ninth through twelfth packets p8 through p11 that represent elements in the third row of the first through fourth vector matrices, and a fourth reduce result packet, corresponding to thirteenth through sixteenth packets p12 through p15 that represent elements in the fourth row of the first through fourth vector matrices, are all stored in a second scratch-pad coupled to the second network router 112(2). During the reduce operation process according to this example, each packet used as an operand of the reduce operation is configured as a reduce packet. Accordingly, partial sum packets generated during the reduce operation are also configured as reduce packets. Reduce result packets, which are generated as final outputs of the reduce operation, are configured as transfer packets. Depending on the destination settings, reduce packets and partial sum packets may be processed as either reduce pass packets or reduce target packets, while reduce result packets may be processed as either transfer pass packets or transfer target packets.

In the second step (STEP 2) of the reduce operation, the first network router 112(1) transmits a ninth packet p8, which is stored in a first scratch-pad coupled thereto, toward the fourth network router 112(4) in a first direction. The first network router 112(1) also transmits a first packet p0, which is also stored in the first scratch-pad, toward the second network router 112(2) in a second direction. The destination of both the ninth packet p8 and the first packet p0 is set to the second network router 112(2). The third network router 112(3) transmits a seventh packet p6, stored in a third scratch-pad coupled thereto, toward the second network router 112(2) in the first direction. In addition, the third network router 112(3) transmits a fifteenth packet p14, also stored in the third scratch-pad, toward the fourth network router 112(4) in the second direction. The destinations of both the seventh packet p6 and the fifteenth packet p14 are likewise set to the second network router 112(2). The fourth network router 112(4) transmits a fourth packet p3, which is stored in a fourth scratch-pad coupled thereto, toward the third network router 112(3) in the first direction. The fourth network router 112(4) also transmits an eighth packet p7, also stored in the fourth scratch-pad, toward the first network router 112(1) in the second direction. The destinations of both the fourth packet p3 and the eighth packet p7 are set to the second network router 112(2).

The first network router 112(1), having received an eighth packet p7 from the fourth network router 112(4), performs a reduce operation, for example, an addition operation, on the fifth packet p4 stored in the first scratch-pad and the received eighth packet p7, thereby generating a first partial sum packet p4+p7. Since the destination of the eighth packet p7 is set to the second network router 112(2), the destination of the first partial sum packet p4+p7 is also set to the second network router 112(2). Accordingly, the first network router 112(1) handles the first partial sum packet p4+p7 as a reduce pass packet. That is, the first network router 112(1) stores the first partial sum packet p4+p7 in a sender (or transmission buffer) of the first network router 112(1).

The second network router 112(2), having received a first packet p0 from the first network router 112(1), performs an addition operation on the first packet p0 and a second packet p1 stored in the second scratch-pad to generate a second partial sum packet p1+p0. Since the destination of the first packet p0 is set to the second network router 112(2), the destination of the second partial sum packet p1+p0 is also set to the second network router 112(2). Accordingly, the second network router 112(2) handles the second partial sum packet p1+p0 as a reduce target packet. That is, the second network router 112(2) transmits the second partial sum packet p1+p0 to the second scratch-pad. The second network router 112(2), having received a seventh packet p6 from the third network router 112(3), performs an addition operation on the seventh packet p6 and a sixth packet p5 stored in the second scratch-pad to generate a third partial sum packet p5+p6. Since the destination of the seventh packet p6 is set to the second network router 112(2), the destination of the third partial sum packet p5+p6 is also set to the second network router 112(2). Accordingly, the second network router 112(2) handles the third partial sum packet p5+p6 as a reduce target packet. That is, the second network router 112(2) transmits the third partial sum packet p5+p6 to the second scratch-pad.

The third network router 112(3), having received a fourth packet p3 from the fourth network router 112(4), performs a reduce operation, such as an addition operation, on a third packet p2 stored in the third scratch-pad and the received fourth packet p3 to generate a fourth partial sum packet p2+p3. Since the destination of the fourth packet p3 is set to the second network router 112(2), the destination of the fourth partial sum packet p2+p3 is also set to the second network router 112(2). Accordingly, the third network router 112(3) handles the fourth partial sum packet p2+p3 as a reduce pass packet. That is, the third network router 112(3) stores the fourth partial sum packet p2+p3 in the sender of the third network router 112(3).

The fourth network router 112(4), having received a ninth packet p8 from the first network router 112(1), performs an addition operation on a twelfth packet p11 stored in the fourth scratch-pad and the received ninth packet p8 to generate a fifth partial sum packet p11+p8. Since the destination of the ninth packet p8 is set to the second network router 112(2), the destination of the fifth partial sum packet p11+p8 is also set to the second network router 112(2). Accordingly, the fourth network router 112(4) handles the fifth partial sum packet p11+p8 as a reduce pass packet. Specifically, the fourth network router 112(4) stores the fifth partial sum packet p11+p8 in the sender of the fourth network router 112(4). Subsequently, the fourth network router 112(4), having received a fifteenth packet p14 from the third network router 112(3), performs an addition operation on a sixteenth packet p15 stored in the fourth scratch-pad and the received fifteenth packet p14 to generate a sixth partial sum packet p15+p14. Since the destination of the sixteenth packet p15 is set to the second network router 112(2), the destination of the sixth partial sum packet p15+p14 is also set to the second network router 112(2). Accordingly, the fourth network router 112(4) handles the sixth partial sum packet p15+p14 as a reduce pass packet. Specifically, the fourth network router 112(4) stores the sixth partial sum packet p15+p14 in the sender of the fourth network router 112(4).

Referring to FIG. 25B, in a third step (STEP 3) of a reduce operation, the first network router 112(1) transmits a first partial sum packet p4+p7, stored in the sender of the first network router 112(1), toward the second direction to the second network router 112(2). The third network router 112(3) transmits a fourth partial sum packet p2+p3, stored in the sender of the third network router 112(3), toward the first direction to the second network router 112(2). The fourth network router 112(4) transmits a fifth partial sum packet p11+p8, stored in the sender of the fourth network router 112(4), toward the first direction to the third network router 112(3). The fourth network router 112(4) also transmits a sixth partial sum packet p15+p14, stored in the sender of the fourth network router 112(4), toward the second direction to the first network router 112(1).

Upon receiving a sixth partial sum packet p15+p14 from the fourth network router 112(4), the first network router 112(1) performs a summation operation between the thirteenth packet p12 stored in the first scratch-pad and the sixth partial sum packet p15+p14, thereby generating a seventh partial sum packet p12+p15+p14. Since the destination of the sixth partial sum packet p15+p14 is set to the second network router 112(2), the seventh partial sum packet p12+p15+p14 is also assigned the second network router 112(2) as its destination. Accordingly, the first network router 112(1) processes the seventh partial sum packet p12+p15+p14 as a reduce pass packet. That is, the first network router 112(1) stores the seventh partial sum packet p12+p15+p14 in the sender of the first network router 112(1).

Upon receiving a fourth partial sum packet p2+p3 from the third network router 112(3), the second network router 112(2) performs a summation operation between the second partial sum packet p1+p0, which is stored in the second scratch-pad, and the fourth partial sum packet p2+p3, thereby generating a first reduce result packet p1+p0+p2+p3. Since the destination of the fourth partial sum packet p2+p3 is set to the second network router 112(2), the first reduce result packet p1+p0+p2+p3 is also assigned the second network router 112(2) as its destination. Accordingly, the second network router 112(2) processes the first reduce result packet p1+p0+p2+p3 as a transmission target packet. That is, the second network router 112(2) transfers the first reduce result packet p1+p0+p2+p3 to the second scratch-pad.

Upon receiving a first partial sum packet p4+p7 from the first network router 112(1), the second network router 112(2) performs a summation operation between the third partial sum packet p5+p6, which is stored in the second scratch-pad, and the first partial sum packet p4+p7, thereby generating a second reduce result packet p5+p6+p4+p7. Since the destination of the first partial sum packet p4+p7 is set to the second network router 112(2), the second reduce result packet p5+p6+p4+p7 is also assigned the second network router 112(2) as its destination. Accordingly, the second network router 112(2) processes the second reduce result packet p5+p6+p4+p7 as a transmission target packet. That is, the second network router 112(2) transfers the second reduce result packet p5+p6+p4+p7 to the second scratch-pad.

Upon receiving a fifth partial sum packet p11+p8 from the fourth network router 112(4), the third network router 112(3) performs a summation operation between the eleventh packet p10, which is stored in the third scratch-pad, and the fifth partial sum packet p11+p8, thereby generating an eighth partial sum packet p10+p11+p8. Since the destination of the fifth partial sum packet p11+p8 is set to the second network router 112(2), the eighth partial sum packet p10+p11+p8 is also assigned the second network router 112(2) as its destination. Accordingly, the third network router 112(3) processes the eighth partial sum packet p10+p11+p8 as a reduce pass packet. That is, the third network router 112(3) stores the eighth partial sum packet p10+p11+p8 in its sender.

In a fourth step (STEP 4) of the reduce operation, the first network router 112(1) transmits a seventh partial sum packet p12+p15+p14, which is stored in a sender of the first network router 112(1), toward the second network router 112(2) along a second direction. The third network router 112(3) transmits an eighth partial sum packet p10+p11+p8, which is stored in a sender of the third network router 112(3), toward the second network router 112(2) along the second direction.

Upon receiving the eighth partial sum packet p10+p11+p8 from the third network router 112(3), the second network router 112(2) performs a sum operation on a tenth packet p9, which is stored in a second scratch-pad coupled to the second network router 112(2), and the eighth partial sum packet p10+p11+p8, thereby generating a third reduce result packet p9+p10+p11+p8. Since the destination of the eighth partial sum packet p10+p11+p8 is set to the second network router 112(2), the third reduce result packet p9+p10+p11+p8 is also designated to the second network router 112(2). Accordingly, the second network router 112(2) handles the third reduce result packet p9+p10+p11+p8 as a transmission target packet. That is, the second network router 112(2) transmits the third reduce result packet p9+p10+p11+p8 to the second scratch-pad.

Upon receiving a seventh partial sum packet p12+p15+p14 from the first network router 112(1), the second network router 112(2) performs a sum operation on a fourteenth packet p13, which is stored in a second scratch-pad coupled to the second network router 112(2), and the seventh partial sum packet p12+p15+p14, thereby generating a fourth reduce result packet p13+p12+p15+p14. Since the destination of the seventh partial sum packet p12+p15+p14 is set to the second network router 112(2), the fourth reduce result packet p13+p12+p15+p14 is also designated to the second network router 112(2). Accordingly, the second network router 112(2) handles the fourth reduce result packet p13+p12+p15+p14 as a transmission target packet. That is, the second network router 112(2) transmits the fourth reduce result packet p13+p12+p15+p14 to the second scratch-pad.

As a result of the foregoing steps, a first reduce result packet p1+p0+p2+p3, corresponding to a reduce operation performed on first through fourth packets p0, p1, p2, p3 which are elements of the first row of the first through fourth vector matrices, a second reduce result packet p5+p6+p4+p7, corresponding to a reduce operation performed on fifth through eighth packets p4, p5, p6, p7 which are elements of the second row of the first through fourth vector matrices, a third reduce result packet p9+p10+p11+p8, corresponding to a reduce operation performed on ninth through twelfth packets p8, p9, p10, p11 which are elements of the third row of the first through fourth vector matrices, and a fourth reduce result packet p13+p12+p15+p14, corresponding to a reduce operation performed on thirteenth through sixteenth packets p12, p13, p14, p15 which are elements of the fourth row of the first through fourth vector matrices, are all stored in the second scratch-pad coupled to the second network router 112(2).

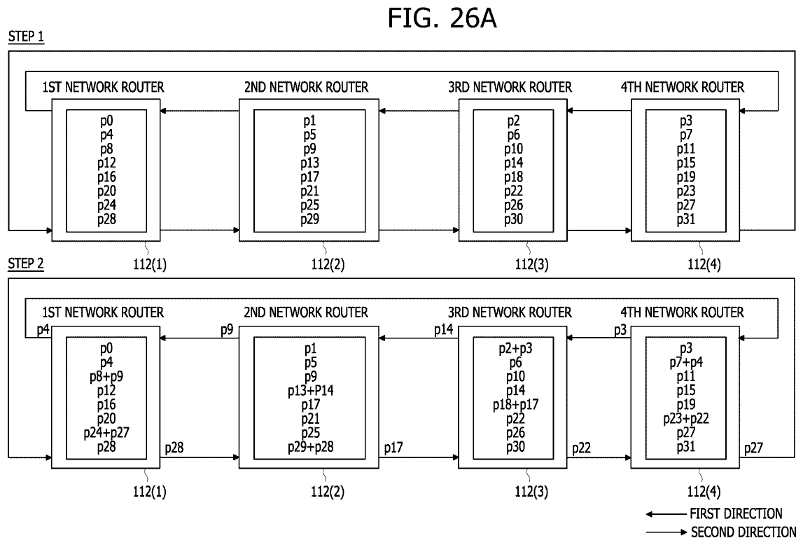

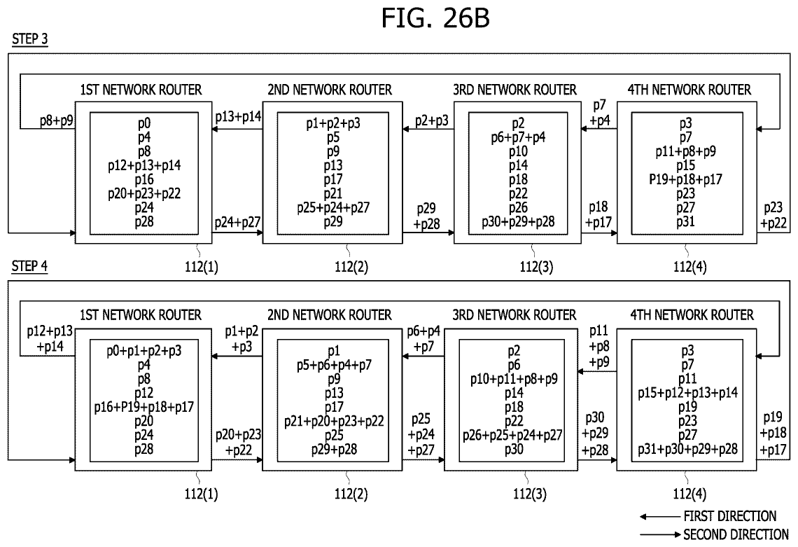

FIGS. 26A and 26B are diagrams illustrating a reduce-scatter operation in the accelerator system of FIG. 1 including the network router of FIG. 3.

Referring to FIG. 26A, during a first step (STEP 1) of a reduce-scatter operation, a first scratch-pad coupled to a first network router 112(1) stores a first group of packets p0, p4, p8, p12, p16, p20, p24, p28. A second scratch-pad coupled to a second network router 112(2) stores a second group of packets p1, p5, p9, p13, p17, p21, p25, p29. A third scratch-pad coupled to a third network router 112(3) stores a third group of packets p2, p6, p10, p14, p18, p22, p26, p30. A fourth scratch-pad coupled to a fourth network router 112(4) stores a fourth group of packets p3, p7, p11, p15, p19, p23, p27, p31. In one example, the first group of packets p0, p4, p8, p12, p16, p20, p24, p28 may correspond to elements of a first through eighth row of a first input vector. The second group of packets p1, p5, p9, p13, p17, p21, p25, p29 may correspond to elements of a first through eighth row of a second input vector. The third group of packets p2, p6, p10, p14, p18, p22, p26, p30 may correspond to elements of a first through eighth row of a third input vector. The fourth group of packets p3, p7, p11, p15, p19, p23, p27, p31 may correspond to elements of a first through eighth row of a fourth input vector.

The reduce-scatter operation may be performed by executing a reduce operation to compute reduce result packets, followed by a scatter operation that returns portions of the reduce result packets to respective network routers. In the present example, a first reduce result packet p0+p1+p2+p3, corresponding to the elements of a first row of a first through fourth input vector, and a fifth reduce result packet p16+p19+p17+p18, corresponding to the elements of a fifth row of the first through fourth input vector, are returned to the first network router 112(1). A second reduce result packet p5+p6+p4+p7, corresponding to the elements of a second row of the first through fourth input vector, and a sixth reduce result packet p21+p20+p22+p23, corresponding to the elements of a sixth row of the first through fourth input vector, are returned to the second network router 112(2). A third reduce result packet p10+p11+p8+p9, corresponding to the elements of a third row of the first through fourth input vector, and a seventh reduce result packet p26+p25+p24+p27, corresponding to the elements of a seventh row of the first through fourth input vector, are returned to the third network router 112(3). A fourth reduce result packet p15+p12+p13+p14, corresponding to the elements of a fourth row of the first through fourth input vector, and an eighth reduce result packet p31+p30+p28+p29, corresponding to the elements of an eighth row of the first through fourth input vector, are returned to the fourth network router 112(4).

In the reduce-scatter operation, each packet that is transmitted between the network routers and utilized in the reduce operation is designated as a reduce packet in terms of packet type. A reduce-scatter result packet is designated as a transmission packet in terms of packet type. Each partial sum packet that is generated during the reduce operation performed in the reduce-scatter process is also designated as a reduce packet in terms of packet type. According to the destination setting, a reduce packet may be processed either as a reduce pass packet or as a reduce target packet. A reduce-scatter result packet may be processed either as a transmission pass packet or as a transmission target packet.

Specifically, in a second step (STEP 2) of the reduce-scatter operation, a first network router 112(1) receives a tenth packet p9 from a second network router 112(2) in a first direction, and receives a twenty-eighth packet p27 from a fourth network router 112(4) in a second direction. The second network router 112(2) receives a fifteenth packet p14 from a third network router 112(3) in the first direction, and receives a twenty-ninth packet p28 from the first network router 112(1) in the second direction. The third network router 112(3) receives a fourth packet p3 from the fourth network router 112(4) in the first direction, and receives an eighteenth packet p17 from the second network router 112(2) in the second direction. The fourth network router 112(4) receives a fifth packet p4 from the first network router 112(1) in the first direction, and receives a twenty-third packet p22 from the third network router 112(3) in the second direction.

For a packet transmitted in a first direction, a destination of the packet is set to a network router that is most adjacent to a network router outputting the packet in a second direction. For a packet transmitted in a second direction, a destination of the packet is set to a network router that is most adjacent to a network router outputting the packet in the first direction. Specifically, a destination of a fifth packet p4 transmitted from a first network router 112(1) in the first direction is set to a second network router 112(2). A destination of a twenty-ninth packet p28 transmitted from the first network router 112(1) in the second direction is set to a fourth network router 112(4). A destination of a tenth packet p9 transmitted from a second network router 112(2) in the first direction is set to a third network router 112(3). A destination of an eighteenth packet p17 transmitted from the second network router 112(2) in the second direction is set to the first network router 112(1). A destination of a fifteenth packet p14 transmitted from a third network router 112(3) in the first direction is set to the fourth network router 112(4). A destination of a twenty-third packet p22 transmitted from the third network router 112(3) in the second direction is set to the second network router 112(2). A destination of a fourth packet p3 transmitted from a fourth network router 112(4) in the first direction is set to the first network router 112(1). A destination of a twenty-eighth packet p27 transmitted from the fourth network router 112(4) in the second direction is set to the third network router 112(3).

The first network router 112(1) performs a reduce operation, such as an addition operation, on a ninth packet p8 stored in a first scratch-pad coupled to the first network router 112(1) and a tenth packet p9 received from a second network router 112(2) to generate a first partial sum packet p8+p9. A destination of the tenth packet p9 is set to a third network router 112(3). Accordingly, a destination of the first partial sum packet p8+p9 is also set to the third network router 112(3). In response, the first network router 112(1) processes the first partial sum packet p8+p9 as a reduce-pass packet. Specifically, the first network router 112(1) stores the first partial sum packet p8+p9 in a sender included in the first network router 112(1).

Also, the first network router 112(1) performs an addition operation on a twenty-fifth packet p24 stored in a first scratch-pad coupled to the first network router 112(1) and a twenty-eighth packet p27 received from a fourth network router 112(4), thereby generating a second partial sum packet p24+p27. A destination of the twenty-eighth packet p27 is set to a third network router 112(3). Accordingly, a destination of the second partial sum packet p24+p27 is also set to the third network router 112(3). As a result, the first network router 112(1) processes the second partial sum packet p24+p27 as a reduce-pass packet. Specifically, the first network router 112(1) stores the second partial sum packet p24+p27 in a sender included in the first network router 112(1).

The second network router 112(2) performs an addition operation on a fourteenth packet p13 stored in a second scratch-pad coupled to the second network router 112(2) and a fifteenth packet p14 received from a third network router 112(3), thereby generating a third partial sum packet p13+p14. A destination of the fifteenth packet p14 is set to a fourth network router 112(4). Accordingly, a destination of the third partial sum packet p13+p14 is also set to the fourth network router 112(4). As a result, the second network router 112(2) processes the third partial sum packet p13+p14 as a reduce-pass packet. Specifically, the second network router 112(2) stores the third partial sum packet p13+p14 in a sender included in the second network router 112(2).

Also, the second network router 112(2) performs an addition operation on a thirtieth packet p29 stored in a second scratch-pad coupled to the second network router 112(2) and a twenty-ninth packet p28 received from a first network router 112(1), thereby generating a fourth partial sum packet p29+p28. A destination of the twenty-ninth packet p28 is set to a fourth network router 112(4). Accordingly, a destination of the fourth partial sum packet p29+p28 is also set to the fourth network router 112(4). As a result, the second network router 112(2) processes the fourth partial sum packet p29+p28 as a reduce-pass packet. Specifically, the second network router 112(2) stores the fourth partial sum packet p29+p28 in a sender included in the second network router 112(2).

The third network router 112(3) performs an addition operation on a third packet p2 stored in a third scratch-pad coupled to the third network router 112(3) and a fourth packet p3 received from a fourth network router 112(4), thereby generating a fifth partial sum packet p2+p3. A destination of the fourth packet p3 is set to the first network router 112(1). Accordingly, a destination of the fifth partial sum packet p2+p3 is also set to the first network router 112(1). As a result, the third network router 112(3) processes the fifth partial sum packet p2+p3 as a reduce-pass packet. Specifically, the third network router 112(3) stores the fifth partial sum packet p2+p3 in a sender included in the third network router 112(3).

Additionally, the third network router 112(3) performs an addition operation on a nineteenth packet p19 stored in the third scratch-pad and an eighteenth packet p17 received from the second network router 112(2), thereby generating a sixth partial sum packet p18+p17. A destination of the eighteenth packet p17 is set to the first network router 112(1). Accordingly, a destination of the sixth partial sum packet p18+p17 is also set to the first network router 112(1). As a result, the third network router 112(3) processes the sixth partial sum packet p18+p17 as a reduce-pass packet. Specifically, the third network router 112(3) stores the sixth partial sum packet p18+p17 in the sender included in the third network router 112(3).

The fourth network router 112(4) performs a reduce operation, specifically an addition operation, on an eighth packet p7 stored in a fourth scratch-pad coupled to the fourth network router 112(4) and a fifth packet p4 received from the first network router 112(1), thereby generating a seventh partial sum packet p7+p4. A destination of the fifth packet p4 is set to the second network router 112(2). Accordingly, a destination of the seventh partial sum packet p7+p4 is also set to the second network router 112(2). As a result, the fourth network router 112(4) processes the seventh partial sum packet p7+p4 as a reduce-pass packet. Specifically, the fourth network router 112(4) stores the seventh partial sum packet p7+p4 in a sender included in the fourth network router 112(4).

Additionally, the fourth network router 112(4) performs an addition operation on a twenty-fourth packet p23 stored in the fourth scratch-pad and a twenty-third packet p22 received from the third network router 112(3), thereby generating an eighth partial sum packet p23+p22. A destination of the twenty-third packet p22 is set to the second network router 112(2). Accordingly, a destination of the eighth partial sum packet p23+p22 is also set to the second network router 112(2). As a result, the fourth network router 112(4) processes the cighth partial sum packet p23+p22 as a reduce-pass packet. Specifically, the fourth network router 112(4) stores the eighth partial sum packet p23+p22 in the sender included in the fourth network router 112(4).

Referring to FIG. 26B, in a third step (STEP 3) of a reduce-scatter operation, the first network router 112(1) receives a third partial sum packet p13+p14 from the second network router 112(2) in a first direction, and receives an eighth partial sum packet p23+p22 from the fourth network router 112(4) in a second direction. The first network router 112(1) performs an addition operation on a thirteenth packet p12, which is stored in a first scratch-pad coupled to the first network router 112(1), and the third partial sum packet p13+p14, which is received from the second network router 112(2). This operation generates a ninth partial sum packet p12+p13+p14. A destination of the third partial sum packet p13+p14 is set to the fourth network router 112(4). Accordingly, a destination of the ninth partial sum packet p12+p13+p14 is also set to the fourth network router 112(4). As a result, the first network router 112(1) processes the ninth partial sum packet p12+p13+p14 as a reduce-pass packet. Specifically, the first network router 112(1) stores the ninth partial sum packet p12+p13+p14 in a sender included in the first network router 112(1).

In addition, the first network router 112(1) performs an addition operation on a twenty-first packet p20, which is stored in the first scratch-pad, and the eighth partial sum packet p23+p22, which is received from the fourth network router 112(4). This operation generates a tenth partial sum packet p20+p23+p22. A destination of the eighth partial sum packet p23+p22 is set to the second network router 112(2). Accordingly, a destination of the tenth partial sum packet p20+p23+p22 is also set to the second network router 112(2). As a result, the first network router 112(1) processes the tenth partial sum packet p20+p23+p22 as a reduce-pass packet. Specifically, the first network router 112(1) stores the tenth partial sum packet p20+p23+p22 in the sender included in the first network router 112(1).

In a third step (STEP 3) of a reduce-scatter operation, the second network router 112(2) receives a fifth partial sum packet p2+p3 from the third network router 112(3) in a first direction, and receives a second partial sum packet p24+p27 from the first network router 112(1) in a second direction. The second network router 112(2) performs an addition operation on a second packet p1, which is stored in a second scratch-pad coupled to the second network router 112(2), and the fifth partial sum packet p2+p3, which is received from the third network router 112(3). This operation generates an eleventh partial sum packet p1+p2+p3. A destination of the fifth partial sum packet p2+p3 is set to the first network router 112(1). Accordingly, a destination of the eleventh partial sum packet p1+p2+p3 is also set to the first network router 112(1). As a result, the second network router 112(2) processes the eleventh partial sum packet p1+p2+p3 as a reduce-pass packet. Specifically, the second network router 112(2) stores the eleventh partial sum packet p1+p2+p3 in a sender included in the second network router 112(2).

In addition, the second network router 112(2) performs an addition operation on a twenty-sixth packet p25, which is stored in the second scratch-pad, and the second partial sum packet p24+p27, which is received from the first network router 112(1). This operation generates a twelfth partial sum packet p25+p24+p27. A destination of the second partial sum packet p24+p27 is set to the third network router 112(3). Accordingly, a destination of the twelfth partial sum packet p25+p24+p27 is also set to the third network router 112(3). As a result, the second network router 112(2) processes the twelfth partial sum packet p25+p24+p27 as a reduce-pass packet. Specifically, the second network router 112(2) stores the twelfth partial sum packet p25+p24+p27 in the sender included in the second network router 112(2).

In a third step (STEP 3) of a reduce-scatter operation, the third network router 112(3) receives a seventh partial sum packet p7+p4 from the fourth network router 112(4) in a first direction and receives a fourth partial sum packet p29+p28 from the second network router 112(2) in a second direction. The third network router 112(3) performs an addition operation on a seventh packet p6, which is stored in a third scratch-pad coupled to the third network router 112(3), and the seventh partial sum packet p7+p4, which is received from the fourth network router 112(4). This operation generates a thirteenth partial sum packet p6+p7+p4. A destination of the seventh partial sum packet p7+p4 is set to the second network router 112(2). Accordingly, a destination of the thirteenth partial sum packet p6+p7+p4 is also set to the second network router 112(2). As a result, the third network router 112(3) processes the thirteenth partial sum packet p6+p7+p4 as a reduce-pass packet. Specifically, the third network router 112(3) stores the thirteenth partial sum packet p6+p7+p4 in a sender included in the third network router 112(3).

In addition, the third network router 112(3) performs an addition operation on a thirty-first packet p30, which is stored in the third scratch-pad, and the fourth partial sum packet p29+p28, which is received from the second network router 112(2). This operation generates a fourteenth partial sum packet p30+p29+p28. A destination of the fourth partial sum packet p29+p28 is set to the fourth network router 112(4). Accordingly, a destination of the fourteenth partial sum packet p30+p29+p28 is also set to the fourth network router 112(4). As a result, the third network router 112(3) processes the fourteenth partial sum packet p30+p29+p28 as a reduce-pass packet. Specifically, the third network router 112(3) stores the fourteenth partial sum packet p30+p29+p28 in the sender included in the third network router 112(3).

In a third step (STEP 3) of a reduce-scatter operation, the fourth network router 112(4) receives a first partial sum packet p8+p9 from the first network router 112(1) in a first direction and receives a sixth partial sum packet p18+p17 from the third network router 112(3) in a second direction. The fourth network router 112(4) performs an addition operation on a twelfth packet p11, which is stored in a fourth scratch-pad coupled to the fourth network router 112(4), and the first partial sum packet p8+p9, which is received from the first network router 112(1). This operation generates a fifteenth partial sum packet p11+p8+p9. A destination of the first partial sum packet p8+p9 is set to the third network router 112(3). Accordingly, a destination of the fifteenth partial sum packet p11+p8+p9 is also set to the third network router 112(3). As a result, the fourth network router 112(4) processes the fifteenth partial sum packet p11+p8+p9 as a reduce-pass packet. Specifically, the fourth network router 112(4) stores the fifteenth partial sum packet p11+p8+p9 in a sender included in the fourth network router 112(4).

In addition, the fourth network router 112(4) performs an addition operation on a twentieth packet p19, which is stored in the fourth scratch-pad, and the sixth partial sum packet p18+p17, which is received from the third network router 112(3). This operation generates a sixteenth partial sum packet p19+p18+p17. A destination of the sixth partial sum packet p18+p17 is set to the first network router 112(1). Accordingly, a destination of the sixteenth partial sum packet p19+p18+p17 is also set to the first network router 112(1). As a result, the fourth network router 112(4) processes the sixteenth partial sum packet p19+p18+p17 as a reduce-pass packet. Specifically, the fourth network router 112(4) stores the sixteenth partial sum packet p19+p18+p17 in the sender included in the fourth network router 112(4).

In a fourth step (STEP 4) of a reduce-scatter operation, the first network router 112(1) receives an eleventh partial sum packet p1+p2+p3 from the second network router 112(2) in a first direction, and receives a sixteenth partial sum packet p19+p18+p17 from the fourth network router 112(4) in a second direction. The first network router 112(1) performs an addition operation on a first packet p0, which is stored in a first scratch-pad coupled to the first network router 112(1), and the eleventh partial sum packet p1+p2+p3, which is received from the second network router 112(2). This operation generates a first reduce result packet p0+p1+p2+p3. In addition, the first network router 112(1) performs an addition operation on a seventeenth packet p16, which is stored in the first scratch-pad, and the sixteenth partial sum packet p19+p18+p17, which is received from the fourth network router 112(4). This operation generates a fifth reduce result packet p16+p19+p18+p17. A destination of the eleventh partial sum packet p1+p2+p3 and a destination of the sixteenth partial sum packet p19+p18+p17 are both set to the first network router 112(1). Accordingly, a destination of the first reduce result packet p0+p1+p2+p3 and a destination of the fifth reduce result packet p16+p19+p18+p17 are also set to the first network router 112(1). As a result, the first network router 112(1) processes the first reduce result packet p0+p1+p2+p3 and the fifth reduce result packet p16+p19+p18+p17 as transfer-target packets. Specifically, the first network router 112(1) transfers the first reduce result packet p0+p1+p2+p3 and the fifth reduce result packet p16+p19+p18+p17 to the first scratch-pad.

In a fourth step (STEP 4) of a reduce-scatter operation, the second network router 112(2) receives a thirteenth partial sum packet p6+p4+p7 from the third network router 112(3) in a first direction, and receives a tenth partial sum packet p20+p23+p22 from the first network router 112(1) in a second direction. The second network router 112(2) performs an addition operation on a sixth packet p5, which is stored in a second scratch-pad coupled to the second network router 112(2), and the thirteenth partial sum packet p6+p4+p7, which is received from the third network router 112(3). This operation generates a second reduce result packet p5+p6+p4+p7. In addition, the second network router 112(2) performs an addition operation on a twenty-second packet p21, which is also stored in the second scratch-pad, and the tenth partial sum packet p20+p23+p22, which is received from the first network router 112(1). This operation generates a sixth reduce result packet p21+p20+p23+p22. A destination of the thirteenth partial sum packet p6+p4+p7 and a destination of the tenth partial sum packet p20+p23+p22 are both set to the second network router 112(2). Accordingly, a destination of the second reduce result packet p5+p6+p4+p7 and a destination of the sixth reduce result packet p21+p20+p23+p22 are also set to the second network router 112(2). As a result, the second network router 112(2) processes the second reduce result packet p5+p6+p4+p7 and the sixth reduce result packet p21+p20+p23+p22 as transfer-target packets. Specifically, the second network router 112(2) transfers the second reduce result packet p5+p6+p4+p7 and the sixth reduce result packet p21+p20+p23+p22 to the second scratch-pad.

In a fourth step (STEP 4) of a reduce-scatter operation, the third network router 112(3) receives a fifteenth partial sum packet p11+p8+p9 from the fourth network router 112(4) in a first direction, and receives a twelfth partial sum packet p25+p24+p27 from the second network router 112(2) in a second direction. The third network router 112(3) performs an addition operation between an eleventh packet p10, which is stored in a third scratch-pad coupled to the third network router 112(3), and the fifteenth partial sum packet p11+p8+p9, which is received from the fourth network router 112(4). As a result of this addition operation, a third reduce result packet p10+p11+p8+p9 is generated. Additionally, the third network router 112(3) performs an addition operation between a twenty-seventh packet p26, which is also stored in the third scratch-pad, and the twelfth partial sum packet p25+p24+p27, which is received from the second network router 112(2). This addition operation generates a seventh reduce result packet p26+p25+p24+p27. A destination of the fifteenth partial sum packet p11+p8+p9 and a destination of the twelfth partial sum packet p25+p24+p27 are both set to the third network router 112(3). Accordingly, a destination of the third reduce result packet p10+p11+p8+p9 and a destination of the seventh reduce result packet p26+p25+p24+p27 are also set to the third network router 112(3). As a result, the third network router 112(3) processes the third reduce result packet p10+p11+p8+p9 and the seventh reduce result packet p26+p25+p24+p27 as transfer-target packets. Specifically, the third network router 112(3) transfers the third reduce result packet p10+p11+p8+p9 and the seventh reduce result packet p26+p25+p24+p27 to the third scratch-pad.

In a fourth step (STEP 4) of the reduce-scatter operation, the fourth network router 112(4) receives a ninth partial sum packet p12+p13+p14 from the first network router 112(1) in a first direction and receives a fourteenth partial sum packet p30+p29+p28 from the third network router 112(3) in a second direction. The fourth network router 112(4) performs an addition operation between a sixteenth packet p15, which is stored in a fourth scratch-pad coupled to the fourth network router 112(4), and the ninth partial sum packet p12+p13+p14, which is received from the first network router 112(1). As a result of the addition operation, a fourth reduce result packet p15+p12+p13+p14 is generated. Additionally, the fourth network router 112(4) performs an addition operation between a thirty-second packet p31, which is also stored in the fourth scratch-pad, and the fourteenth partial sum packet p30+p29+p28, which is received from the third network router 112(3). This operation results in an eighth reduce result packet p31+p30+p29+p28. A destination of the ninth partial sum packet p12+p13+p14 and a destination of the fourteenth partial sum packet p30+p29+p28 are both set to the fourth network router 112(4). Accordingly, a destination of the fourth reduce result packet p15+p12+p13+p14 and a destination of the eighth reduce result packet p31+p30+p29+p28 are also set to the fourth network router 112(4). As a result, the fourth network router 112(4) processes the fourth reduce result packet p15+p12+p13+p14 and the eighth reduce result packet p31+p30+p29+p28 as transfer-target packets. Specifically, the fourth network router 112(4) transfers the fourth reduce result packet p15+p12+p13+p14 and the eighth reduce result packet p31+p30+p29+p28 to the fourth scratch-pad.

Upon completion of the aforementioned steps, a first reduce result packet p0+p1+p2+p3, which corresponds to the result of a reduce operation performed on the first through fourth packets p0, p1, p2, p3 representing the elements of a first row of the first through fourth vector matrices, and a fifth reduce result packet p16+p19+p18+p17, which corresponds to the result of a reduce operation performed on the seventeenth through twentieth packets p16, p17, p18, p19 representing the elements of a fifth row of the first through fourth vector matrices, are stored in a first scratch-pad coupled to the first network router 112(1). A second reduce result packet p5+p6+p4+p7, which corresponds to the result of a reduce operation performed on the fifth through eighth packets p4, p5, p6, p7 representing the elements of a second row of the first through fourth vector matrices, and a sixth reduce result packet p21+p20+p23+p22, which corresponds to the result of a reduce operation performed on the twenty-first through twenty-fourth packets p20, p21, p22, p23 representing the elements of a sixth row of the first through fourth vector matrices, are stored in a second scratch-pad coupled to the second network router 112(2).

A third reduce result packet p10+p11+p8+p9, which corresponds to the result of a reduce operation performed on the ninth through twelfth packets p8, p9, p10, p11 representing the elements of a third row of the first through fourth vector matrices, and a seventh reduce result packet p26+p25+p24+p27, which corresponds to the result of a reduce operation performed on the twenty-fifth through twenty-eighth packets p24, p25, p26, p27 representing the elements of a seventh row of the first through fourth vector matrices, are stored in a third scratch-pad coupled to the third network router 112(3). A fourth reduce result packet p15+p12+p13+p14, which corresponds to the result of a reduce operation performed on the thirteenth through sixteenth packets p12, p13, p14, p15 representing the elements of a fourth row of the first through fourth vector matrices, and an eighth reduce result packet p31+p30+p29+p28, which corresponds to the result of a reduce operation performed on the twenty-ninth through thirty-second packets p28, p29, p30, p31 representing the elements of an eighth row of the first through fourth vector matrices, are stored in a fourth scratch-pad coupled to the fourth network router 112(4).

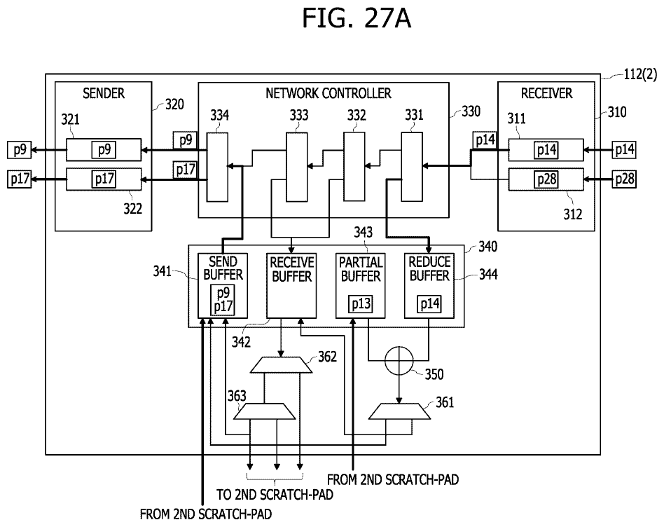

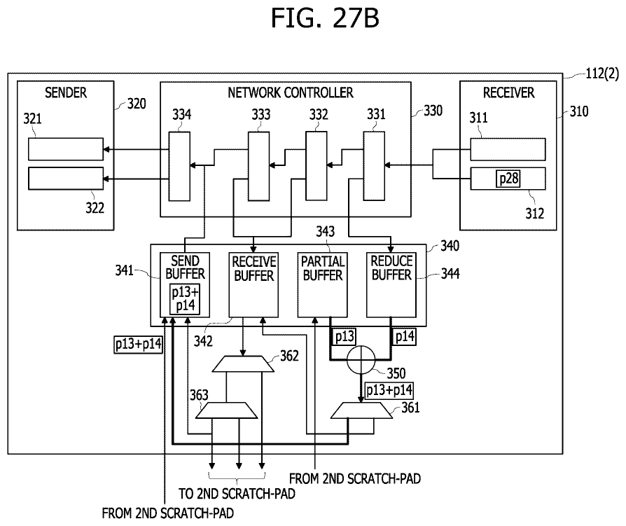

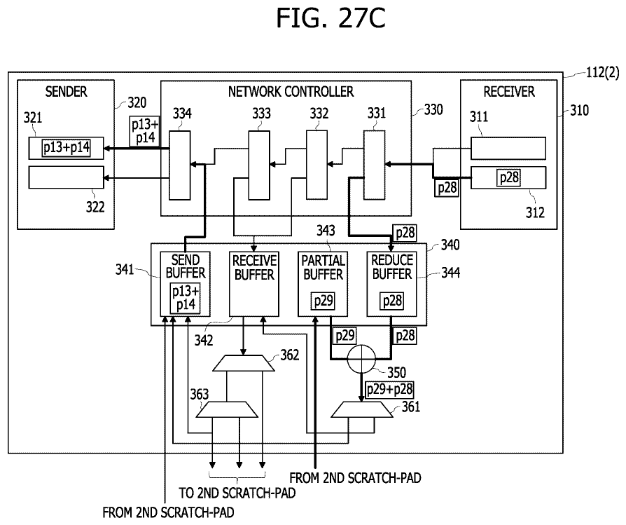

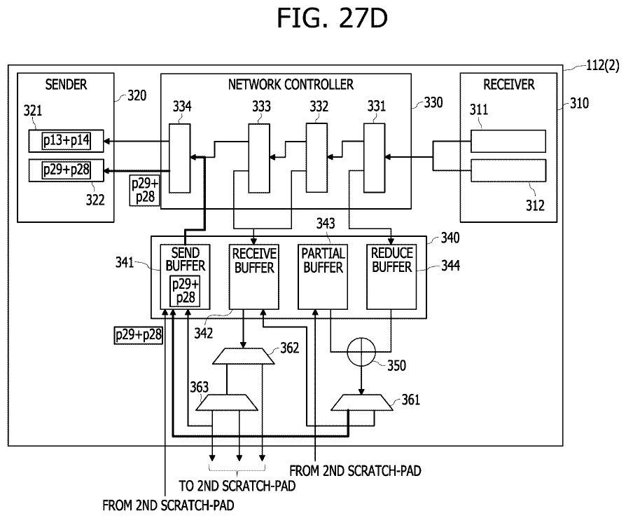

FIGS. 27A to 27D are diagrams illustrating the operation of a second network router in a second step of the reduce-scatter operation shown in FIG. 26A.

Referring to FIG. 27A in conjunction with FIG. 26A, during a second step (STEP 2) of a reduce-scatter operation, a second network router 112(2) outputs a tenth packet p9 in a first direction and an eighteenth packet p17 in a second direction. Furthermore, the second network router 112(2) receives a fifteenth packet p14 from a third network router 112(3) in the first direction, and a twenty-ninth packet p28 from a first network router 112(1) in the second direction. As described with reference to FIG. 26A, the tenth packet p9 is designated with a destination set to the third network router 112(3). The eighteenth packet p17 is designated with a destination set to the first network router 112(1). The fifteenth packet p14 and the twenty-ninth packet p28 are both designated with destinations set to the fourth network router 112(4).

The second network router 112(2) reads a tenth packet p9 and an eighteenth packet p17, which are designated as reduce packets, from a second scratch-pad, and temporarily stores the tenth packet p9 and the eighteenth packet p17 in a send buffer 341 of a buffer circuit 340. The send buffer 341 transmits the tenth packet p9 to an input terminal of a fourth packet transmission circuit 334 of a network controller 330. The transmission direction of the tenth packet p9 is set to the first direction. Accordingly, the fourth packet transmission circuit 334 outputs the tenth packet p9 to a first sender buffer 321 of a sender 320 through a first output terminal. Subsequently, the send buffer 341 transmits the eighteenth packet p17 to the input terminal of the fourth packet transmission circuit 334. The transmission direction of the eighteenth packet p17 is set to the second direction. Accordingly, the fourth packet transmission circuit 334 outputs the eighteenth packet p17 to a second sender buffer 322 of the sender 320 through a second output terminal. The sender 320 outputs the tenth packet p9, which is stored in the first sender buffer 321, in the first direction toward the first network router 112(1). In addition, the sender 320 outputs the eighteenth packet p17, which is stored in the second sender buffer 322, in the second direction toward the third network router 112(3).

Meanwhile, since the transmission direction of the fifteenth packet p14 is the first direction and the transmission direction of the twenty-ninth packet p28 is the second direction, a receiver 310 of second network router 112(2) stores the fifteenth packet p14 in a first receiver buffer 311 and stores the twenty-ninth packet p28 in a second receiver buffer 312. The receiver 310 transmits the fifteenth packet p14, stored in the first receiver buffer 311, to an input terminal of a first packet transmission circuit 331 of a network controller 330 in accordance with a preconfigured priority order for output. Since the fifteenth packet p14 corresponds to a reduce packet, the first packet transmission circuit 331 transmits the fifteenth packet p14 to a reduce buffer 344 of a buffer circuit 340 via a second output terminal. Upon reception of the fifteenth packet p14 as a reduce packet, second network router 112(2) retrieves a fourteenth packet p13, which is used as an operand packet in a reduce operation together with the fifteenth packet p14, from a second scratch-pad and stores the fourteenth packet p13 in a partial buffer 343 of the buffer circuit 340. As a result, the partial buffer 343 and the reduce buffer 344 of the buffer circuit 340 respectively store the fourteenth packet p13 and the fifteenth packet p14.

Referring to FIG. 27B in conjunction with FIG. 26A, a partial buffer 343 transmits a fourteenth packet p13 to a first input terminal of a reduce operation circuit 350. A reduce buffer 344 transmits a fifteenth packet p14 to a second input terminal of the reduce operation circuit 350. The reduce operation circuit 350 performs an addition operation on the fourteenth packet p13 and the fifteenth packet p14 to generate a third partial sum packet p13+p14. The reduce operation circuit 350 then transmits the third partial sum packet p13+p14 to an input terminal of a first demultiplexer 361. As described with reference to FIG. 26A, since the third partial sum packet p13+p14 corresponds to a reduce pass packet, the first demultiplexer 361 transmits the third partial sum packet p13+p14 to a send buffer 341 of a buffer circuit 340 via a first output terminal.

Referring to FIG. 27C in conjunction with FIG. 26A, a send buffer 341 transmits a third partial sum packet p13+p14 to an input terminal of a fourth packet transmission circuit 334 of a network controller 330. Since the output direction of the third partial sum packet p13+p14 in the subsequent step is set to the first direction, the fourth packet transmission circuit 334 transmits the third partial sum packet p13+p14 to a first sender buffer 321 of a sender 320 through a first output terminal. Although not shown in the drawings, as described with reference to FIG. 26B, during a third step (STEP 3) of a reduce-scatter operation, a sender 320 of the second network router 112(2) transmits the third partial sum packet p13+p14, stored in the first sender buffer 321, to a first network router 112(1) in the first direction.

Meanwhile, a receiver 310 transmits a twenty-ninth packet p28, stored in a second receiver buffer 312, to an input terminal of a first packet transmission circuit 331 of a network controller 330. Since the twenty-ninth packet p28 corresponds to a reduce packet, the first packet transmission circuit 331 transmits the twenty-ninth packet p28 to a reduce buffer 344 of a buffer circuit 340 through a second output terminal. Upon receiving the reduce packet p28, the second network router 112(2) retrieves a thirtieth packet p29 from a second scratch-pad, the thirtieth packet p29 being used as an operand in a reduce operation along with the twenty-ninth packet p28, and stores the thirtieth packet p29 in a partial buffer 343 of the buffer circuit 340. As a result, the partial buffer 343 and the reduce buffer 344 of the buffer circuit 340 store the thirtieth packet p29 and the twenty-ninth packet p28, respectively.

The partial buffer 343 transmits a thirtieth packet p29 to a first input terminal of a reduce operation circuit 350. The reduce buffer 344 transmits a twenty-ninth packet p28 to a second input terminal of the reduce operation circuit 350. The reduce operation circuit 350 performs a reduce operation, specifically an addition operation, on the thirtieth packet p29 and the twenty-ninth packet p28 to generate a fourth partial sum packet p29+p28. The reduce operation circuit 350 transmits the fourth partial sum packet p29+p28 to an input terminal of a first demultiplexer 361.

Referring to FIG. 27D in conjunction with FIG. 26A, since a fourth partial sum packet p29+p28 is a reduce pass packet, a first demultiplexer 361 transmits the fourth partial sum packet p29+p28 to a send buffer 341 of a buffer circuit 340 through a first output terminal. The send buffer 341 transmits the fourth partial sum packet p29+p28 to an input terminal of a fourth packet transmission circuit 334 of a network controller 330. Since a transmission direction of the fourth partial sum packet p29+p28 in a subsequent step is set to a second direction, the fourth packet transmission circuit 334 transmits the fourth partial sum packet p29+p28 to a second sender buffer 322 of a sender 320 through a second output terminal. Although not illustrated in the drawing, as described with reference to FIG. 26B, during a third step (STEP 3) of a reduce-scatter operation, the sender 320 of the second network router 112(2) transmits the fourth partial sum packet p29+p28 stored in the second sender buffer 322 to a third network router 112(3) along the second direction.

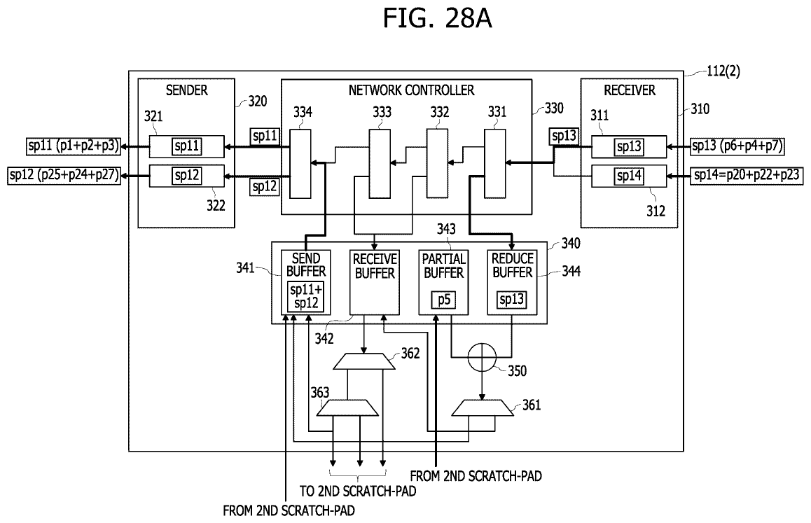

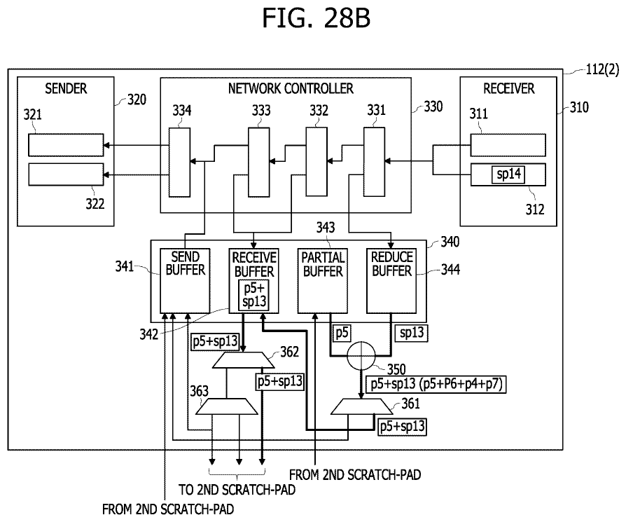

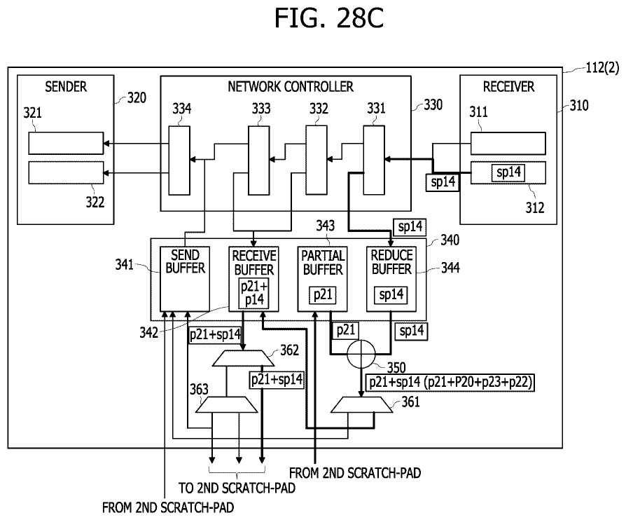

FIGS. 28A to 28C are diagrams illustrating the operation of a second network router in a fourth step of the reduce-scatter operation shown in FIG. 26B.

Referring to FIG. 28A in conjunction with FIG. 26B, during a fourth step (STEP 4) of a reduce-scatter operation, a second network router 112(2) outputs, along a first direction, an eleventh partial sum packet p1+p2+p3 (hereinafter also referred to as “sp11”), and outputs, along a second direction, a twelfth partial sum packet p25+p24+p27 (hereinafter also referred to as “sp12”). Additionally, the second network router 112(2) receives, along the first direction, a thirteenth partial sum packet p6+p4+p7 (hereinafter also referred to as “sp13”) from a third network router 112(3), and receives, along the second direction, a tenth partial sum packet p20+p23+p22 (hereinafter also referred to as “sp14”) from a first network router 112(1). As described with reference to FIG. 26B, the eleventh partial sum packet sp11 has a destination set to the first network router 112(1), and the twelfth partial sum packet sp12 has a destination set to the third network router 112(3). Furthermore, both the thirteenth partial sum packet sp13 and the fourteenth partial sum packet sp14 have destinations set to the second network router 112(2).

The second network router 112(2) reads the eleventh partial sum packet sp11 and the twelfth partial sum packet sp12, both of which are reduce packets, from a second scratch-pad and temporarily stores the packets in a send buffer 341 of a buffer circuit 340. The send buffer 341 transmits the eleventh partial sum packet sp11 to an input terminal of a fourth packet transmission circuit 334 of a network controller 330. A transmission direction of the eleventh partial sum packet sp11 is set to the first direction. Accordingly, the fourth packet transmission circuit 334 transmits the eleventh partial sum packet sp11 to a first sender buffer 321 of a sender 320 through a first output terminal. Next, the send buffer 341 transmits the twelfth partial sum packet sp12 to the input terminal of the fourth packet transmission circuit 334. A transmission direction of the twelfth partial sum packet sp12 is set to the second direction. Accordingly, the fourth packet transmission circuit 334 transmits the twelfth partial sum packet sp12 to a second sender buffer 322 of the sender 320 through a second output terminal. The sender 320 outputs the eleventh partial sum packet sp11, stored in the first sender buffer 321, to the first network router 112(1) along the first direction. Additionally, the sender 320 outputs the twelfth partial sum packet sp12, stored in the second sender buffer 322, to the third network router 112(3) along the second direction.

Meanwhile, since a transmission direction of a thirteenth partial sum packet sp13 input to the second network router 112(2) is set to the first direction, and a transmission direction of a fourteenth partial sum packet sp14 is set to the second direction, a receiver 310 of the second network router 112(2) stores the thirteenth partial sum packet sp13 in a first receiver buffer 311 and stores the fourteenth partial sum packet sp14 in a second receiver buffer 312. The receiver 310 transmits the thirteenth partial sum packet sp13, stored in the first receiver buffer 311, to an input terminal of a first packet transmission circuit 331 of a network controller 330, in accordance with a preconfigured priority order of output operations. Since the thirteenth partial sum packet sp13 is a reduce packet, the first packet transmission circuit 331 transmits the thirteenth partial sum packet sp13 to a reduce buffer 344 of a buffer circuit 340 through a second output terminal. Upon receiving the thirteenth partial sum packet sp13, the second network router 112(2) retrieves a sixth packet p5, which is used as an operand in a reduce operation along with the thirteenth partial sum packet sp13, from a second scratch-pad and stores the sixth packet p5 in a partial buffer 343 of the buffer circuit 340. As a result, the partial buffer 343 and the reduce buffer 344 of the buffer circuit 340 store the sixth packet p5 and the thirteenth partial sum packet sp13, respectively.

Referring to FIG. 28B in conjunction with FIG. 26B, a partial buffer 343 transmits a sixth packet p5 to a first input terminal of a reduce operation circuit 350. A reduce buffer 344 transmits a thirteenth partial sum packet sp13 to a second input terminal of the reduce operation circuit 350. The reduce operation circuit 350 performs a reduce operation, specifically an addition operation, on the sixth packet p5 and the thirteenth partial sum packet sp13, and generates a second reduce result packet p5+sp13. The reduce operation circuit 350 transmits the second reduce result packet p5+sp13 to an input terminal of a first demultiplexer 361. Since the second reduce result packet p5+sp13 is a transmission target packet whose destination is the second network router 112(2), the first demultiplexer 361 transmits the second reduce result packet p5+sp13 to a receive buffer 342 of a buffer circuit 340 through a second output terminal. Although not illustrated in the drawing, when the second reduce result packet p5+sp13 is transmitted to the receive buffer 342, a network controller 330 of the second network router 112(2) issues a receive command to the receive buffer 342. In response to the receive command, the receive buffer 342 transmits the second reduce result packet p5+sp13 to an input terminal of a second demultiplexer 362. Since the second reduce result packet p5+sp13 is a transmission target packet, the second demultiplexer 362 outputs the second reduce result packet p5+sp13 through a second output terminal and transfers it to a second scratch-pad.

Referring to FIG. 28C in conjunction with FIG. 26B, a receiver 310 transmits a fourteenth partial sum packet sp14, stored in a second receiver buffer 312, to an input terminal of a first packet transmission circuit 331 included in a network controller 330. Since the fourteenth partial sum packet sp14 corresponds to a reduce packet, the first packet transmission circuit 331 transfers the fourteenth partial sum packet sp14 to a reduce buffer 344 of a buffer circuit 340 via a second output terminal. Upon receiving the reduce packet sp14, the second network router 112(2) retrieves a twenty-second packet p21 from a second scratch-pad, the packet p21 being an operand to be used in a reduce operation together with the reduce packet sp14. The retrieved packet p21 is stored in a partial buffer 343 of the buffer circuit 340. As a result, the partial buffer 343 and the reduce buffer 344 of the buffer circuit 340 respectively store the twenty-second packet p21 and the fourteenth partial sum packet sp14.

The partial buffer 343 transfers the twenty-second packet p21 to a first input terminal of a reduce operation circuit 350. The reduce buffer 344 transfers the fourteenth partial sum packet sp14 to a second input terminal of the reduce operation circuit 350. The reduce operation circuit 350 performs a reduce operation, i.e., an addition operation, on the twenty-second packet p21 and the fourteenth partial sum packet sp14, thereby generating a sixth reduce result packet p21+sp14. The reduce operation circuit 350 transmits the sixth reduce result packet p21+sp14 to an input terminal of a first demultiplexer 361. Since the sixth reduce result packet p21+sp14 corresponds to a transfer target packet having the second network router 112(2) as its destination, the first demultiplexer 361 outputs the sixth reduce result packet p21+sp14 via a second output terminal to a receive buffer 342 of a buffer circuit 340. Although not shown in the drawing, when the sixth reduce result packet p21+sp14 is delivered to the receive buffer 342, the network controller 330 of the second network router 112(2) issues a receive command to the receive buffer 342. In response to the receive command, the receive buffer 342 transfers the sixth reduce result packet p21+sp14 to an input terminal of a second demultiplexer 362. Since the sixth reduce result packet p21+sp14 corresponds to a transfer target packet, the second demultiplexer 362 outputs the packet via a second output terminal to the second scratch-pad.

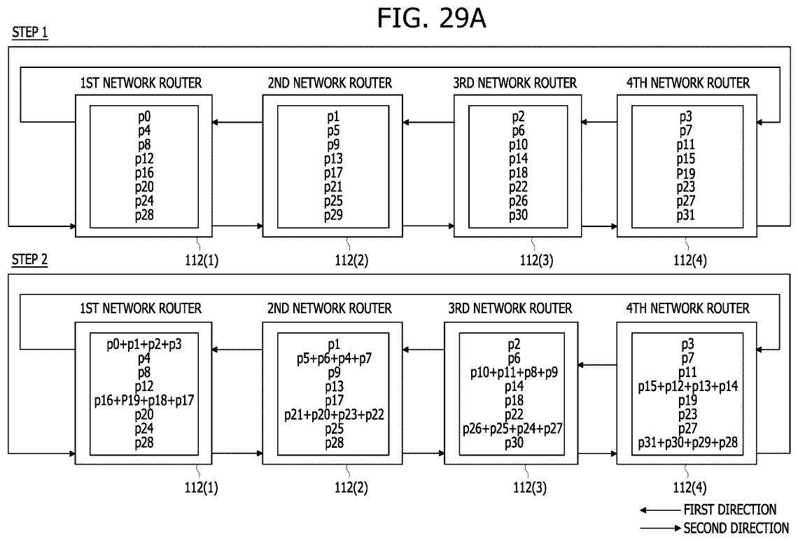

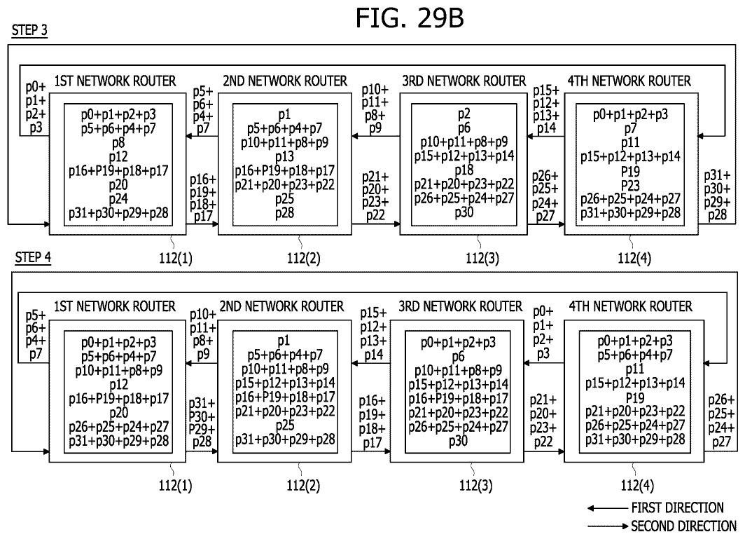

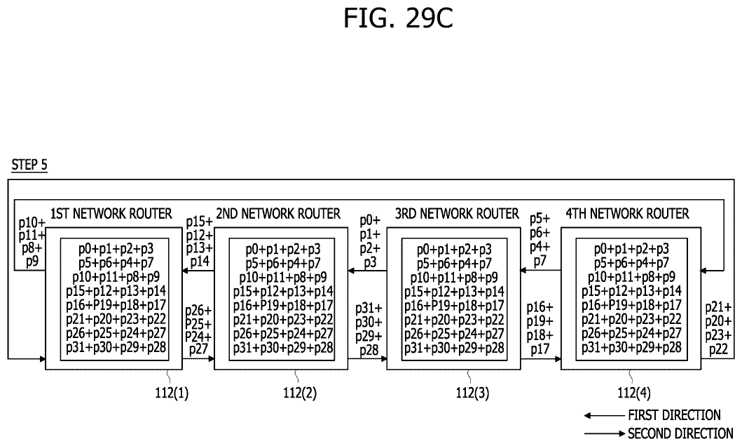

FIGS. 29A to 29C are diagrams illustrating an all-reduce operation in the accelerator system of FIG. 1 including the network router of FIG. 3.

Referring to FIG. 29A, in a first step (STEP 1) of the all-reduce operation, it is assumed that a first group of packets p0, p4, p8, p12, p16, p20, p24, and p28 are stored in a first scratch-pad coupled to a first network router 112(1); a second group of packets p1, p5, p9, p13, p17, p21, p25, and p29 are stored in a second scratch-pad coupled to a second network router 112(2); a third group of packets p2, p6, p10, p14, p18, p22, p26, and p30 are stored in a third scratch-pad coupled to a third network router 112(3); and a fourth group of packets p3, p7, p11, p15, p19, p23, p27, and p31 are stored in a fourth scratch-pad coupled to a fourth network router 112(4). In this initial step, each network router holds its respective local data elements in preparation for the distributed reduction phase of the all-reduce operation.

In one embodiment, the first group of packets p0, p4, p8, p12, p16, p20, p24, p28 may correspond to elements of first through eighth rows of a first input vector. The second group of packets p1, p5, p9, p13, p17, p21, p25, p29 may correspond to elements of first through cighth rows of a second input vector. The third group of packets p2, p6, p10, p14, p18, p22, p26, p30 may correspond to elements of first through eighth rows of a third input vector. The fourth group of packets p3, p7, p11, p15, p19, p23, p27, p31 may correspond to elements of first through eighth rows of a fourth input vector.

The all-reduce operation may be performed by executing a reduce-scatter operation and then gathering the resulting data to all network routers. That is, after executing the reduce-scatter operation to return reduce result packets to each of the network routers, an all-gather operation is performed on the returned reduce result packets so that the returned reduce result packets are collected at all network routers. During the all-reduce operation, a packet transmitted between the network routers for use in a reduce operation is classified as a reduce packet, and an all-reduce result packet is classified as an all-gather packet. A partial summation packet generated during the reduce operation is also classified as a reduce packet. Depending on the destination setting, the reduce packet may be processed either as a reduce-pass packet or as a reduce-target packet, and the all-reduce result packet may be processed either as an all-gather-pass packet or as an all-gather-target packet.

In a second step (STEP 2) of the all-reduce operation, the reduce-scatter operation is performed in the same manner as described with reference to FIG. 26A and FIG. 26B. Upon completion of the reduce-scatter operation, a first reduce result packet, which is the result of the reduce operation on packets p0, p1, p2, and p3, and a fifth reduce result packet, which is the result of the reduce operation on packets p16, p17, p18, and p19, are stored in a first scratch-pad coupled to the first network router 112(1). A second reduce result packet, which is the result of the reduce operation on packets p4, p5, p6, and p7, and a sixth reduce result packet, which is the result of the reduce operation on packets p20, p21, p22, and p23, are stored in a second scratch-pad coupled to the second network router 112(2). A third reduce result packet, which is the result of the reduce operation on packets p8, p9, p10, and p11, and a seventh reduce result packet, which is the result of the reduce operation on packets p24, p25, p26, and p27, are stored in a third scratch-pad coupled to the third network router 112(3). A fourth reduce result packet, which is the result of the reduce operation on packets p12, p13, p14, and p15, and an eighth reduce result packet, which is the result of the reduce operation on packets p28, p29, p30, and p31, are stored in a fourth scratch-pad coupled to the fourth network router 112(4).

Referring to FIG. 29B, in a third step (STEP 3) of the all-reduce operation, a first process of the all-gather operation is performed on the all-reduce result packets that have been generated through the reduce-scatter operation. Specifically, the first network router 112(1) transmits a first all-reduce result packet p0+p1+p2+p3 to the fourth network router 112(4) in a first direction, and transmits a fifth all-reduce result packet p16+p19+p18+p17 to the second network router 112(2) in a second direction. The second network router 112(2) transmits a second all-reduce result packet p5+p6+p4+p7 to the first network router 112(1) in the first direction, and transmits a sixth all-reduce result packet p21+p20+p23+p22 to the third network router 112(3) in the second direction. The third network router 112(3) transmits a third all-reduce result packet p10+p11+p8+p9 to the second network router 112(2) in the first direction, and transmits a seventh all-reduce result packet p26+p25+p24+p27 to the fourth network router 112(4) in the second direction. The fourth network router 112(4) transmits a fourth all-reduce result packet p15+p12+p13+p14 to the third network router 112(3) in the first direction, and transmits an eighth all-reduce result packet p31+p30+p29+p28 to the first network router 112(1) in the second direction.

In the case of a packet transmitted in the first direction, a destination of the packet is set to be a network router that is nearest in the second direction relative to the network router that outputs the packet. In the case of a packet transmitted in the second direction, a destination of the packet is set to be a network router that is nearest in the first direction relative to the network router that outputs the packet. Specifically, a destination of the first all-reduce result packet p0+p1+p2+p3 is set to the second network router 112(2), and a destination of the fifth all-reduce result packet p16+p19+p18+p17 is set to the fourth network router 112(4). A destination of the second all-reduce result packet p5+p6+p4+p7 is set to the third network router 112(3), and a destination of the sixth all-reduce result packet p21+p20+p23+p22 is set to the first network router 112(1). A destination of the third all-reduce result packet p10+p11+p8+p9 is set to the fourth network router 112(4), and a destination of the seventh all-reduce result packet p26+p25+p24+p27 is set to the second network router 112(2). A destination of the fourth all-reduce result packet p15+p12+p13+p14 is set to the first network router 112(1), and a destination of the eighth all-reduce result packet p31+p30+p29+p28 is set to the third network router 112(3).

Accordingly, the first network router 112(1) processes the second all-reduce result packet p5+p6+p4+p7 and the eighth all-reduce result packet p31+p30+p29+p28 as all-gather pass packets. Specifically, the first network router 112(1) stores the second all-reduce result packet and the eighth all-reduce result packet in a sender of the first network router 112(1), and also transfers the same packets to the first scratch-pad. The second network router 112(2) processes the third all-reduce result packet p10+p11+p8+p9 and the fifth all-reduce result packet p16+p19+p18+p17 as all-gather pass packets. Specifically, the second network router 112(2) stores the third all-reduce result packet and the fifth all-reduce result packet in a sender of the second network router 112(2), and also transfers the same packets to the second scratch-pad. The third network router 112(3) processes the fourth all-reduce result packet p15+p12+p13+p14 and the sixth all-reduce result packet p21+p20+p23+p22 as all-gather pass packets. Specifically, the third network router 112(3) stores the fourth all-reduce result packet and the sixth all-reduce result packet in a sender of the third network router 112(3), and also transfers the same packets to the third scratch-pad. The fourth network router 112(4) processes the first all-reduce result packet p0+p1+p2+p3 and the seventh all-reduce result packet p26+p25+p24+p27 as all-gather pass packets. Specifically, the fourth network router 112(4) stores the first all-reduce result packet and the seventh all-reduce result packet in a sender of the fourth network router 112(4), and also transfers the same packets to the fourth scratch-pad.

In a fourth step (STEP 4) of the all-reduce operation, a second stage of the all-gather process is performed. Specifically, the first network router 112(1) transmits the second all-reduce result packet p5+p6+p4+p7 to the fourth network router 112(4) in the first direction, and transmits the eighth all-reduce result packet p31+p30+p29+p28 to the second network router 112(2) in the second direction. The second network router 112(2) transmits the third all-reduce result packet p10+p11+p8+p9 to the first network router 112(1) in the first direction, and transmits the fifth all-reduce result packet p16+p19+p18+p17 to the third network router 112(3) in the second direction. The third network router 112(3) transmits the fourth all-reduce result packet p15+p12+p13+p14 to the second network router 112(2) in the first direction, and transmits the sixth all-reduce result packet p21+p20+p23+p22 to the fourth network router 112(4) in the second direction. The fourth network router 112(4) transmits the first all-reduce result packet p0+p1+p2+p3 to the third network router 112(3) in the first direction, and transmits the seventh all-reduce result packet p26+p25+p24+p27 to the first network router 112(1) in the second direction.

Since the destination of the third all-reduce result packet p10+p11+p8+p9 and the destination of the seventh all-reduce result packet p26+p25+p24+p27 are respectively set to the fourth network router 112(4) and the second network router 112(2), the first network router 112(1) processes both the third all-reduce result packet p10+p11+p8+p9 and the seventh all-reduce result packet p26+p25+p24+p27 as all-gather pass packets. That is, the first network router 112(1) stores the third all-reduce result packet p10+p11+p8+p9 and the seventh all-reduce result packet p26+p25+p24+p27 in the sender of the first network router 112(1), and also transmits these packets to the first scratch-pad.

Since the destination of the fourth all-reduce result packet p15+p12+p13+p14 and the destination of the eighth all-reduce result packet p31+p30+p29+p28 are respectively set to the first network router 112(1) and the third network router 112(3), the second network router 112(2) processes both the fourth all-reduce result packet p15+p12+p13+p14 and the eighth all-reduce result packet p31+p30+p29+p28 as all-gather pass packets. That is, the second network router 112(2) stores the fourth all-reduce result packet p15+p12+p13+p14 and the eighth all-reduce result packet p31+p30+p29+p28 in the sender of the second network router 112(2), and also transmits these packets to the second scratch-pad.

Since the destination of the first all-reduce result packet p0+p1+p2+p3 and the destination of the fifth all-reduce result packet p16+p19+p18+p17 are respectively set to the second network router 112(2) and the fourth network router 112(4), the third network router 112(3) processes both the first all-reduce result packet p0+p1+p2+p3 and the fifth all-reduce result packet p16+p19+p18+p17 as all-gather pass packets. That is, the third network router 112(3) stores the first all-reduce result packet p0+p1+p2+p3 and the fifth all-reduce result packet p16+p19+p18+p17 in the sender of the third network router 112(3), and also transmits these packets to the third scratch-pad.

Since the destination of the second all-reduce result packet p5+p6+p4+p7 and the destination of the sixth all-reduce result packet p21+p20+p23+p22 are respectively set to the third network router 112(3) and the first network router 112(1), the fourth network router 112(4) processes both the second all-reduce result packet p5+p6+p4+p7 and the sixth all-reduce result packet p21+p20+p23+p22 as all-gather pass packets. That is, the fourth network router 112(4) stores the second all-reduce result packet p5+p6+p4+p7 and the sixth all-reduce result packet p21+p20+p23+p22 in the sender of the fourth network router 112(4), and also transmits these packets to the fourth scratch-pad.

In a fifth step (STEP 5) of the all-reduce operation, as illustrated in FIG. 29C, the third stage of the all-gather operation is performed. The first network router 112(1) transmits the third all-reduce result packet p10+p11+p8+p9 in the first direction to the fourth network router 112(4) and the seventh all-reduce result packet p26+p25+p24+p27 in the second direction to the second network router 112(2). The second network router 112(2) transmits the fourth all-reduce result packet p15+p12+p13+p14 in the first direction to the first network router 112(1) and the eighth all-reduce result packet p31+p30+p29+p28 in the second direction to the third network router 112(3). The third network router 112(3) transmits the first all-reduce result packet p0+p1+p2+p3 in the first direction to the second network router 112(2) and the fifth all-reduce result packet p16+p19+p18+p17 in the second direction to the fourth network router 112(4). The fourth network router 112(4) transmits the second all-reduce result packet p5+p6+p4+p7 in the first direction to the third network router 112(3) and the sixth all-reduce result packet p21+p20+p23+p22 in the second direction to the first network router 112(1). As a result of these transmissions, each network router stores all eight all-reduce result packets in the corresponding scratch-pad. This completes the all-gather process, thereby finalizing the all-reduce operation across the network routers.

The destination of the fourth all-reduce result packet p15+p12+p13+p14 and the sixth all-reduce result packet p21+p20+p23+p22 is set to the first network router 112(1). Therefore, the first network router 112(1) processes these two packets as all-gather target packets. In other words, the first network router 112(1) transfers the fourth all-reduce result packet p15+p12+p13+p14 and the sixth all-reduce result packet p21+p20+p23+p22 to the first scratch-pad connected to the first network router. This completes the delivery of these packets to their intended destination within the all-gather phase of the all-reduce operation.

Since the destination of the first all-reduce result packet p0+p1+p2+p3 and the seventh all-reduce result packet p26+p25+p24+p27 is set to the second network router 112(2), the second network router 112(2) processes both of these packets as all-gather target packets. Accordingly, the second network router 112(2) transfers the first all-reduce result packet p0+p1+p2+p3 and the seventh all-reduce result packet p26+p25+p24+p27 to the second scratch-pad connected to the second network router. This completes the reception of these designated result packets in the final step of the all-gather phase for 112(2).

Since the destination of the second all-reduce result packet p5+p6+p4+p7 and the eighth all-reduce result packet p31+p30+p29+p28 is set to the third network router 112(3), the third network router 112(3) processes both of these packets as all-gather target packets. Accordingly, the third network router 112(3) transfers the second all-reduce result packet p5+p6+p4+p7 and the eighth all-reduce result packet p31+p30+p29+p28 to the third scratch-pad connected to the third network router. This ensures that the complete reduction results are gathered and retained locally at the third network router 112(3) for further use.

Since the destination of the third all-reduce result packet p10+p11+p8+p9 and the fifth all-reduce result packet p16+p19+p18+p17 is set to the fourth network router 112(4), the fourth network router 112(4) processes both of these packets as all-gather target packets. Accordingly, the fourth network router 112(4) transfers the third all-reduce result packet p10+p11+p8+p9 and the fifth all-reduce result packet p16+p19+p18+p17 to the fourth scratch-pad connected to the fourth network router.

When such steps are performed, the first scratch-pad coupled to the first network router 112(1), the second scratch-pad coupled to the second network router 112(2), the third scratch-pad coupled to the third network router 112(3), and the fourth scratch-pad coupled to the fourth network router 112(4) are in a state where the first through eighth all-reduce result packets, which are the results of the reduce operations, that is, the addition operations, for each of the eight rows of the first through fourth vector matrices, are stored. The operation of the first, second, third, and fourth network routers 112(1), 112(2), 112(3), and 112(4) in the third step (STEP 3) of FIG. 29B is performed in the same manner as the operation of the second network router 112(2) described with reference to FIGS. 16A and 16B. The operation of the first, second, third, and fourth network routers 112(1), 112(2), 112(3), and 112(4) in the fourth step (STEP 4) of FIG. 29B is performed in the same manner as the operation of the second network router 112(2) described with reference to FIGS. 17A and 17B. The operation of the first, second, third, and fourth network routers 112(1), 112(2), 112(3), and 112(4) in the fifth step (STEP 5) of FIG. 29B is performed in the same manner as the operation of the second network router 112(2) described with reference to FIG. 18.

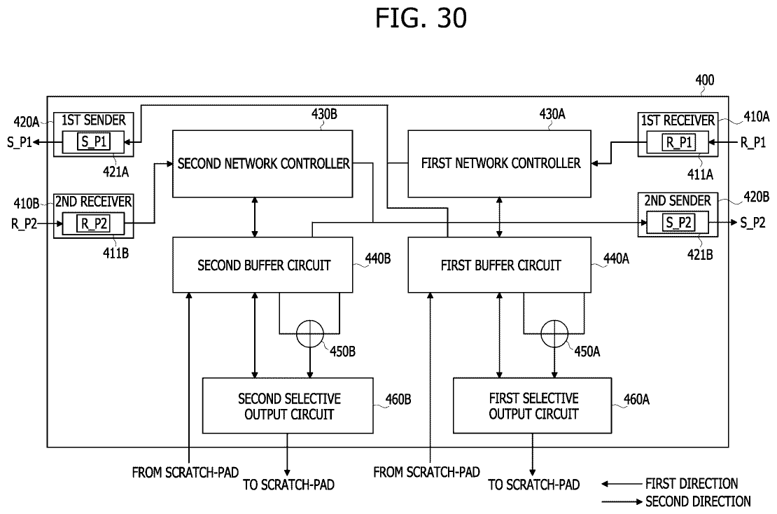

FIG. 30 is a block diagram illustrating another example of a network router according to the present disclosure. The description of the network router according to this example is equally applicable to the first through N-th network routers 112(1) to 112(N) shown in FIG. 1 and to the network router 220 shown in FIG. 2.

Referring to FIG. 30, the network router 400 includes a first router circuit for processing collective operation packets transmitted in a first direction, and a second router circuit for processing collective operation packets transmitted in a second direction. The first router circuit may receive and output collective operation packets in the first direction. The second router circuit may receive and output collective operation packets in the second direction. In one embodiment, the first router circuit may include a first receiver 410A, a first sender 420A, a first network controller 430A, a first buffer circuit 440A, a first reduce operation circuit 450A, and a first selective output circuit 460A. The second router circuit may include a second receiver 410B, a second sender 420B, a second network controller 430B, a second buffer circuit 440B, a second reduce operation circuit 450B, and a second selective output circuit 460B. The network router 400 may independently perform data movement and reduce operation processing for a packet input in the first direction, and data movement and reduce operation processing for a packet input in the second direction.

The first receiver 410A of the first router circuit may receive a first received packet R_P1 that is transmitted from another network router in the first direction. The first receiver 410A may include at least one first receiver buffer 411A in which the first received packet R_P1 transmitted from another network router is stored. The first receiver 410A stores the first received packet R_P1, which is input from another network router in the first direction, into the first receiver buffer 411A. The first receiver 410A may output the first received packet R_P1 stored in the first receiver buffer 411A to the first network controller 430A.

In one embodiment, the first receiver 410A may receive any one of a transmission packet, an all-gather packet, or a reduce packet that is transmitted from another network router in the first direction. The transmission packet that is transmitted from another network router to the first receiver 410A of the network router 400 may be a target packet having the network router 400 as a destination, i.e., a transmission target packet, or may be a pass packet having both the network router 400 and another network router as destinations, i.e., a transmission pass packet. The all-gather packet that is transmitted from another network router to the first receiver 410A of the network router 400 may be a target packet having the network router 400 as a destination, i.e., an all-gather target packet, or may be a pass packet having both the network router 400 and another network router as destinations, i.e., an all-gather pass packet. The reduce packet that is transmitted from another network router to the first receiver 410A of the network router 400 may be a target packet having the network router 400 as a destination, i.e., a reduce target packet, or may be a pass packet having both the network router 400 and another network router as destinations, i.e., a reduce pass packet.

The first sender 420A of the first router circuit may receive a packet output from the first network controller 430A or the first buffer circuit 440A. The first sender 420A may include at least one first sender buffer 421A in which a packet transmitted from the first network controller 430A or the first buffer circuit 440A is stored. The first sender 420A may output a first send packet S_P1 stored in the first sender buffer 421A in the first direction and transmit the packet to the first receiver of another network router. The first sender 420A may receive a transmission pass packet that is input from another network router to the first receiver 410A of the network router 400 through the first network controller 430A. The first sender 420A may receive a transmission packet, an all-gather packet, or a reduce packet that is stored in a scratch-pad coupled to the network router 400 through the first buffer circuit 440A. The first sender 420A may receive an all-gather pass packet that is input from another network router to the first receiver 410A of the network router 400 from the first buffer circuit 440A. In addition, the first sender 420A may receive a partial sum pass packet, a reduce result pass packet, a reduce-scatter result pass packet, or an all-reduce result pass packet that is output from the first reduce operation circuit 450A from the first buffer circuit 440A.

The first network controller 430A of the first router circuit receives a packet output from the first receiver buffer 411A of the first receiver 410A, and controls a packet transmission path within the network router 400 based on the packet type. The first network controller 430A may generate a first control signal to control an internal operation of the network router 400 for a packet input in the first direction and a packet output in the first direction. For example, the first network controller 430A may be configured to transmit a first command to the first buffer circuit 440A to control an operation of the first buffer circuit 440A. In one embodiment, when a transmission pass packet is received from the first receiver 410A, the first network controller 430A transmits the transmission pass packet to the first sender 420A. When a reduce packet, an all-gather packet, or a transmission target packet is received from the first receiver 410A, the first network controller 430A transmits the reduce packet, the all-gather packet, and the transmission target packet to the first buffer circuit 440A.

The first buffer circuit 440A of the first router circuit may transmit a reduce packet, which is received from another network router and input through the first network controller 430A, to the first reduce operation circuit 450A. The first buffer circuit 440A may transmit an all-gather packet and a transmission target packet, which are received from another network router and input through the first network controller 430A, to the first selective output circuit 460A. When the all-gather packet transmitted to the first selective output circuit 460A is an all-gather pass packet, the first buffer circuit 440A may receive the all-gather pass packet again from the first selective output circuit 460A and store the packet. The first buffer circuit 440A may transmit the all-gather pass packet, which is received again from the first selective output circuit 460A and stored, to the first sender 420A.

The first buffer circuit 440A may receive and store transmission packets, all-gather packets, and reduce packets to be transmitted to another network router along the first direction, from a scratch-pad coupled to the network router 400. The first buffer circuit 440A may transmit the transmission packets and all-gather packets, which are received from the scratch-pad and stored, to the first sender 420A. The first buffer circuit 440A may transmit the reduce packets, which are received from the scratch-pad and stored, to the first sender 420A or the first reduce operation circuit 450A.

The first buffer circuit 440A may receive and store partial sum packets, reduce result packets, reduce-scatter result packets, and all-reduce result packets output from the first reduce operation circuit 450A, through the first selective output circuit 460A. The first buffer circuit 440A may transmit the stored partial sum packets, reduce result packets, reduce-scatter result packets, and all-reduce result packets to the first sender 420A, or alternatively, may retransmit them to the first selective output circuit 460A. Specifically, when the partial sum packet, reduce result packet, reduce-scatter result packet, and all-reduce result packet received from the first selective output circuit 460A and stored in the first buffer circuit 440A are respectively a partial sum pass packet, reduce result pass packet, reduce-scatter result pass packet, and all-reduce result pass packet, the first buffer circuit 440A transmits the partial sum pass packet, reduce result pass packet, reduce-scatter result pass packet, and all-reduce result pass packet to the first sender 420A. When the partial sum packet, reduce result packet, reduce-scatter result packet, and all-reduce result packet received from the first selective output circuit 460A and stored in the first buffer circuit 440A are respectively a partial sum target packet, reduce result target packet, reduce-scatter result target packet, and all-reduce result target packet, the first buffer circuit 440A retransmits the partial sum target packet, reduce result target packet, reduce-scatter result target packet, and all-reduce result target packet to the first selective output circuit 460A.

The first reduce operation circuit 450A of the first router circuit may receive a first operand packet and a second operand packet for a first reduce operation from the first buffer circuit 440A. In one embodiment, the first operand packet is a reduce packet transmitted from a scratch-pad coupled to the network router 400 to the first buffer circuit 440A, and the second operand packet is a reduce packet transmitted from another network router to the first buffer circuit 440A via the first network controller 430A. The first reduce operation circuit 450A performs the first reduce operation on the first operand packet and the second operand packet to generate a partial sum packet, a reduce result packet, a reduce-scatter result packet, or an all-reduce result packet. The partial sum packet may be generated by a reduce operation performed during a reduce operation, a reduce-scatter operation, or an all-reduce operation. The reduce result packet may be generated by a reduce operation performed during a reduce operation. The reduce-scatter result packet may be generated by a reduce operation performed during a reduce-scatter operation. The all-reduce result packet may be generated by a reduce operation performed during an all-reduce operation. The first reduce operation circuit 450A may transmit the partial sum packet, the reduce result packet, the reduce-scatter result packet, and the all-reduce result packet to the first selective output circuit 460A.

The first selective output circuit 460A of the first router circuit may receive a partial sum packet, a reduce result packet, a reduce-scatter result packet, and an all-reduce result packet from the first reduce operation circuit 450A, and may transmit those packets to the first buffer circuit 440A. When the partial sum packet, reduce result packet, reduce-scatter result packet, and all-reduce result packet transmitted to the first buffer circuit 440A are respectively a partial sum target packet, a reduce result target packet, a reduce-scatter result target packet, and an all-reduce result target packet, the first selective output circuit 460A may receive the partial sum target packet, the reduce result target packet, the reduce-scatter result target packet, and the all-reduce result target packet back from the first buffer circuit 440A. The first selective output circuit 460A may transmit the partial sum target packet, the reduce result target packet, the reduce-scatter result target packet, and the all-reduce result target packet, received back from the first buffer circuit 440A, to the scratch-pad.

The first selective output circuit 460A may receive a transmission target packet from the first buffer circuit 440A and may transmit the packet to the scratch-pad. The first selective output circuit 460A may receive an all-gather packet from the first buffer circuit 440A and may transmit the packet only to the scratch-pad or to both the first buffer circuit 440A and the scratch-pad. Specifically, if the all-gather packet transmitted from the first buffer circuit 440A corresponds to a target packet, the first selective output circuit 460A may transmit the all-gather packet to the scratch-pad. If the all-gather packet transmitted from the first buffer circuit 440A corresponds to a pass packet, the first selective output circuit 460A may transmit the all-gather packet to both the first buffer circuit 440A and the scratch-pad.

The second receiver 410B of the second router circuit may receive a second reception packet R_P2 transmitted along the second direction from another network router. The second receiver 410B may include at least one second receiver buffer 411B in which the second reception packet R_P2 received from another network router is stored. The second receiver 410B stores the second reception packet R_P2, which is input along the second direction from another network router, in the second receiver buffer 411B. The second receiver 410B may output the second reception packet R_P2 stored in the second reception buffer 411B to the second network controller 430B.

In one embodiment, the second receiver 410B may receive any one of a transmission packet, an all-gather packet, or a reduce packet transmitted along the second direction from another network router. A transmission packet transmitted from another network router to the second receiver 410B of the network router 400 may be a transmission target packet having the network router 400 as its destination, or a transmission pass packet having the network router 400 and another network router as destinations. An all-gather packet transmitted from another network router to the second receiver 410B of the network router 400 may be an all-gather target packet having the network router 400 as its destination, or an all-gather pass packet having the network router 400 and another network router as destinations. A reduce packet transmitted from another network router to the second receiver 410B of the network router 400 may be a reduce target packet having the network router 400 as its destination, or a reduce pass packet having the network router 400 and another network router as destinations.

The second sender 420B of the second router circuit may receive a packet output from the second network controller 430B or the second buffer circuit 440B. The second sender 420B may include at least one second sender buffer 421B in which a packet transmitted from the second network controller 430B or the second buffer circuit 440B is stored. The second sender 420B may output a second transmission packet S_P2 stored in the second sender buffer 421B along the second direction to transmit it to the second receiver of another network router. The second sender 420B may receive a transmission pass packet, which is input from another network router to the second receiver 410B of the network router 400, via the second network controller 430B. The second sender 420B may receive transmission packets, all-gather packets, and reduce packets stored in a scratch pad coupled to the network router 400 via the second buffer circuit 440B. The second sender 420B may receive all-gather pass packets, which are input from another network router to the second receiver 410B of the network router 400, from the second buffer circuit 440B. Additionally, the second sender 420B may receive partial sum pass packets, reduce result pass packets, reduce-scatter result pass packets, and all-reduce result pass packets output from the second reduce operation circuit 450B via the second buffer circuit 440B.

The second network controller 430B of the second router circuit receives a packet output from the second receiver buffer 411B of the second receiver 410B and controls a packet transfer path within the network router 400 based on the packet type. The second network controller 430B may generate a second control signal to control operations within the network router 400 for packets input in the second direction and packets output in the second direction. For example, the second network controller 430B may be configured to transmit a second command for controlling the operation of the second buffer circuit 440B to the second buffer circuit 440B. In one embodiment, when a transmission pass packet is received from the second receiver 410B, the second network controller 430B transmits the transmission pass packet to the second sender 420B. When a reduce packet, an all-gather packet, or a transmission target packet is received from the second receiver 410B, the second network controller 430B transmits the reduce packet, the all-gather packet, and the transmission target packet to the second buffer circuit 440B.

The second buffer circuit 440B of the second router circuit may transmit a reduce packet, which is transferred from another network router and input through the second network controller 430B, to the second reduce operation circuit 450B. The second buffer circuit 440B may transmit an all-gather packet and a transmission target packet, which are transferred from another network router and input through the second network controller 430B, to the second selective output circuit 460B. When the all-gather packet transmitted to the second selective output circuit 460B corresponds to an all-gather pass packet, the second buffer circuit 440B may receive the all-gather pass packet again from the second selective output circuit 460B and store the received packet. The second buffer circuit 440B may transmit the all-gather pass packet, which has been received again from the second selective output circuit 460B and stored, to the second sender 420B.

The second buffer circuit 440B may receive and store a transmission packet, an all-gather packet, and a reduce packet, which are to be transmitted in a second direction to another network router, from a scratch-pad coupled to the network router 400. The second buffer circuit 440B may transmit the transmission packet and the all-gather packet, which are received and stored from the scratch-pad, to the second sender 420B. The second buffer circuit 440B may transmit the reduce packet, which is received and stored from the scratch-pad, to the second sender 420B or the second reduce operation circuit 450B.

The second buffer circuit 440B may receive and store a partial sum packet, a reduce result packet, a reduce-scatter result packet, and an all-reduce result packet output from the second reduce operation circuit 450B via the second selective output circuit 460B. The second buffer circuit 440B may transmit the stored partial sum packet, reduce result packet, reduce-scatter result packet, and all-reduce result packet back to the second selective output circuit 460B. When the partial sum packet, reduce result packet, reduce-scatter result packet, and all-reduce result packet retransmitted to the second selective output circuit 460B correspond respectively to a partial sum pass packet, a reduce result pass packet, a reduce-scatter result pass packet, and an all-reduce result pass packet, the second buffer circuit 440B may receive the partial sum pass packet, reduce result pass packet, reduce-scatter result pass packet, and all-reduce result pass packet again from the second selective output circuit 460B. The second buffer circuit 440B may transmit the partial sum pass packet, reduce result pass packet, reduce-scatter result pass packet, and all-reduce result pass packet, which are received again from the second selective output circuit 460B, to the second sender 420B.

The second reduce operation circuit 450B of the second router circuit may receive a first operand packet and a second operand packet for a second reduce operation from the second buffer circuit 440B. In one embodiment, the first operand packet may be a reduce packet transmitted from a scratch-pad coupled to the network router 400 to the second buffer circuit 440B, and the second operand packet may be a reduce packet transmitted from another network router to the second buffer circuit 440B via the second network controller 430B. The second reduce operation circuit 450B may perform a second reduce operation on the first operand packet and the second operand packet, and may generate a partial sum packet, a reduce result packet, a reduce-scatter result packet, or an all-reduce result packet. The partial sum packet may be generated by the reduce operation performed in the reduce operation, reduce-scatter operation, or all-reduce operation. The reduce result packet may be generated by the reduce operation performed in the reduce operation. The reduce-scatter result packet may be generated by the reduce operation performed in the reduce-scatter operation. The all-reduce result packet may be generated by the reduce operation performed in the all-reduce operation. The second reduce operation circuit 450B may transmit the partial sum packet, the reduce result packet, the reduce-scatter result packet, and the all-reduce result packet to the second selective output circuit 460B.

The second selective output circuit 460B of the second router circuit may receive a partial sum packet, a reduce result packet, a reduce-scatter result packet, and an all-reduce result packet from the second reduce operation circuit 450B, and may transmit the received packets to the second buffer circuit 440B. If the partial sum packet, reduce result packet, reduce-scatter result packet, and all-reduce result packet transmitted to the second buffer circuit 440B correspond respectively to a partial sum target packet, a reduce result target packet, a reduce-scatter result target packet, and an all-reduce result target packet, the second selective output circuit 460B may receive the partial sum target packet, reduce result target packet, reduce-scatter result target packet, and all-reduce result target packet again from the second buffer circuit 440B. The second selective output circuit 460B may transmit the partial sum target packet, reduce result target packet, reduce-scatter result target packet, and all-reduce result target packet received again from the second buffer circuit 440B to the scratch-pad.

The second selective output circuit 460B of the second router circuit may receive a transmission target packet from the second buffer circuit 440B and may transmit the transmission target packet to the scratch-pad. The second selective output circuit 460B may receive an all-gather packet from the second buffer circuit 440B and may transmit the all-gather packet only to the scratch-pad or may transmit the all-gather packet to both the second buffer circuit 440B and the scratch-pad. Specifically, when the all-gather packet transmitted from the second buffer circuit 440B corresponds to a target packet, the second selective output circuit 460B may transmit the all-gather packet to the scratch-pad. When the all-gather packet transmitted from the second buffer circuit 440B corresponds to a pass packet, the second selective output circuit 460B may transmit the all-gather packet to both the second buffer circuit 440B and the scratch-pad.

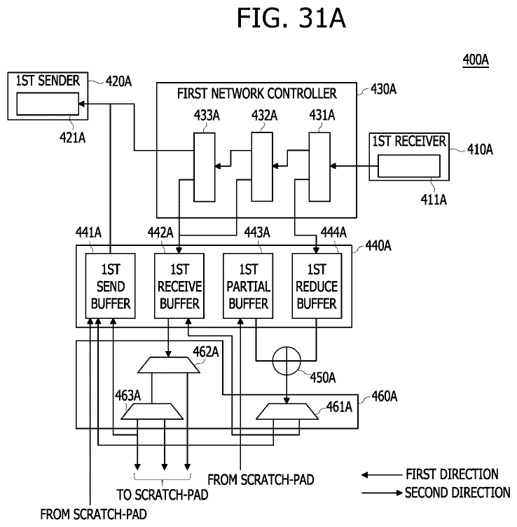

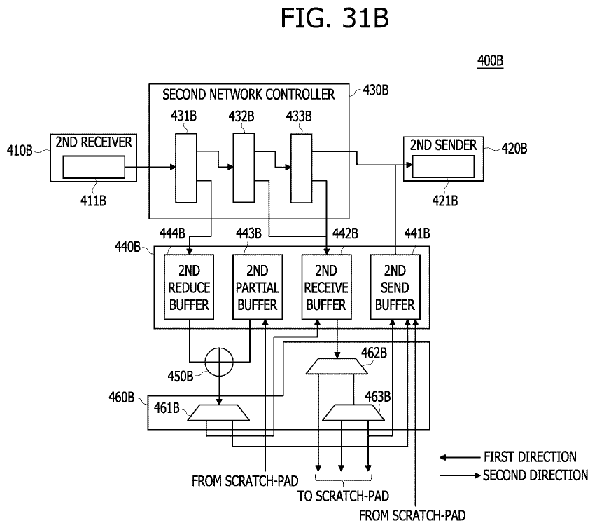

FIG. 31A is a diagram illustrating an example of a first router circuit included in the network router of FIG. 30.

Referring to FIG. 31A, the first network controller 430A may include a first packet transmission circuit 431A, a second packet transmission circuit 432A, and a third packet transmission circuit 433A. The first packet transmission circuit 431A, the second packet transmission circuit 432A, and the third packet transmission circuit 433A may be sequentially arranged in a direction from the first receiver 410A to the first sender 420A. In one embodiment, the first packet transmission circuit 431A, the second packet transmission circuit 432A, and the third packet transmission circuit 433A may each have one input terminal, a first output terminal, and a second output terminal.

An input terminal of the first packet transmission circuit 431A is coupled to an output terminal of the first receiver buffer 411A of the first receiver 410A. Accordingly, the first packet transmission circuit 431A may receive a first receive packet R_P1 transmitted from the first receiver buffer 411A through the input terminal. A first output terminal and a second output terminal of the first packet transmission circuit 431A are coupled to an input terminal of the second packet transmission circuit 432A and the first buffer circuit 440A, respectively. In one embodiment, when a transmission packet or an all-gather packet is input to the input terminal of the first packet transmission circuit 431A, the first packet transmission circuit 431A transmits the transmission packet and the all-gather packet to the input terminal of the second packet transmission circuit 432A through the first output terminal. When a reduce packet is input to the input terminal of the first packet transmission circuit 431A, the first packet transmission circuit 431A transmits the reduce packet to the first buffer circuit 440A through the second output terminal.

An input terminal of the third packet transmission circuit 433A is coupled to a first output terminal of the second packet transmission circuit 432A. A first output terminal and a second output terminal of the third packet transmission circuit 433A are respectively coupled to a first sender buffer 421A of the first sender 420A and the first buffer circuit 440A. The third packet transmission circuit 433A receives a transmission packet from the second packet transmission circuit 432A. When a transmission packet destined for a network router other than the network router 400 is input to the input terminal of the third packet transmission circuit 433A, the third packet transmission circuit 433A transmits a transmission pass packet to the first sender buffer 421A of the first sender 420A through the first output terminal. When a transmission target packet destined for the network router 400 is input to the input terminal of the third packet transmission circuit 433A, the third packet transmission circuit 433A transmits the transmission target packet to the first buffer circuit 440A through the second output terminal.

The first buffer circuit 440A includes a plurality of buffers, for example, a first send buffer 441A, a first receive buffer 442A, a first partial buffer 443A, and a first reduce buffer 444A. The first send buffer 441A of the first buffer circuit 440A may receive a packet from a scratch-pad and the first selective output circuit 460A. Specifically, the first send buffer 441A may receive and store transmission packets, all-gather packets, and reduce packets from a scratch-pad coupled to the network router 400 for transmission to another network router in a first direction from the network router 400. The first send buffer 441A may transmit the stored transmission packets, all-gather packets, and reduce packets to the first sender buffer 421A of the first sender 420A. The first send buffer 441A may receive and store partial sum pass packets, reduce result pass packets, reduce-scatter result pass packets, and all-reduce result pass packets output from the first reduce operation circuit 450A through the first selective output circuit 460A. The first send buffer 441A may transmit the stored partial sum pass packets, reduce result pass packets, reduce-scatter result pass packets, and all-reduce result pass packets to the first sender buffer 421A of the first sender 420A. The first send buffer 441A may receive and store all-gather pass packets having a transmission direction in the first direction from the first selective output circuit 460A. The first send buffer 441A may transmit the all-gather pass packets received from the first selective output circuit 460A to the first sender buffer 421A of the first sender 420A.

The first receive buffer 442A of the first buffer circuit 440A may receive a packet from the second packet transmission circuit 432A and the third packet transmission circuit 433A of the first network controller 430A, as well as from the first selective output circuit 460A. Specifically, the first receive buffer 442A may receive an all-gather packet provided from another network router in the first direction and output from the second output terminal of the second packet transmission circuit 432A. The first receive buffer 442A may receive and store a transmission target packet provided from another network router in the first direction and output from the second output terminal of the third packet transmission circuit 433A. The first receive buffer 442A may receive and store a partial sum target packet, a reduce result target packet, a reduce-scatter result target packet, and an all-reduce result target packet output from the first reduce operation circuit 450A via the first selective output circuit 460A. The first receive buffer 442A may transmit the stored all-gather packet, transmission target packet, partial sum target packet, reduce result target packet, reduce-scatter result target packet, and all-reduce result target packet to the first selective output circuit 460A in response to a first receive command transmitted from the first network controller 430A to the first receive buffer 442A.

The first partial buffer 443A and the first reduce buffer 444A of the first buffer circuit 440A store reduce packets used as operands in a reduce operation. Specifically, the first partial buffer 443A may receive and store a reduce packet used as a first operand in the reduce operation from the scratch-pad. The reduce packet transmitted from the scratch-pad to the first partial buffer 443A may include a partial sum packet that has been generated by a previous reduce operation and stored in the scratch-pad. The first partial buffer 443A may transmit the reduce packet used as the first operand in the reduce operation to the first input terminal of the first reduce operation circuit 450A. The first reduce buffer 444A may receive and store a reduce packet used as a second operand in the reduce operation from the first packet transmission circuit 431A of the first network controller 430A. The reduce packet transmitted from the first packet transmission circuit 431A to the first reduce buffer 444A may include a partial sum pass packet that has been generated by a reduce operation in another network router and transmitted to the network router 400. The first reduce buffer 444A may transmit the reduce packet used as the second operand in the reduce operation to the second input terminal of the first reduce operation circuit 450A.

The first reduce operation circuit 450A performs a collective operation, such as a reduce operation. In one example, the first reduce operation circuit 450A may be an adder that performs an addition operation. However, this is merely one example, and the first reduce operation circuit 450A may alternatively be an arithmetic unit that performs operations other than addition, such as multiplication, division, maximum value computation, or minimum value computation. The first reduce operation circuit 450A includes a plurality of input terminals, such as a first input terminal and a second input terminal, and at least one output terminal. The first input terminal of the first reduce operation circuit 450A is coupled to the first partial buffer 443A of the first buffer circuit 440A. The second input terminal of the first reduce operation circuit 450A is coupled to the first reduce buffer 444A of the first buffer circuit 440A. The output terminal of the first reduce operation circuit 450A is coupled to the first selective output circuit 460A. The first reduce operation circuit 450A may receive, through the first input terminal, a reduce packet used as a first operand in the reduce operation from the first partial buffer 443A. The first reduce operation circuit 450A may receive, through the second input terminal, a reduce packet used as a second operand in the reduce operation from the first reduce buffer 444A. The first reduce operation circuit 450A may perform the reduce operation, such as an addition operation, on the reduce packet used as the first operand and the reduce packet used as the second operand to generate a partial sum packet, a reduce result packet, a reduce-scatter result packet, or an all-reduce result packet. The partial sum packet may be generated by the reduce operation during a reduce operation, a reduce-scatter operation, or an all-reduce operation. The reduce result packet may be generated by the reduce operation during a reduce operation. The reduce-scatter result packet may be generated by the reduce operation during a reduce-scatter operation. The all-reduce result packet may be generated by the reduce operation during an all-reduce operation. The first reduce operation circuit 450A may transmit the partial sum packet, the reduce result packet, the reduce-scatter result packet, and the all-reduce result packet to the first selective output circuit 460A through the output terminal.

The first selective output circuit 460A may include a plurality of demultiplexers, such as a first demultiplexer 461A, a second demultiplexer 462A, and a third demultiplexer 463A. In one example, the first demultiplexer 461A, the second demultiplexer 462A, and the third demultiplexer 463A may each be a 1-to-2 demultiplexer having one input terminal and two output terminals. An input terminal of the first demultiplexer 461A is coupled to an output terminal of the first reduce operation circuit 450A. A first output terminal of the first demultiplexer 461A is coupled to the first send buffer 441A of the first buffer circuit 440A. A second output terminal of the first demultiplexer 461A is coupled to the first receive buffer 442A of the first buffer circuit 440A. An input terminal of the second demultiplexer 462A is coupled to the first receive buffer 442A of the first buffer circuit 440A. A first output terminal of the second demultiplexer 462A is coupled to an input terminal of the third demultiplexer 463A. A second output terminal of the second demultiplexer 462A is coupled to the scratch-pad (reference numeral 213 in FIG. 2). An input terminal of the third demultiplexer 463A is coupled to the first output terminal of the second demultiplexer 462A. A first output terminal of the third demultiplexer 463A is commonly coupled to the scratch-pad and the first send buffer 441A of the first buffer circuit 440A. A second output terminal of the third demultiplexer 463A is coupled to the scratch-pad.

The first demultiplexer 461A receives, through an input terminal, a partial sum packet, a reduce result packet, a reduce-scatter result packet, and an all-reduce result packet output from the first reduce operation circuit 450A. When the partial sum packet, the reduce result packet, the reduce-scatter result packet, and the all-reduce result packet input to the input terminal of the first demultiplexer 461A correspond to a partial sum pass packet, a reduce result pass packet, a reduce-scatter result pass packet, and an all-reduce result pass packet, respectively, the first demultiplexer 461A transmits the partial sum pass packet, the reduce result pass packet, the reduce-scatter result pass packet, and the all-reduce result pass packet to the first send buffer 441A of the first buffer circuit 440A through a first output terminal. When the partial sum packet, the reduce result packet, the reduce-scatter result packet, and the all-reduce result packet input to the input terminal of the first demultiplexer 461A correspond to a partial sum target packet, a reduce result target packet, a reduce-scatter result target packet, and an all-reduce result target packet, respectively, the first demultiplexer 461A transmits the partial sum target packet, the reduce result target packet, the reduce-scatter result target packet, and the all-reduce result target packet to the first receive buffer 442A of the first buffer circuit 440A through the second output terminal.

The second demultiplexer 462A receives, through an input terminal, an all-gather packet, a transmission target packet, a partial sum target packet, a reduce result target packet, a reduce-scatter result target packet, and an all-reduce result target packet output from the first receive buffer 442A of the first buffer circuit 440A. When the all-gather packet is received from the first receive buffer 442A, the second demultiplexer 462A transmits the all-gather packet to the input terminal of the third demultiplexer 463A through a first output terminal. When the transmission target packet, the partial sum target packet, the reduce result target packet, the reduce-scatter result target packet, and the all-reduce result target packet are received from the first receive buffer 442A, the second demultiplexer 462A transmits the transmission target packet, the partial sum target packet, the reduce result target packet, the reduce-scatter result target packet, and the all-reduce result target packet to the scratch-pad through a second output terminal.

The third demultiplexer 463A receives, through an input terminal, the all-gather packet output from the first output terminal of the second demultiplexer 462A. When the all-gather packet received from the second demultiplexer 462A corresponds to an all-gather pass packet, the third demultiplexer 463A transmits the all-gather pass packet to both the first send buffer 441A of the first buffer circuit 440A and the scratch-pad through a first output terminal. In contrast, when the all-gather packet received from the second demultiplexer 462A corresponds to an all-gather target packet, the third demultiplexer 463A transmits the all-gather target packet to the scratch-pad through a second output terminal.

FIG. 31B is a diagram illustrating an example of a second router circuit included in the network router of FIG. 30.

Referring to FIG. 31B, the second network controller 430B may include a fourth packet transmission circuit 431B, a fifth packet transmission circuit 432B, and a sixth packet transmission circuit 433B. The fourth packet transmission circuit 431B, the fifth packet transmission circuit 432B, and the sixth packet transmission circuit 433B may be sequentially arranged in a direction from the second receiver 410B to the second sender 420B. In one embodiment, each of the fourth packet transmission circuit 431B, the fifth packet transmission circuit 432B, and the sixth packet transmission circuit 433B may include one input terminal, a first output terminal, and a second output terminal.

An input terminal of the fourth packet transmission circuit 431B is coupled to an output terminal of the second receiver buffer 411B of the second receiver 410B. Accordingly, the fourth packet transmission circuit 431B may receive a second receive packet R_P2 transmitted from the second receiver buffer 411B through the input terminal. A first output terminal and a second output terminal of the fourth packet transmission circuit 431B are coupled to an input terminal of the fifth packet transmission circuit 432B and to the second buffer circuit 440B, respectively. In one embodiment, when data movement packets, such as broadcast packets, gather packets, scatter packets, and all-gather packets, are input to the input terminal of the fourth packet transmission circuit 431B, the fourth packet transmission circuit 431B may transmit the broadcast packets, gather packets, scatter packets, and all-gather packets to the input terminal of the fifth packet transmission circuit 432B through the first output terminal. When reduction operation packets, such as reduce packets, reduce-scatter packets, and all-reduce packets, are input to the input terminal of the fourth packet transmission circuit 431B, the fourth packet transmission circuit 431B may transmit the reduce packets, reduce-scatter packets, and all-reduce packets to the second buffer circuit 440B through the second output terminal.

An input terminal of the fifth packet transmission circuit 432B is coupled to a first output terminal of the fourth packet transmission circuit 431B. A first output terminal and a second output terminal of the fifth packet transmission circuit 432B are respectively coupled to an input terminal of the sixth packet transmission circuit 433B and to the second buffer circuit 440B. The fifth packet transmission circuit 432B receives data movement packets from the fourth packet transmission circuit 431B. When broadcast packets, gather packets, or scatter packets are input to the input terminal of the fifth packet transmission circuit 432B, the fifth packet transmission circuit 432B transmits the broadcast packets, gather packets, and scatter packets to the input terminal of the sixth packet transmission circuit 433B through the first output terminal. When an all-gather packet is input to the input terminal of the fifth packet transmission circuit 432B, the fifth packet transmission circuit 432B transmits the all-gather packet to the second buffer circuit 440B through the second output terminal.

An input terminal of the sixth packet transmission circuit 433B is coupled to a first output terminal of the fifth packet transmission circuit 432B. A first output terminal and a second output terminal of the sixth packet transmission circuit 433B are respectively coupled to the second sender buffer 421B of the second sender 420B and to the second buffer circuit 440B. The sixth packet transmission circuit 433B receives broadcast packets, gather packets, and scatter packets from the fifth packet transmission circuit 432B. When a path packet, such as a broadcast path packet, gather path packet, or scatter path packet, destined for both the network router 400 and another network router is input to the input terminal of the sixth packet transmission circuit 433B, the sixth packet transmission circuit 433B transmits the broadcast path packet, gather path packet, and scatter path packet to the second sender buffer 421B of the second sender 420B through the first output terminal. When a target packet, such as a broadcast target packet, gather target packet, or scatter target packet, destined for the network router 400 is input to the input terminal of the sixth packet transmission circuit 433B, the sixth packet transmission circuit 433B transmits the broadcast target packet, gather target packet, and scatter target packet to the second buffer circuit 440B through the second output terminal.

The second buffer circuit 440B includes a plurality of buffers, such as a second send buffer 441B, a second receive buffer 442B, a second partial buffer 443B, and a second reduce buffer 444B. The second send buffer 441B of the second buffer circuit 440B may receive packets from a scratch-pad and a second selective output circuit 460B. Specifically, the second send buffer 441B may receive and store broadcast packets, gather packets, scatter packets, and all-gather packets, which are stored in the scratch-pad and to be provided from the network router 400 to another network router along a second direction. The second send buffer 441B may transmit the stored broadcast packets, gather packets, scatter packets, and all-gather packets to the second sender buffer 421B of the second sender 420B. The second send buffer 441B may receive and store all-gather path packets, all-reduce path packets, and reduce result path packets, which are transmitted in the second transmission direction, from the second selective output circuit 460B. The second send buffer 441B may transmit the stored all-gather path packets, all-reduce path packets, and reduce result path packets to the second sender buffer 421B of the second sender 420B.

The second receive buffer 442B of the second buffer circuit 440B may receive packets from a fifth packet transmission circuit 432B, a sixth packet transmission circuit 433B, and a second selective output circuit 460B of the second network controller 430B. Specifically, the second receive buffer 442B may receive all-gather packets, which are provided from another network router along a second direction and output through the second output terminal of the fifth packet transmission circuit 432B. The second receive buffer 442B may receive and store broadcast target packets, gather target packets, and scatter target packets, which are provided from another network router along the second direction and output through the second output terminal of the sixth packet transmission circuit 433B. The second receive buffer 442B may receive and store reduce result target packets from the second selective output circuit 460B. The second receive buffer 442B may transmit the stored all-gather packets, broadcast target packets, gather target packets, scatter target packets, and reduce result target packets to the second selective output circuit 460B in response to a second receive command transmitted from the second network controller 430B.

The second partial buffer 443B and the second reduce buffer 444B of the second buffer circuit 440B store packets used for a reduce operation. Specifically, the second partial buffer 443B of the second buffer circuit 440B may receive packets from a scratch-pad. In one example, the second partial buffer 443B may receive and store reduce operation packets used as operands for a reduce operation from the scratch-pad. Additionally, the second partial buffer 443B may receive and store partial sum packets and reduce result packets, which have been generated by a previous reduce operation and stored in the scratch-pad. The second partial buffer 443B may transmit the stored packets to a first input terminal of the second reduce operation circuit 450B. The second reduce buffer 444B of the second buffer circuit 440B may receive packets from a fourth packet transmission circuit 431B of the second network controller 430B. In one example, the second reduce buffer 444B may receive and store reduce operation packets, such as reduce packets, reduce-scatter packets, and all-reduce packets, which are transmitted from another network router along a second direction. The second reduce buffer 444B may transmit the stored reduce operation packets to a second input terminal of the second reduce operation circuit 450B.

The second reduce operation circuit 450B performs a collective operation, such as a reduce operation. In one example, the second reduce operation circuit 450B may be an adder that performs an addition operation. However, this is merely one example, and the second reduce operation circuit 450B may alternatively be a computation circuit that performs operations other than addition, such as a multiplication operation, division operation, or an operation for determining a maximum or minimum value. The second reduce operation circuit 450B includes a plurality of input terminals, such as a first input terminal and a second input terminal, and at least one output terminal. The first input terminal of the second reduce operation circuit 450B is coupled to a second partial buffer 443B of the second buffer circuit 440B. The second input terminal of the second reduce operation circuit 450B is coupled to a second reduce buffer 444B of the second buffer circuit 440B. The output terminal of the second reduce operation circuit 450B is coupled to a second selective output circuit 460B. The second reduce operation circuit 450B receives, via the first input terminal, a reduce operation packet, a partial sum packet, or a reduce result packet used as a first operand for the reduce operation from the second partial buffer 443B. The second reduce operation circuit 450B also receives, via the second input terminal, a reduce operation packet used as a second operand for the reduce operation from the second reduce buffer 444B. The second reduce operation circuit 450B performs a reduce operation, such as an addition operation, on the first operand packet and the second operand packet to generate a reduce result packet. The second reduce operation circuit 450B transmits the reduce result packet to the second selective output circuit 460B via the output terminal.

The second selective output circuit 460B may include a plurality of demultiplexers, such as a fourth demultiplexer 461B, a fifth demultiplexer 462B, and a sixth demultiplexer 463B. In one example, each of the fourth demultiplexer 461B, the fifth demultiplexer 462B, and the sixth demultiplexer 463B may be a 1:2 demultiplexer that includes one input terminal and two output terminals. An input terminal of the fourth demultiplexer 461B is coupled to an output terminal of the second reduce operation circuit 450B. A first output terminal of the fourth demultiplexer 461B is coupled to a second send buffer 441B of the second buffer circuit 440B. A second output terminal of the fourth demultiplexer 461B is coupled to a second receive buffer 442B of the second buffer circuit 440B. An input terminal of the fifth demultiplexer 462B is coupled to the second receive buffer 442B of the second buffer circuit 440B. A first output terminal of the fifth demultiplexer 462B is coupled to an input terminal of the sixth demultiplexer 463B. A second output terminal of the fifth demultiplexer 462B is coupled to a scratch-pad. An input terminal of the sixth demultiplexer 463B is coupled to the first output terminal of the fifth demultiplexer 462B. A first output terminal of the sixth demultiplexer 463B is commonly coupled to both the scratch-pad and the second send buffer 441B of the second buffer circuit 440B. A second output terminal of the sixth demultiplexer 463B is coupled to the scratch-pad.

The fourth demultiplexer 461B receives a reduce result packet output from the second reduce operation circuit 450B through the input terminal. When the reduce result packet corresponds to a pass packet, the fourth demultiplexer 461B transmits the reduce result pass packet to the first output terminal, which is connected to the second send buffer 441B of the second buffer circuit 440B. When the reduce result packet corresponds to a target packet, the fourth demultiplexer 461B transmits the reduce result target packet to the second output terminal, which is connected to the second receive buffer 442B of the second buffer circuit 440B.

The fifth demultiplexer 462B receives, through the input terminal, an all-gather packet, a broadcast target packet, a gather target packet, a scatter target packet, and a reduce result packet output from the second receive buffer 442B of the second buffer circuit 440B. When an all-gather packet is transmitted from the second receive buffer 442B, the fifth demultiplexer 462B transmits the all-gather packet to the input terminal of the sixth demultiplexer 463B via the first output terminal. When a broadcast target packet, a gather target packet, or a scatter target packet is transmitted from the second receive buffer 442B, the fifth demultiplexer 462B transmits the respective packet to the scratch-pad via the second output terminal. When a reduce result packet is transmitted from the second receive buffer 442B, the fifth demultiplexer 462B transmits the reduce result packet either to the input terminal of the sixth demultiplexer 463B or to the scratch-pad. Specifically, when the reduce result packet transmitted from the second receive buffer 442B is a result of an all-reduce operation, the fifth demultiplexer 462B transmits the reduce result packet to the input terminal of the sixth demultiplexer 463B. On the other hand, when the reduce result packet transmitted from the second receive buffer 442B is a result of a reduce operation or a reduce-scatter operation, the fifth demultiplexer 462B transmits the reduce result packet to the scratch-pad.

The sixth demultiplexer 463B receives, through the input terminal, an all-gather packet and a reduce result packet generated by an all-reduce operation, which are output from the first output terminal of the fifth demultiplexer 462B. When the all-gather packet and the reduce result packet generated by the all-reduce operation correspond to pass packets, the sixth demultiplexer 463B transmits the all-gather pass packet and the reduce result pass packet to both the second send buffer 441B of the second buffer circuit 440B and the scratch-pad via the first output terminal. On the other hand, when the all-gather packet and the reduce result packet generated by the all-reduce operation correspond to target packets, the sixth demultiplexer 463B transmits the all-gather packet and the reduce result packet to the scratch-pad via the second output terminal.

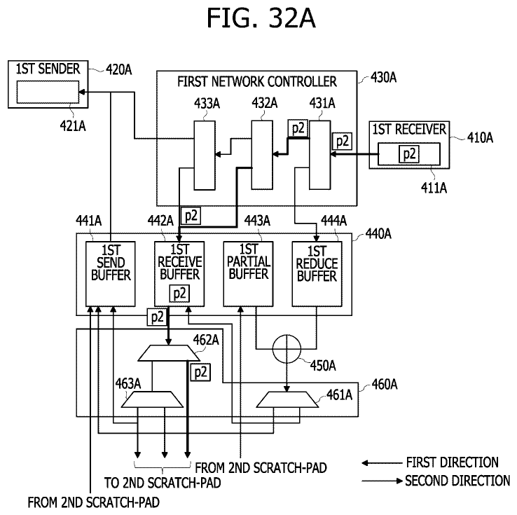

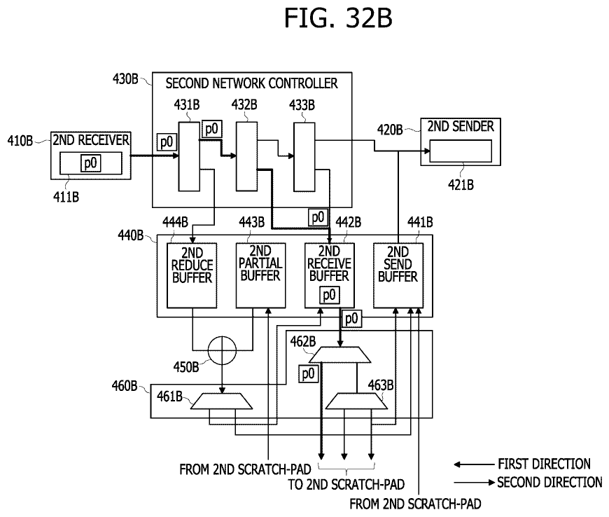

FIG. 32A is a diagram illustrating the operation of the first router circuit of the network router of FIG. 30 receiving two transmission target packets along a first direction and a second direction. And FIG. 32B is a diagram illustrating the operation of the second router circuit of the network router of FIG. 30 receiving two transmission target packets along a first direction and a second direction. The operation of the first router circuit and the second router circuit of the network router according to the present embodiment may be applied to the second step (STEP 2) of the gather operation of the second network router (112(2) of FIG. 12A), as described with reference to FIG. 12A. In FIGS. 32A and 32B, the same reference numerals as those in FIGS. 31A and 31B denote the same components.

Referring to FIGS. 32A and 32B, the network router 400 receives a third packet, p2, along a first direction from another network router, such as the third network router 112-3 of FIG. 12A, and receives a first packet, p0, along a second direction from yet another network router, such as the first network router 112-1 of FIG. 12A. As described with reference to FIG. 12A, the first packet p0 and the third packet p2 are transmission target packets having the network router 400 as a destination. A first receiver 410A of the network router 400 stores the third packet p2 in a first receiver buffer 411A. A second receiver 410B of the network router 400 stores the first packet p0 in a second receiver buffer 411B. The first receiver 410A outputs the third packet p2 stored in the first receiver buffer 411A, and the second receiver 410B outputs the first packet p0 stored in the second receiver buffer 411B. The third packet p2 output from the first receiver buffer 411A is input to a first packet transmission circuit 431A of a first network controller 430A, and the first packet p0 output from the second receiver buffer 411B is input to a fourth packet transmission circuit 431B of a second network controller 430B.

Since both the first packet p0 and the third packet p2 are transmission target packets, the first packet transmission circuit 431A transmits the third packet p2 to the input terminal of the second packet transmission circuit 432A through the first output terminal. Similarly, the fourth packet transmission circuit 431B transmits the first packet p0 to the input terminal of the fifth packet transmission circuit 432B through the first output terminal. The second packet transmission circuit 432A transmits the third packet p2 to the first receive buffer 442A of the first buffer circuit 440A through the second output terminal, and the fifth packet transmission circuit 432B transmits the first packet p0 to the second receive buffer 442B of the second buffer circuit 440B through the second output terminal. Although not illustrated in the drawings, when the third packet p2 is transmitted to the first receive buffer 442A, the first network controller 430A may transmit a first receive command to the first receive buffer 442A. Likewise, when the first packet p0 is transmitted to the second receive buffer 442B, the second network controller 430B may transmit a second receive command to the second receive buffer 442B.

The first receive buffer 442A, which has received the third packet p2 from the second packet transmission circuit 432A, outputs the third packet p2 in response to the first receive command. The third packet p2 output from the first receive buffer 442A is transmitted to the input terminal of the second demultiplexer 462A of the first selective output circuit 460A. Since the third packet p2 is a transmission target packet, the second demultiplexer 462A transmits the third packet p2 to the scratch-pad through the second output terminal. Similarly, the second receive buffer 442B, which has received the first packet p0 from the fifth packet transmission circuit 432B, outputs the first packet p0 in response to the second receive command. The first packet p0 output from the second receive buffer 442B is transmitted to the input terminal of the fifth demultiplexer 462B of the second selective output circuit 460B. Since the first packet p0 is a transmission target packet, the fifth demultiplexer 462B transmits the first packet p0 to the scratch-pad through the second output terminal. When the first receive command transmitted to the first receive buffer 442A and the second receive command transmitted to the second receive buffer 442B are issued at substantially the same time, the third packet p2 and the first packet p0 may be transmitted to the scratch-pad at substantially the same time.

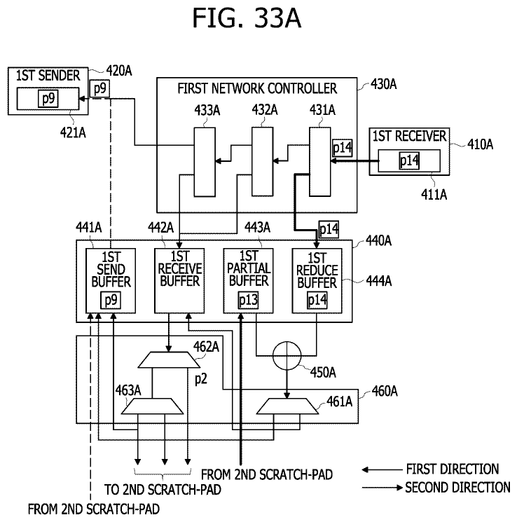

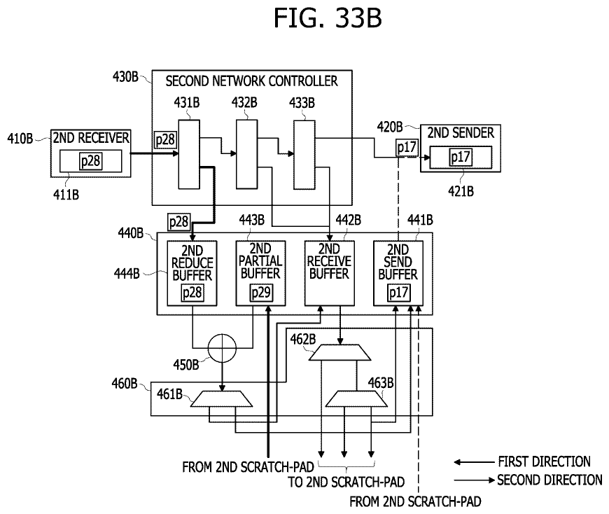

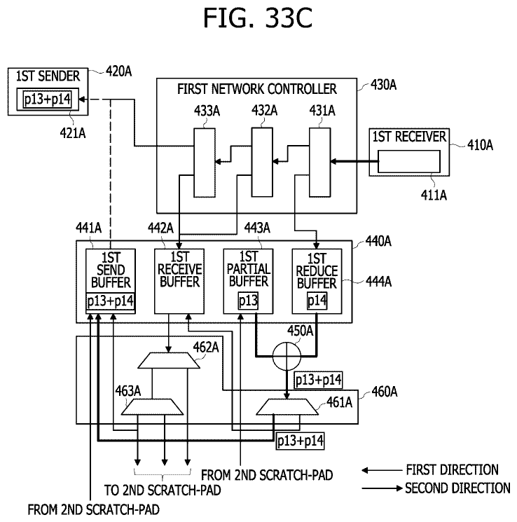

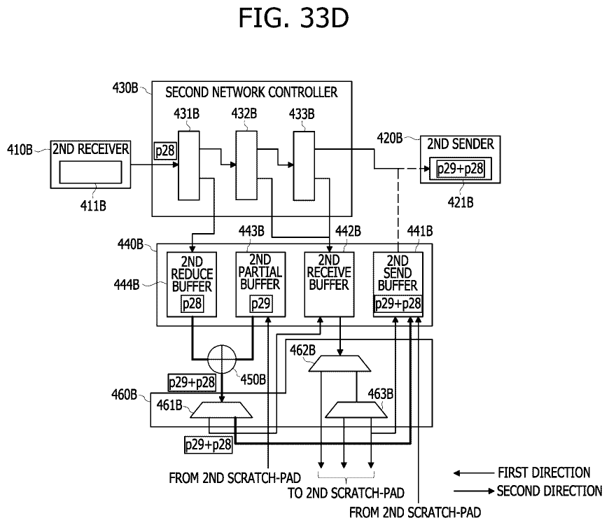

FIGS. 33A through 33D are diagrams illustrating the operation of the first router circuit and the second router circuit of the network router of FIG. 30 that transmits two reduce packets and receives two reduce-pass packets along a first direction and a second direction. The operations of the first router circuit and the second router circuit of the network router according to the present example may be applied to the second network router (112(2) in FIG. 26A) at the second step (STEP 2) of the reduce-scatter operation described with reference to FIG. 26A. In FIGS. 33A through 33D, the same reference numerals as those in FIGS. 31A and 31B denote the same components.

Referring to FIGS. 33A through 33D, the network router 400 transmits a tenth packet p9, which is stored in the scratch-pad, in a first direction to another network router, for example, the first network router 112(1) shown in FIG. 26A. The network router 400 also transmits an eighteenth packet p17, which is stored in the scratch-pad, in a second direction to another network router, for example, the third network router 112(3) shown in FIG. 26A. Furthermore, the network router 400 receives a twenty-ninth packet p28 from the first network router 112(1) in the second direction, and receives a fifteenth packet p14 from the third network router 112(3) in the first direction. As described with reference to FIG. 26A, the tenth packet p9, the eighteenth packet p17, the twenty-ninth packet p28, and the fifteenth packet p14 are all reduce packets. The destination of the tenth packet p9 is set to the third network router 112(3), and the destination of the eighteenth packet p17 is set to the first network router 112(1). The destinations of both the twenty-ninth packet p28 and the fifteenth packet p14 are set to another network router, for example, the fourth network router 112(4) shown in FIG. 26A. Accordingly, the network router 400 processes both the twenty-ninth packet p28, which is received from the first network router 112(1), and the fifteenth packet p14, which is received from the third network router 112(3), as reduce pass packets.

Specifically, as illustrated in FIGS. 33A and 33B, the network router 400 transfers a tenth packet p9, stored in the scratch-pad, to a first send buffer 441A of a first buffer circuit 440A. The network router 400 also transfers an eighteenth packet p17, stored in the scratch-pad, to a second send buffer 441B of a second buffer circuit 440B. The first send buffer 441A transfers the tenth packet p9 to a first sender buffer 421A of a first sender 420A, and the second send buffer 441B transfers the eighteenth packet p17 to a second sender buffer 421B of a second sender 420B. The first sender 420A outputs the tenth packet p9, stored in the first sender buffer 421A, in the first direction and transmits the packet to the first network router 112(1) shown in FIG. 26A. The second sender 420B outputs the eighteenth packet p17, stored in the second sender buffer 421B, in the second direction and transmits the packet to the third network router 112(3) shown in FIG. 26A. Upon output of the tenth packet p9 and the eighteenth packet p17, the first sender buffer 421A of the first sender 420A and the second sender buffer 421B of the second sender 420B become empty.

In parallel with the output operations of the tenth packet p9 and the eighteenth packet p17, processing operations for the fifteenth packet p14 and the twenty-ninth packet p28 are also performed. A first receiver 410A of the network router 400 stores the fifteenth packet p14, transmitted in the first direction from a third network router 112(3) shown in FIG. 26A, into a first receiver buffer 411A. A second receiver 410B of the network router 400 stores the twenty-ninth packet p28, transmitted in the second direction from a first network router 112(1) shown in FIG. 26A, into a second receiver buffer 411B. The first receiver 410A outputs the fifteenth packet p14 stored in the first receiver buffer 411A, and the second receiver 410B outputs the twenty-ninth packet p28 stored in the second receiver buffer 411B. The fifteenth packet p14 output from the first receiver buffer 411A is input to a first packet transmission circuit 431A of a first network controller 430A, and the twenty-ninth packet p28 output from the second receiver buffer 411B is input to a fourth packet transmission circuit 431B of a second network controller 430B.

Since both the fifteenth packet p14 and the twenty-ninth packet p28 are reduce packets, the first packet transmission circuit 431A transmits the fifteenth packet p14 to a first reduce buffer 444A of a first buffer circuit 440A via a second output terminal. Similarly, the fourth packet transmission circuit 431B transmits the twenty-ninth packet p28 to a second reduce buffer 444B of a second buffer circuit 440B via a second output terminal. As the fifteenth packet p14 is transferred to the first reduce buffer 444A, the network router 400 transfers a fourteenth packet p13, used as an operand for a first reduce operation, from a scratch-pad to a first partial buffer 443A of the first buffer circuit 440A. In a similar manner, as the twenty-ninth packet p28 is transferred to the second reduce buffer 444B, the network router 400 transfers a thirtieth packet p29, used as an operand for a second reduce operation, from the scratch-pad to a second partial buffer 443B of the second buffer circuit 440B.

Referring next to FIGS. 33C and 33D, the first partial buffer 443A transmits packet 13 to a first input terminal of the first reduce operation circuit 450A, and the first reduce buffer 444A transmits packet 14 to a second input terminal of the first reduce operation circuit 450A. Similarly, the second partial buffer 443B transmits packet 29 to a first input terminal of the second reduce operation circuit 450B, and the second reduce buffer 444B transmits packet 28 to a second input terminal of the second reduce operation circuit 450B. The first reduce operation circuit 450A performs a first reduce operation, namely a first addition operation, on packet 13 and packet 14 to generate a third partial sum packet representing the result of packet 13 plus packet 14. In parallel, the second reduce operation circuit 450B performs a second reduce operation, namely a second addition operation, on packet 29 and packet 28 to generate a fourth partial sum packet representing the result of packet 29 plus packet 28. The first reduce operation circuit 450A outputs the third partial sum packet and transmits the third partial sum packet to an input terminal of the first demultiplexer 461A of the first selective output circuit 460A. Likewise, the second reduce operation circuit 450B outputs the fourth partial sum packet and transmits the fourth partial sum packet to an input terminal of the fourth demultiplexer 461B of the second selective output circuit 460B.

Since the destination of packet p14 is set to the fourth network router (112(4) of FIG. 26A), the destination of the third partial sum packet p13+p14 is also set to the fourth network router (112(4) of FIG. 26A). Accordingly, the network router 400 handles the third partial sum packet p13+p14 as a partial sum pass packet. That is, the first demultiplexer 461A transmits the third partial sum packet p13+p14, via a first output terminal, to the first send buffer 441A of the first buffer circuit 440A. The first send buffer 441A transmits the third partial sum packet p13+p14 to the first sender buffer 421A of the first sender 420A. Likewise, since the destination of packet p28 is set to the fourth network router (112(4) of FIG. 26A), the destination of the fourth partial sum packet p29+p28 is also set to the fourth network router (112(4) of FIG. 26A). Accordingly, the network router 400 handles the fourth partial sum packet p29+p28 as a partial sum pass packet. That is, the fourth demultiplexer 461B transmits the fourth partial sum packet p29+p28, via a first output terminal, to the second send buffer 441B of the second buffer circuit 440B. The second send buffer 441B transmits the fourth partial sum packet p29+p28 to the second sender buffer 421B of the second sender 420B.

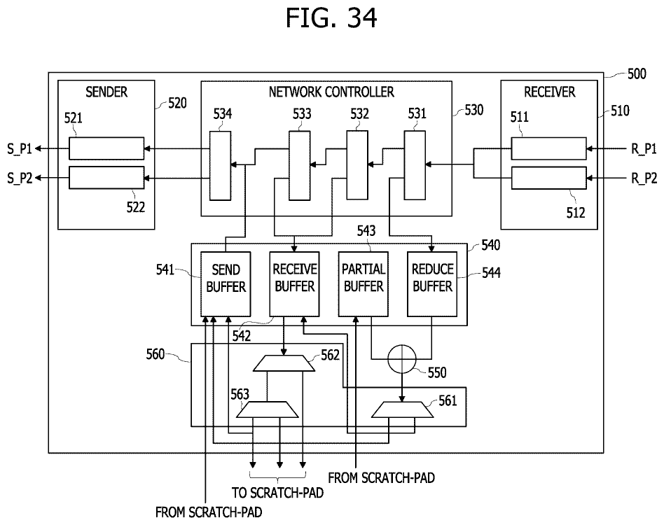

FIG. 34 is a diagram illustrating another example of a network router according to the present disclosure. The description of the network router according to the present example may be equally applied to the first through N-th network routers 112(1)-112(N) of FIG. 1 and the network router 220 of FIG. 2. In the present example, a transmission packet is defined as a term referring to any one of a send packet, a scatter packet, or a gather packet. Accordingly, a broadcast packet is not included in the transmission packets. The method for performing collective operations, except for a broadcast operation, in the network router according to the present example is the same as the method for performing the collective operations in the network router 300 described with reference to FIG. 3.

Referring to FIG. 34, a network router 500 may receive a first received packet R_P1 in a first direction and a second received packet R_P2 in a second direction. The network router 500 may also output a first transmitted packet S_P1 in the first direction and a second transmitted packet S_P2 in the second direction. The network router 500 may receive a packet from a scratch-pad (e.g., scratch-pad 213 of FIG. 2) coupled to the network router 500, or may transmit a packet to the scratch-pad. The network router 500 may be configured to perform collective operations such as data movement operations and reduce operation processing.

The network router 500 may include a receiver 510, a sender 520, a network controller 530, a buffer circuit 540, a reduce operation circuit 550, and a selective output circuit 560. The receiver 510 may include a first receiver buffer 511 and a second receiver buffer 512. The sender 520 may include a first sender buffer 521 and a second sender buffer 522. The network controller 530 may include a first packet transmission circuit 531, a second packet transmission circuit 532, a third packet transmission circuit 533, and a fourth packet transmission circuit 534. The buffer circuit 540 may include a send buffer 541, a receive buffer 542, a partial buffer 543, and a reduce buffer 544. The selective output circuit 560 may include a first demultiplexer 561, a second demultiplexer 562, and a third demultiplexer 563. The receiver 510, the sender 520, and the reduce operation circuit 550 of the network router 500 may be configured in the same manner as the receiver 310, the sender 320, and the reduce operation circuit 350 of the network router 300 described with reference to FIG. 3. The partial buffer 543 and the reduce buffer 544 of the buffer circuit 540 may be configured in the same manner as the partial buffer 343 and the reduce buffer 344 of the buffer circuit 340 included in the network router 300 described with reference to FIG. 3. In addition, the first demultiplexer 561 of the selective output circuit 560 may be configured in the same manner as the first demultiplexer 361 of the selective output circuit 360 included in the network router 300 described with reference to FIG. 3. Accordingly, redundant explanations will be omitted hereinafter.

Each of the first packet transmission circuit 531, the second packet transmission circuit 532, the third packet transmission circuit 533, and the fourth packet transmission circuit 534 of the network controller 530 may include one input terminal and two output terminals, that is, a first output terminal and a second output terminal. An input terminal of the first packet transmission circuit 531 may be commonly connected to the first receiver buffer 511 and the second receiver buffer 512 of the receiver 510. A first output terminal of the first packet transmission circuit 531 may be connected to an input terminal of the second packet transmission circuit 532. A second output terminal of the first packet transmission circuit 531 may be connected to the reduce buffer 544 of the buffer circuit 540. A first output terminal of the second packet transmission circuit 532 may be connected to an input terminal of the third packet transmission circuit 533. A second output terminal of the second packet transmission circuit 532 may be connected to the receive buffer 542 of the buffer circuit 540. A first output terminal of the third packet transmission circuit 533 may be connected to an input terminal of the fourth packet transmission circuit 534. A second output terminal of the third packet transmission circuit 533 may be connected to the receive buffer 542 of the buffer circuit 540. An input terminal of the fourth packet transmission circuit 534 may be connected not only to the first output terminal of the third packet transmission circuit 533 but also to the send buffer 541 of the buffer circuit 540. A first output terminal of the fourth packet transmission circuit 534 may be connected to the first sender buffer 521 of the sender 520. A second output terminal of the fourth packet transmission circuit 534 may be connected to the second sender buffer 522 of the sender 520.

The first packet transmission circuit 531 of the network router 500 may receive a transfer packet, a broadcast packet, an all-gather packet, and a reduce packet from the receiver 510 via an input terminal. The first packet transmission circuit 531 may transmit the transfer packet, the broadcast packet, and the all-gather packet to the input terminal of the second packet transmission circuit 532 via the first output terminal. The first packet transmission circuit 531 may transmit the reduce packet to the reduce buffer 544 of the buffer circuit 540 via the second output terminal. The second packet transmission circuit 532 may transmit the transfer packet to the input terminal of the third packet transmission circuit 533 via the first output terminal. The second packet transmission circuit 532 may transmit the broadcast packet and the all-gather packet to the receive buffer 542 of the buffer circuit 540 via the second output terminal. The third packet transmission circuit 533 may transmit a transfer pass packet to the input terminal of the fourth packet transmission circuit 534 via the first output terminal. The third packet transmission circuit 533 may transmit a transfer target packet to the receive buffer 542 of the buffer circuit 540 via the second output terminal. The fourth packet transmission circuit 534 may output the transfer pass packet via either the first output terminal or the second output terminal depending on the transfer direction.

The fourth packet transmission circuit 534 may receive a transfer packet, a broadcast packet, an all-gather packet, and a reduce packet transmitted from a scratch-pad coupled to the network router 500 via the send buffer 541 of the buffer circuit 540. When the transfer direction of the transfer packet, the broadcast packet, the all-gather packet, and the reduce packet received from the send buffer 541 is a first direction, the fourth packet transmission circuit 534 may transmit the transfer packet, the broadcast packet, the all-gather packet, and the reduce packet to the first sender buffer 521 of the sender 520 via the first output terminal. When the transfer direction of the transfer packet, the broadcast packet, the all-gather packet, and the reduce packet received from the send buffer 541 is a second direction, the fourth packet transmission circuit 534 may transmit the transfer packet, the broadcast packet, the all-gather packet, and the reduce packet to the second sender buffer 522 of the sender 520 via the second output terminal. The fourth packet transmission circuit 534 may receive a broadcast pass packet and an all-gather pass packet transmitted from another network router via the send buffer 541 of the buffer circuit 540. When the transfer direction of the broadcast pass packet and the all-gather pass packet received from the send buffer 541 is the first direction, the fourth packet transmission circuit 534 may transmit the broadcast pass packet and the all-gather pass packet to the first sender buffer 521 of the sender 520 via the first output terminal. When the transfer direction of the broadcast pass packet and the all-gather pass packet received from the send buffer 541 is the second direction, the fourth packet transmission circuit 534 may transmit the broadcast pass packet and the all-gather pass packet to the second sender buffer 522 of the sender 520 via the second output terminal.

The send buffer 541 of the buffer circuit 540 may receive packets from a scratch-pad coupled to the network router 500, and from the first demultiplexer 561 and the third demultiplexer 563 of the selective output circuit 560. Specifically, the send buffer 541 may receive and store a transfer packet, a broadcast packet, an all-gather packet, and a reduce packet to be transmitted to another network router from the scratch-pad coupled to the network router 500. The send buffer 541 may transmit the stored transfer packet, broadcast packet, all-gather packet, and reduce packet to the input terminal of the fourth packet transmission circuit 534 of the network controller 530. The send buffer 541 may receive and store a partial sum pass packet, a reduce result pass packet, a reduce-scatter result pass packet, and an all-reduce result pass packet from the first demultiplexer 561 of the selective output circuit 560. The send buffer 541 may transmit the stored partial sum pass packet, reduce result pass packet, reduce-scatter result pass packet, and all-reduce result pass packet to the input terminal of the fourth packet transmission circuit 534 of the network controller 530. The send buffer 541 may receive and store a broadcast pass packet and an all-gather pass packet from the third demultiplexer 563 of the selective output circuit 560. The send buffer 541 may transmit the stored broadcast pass packet and all-gather pass packet to the input terminal of the fourth packet transmission circuit 534 of the network controller 530.

The receive buffer 542 of the buffer circuit 540 may receive packets from the second packet transmission circuit 532 and the third packet transmission circuit 533 of the network controller 530, and from the first demultiplexer 561 of the selective output circuit 560. Specifically, the receive buffer 542 may receive and store a broadcast packet and an all-gather packet input to the network router 500 from another network router and output through the second output terminal of the second packet transmission circuit 532. The receive buffer 542 may receive and store a transfer target packet input to the network router 500 from another network router and output through the second output terminal of the third packet transmission circuit 533. The receive buffer 542 may receive and store a partial sum target packet, a reduce result target packet, a reduce-scatter target packet, and an all-reduce result target packet output from the reduce operation circuit 550 and transmitted via the first demultiplexer 561 of the selective output circuit 560. The receive buffer 542 may output the stored packets to the second demultiplexer 562 of the selective output circuit 560. In one example, the packet output operation from the receive buffer 542 may be performed in response to a receive command transmitted from the network controller 530 to the receive buffer 542.

The input terminal of the second demultiplexer 562 of the selective output circuit 560 is coupled to the receive buffer 542 of the buffer circuit 540. A first output terminal of the second demultiplexer 562 is coupled to the input terminal of the third demultiplexer 563. A second output terminal of the second demultiplexer 562 is coupled to the scratch-pad. A first output terminal of the third demultiplexer 563 is commonly coupled to both the scratch-pad and the send buffer 541 of the buffer circuit 540. A second output terminal of the third demultiplexer 563 is coupled to the scratch-pad.

The second demultiplexer 562 receives, via its input terminal, a broadcast packet, an all-gather packet, a transmission target packet, a partial sum target packet, a reduce result target packet, a reduce-scatter result target packet, and an all-reduce result target packet output from the receive buffer 542 of the buffer circuit 540. When the broadcast packet and the all-gather packet are transmitted from the receive buffer 542, the second demultiplexer 562 transmits the broadcast packet and the all-gather packet to the input terminal of the third demultiplexer 563 via the first output terminal. When the transmission target packet, the partial sum target packet, the reduce result target packet, the reduce-scatter result target packet, and the all-reduce result target packet are transmitted from the receive buffer 542, the second demultiplexer 562 transmits the transmission target packet, the partial sum target packet, the reduce result target packet, the reduce-scatter result target packet, and the all-reduce result target packet to the scratch-pad via the second output terminal.

The third demultiplexer 563 receives, via its input terminal, a broadcast packet and an all-gather packet output from the first output terminal of the second demultiplexer 562. When a broadcast pass packet and an all-gather pass packet are input from the second demultiplexer 562, the third demultiplexer 563 transmits the broadcast pass packet and the all-gather pass packet to both the send buffer 541 and the scratch-pad via the first output terminal. When a broadcast target packet and an all-gather target packet are input from the second demultiplexer 562, the third demultiplexer 563 transmits the broadcast target packet and the all-gather target packet to the scratch-pad via the second output terminal.

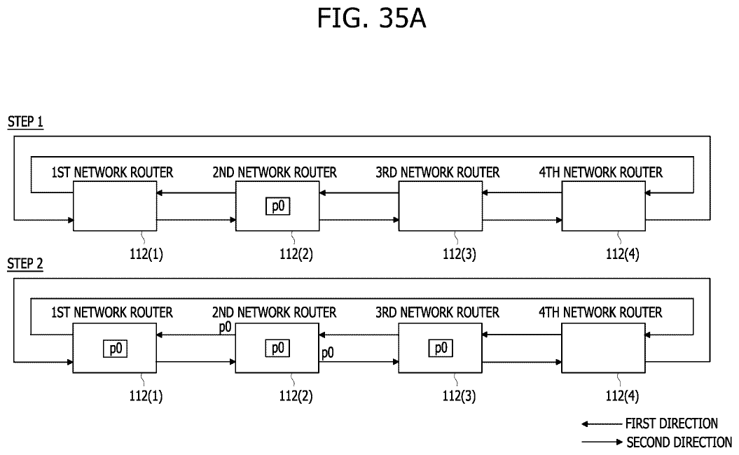

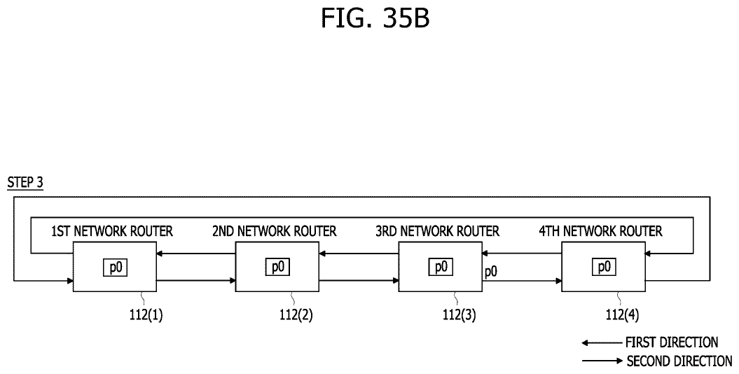

FIGS. 35A and 35B are diagrams illustrating a broadcast operation in the accelerator system of FIG. 1 including the network router of FIG. 34.

Referring to FIG. 35A, in a first step (STEP 1) of a broadcast operation, it is assumed that a first packet p0 is stored in a second scratch-pad coupled to a second network router 112(2), while a first scratch-pad coupled to a first network router 112(1), a third scratch-pad coupled to a third network router 112(3), and a fourth scratch-pad coupled to a fourth network router 112(4) do not store the first packet p0. The broadcast operation may be performed by transmitting the first packet p0, stored in the second network router 112(2), to the first network router 112(1), the third network router 112(3), and the fourth network router 112(4). Depending on the destination configuration of the broadcast packet transmitted among the network routers, the broadcast packet may be processed as cither a broadcast pass packet or a broadcast target packet.

In a second step (STEP 2) of the broadcast operation, the second network router 112(2) transmits the first packet p0, which is stored in the second scratch-pad, to a receiver of the first network router 112(1) in a first direction, and also transmits the first packet p0 to a receiver of the third network router 112(3) in a second direction. This process may be performed in the same manner as the operation of the second network router described with reference to FIG. 9. The destination of the first packet p0 transmitted from the second network router 112(2) to the first network router 112(1) is set to the first network router 112(1). The destination of the first packet p0 transmitted from the second network router 112(2) to the third network router 112(3) is set to the fourth network router 112(4). The first network router 112(1) processes the first packet p0, transmitted from the second network router 112(2), as a broadcast target packet and stores the first packet p0 in the first scratch-pad. The third network router 112(3) processes the first packet p0, transmitted from the second network router 112(2), as a broadcast pass packet and stores the first packet p0 in a sender and a third scratch-pad of the third network router 112(3).

Referring to FIG. 35B, in a third step (STEP 3) of the broadcast operation, the third network router 112(3) transmits the first packet p0, which is stored in a sender of the third network router 112(3), to a receiver of the fourth network router 112(4). Since the destination of the first packet p0 transmitted from the third network router 112(3) to the fourth network router 112(4) is set to the fourth network router 112(4), the fourth network router 112(4) processes the first packet p0 transmitted from the third network router 112(3) as a broadcast target packet. That is, the fourth network router 112(4) stores the first packet p0, which is transmitted from the third network router 112(3), in a fourth scratch-pad. As such, by performing the second step (STEP 2) and the third step (STEP 3) of the broadcast operation, the first packet p0 stored in the second scratch-pad of the second network router 112(2) is stored in the first scratch-pad coupled to the first network router 112(1), the second scratch-pad coupled to the second network router 112(2), and the fourth scratch-pad coupled to the fourth network router 112(4).

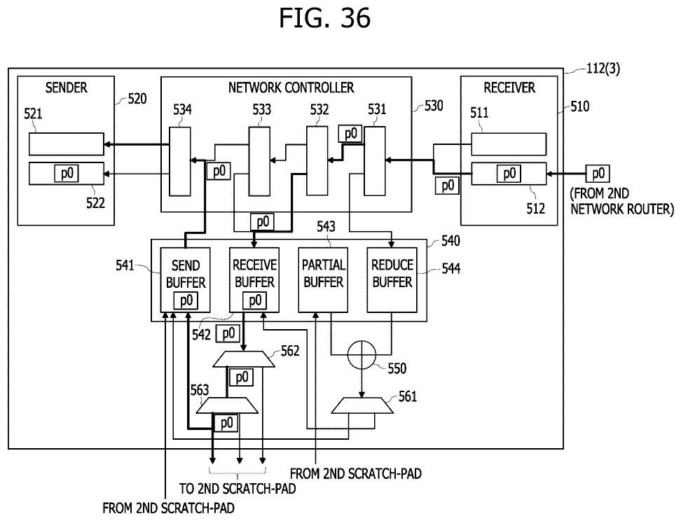

FIG. 36 is a diagram illustrating the operation of a third network router in a second step of the broadcast operation shown in FIG. 35A.

Referring to FIG. 36 in conjunction with FIG. 35A, in a second step (STEP 2) of the broadcast operation, the third network router 112(3) receives the first packet p0, which corresponds to a broadcast packet, from the second send buffer of the second network router 112(2) along a second direction. Since the transmission of the first packet p0 is performed along the second direction, the third network router 112(3) stores the first packet p0 in the second receiver buffer 512 of the receiver 510. The receiver 510 transmits the first packet p0 stored in the second receiver buffer 512 to an input terminal of the first packet transmission circuit 531 of the network controller 530. Since the first packet p0 is a broadcast packet, the first packet transmission circuit 531 transmits the first packet p0 to an input terminal of the second packet transmission circuit 532 via a first output terminal. The second packet transmission circuit 532 transmits the first packet p0 to the receive buffer 542 of the buffer circuit 540 via a second output terminal. The receive buffer 542 transmits the first packet p0 to an input terminal of the second demultiplexer 562. The second demultiplexer 562 transmits the first packet p0 to an input terminal of the third demultiplexer 563 via a first output terminal. Since the destination of the first packet p0 transmitted from the second network router 112(2) to the third network router 112(3) is set to the fourth network router 112(4), the third network router 112(3) processes the first packet p0 as a broadcast pass packet. That is, the third demultiplexer 563 transmits the first packet p0 to both the send buffer 541 and a third scratch-pad via a first output terminal. The send buffer 541 transmits the first packet p0 to an input terminal of the fourth packet transmission circuit 534. Since the output direction of the first packet p0 is the second direction, the fourth packet transmission circuit 534 transmits the first packet p0 to the second sender buffer 522 of the sender 520 via a second output terminal.

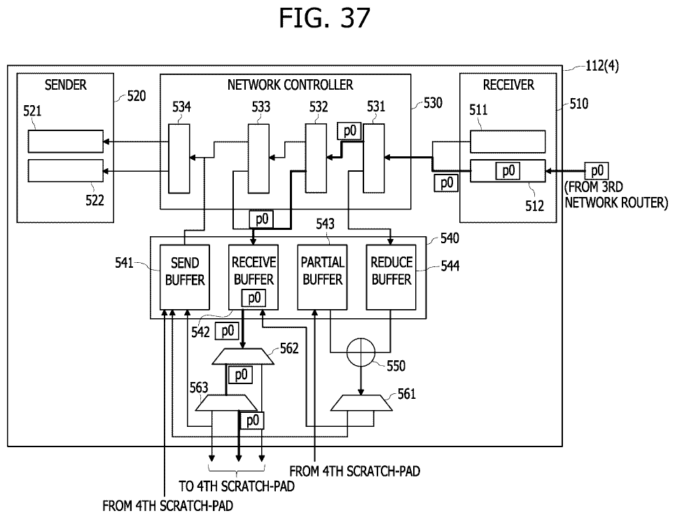

FIG. 37 is a diagram illustrating the operation of a fourth network router in a third step of the broadcast operation shown in FIG. 35B.

Referring to FIG. 37 in conjunction with FIG. 35B, in a third step (STEP 3) of the broadcast operation, the third network router 112(3) transmits the first packet p0, stored in the second send buffer, to the fourth network router 112(4) along a second direction. Since the destination of the first packet p0 transmitted from the third network router 112(3) to the fourth network router 112(4) is set to the fourth network router 112(4), the fourth network router 112(4) processes the first packet p0 received from the third network router 112(3) as a broadcast target packet. Specifically, the receiver 510 of the third network router 112(3) transmits the first packet p0 stored in the second receiver buffer 512 to an input terminal of the first packet transmission circuit 531 of the network controller 530. Since the first packet p0 is a broadcast packet, the first packet transmission circuit 531 transmits the first packet p0 to an input terminal of the second packet transmission circuit 532 via a first output terminal. The second packet transmission circuit 532 transmits the first packet p0 to the receive buffer 542 of the buffer circuit 540 via a second output terminal. The receive buffer 542 transmits the first packet p0 to an input terminal of the second demultiplexer 562. The second demultiplexer 562 transmits the first packet p0 to an input terminal of the third demultiplexer 563 via a first output terminal. Since the first packet p0 is a broadcast target packet, the third demultiplexer 563 transmits the first packet p0 to a fourth scratch-pad via a second output terminal.

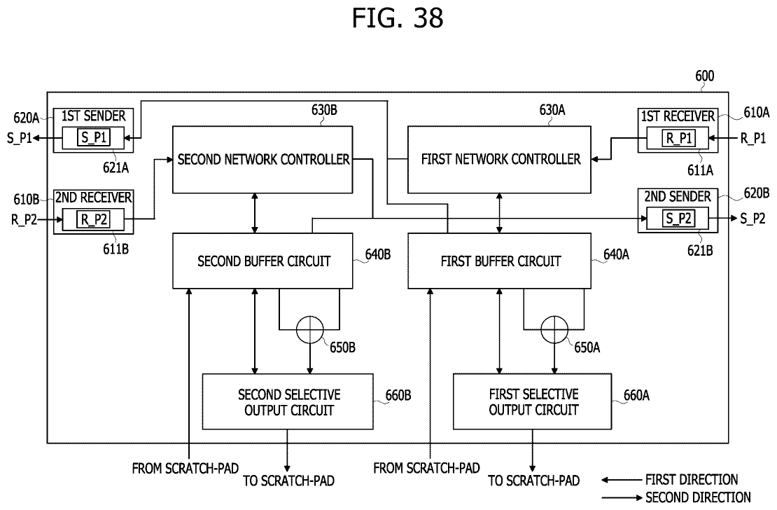

FIG. 38 is a block diagram illustrating another example of a network router according to the present disclosure. The description of the network router according to this embodiment may be equally applicable to the first through N-th network routers 112(1)-112(N) shown in FIG. 1 and the network router 220 shown in FIG. 2. In this embodiment, a transmission packet is defined as a term referring to any one of a send packet, a scatter packet, or a gather packet. Accordingly, a broadcast packet is not included in the transmission packet. The operations for performing collective operations, excluding the broadcast operation, in the network router according to this embodiment are the same as those for performing collective operations in the network router 400 described with reference to FIG. 30.

Referring to FIG. 38, a network router 600 includes Ia first router circuit that processes collective operation packets transmitted in a first direction, and a second router circuit that processes collective operation packets transmitted in a second direction. The first router circuit may receive collective operation packets in the first direction and output collective operation packets in the first direction. The second router circuit may receive collective operation packets in the second direction and output collective operation packets in the second direction. In one embodiment, the first router circuit may include a first receiver 610A, a first sender 620A, a first network controller 630A, a first buffer circuit 640A, a first reduce operation circuit 650A, and a first selective output circuit 660A. The second router circuit may include a second receiver 610B, a second sender 620B, a second network controller 630B, a second buffer circuit 640B, a second reduce operation circuit 650B, and a second selective output circuit 660B. The network router 600 may independently perform a data movement operation and a reduce operation on packets input in the first direction and a data movement operation and a reduce operation on packets input in the second direction.

The first receiver 610A of the first router circuit may receive a first receive packet R_P1 transmitted from another network router in a first direction. The first receiver 610A may include at least one first receiver buffer 611A in which the first receive packet R_P1, input from another network router, is stored. The first receiver 610A stores the first receive packet R_P1, input in the first direction from another network router, in the first receiver buffer 611A. The first receiver 610A may output the first receive packet R_P1, stored in the first receiver buffer 611A, to the first network controller 630A. In one embodiment, the first receiver 610A may receive, from another network router in the first direction, any one of a transmission packet, a broadcast packet, an all-gather packet, or a reduce packet.

The first sender 620A of the first router circuit may receive a packet output from the first network controller 630A or the first buffer circuit 640A. The first sender 620A may include at least one first sender buffer 621A in which a packet transmitted from the first network controller 630A or the first buffer circuit 640A is stored. The first sender 620A may output the first send packet S_P1 stored in the first sender buffer 621A in the first direction and transmit it to a first receiver of another network router. The first sender 620A may receive a transmission pass packet, which is input to the first receiver 610A of the network router 600 from another network router, via the first network controller 630A. The first sender 620A may receive a transmission packet, a broadcast packet, an all-gather packet, or a reduce packet, stored in a scratch-pad coupled to the network router 600, via the first buffer circuit 640A. The first sender 620A may receive a broadcast pass packet or an all-gather pass packet, which is input to the first receiver 610A of the network router 600 from another network router, from the first buffer circuit 640A. Additionally, the first sender 620A may receive a partial sum pass packet, a reduce result pass packet, a reduce-scatter result pass packet, or an all-reduce result pass packet output from the first reduce operation circuit 650A via the first buffer circuit 640A.

The first network controller 630A of the first router circuit receives a packet output from the first receiver buffer 611A of the first receiver 610A, and controls a transmission path of the packet within the network router 600 based on the type of the packet. The first network controller 630A may generate a first control signal for controlling operations within the network router 600 with respect to packets input in the first direction and packets output in the first direction. For example, the first network controller 630A may be configured to transmit a first command to the first buffer circuit 640A for controlling the operation of the first buffer circuit 640A. In one embodiment, when a transmission pass packet is input from the first receiver 610A, the first network controller 630A transmits the transmission pass packet to the first sender 620A. When a reduce packet, a broadcast packet, an all-gather packet, or a transmission target packet is input from the first receiver 610A, the first network controller 630A transmits the reduce packet, the broadcast packet, the all-gather packet, or the transmission target packet to the first buffer circuit 640A.

The first buffer circuit 640A of the first router circuit may transmit a reduce packet, which is transmitted from another network router and input via the first network controller 630A, to the first reduce operation circuit 650A. The first buffer circuit 640A may also transmit a broadcast packet, an all-gather packet, and a transmission target packet—each transmitted from another network router and input via the first network controller 630A—to the first selective output circuit 660A. When the broadcast packet and all-gather packet transmitted to the first selective output circuit 660A correspond to a broadcast pass packet and an all-gather pass packet, respectively, the first buffer circuit 640A may receive and store the broadcast pass packet and all-gather pass packet from the first selective output circuit 660A. The first buffer circuit 640A may then transmit the stored broadcast pass packet and all-gather pass packet to the first sender 620A.

The first buffer circuit 640A may receive and store a transmission packet, a broadcast packet, an all gather packet, and a reduce packet, each to be transmitted to another network router in the first direction, from a scratch-pad coupled to the network router 600. The first buffer circuit 640A may transmit the transmission packet and the all gather packet, which have been received from and stored from the scratch-pad, to the first sender 620A. Additionally, the first buffer circuit 640A may transmit the reduce packet, which has been received from and stored from the scratch-pad, cither to the first sender 620A or to the first reduce operation circuit 650A.

The first buffer circuit 640A may receive and store a partial sum packet, a reduce result packet, a reduce scatter result packet, and an all reduce result packet output from the first reduce operation circuit 650A via the first selective output circuit 660A. The first buffer circuit 640A may transmit the stored partial sum packet, reduce result packet, reduce scatter result packet, and all reduce result packet to the first sender 620A, or may alternatively retransmit them to the first selective output circuit 660A. Specifically, when the partial sum packet, reduce result packet, reduce scatter result packet, and all reduce result packet received from the first selective output circuit 660A and stored in the first buffer circuit 640A correspond to a partial sum pass packet, a reduce result pass packet, a reduce scatter result pass packet, and an all reduce result pass packet, respectively, the first buffer circuit 640A may transmit the partial sum pass packet, reduce result pass packet, reduce scatter result pass packet, and all reduce result pass packet to the first sender 620A. When the partial sum packet, reduce result packet, reduce scatter result packet, and all reduce result packet received from the first selective output circuit 660A and stored in the first buffer circuit 640A correspond to a partial sum target packet, a reduce result target packet, a reduce scatter result target packet, and an all reduce result target packet, respectively, the first buffer circuit 640A may retransmit the partial sum target packet, reduce result target packet, reduce scatter result target packet, and all reduce result target packet to the first selective output circuit 660A.

The first reduce operation circuit 650A of the first router circuit may receive a first operand packet and a second operand packet for a first reduce operation from the first buffer circuit 640A. In one embodiment, the first operand packet may be a reduce packet transmitted from a scratch pad coupled to the network router 600 to the first buffer circuit 640A, and the second operand packet may be a reduce packet transmitted from another network router to the first buffer circuit 640A via the first network controller 630A. The first reduce operation circuit 650A performs a first reduce operation on the first operand packet and the second operand packet, and generates a partial sum packet, a reduce result packet, a reduce scatter result packet, and an all reduce result packet. The partial sum packet may be generated by a reduce operation performed during a reduce operation, a reduce scatter operation, or an all reduce operation. The reduce result packet may be generated by a reduce operation performed during a reduce operation. The reduce scatter result packet may be generated by a reduce operation performed during a reduce scatter operation. The all reduce result packet may be generated by a reduce operation performed during an all reduce operation. The first reduce operation circuit 650A may transmit the partial sum packet, reduce result packet, reduce scatter result packet, and all reduce result packet to the first selective output circuit 660A.

The first selective output circuit 660A of the first router circuit may receive a partial sum packet, a reduce result packet, a reduce scatter result packet, and an all reduce result packet from the first reduce operation circuit 650A and may transmit them to the first buffer circuit 640A. When the partial sum packet, the reduce result packet, the reduce scatter result packet, and the all reduce result packet transmitted to the first buffer circuit 640A correspond to a partial sum target packet, a reduce result target packet, a reduce scatter result target packet, and an all reduce result target packet, respectively, the first selective output circuit 660A may receive the partial sum target packet, the reduce result target packet, the reduce scatter result target packet, and the all reduce result target packet again from the first buffer circuit 640A. The first selective output circuit 660A may transmit the partial sum target packet, the reduce result target packet, the reduce scatter result target packet, and the all reduce result target packet received again from the first buffer circuit 640A to a scratch pad.

The first selective output circuit 660A may receive a transfer target packet from the first buffer circuit 640A and may transmit the transfer target packet to a scratch pad. The first selective output circuit 660A may receive a broadcast packet and an all-gather packet from the first buffer circuit 640A and may transmit the broadcast packet and the all-gather packet only to the scratch pad or to both the first buffer circuit 640A and the scratch pad. Specifically, when the broadcast packet and the all-gather packet transmitted from the first buffer circuit 640A correspond to target packets, the first selective output circuit 660A may transmit the broadcast target packet and the all-gather target packet to the scratch pad. When the broadcast packet and the all-gather packet transmitted from the first buffer circuit 640A correspond to pass packets, the first selective output circuit 660A may transmit the broadcast pass packet and the all-gather pass packet to both the first buffer circuit 640A and the scratch pad.

The second receiver 610B of the second router circuit may receive a second received packet R_P2 transmitted from another network router in a second direction. The second receiver 610B may include at least one second receiver buffer 611B in which the second received packet R_P2 transmitted from another network router is stored. The second receiver 610B stores the second received packet R_P2, which is received in the second direction from another network router, in the second receiver buffer 611B. The second receiver 610B may output the second received packet R_P2 stored in the second receiver buffer 611B to the second network controller 630B. In one embodiment, the second receiver 610B may receive, from another network router in the second direction, one of a transfer packet, a broadcast packet, an all-gather packet, or a reduce packet.

The second sender 620B of the second router circuit may receive a packet output from the second network controller 630B or the second buffer circuit 640B. The second sender 620B may include at least one second sender buffer 621B in which a packet transmitted from the second network controller 630B or the second buffer circuit 640B is stored. The second sender 620B may output the second transmission packet S_P2 stored in the second sender buffer 621B in the second direction and transmit the packet to a second receiver of another network router. The second sender 620B may receive a transfer pass packet input to the second receiver 610B of the network router 600 from another network router via the second network controller 630B. The second sender 620B may also receive, via the second buffer circuit 640B, a transfer packet, broadcast packet, all gather packet, or reduce packet stored in a scratch pad coupled to the network router 600. The second sender 620B may further receive a broadcast pass packet and an all gather pass packet, each transmitted to the second receiver 610B of the network router 600 from another network router, via the second buffer circuit 640B. In addition, the second sender 620B may receive, from the second buffer circuit 640B, a partial sum pass packet, a reduce result pass packet, a reduce scatter result pass packet, and an all reduce result pass packet output from the second reduce operation circuit 650B.

The second network controller 630B of the second router circuit may receive a packet output from the second receiver buffer 611B of the second receiver 610B and may control the packet transmission path within the network router 600 based on the type of the packet. The second network controller 630B may generate a second control signal for controlling operations within the network router 600 with respect to packets input in the second direction and packets output in the second direction. For example, the second network controller 630B may be configured to transmit a second command for controlling the operation of the second buffer circuit 640B to the second buffer circuit 640B. In one embodiment, when a transfer pass packet is input from the second receiver 610B, the second network controller 630B may transmit the transfer pass packet to the second sender 620B. When a reduce packet, a broadcast packet, an all gather packet, or a transfer target packet is transmitted from the second receiver 610B, the second network controller 630B may transmit the reduce packet, the broadcast packet, the all gather packet, or the transfer target packet to the second buffer circuit 640B.

The second buffer circuit 640B of the second router circuit may transmit a reduce packet, which is transferred from another network router and input via the second network controller 630B, to the second reduce operation circuit 650B. The second buffer circuit 640B may transmit a broadcast packet, an all gather packet, and a transfer target packet, which are transferred from another network router and input via the second network controller 630B, to the second selective output circuit 660B. When the broadcast packet and the all gather packet transmitted to the second selective output circuit 660B are respectively a broadcast pass packet and an all gather pass packet, the second buffer circuit 640B may receive the broadcast pass packet and the all gather pass packet again from the second selective output circuit 660B and store them. The second buffer circuit 640B may then transmit the stored broadcast pass packet and all gather pass packet to the second sender 620B.

The second buffer circuit 640B may receive and store a transfer packet, a broadcast packet, an all gather packet, and a reduce packet to be transmitted in the second direction to another network router, from a scratch-pad coupled to the network router 600. The second buffer circuit 640B may transmit the stored transfer packet and all gather packet, which are received from the scratch-pad, to the second sender 620B. The second buffer circuit 640B may transmit the stored reduce packet, which is received from the scratch-pad, to the second sender 620B or to the second reduce operation circuit 650B.

The second buffer circuit 640B of the second router circuit may receive and store a partial sum packet, a reduce result packet, a reduce scatter result packet, and an all reduce result packet output from the second reduce operation circuit 650B via the second selective output circuit 660B. The second buffer circuit 640B may transmit the stored partial sum packet, reduce result packet, reduce scatter result packet, and all reduce result packet to the second sender 620B, or may retransmit them to the second selective output circuit 660B. Specifically, if the partial sum packet, reduce result packet, reduce scatter result packet, and all reduce packet received from the second selective output circuit 660B and stored in the second buffer circuit 640B are each a partial sum pass packet, a reduce result pass packet, a reduce scatter result pass packet, and an all reduce result pass packet, then the second buffer circuit 640B may transmit the partial sum pass packet, reduce result pass packet, reduce scatter result pass packet, and all reduce result pass packet to the second sender 620B. When the partial sum packet, reduce result packet, reduce scatter result packet, and all reduce packet received from the second selective output circuit 660B and stored in the second buffer circuit 640B are each a partial sum target packet, a reduce result target packet, a reduce scatter target pass packet, and an all reduce result target packet, then the second buffer circuit 640B may retransmit the partial sum target packet, reduce result target packet, reduce scatter target pass packet, and all reduce result target packet to the second selective output circuit 660B.

The second reduce operation circuit 650B of the second router circuit may receive a second operand packet and a second operand packet for a second reduce operation from the second buffer circuit 640B. In one embodiment, the first operand packet may be a reduce packet transferred from a scratch-pad coupled to the network router 600 to the second buffer circuit 640B, and the second operand packet may be a reduce packet transferred from another network router to the second buffer circuit 640B via the second network controller 630B. The second reduce operation circuit 650B may perform the second reduce operation on the first operand packet and the second operand packet to generate a partial sum packet, a reduce result packet, a reduce scatter result packet, or an all reduce result packet. The partial sum packet may be generated by the reduce operation in a reduce operation, a reduce scatter operation, or an all reduce operation. The reduce result packet may be generated by the reduce operation in a reduce operation. The reduce scatter result packet may be generated by the reduce operation in a reduce scatter operation. The all reduce result packet may be generated by the reduce operation in an all reduce operation. The second reduce operation circuit 650B may transmit the partial sum packet, the reduce result packet, the reduce scatter result packet, and the all reduce result packet to the second selective output circuit 660B.

The second selective output circuit 660B of the second router circuit may receive a partial sum packet, a reduce result packet, a reduce scatter result packet, and an all reduce result packet from the second reduce operation circuit 650B, and may transfer those packets to the second buffer circuit 640B. When the partial sum packet, reduce result packet, reduce scatter result packet, and all reduce result packet transferred to the second buffer circuit 640B are identified respectively as a partial sum target packet, a reduce result target packet, a reduce scatter result target packet, and an all reduce result target packet, the second selective output circuit 660B may receive the partial sum target packet, reduce result target packet, reduce scatter result target packet, and all reduce result target packet back from the second buffer circuit 640B. The second selective output circuit 660B may transmit the partial sum target packet, reduce result target packet, reduce scatter result target packet, and all reduce result target packet, which are received again from the second buffer circuit 640B, to the scratch-pad.

The second selective output circuit 660B of the second router circuit may receive a transfer target packet from the second buffer circuit 640B and may transmit the packet to the scratch-pad. The second selective output circuit 660B may receive a broadcast packet and an all gather packet from the second buffer circuit 640B, and may transmit the packet cither solely to the scratch-pad or simultaneously to both the second buffer circuit 640B and the scratch-pad. Specifically, when the broadcast packet and the all gather packet transferred from the second buffer circuit 640B correspond to target packets, the second selective output circuit 660B may transmit a broadcast target packet and an all gather target packet to the scratch-pad. When the broadcast packet and the all gather packet transferred from the second buffer circuit 640B correspond to pass packets, the second selective output circuit 660B may transmit the broadcast pass packet and the all gather pass packet to both the second buffer circuit 640B and the scratch-pad.

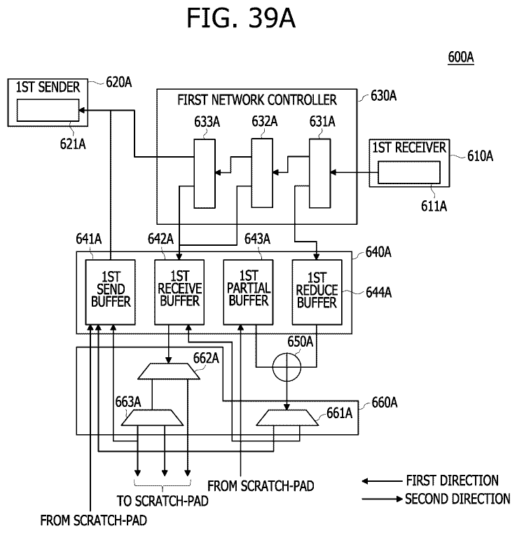

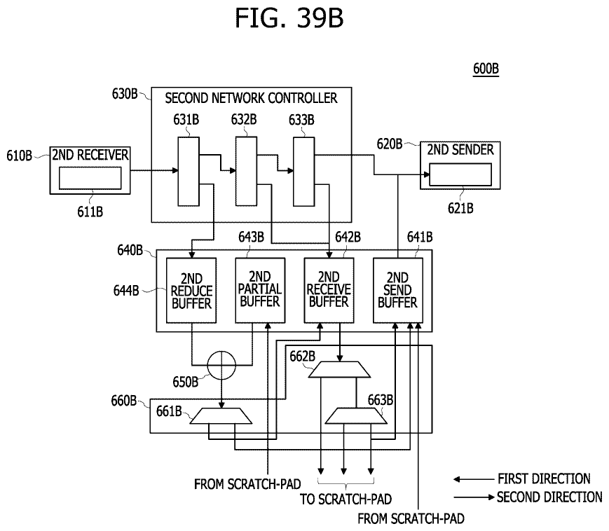

FIG. 39A is a diagram illustrating an example of a first router circuit included in the network router of FIG. 38.

Referring to FIG. 39A, the first router circuit 600A includes a first receiver 610A, a first sender 620A, a first network controller 630A, a first buffer circuit 640A, a first reduce operation circuit 650A, and a first selective output circuit 660A. The first network controller 630A may include a first packet transmission circuit 631A, a second packet transmission circuit 632A, and a third packet transmission circuit 633A. The first buffer circuit 640A may include a plurality of buffers, for example, a first send buffer 641A, a first receive buffer 642A, a first partial buffer 643A, and a first reduce buffer 644A. The first selective output circuit 660A may include a plurality of demultiplexers, for example, a first demultiplexer 661A, a second demultiplexer 662A, and a third demultiplexer 663A. The first receiver 610A and the first sender 620A of the first router circuit, the first partial buffer 643A and the first reduce buffer 644A of the first buffer circuit 640A, the first reduce operation circuit 650A, and the first demultiplexer 661A of the first selective output circuit 660A may be configured identically to the first receiver 410A, the first sender 420A, the first partial buffer 443A and the first reduce buffer 444A of the first buffer circuit 440A, the first reduce operation circuit 450A, and the first demultiplexer 461A of the first selective output circuit 460A included in the first router circuit of the network router 400A described with reference to FIG. 31A.

The first packet transmission circuit 631A, the second packet transmission circuit 632A, and the third packet transmission circuit 633A of the first network controller 630A may each have one input terminal, a first output terminal, and a second output terminal. The input terminal of the first packet transmission circuit 631A is connected to the output terminal of the first receiver buffer 611A of the first receiver 610A. The first output terminal and the second output terminal of the first packet transmission circuit 631A are connected to the input terminal of the second packet transmission circuit 632A and to the first buffer circuit 640A, respectively. The first output terminal and the second output terminal of the second packet transmission circuit 632A are connected to the input terminal of the third packet transmission circuit 633A and to the first buffer circuit 640A, respectively. The first output terminal and the second output terminal of the third packet transmission circuit 633A are connected to the first sender buffer 621A of the first sender 620A and to the first buffer circuit 640A, respectively.

When the input terminal of the first packet transmission circuit 631A receives a transmission packet, a broadcast packet, or an all-gather packet, the first output terminal of the first packet transmission circuit 631A transfers the received transmission packet, broadcast packet, or all-gather packet to the input terminal of the second packet transmission circuit 632A. When the input terminal of the first packet transmission circuit 631A receives a reduce packet, the second output terminal of the first packet transmission circuit 631A transfers the received reduce packet to the first buffer circuit 640A. When the input terminal of the second packet transmission circuit 632A receives a transmission packet, the first output terminal of the second packet transmission circuit 632A transfers the received transmission packet to the input terminal of the third packet transmission circuit 633A. When the input terminal of the second packet transmission circuit 632A receives a broadcast packet or an all-gather packet, the second output terminal of the second packet transmission circuit 632A transfers the received broadcast packet or all-gather packet to the first buffer circuit 640A. When the input terminal of the third packet transmission circuit 633A receives a transmission path packet, the first output terminal of the third packet transmission circuit 633A transfers the received transmission path packet to the first sender buffer 621A included in the first sender 620A. When the input terminal of the third packet transmission circuit 633A receives a transmission target packet, the second output terminal of the third packet transmission circuit 633A transfers the received transmission target packet to the first buffer circuit 640A.

The first send buffer 641A of the first buffer circuit 640A may receive packets from a scratch-pad and from the first selective output circuit 660A. Specifically, the first send buffer 641A may receive and store transmission packets, broadcast packets, all-gather packets, and reduce packets to be transmitted from the network router 600 to another network router in the first direction, by receiving those packets from a scratch-pad coupled to the network router 600. The first send buffer 641A may transfer the stored transmission packets, broadcast packets, all-gather packets, and reduce packets to the first sender buffer 621A of the first sender 620A. The first send buffer 641A may receive and store partial sum pass packets, reduce result pass packets, reduce-scatter result pass packets, and all-reduce result pass packets output from the first reduce operation circuit 650A via the first demultiplexer 661A of the first selective output circuit 660A. The first send buffer 641A may transfer the stored partial sum pass packets, reduce result pass packets, reduce-scatter result pass packets, and all-reduce result pass packets to the first sender buffer 621A of the first sender 620A. The first send buffer 641A may receive and store broadcast pass packets and all-gather pass packets having a transmission direction corresponding to the first direction, through the second demultiplexer 662A and the third demultiplexer 663A of the first selective output circuit 660A. The first send buffer 641A may transfer the broadcast pass packets and the all-gather pass packets received via the second demultiplexer 662A and the third demultiplexer 663A of the first selective output circuit 660A to the first sender buffer 621A of the first sender 620A.

The first receive buffer 642A of the first buffer circuit 640A may receive broadcast packets and all-gather packets provided from another network router in the first direction, the broadcast packets and all-gather packets being output from a second output terminal of the second packet transmission circuit 632A. The first receive buffer 642A may receive and store transmission target packets provided from another network router in the first direction, the transmission target packets being output from a second output terminal of the third packet transmission circuit 633A. The first receive buffer 642A may receive and store partial sum target packets, reduce result target packets, reduce-scatter result target packets, and all-reduce result target packets output from the first reduce operation circuit 650A via the first demultiplexer 661A of the first selective output circuit 660A. In response to a first receive command transmitted from the first network controller 630A to the first receive buffer 642A, the first receive buffer 642A may transmit the stored broadcast packets, all-gather packets, transmission target packets, partial sum target packets, reduce result target packets, reduce-scatter result target packets, and all-reduce result target packets to the second demultiplexer 662A of the first selective output circuit 660A.

The first demultiplexer 661A, the second demultiplexer 662A, and the third demultiplexer 663A, which are included in the first selective output circuit 660A, may each be configured as a one-to-two demultiplexer including one input terminal and two output terminals. The input terminal of the first demultiplexer 661A may be coupled to the output terminal of the first reduce operation circuit 650A. The first output terminal of the first demultiplexer 661A may be coupled to the first send buffer 641A of the first buffer circuit 640A. The second output terminal of the first demultiplexer 661A may be coupled to the first receive buffer 642A of the first buffer circuit 640A. The input terminal of the second demultiplexer 662A may be coupled to the first receive buffer 642A of the first buffer circuit 640A. The first output terminal of the second demultiplexer 662A may be coupled to the input terminal of the third demultiplexer 663A. The second output terminal of the second demultiplexer 662A may be coupled to a scratch-pad memory such as the scratch-pad 213 shown in FIG. 2. The first output terminal of the third demultiplexer 663A may be commonly coupled to the scratch-pad and to the first send buffer 641A of the first buffer circuit 640A. The second output terminal of the third demultiplexer 663A may be coupled to the scratch-pad.

The second demultiplexer 662A receives, through an input terminal, broadcast packets, all-gather packets, transmission target packets, partial sum target packets, reduce result target packets, reduce-scatter result target packets, and all-reduce result target packets output from the first receive buffer 642A of the first buffer circuit 640A. When the broadcast packets and the all-gather packets are received from the first receive buffer 642A, the second demultiplexer 662A transfers the broadcast packets and the all-gather packets to the input terminal of the third demultiplexer 663A through the first output terminal. When the transmission target packets, the partial sum target packets, the reduce result target packets, the reduce-scatter result target packets, and the all-reduce result target packets are received from the first receive buffer 642A, the second demultiplexer 662A transfers the transmission target packets, the partial sum target packets, the reduce result target packets, the reduce-scatter result target packets, and the all-reduce result target packets to the scratch-pad through the second output terminal.

The third demultiplexer 663A receives, through an input terminal, the broadcast packets and the all-gather packets output from the first output terminal of the second demultiplexer 662A. When the broadcast packets and the all-gather packets input from the second demultiplexer 662A correspond to a broadcast pass packet and an all-gather pass packet, respectively, the third demultiplexer 663A transfers the broadcast pass packet and the all-gather pass packet through the first output terminal to both the first send buffer 641A of the first buffer circuit 640A and the scratch-pad. In contrast, when the broadcast packets and the all-gather packets input from the second demultiplexer 662A correspond to a broadcast target packet and an all-gather target packet, respectively, the third demultiplexer 663A transfers the broadcast target packet and the all-gather target packet through the second output terminal to the scratch-pad.

FIG. 39B is a diagram illustrating an example of a second router circuit included in the network router of FIG. 38.

Referring to FIG. 39B, the second router circuit 600B includes a second receiver 610B, a second sender 620B, a second network controller 630B, a second buffer circuit 640B, a second reduce operation circuit 650B, and a second selective output circuit 660B. The second network controller 630B may include a fourth packet transmission circuit 631B, a fifth packet transmission circuit 632B, and a sixth packet transmission circuit 633B. The second buffer circuit 640B may include a plurality of buffers, for example, a second send buffer 641B, a second receive buffer 642B, a second partial buffer 643B, and a second reduce buffer 644B. The second selective output circuit 660B may include a plurality of demultiplexers, for example, a fourth demultiplexer 661B, a fifth demultiplexer 662B, and a sixth demultiplexer 663B. The second receiver 610B of the second router circuit, the second sender 620B, the second partial buffer 643B and the second reduce buffer 644B of the second buffer circuit 640B, the second reduce operation circuit 650B, and the fourth demultiplexer 661B of the second selective output circuit 660B may be configured in the same manner as the second receiver 410B, the second sender 420B, the second partial buffer 443B and the second reduce buffer 444B of the second buffer circuit 440B, the second reduce operation circuit 450B, and the fourth demultiplexer 461B of the second selective output circuit 460B included in the second router circuit of the network router 400B described with reference to FIG. 31B.

Each of the fourth packet transmission circuit of the second network controller, the fifth packet transmission circuit of the second network controller, and the sixth packet transmission circuit of the second network controller may include one input terminal, a first output terminal, and a second output terminal. The input terminal of the fourth packet transmission circuit is coupled to the output terminal of the second receive buffer of the second receiver. The first output terminal and the second output terminal of the fourth packet transmission circuit are coupled to the input terminal of the fifth packet transmission circuit and to the second buffer circuit, respectively. The first output terminal and the second output terminal of the fifth packet transmission circuit are coupled to the input terminal of the sixth packet transmission circuit and to the second buffer circuit, respectively. The first output terminal and the second output terminal of the sixth packet transmission circuit are coupled to the second send buffer of the second sender and to the second buffer circuit, respectively.

When a transmission packet, a broadcast packet, or an all-gather packet is input to the input terminal of the fourth packet transmission circuit 631B, the fourth packet transmission circuit 631B transmits the transmission packet, the broadcast packet, and the all-gather packet to the input terminal of the fifth packet transmission circuit 632B through the first output terminal. When a reduce packet is input to the input terminal of the fourth packet transmission circuit 631B, the fourth packet transmission circuit 631B transmits the reduce packet to the second buffer circuit 640B through the second output terminal. When a transmission packet is input to the input terminal of the fifth packet transmission circuit 632B, the fifth packet transmission circuit 632B transmits the transmission packet to the input terminal of the sixth packet transmission circuit 633B through the first output terminal. When a broadcast packet or an all-gather packet is input to the input terminal of the fifth packet transmission circuit 632B, the fifth packet transmission circuit 632B transmits the broadcast packet and the all-gather packet to the second buffer circuit 640B through the second output terminal. When a transmission pass packet is input to the input terminal of the sixth packet transmission circuit 633B, the sixth packet transmission circuit 633B transmits the transmission pass packet to the second sender buffer 621B of the second sender 620B through the first output terminal. When a transmission target packet is input to the input terminal of the sixth packet transmission circuit 633B, the sixth packet transmission circuit 633B transmits the transmission target packet to the second buffer circuit 640B through the second output terminal.

The second send buffer 641B of the second buffer circuit 640B may receive packets from a scratch-pad and the second selective output circuit 660B. Specifically, the second send buffer 641B may receive and store transmission packets, broadcast packets, all-gather packets, and reduce packets, which are to be transmitted from the network router 600 to another network router along a second direction, from the scratch-pad coupled to the network router 600. The second send buffer 641B may transmit the stored transmission packets, broadcast packets, all-gather packets, and reduce packets to the second sender buffer 621B of the second sender 620B. The second send buffer 641B may receive and store partial sum pass packets, reduce result pass packets, reduce-scatter result pass packets, and all-reduce result pass packets, which are output from the second reduce operation circuit 650B, via the fourth demultiplexer 661B of the second selective output circuit 660B. The second send buffer 641B may transmit the stored partial sum pass packets, reduce result pass packets, reduce-scatter result pass packets, and all-reduce result pass packets to the second sender buffer 621B of the second sender 620B. The second send buffer 641B may receive and store broadcast pass packets and all-gather pass packets, which have a transmission direction corresponding to the second direction, via the fifth demultiplexer 662B and the sixth demultiplexer 663B of the second selective output circuit 660B. The second send buffer 641B may transmit the broadcast pass packets and the all-gather pass packets, received via the fifth demultiplexer 662B and the sixth demultiplexer 663B of the second selective output circuit 660B, to the second sender buffer 621B of the second sender 620B.

The second receive buffer 642B of the second buffer circuit 640B may receive broadcast packets and all-gather packets provided from another network router along a second direction, output through the second output terminal of the fifth packet transmission circuit 632B. The second receive buffer 642B may receive and store transmission target packets provided from another network router along the second direction, output through the second output terminal of the sixth packet transmission circuit 633B. The second receive buffer 642B may receive and store partial sum target packets, reduce result target packets, reduce-scatter result target packets, and all-reduce result target packets, output from the second reduce operation circuit 650B via the fourth demultiplexer 661B of the second selective output circuit 660B. In response to a second receive command transmitted from the second network controller 630B to the second receive buffer 642B, the second receive buffer 642B may transmit the stored broadcast packets, all-gather packets, transmission target packets, partial sum target packets, reduce result target packets, reduce-scatter result target packets, and all-reduce result target packets to the fifth demultiplexer 662B of the second selective output circuit 660B.

Each of the fourth demultiplexer 661B, the fifth demultiplexer 662B, and the sixth demultiplexer 663B included in the second selective output circuit 660B may be a 1-to-2 demultiplexer comprising one input terminal and two output terminals. The input terminal of the fourth demultiplexer 661B may be coupled to the output terminal of the second reduce operation circuit 650B. The first output terminal of the fourth demultiplexer 661B may be coupled to the second send buffer 641B of the second buffer circuit 640B. The second output terminal of the fourth demultiplexer 661B may be coupled to the second receive buffer 642B of the second buffer circuit 640B. The input terminal of the fifth demultiplexer 662B may be coupled to the second receive buffer 642B of the second buffer circuit 640B. The first output terminal of the fifth demultiplexer 662B may be coupled to the input terminal of the sixth demultiplexer 663B. The second output terminal of the fifth demultiplexer 662B may be coupled to the scratch-pad memory (213 in FIG. 2). The first output terminal of the sixth demultiplexer 663B may be commonly coupled to both the scratch-pad memory and the second send buffer 641B of the second buffer circuit 640B. The second output terminal of the sixth demultiplexer 663B may be coupled to the scratch-pad.

The fifth demultiplexer 662B may receive, through the input terminal, a broadcast packet, an all-gather packet, a transfer target packet, a partial sum target packet, a reduce result target packet, a reduce-scatter result target packet, and an all-reduce result target packet output from the second receive buffer 642B of the second buffer circuit 640B. When the broadcast packet and the all-gather packet are input from the second receive buffer 642B, the fifth demultiplexer 662B may transmit the broadcast packet and the all-gather packet to the input terminal of the sixth demultiplexer 663B through the first output terminal. When the transfer target packet, the partial sum target packet, the reduce result target packet, the reduce-scatter result target packet, and the all-reduce result target packet are output from the second receive buffer 642B, the fifth demultiplexer 662B may transmit the transfer target packet, the partial sum target packet, the reduce result target packet, the reduce-scatter result target packet, and the all-reduce result target packet to the scratch-pad memory through the second output terminal.

The sixth demultiplexer 663B receives, through the input terminal, a broadcast packet and an all-gather packet output from the first output terminal of the fifth demultiplexer 662B. When the broadcast packet and the all-gather packet input from the fifth demultiplexer 662B correspond to a broadcast pass packet and an all-gather pass packet, respectively, the sixth demultiplexer 663B transmits the broadcast pass packet and the all-gather pass packet, through the first output terminal, to both the second send buffer 641B of the second buffer circuit 640B and the scratch-pad memory. On the other hand, when the broadcast packet and the all-gather packet input from the fifth demultiplexer 662B correspond to a broadcast target packet and an all-gather target packet, respectively, the sixth demultiplexer 663B transmits the broadcast target packet and the all-gather target packet to the scratch-pad memory through the second output terminal.

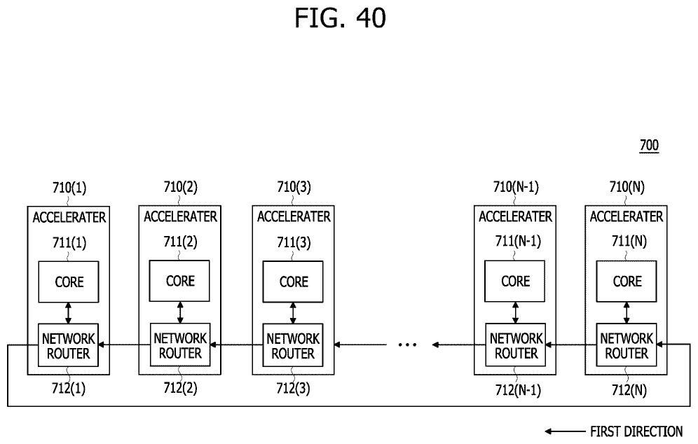

FIG. 40 is a block diagram illustrating another example of an accelerator system according to the present disclosure.

Referring to FIG. 40, the accelerator system 700 includes a plurality of accelerators, for example, first through N-th accelerators 710(1) to 710(N). In this example, the accelerator system 700 includes N accelerators 710(1) to 710(N), where N is a natural number equal to or greater than 2. However, this is merely one example, and the accelerator system 700 may include more than N accelerators. The first through N-th accelerators 710(1) to 710(N) respectively include first through N-th cores 711(1) to 711(N) and first through N-th network routers 712(1) to 712(N). For example, the first accelerator 710(1) includes the first core 711(1) and the first network router 712(1). The second accelerator 710(2) includes the second core 711(2) and the second network router 712(2). Similarly, the N-th accelerator 710(N) includes the N-th core 711(N) and the N-th network router 712(N). The first through N-th accelerators 710(1) to 710(N) respectively have unique identifiers. That is, each of the first through N-th accelerators 710(1) to 710(N) can be distinguished by the respective identifier. In this example as well, each of the first through N-th network routers 712(1) to 712(N) is assumed to have the same identifier as the corresponding one of the first through N-th accelerators 710(1) to 710(N).

The first through N-th cores 711(1) to 711(N) may be configured to perform artificial intelligence operations. That is, the first through N-th cores 711(1) to 711(N) may include hardware specialized for artificial intelligence tasks involving large-scale data processing and computation. In one example, the first through N-th cores 711(1) to 711(N) may perform operations such as convolutional neural network (CNN) operations, fully connected layer (FCL) operations, and transformer operations. In one embodiment, each of the first through N-th cores 711(1) to 711(N) may include at least one processing-in-memory (PIM) device and a control device for controlling the PIM device. The first through N-th cores 711(1) to 711(N) may respectively transmit data to the corresponding first through N-th network routers 712(1) to 712(N). Additionally, the first through N-th cores 711(1) to 711(N) may respectively receive data from the corresponding first through N-th network routers 712(1) to 712(N).

Similar to the accelerator system 100 described with reference to FIG. 1, the first through N-th network routers 712(1) to 712(N) included in the accelerator system 700 may perform collective operations, such as data movement operations and collective computation operations. In one embodiment, the first through N-th network routers 712(1) to 712(N) may be connected in a one-dimensional torus topology. In this case, the first through N-th network routers 712(1) to 712(N) constitute nodes of the one-dimensional torus topology. Accordingly, each of the first through N-th network routers 712(1) to 712(N) is coupled to two neighboring network routers. That is, the connection structure of the first through N-th network routers 712(1) to 712(N) forms a loop. Communication between the first through N-th network routers 712(1) to 712(N) is unidirectional, namely performed in only one of a first direction or a second direction. In the following description, an example is provided in which the first through N-th network routers 712(1) to 712(N) transmit data or packets only in the first direction and receive data or packets only in the first direction (i.e., the direction indicated by the arrow in the drawing).

As illustrated in FIG. 40, the first network router 712(1) of the first accelerator 710(1) receives data or a packet from the second network router 712(2) of the second accelerator 710(2) in the first direction and transmits data or a packet to the N-th network router 712(N) of the N-th accelerator 710(N) in the first direction. The second network router 712(2) of the second accelerator 710(2) receives data or a packet from the third network router 712(3) of the third accelerator 710(3) in the first direction and transmits data or a packet to the first network router 712(1) of the first accelerator 710(1) in the first direction. The third network router 712(3) of the third accelerator 710(3) receives data or a packet from the fourth network router (not illustrated) of the fourth accelerator (not illustrated) in the first direction and transmits data or a packet to the second network router 712(2) of the second accelerator 710(2) in the first direction. The (N−1)-th network router 712(N−1) of the (N−1)-th accelerator 710(N−1) receives data or a packet from the N-th network router 712(N) of the N-th accelerator 710(N) in the first direction and transmits data or a packet to the (N−2)-th network router (not illustrated) of the (N−2)-th accelerator (not illustrated) in the first direction. The N-th network router 712(N) of the N-th accelerator 710(N) receives data or a packet from the first network router 712(1) of the first accelerator 710(1) in the first direction and transmits data or a packet to the (N−1)-th network router 712(N−1) of the (N−1)-th accelerator 710(N−1) in the first direction.

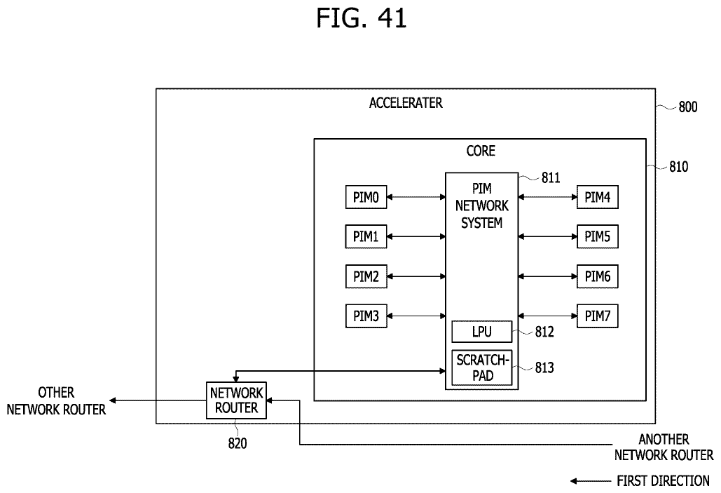

FIG. 41 is a block diagram illustrating an accelerator included in the accelerator system of FIG. 40. The description of the accelerator according to the present example is equally applicable to the first through N-th accelerators 710(1) through 710(N) illustrated in FIG. 40.

Referring to FIG. 41, an accelerator 800 may include a core 810 and a network router 820. The core 810 may be configured in the same manner as the core 210 described with reference to FIG. 2. Accordingly, the core 810 may include first through eighth PIM devices PIM0 through PIM7 and a PIM network system 811. The PIM network system 811 may include a local processing unit (LPU) 812. The PIM network system 811 may include a local memory, such as a scratch-pad 813. The network router 820 may be coupled to the PIM network system 811 of the core 810. The network router 820 may be coupled, along a first direction and a second direction, to another network router and to yet another network router of other accelerators, as indicated in FIG. 41. The network router 820 may transmit a packet received from the scratch-pad 813 included in the core 810 to another network router in the first direction, or may utilize the packet in a reduce operation performed within the network router 820. The network router 820 may transmit a packet received from the other network router in the first direction to the scratch-pad 813, or may forward the packet to another network router in the first direction. The network router 820 may transmit, simultaneously, a packet received from the other network router in the first direction to the scratch-pad 813 and to another network router in the first direction. The network router 820 may perform a reduce operation on a packet stored in the scratch-pad 813 and a packet received from the other network router in the first direction, and may either store the resulting packet in the scratch-pad 813 or transmit the resulting packet to another network router in the first direction.

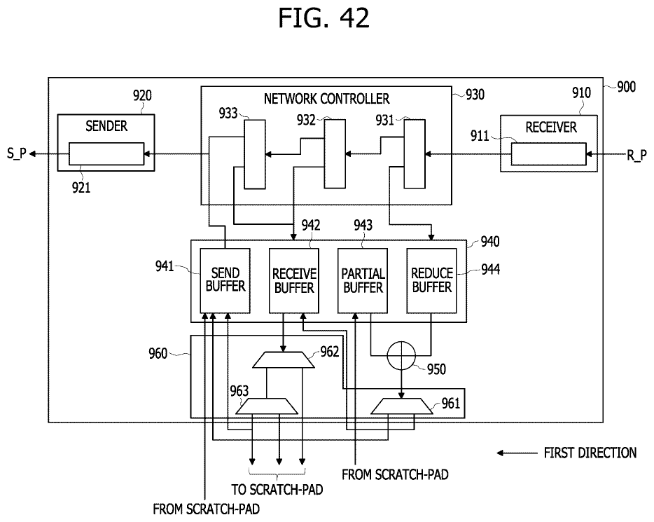

FIG. 42 is a block diagram illustrating another example of a network router according to the present disclosure. The description of the network router according to the present example may be equally applicable to first through N-th network routers 712(1)-712(N) included in an accelerator system 700 of FIG. 40 and to network router 820 included in an accelerator 800 of FIG. 41.

Referring to FIG. 42, a network router 900 may include a receiver 910, a sender 920, a network controller 930, a buffer circuit 940, a reduce operation circuit 950, and a selective output circuit 960. The network controller 930 may include a first packet transmission circuit 931, a second packet transmission circuit 932, and a third packet transmission circuit 933. The buffer circuit 940 may include a send buffer 941, a receive buffer 942, a partial buffer 943, and a reduce buffer 944. The selective output circuit 960 may include a first demultiplexer 961, a second demultiplexer 962, and a third demultiplexer 963.

The receiver 910 may be configured to receive a receive packet R_P transmitted along a first direction from another network router. The receiver 910 may include at least one receiver buffer 911 configured to store the receive packet R_P transmitted along the first direction from the other network router. The receiver 910 may output the receive packet R_P stored in the receiver buffer 911 and transmit the receive packet R_P to a first packet transmission circuit 931 of a network controller 930. In one embodiment, the receiver 910 may be configured to receive a transfer packet, an all-gather packet, and a reduce packet transmitted along the first direction from another network router. The transfer packet transmitted from the other network router to the receiver 910 of the network router 900 may be a transfer target packet destined for the network router 900 or a transfer pass packet destined for another network router as well as the network router 900. The all-gather packet transmitted from the other network router to the receiver 910 of the network router 900 may be an all-gather target packet destined for the network router 900 or an all-gather pass packet destined for another network router as well as the network router 900. The reduce packet transmitted from the other network router to the receiver 910 of the network router 900 may be a reduce target packet destined for the network router 900 or a reduce pass packet destined for another network router as well as the network router 900.

The sender 920 may be configured to receive packets output from a third packet transmission circuit 933 of a network controller 930 and a send buffer 941 of a buffer circuit 940. The sender 920 may include at least one sender buffer 921 configured to store packets transmitted from the third packet transmission circuit 933 of the network controller 930 and the send buffer 941 of the buffer circuit 940. The sender 920 may output a transmit packet S_P stored in the sender buffer 921 along a first direction and transmit the transmit packet S_P to a receiver of another network router. The sender 920 may be configured to receive a transfer pass packet input to a receiver 910 of the network router 900 from another network router via a first packet transmission circuit 931, a second packet transmission circuit 932, and the third packet transmission circuit 933 of the network controller 930. The sender 920 may be configured to receive a transfer packet, an all-gather packet, and a reduce packet stored in a scratch-pad coupled to the network router 900 from the send buffer 941 of the buffer circuit 940. The sender 920 may be configured to receive an all-gather pass packet input to the receiver 910 of the network router 900 from another network router from the send buffer 941 of the buffer circuit 940. Additionally, the sender 920 may be configured to receive a partial sum pass packet, a reduce result pass packet, a reduce-scatter result pass packet, and an all-reduce result pass packet output from a reduce operation circuit 950 from the send buffer 941 of the buffer circuit 940.

The first packet transmission circuit 931, the second packet transmission circuit 932, and the third packet transmission circuit 933 of the network controller 930 may each include one input terminal, one first output terminal, and one second output terminal. An input terminal of the first packet transmission circuit 931 may be connected to an output terminal of a receiver buffer 911 of a receiver 910. Accordingly, the first packet transmission circuit 931 may receive a receive packet R_P transmitted from the receiver buffer 911 through the input terminal. The first output terminal and the second output terminal of the first packet transmission circuit 931 may be connected to an input terminal of the second packet transmission circuit 932 and a reduce buffer 944 of a buffer circuit 940, respectively. In one embodiment, when a transfer packet and an all-gather packet are input to the input terminal of the first packet transmission circuit 931, the first packet transmission circuit 931 may transmit the transfer packet and the all-gather packet from the first output terminal to the input terminal of the second packet transmission circuit 932. When a reduce packet is input to the input terminal of the first packet transmission circuit 931, the first packet transmission circuit 931 may transmit the reduce packet from the second output terminal to the reduce buffer 944 of the buffer circuit 940.

An input terminal of the second packet transmission circuit 932 is connected to a first output terminal of the first packet transmission circuit 931. A first output terminal and a second output terminal of the second packet transmission circuit 932 are connected to an input terminal of the third packet transmission circuit 933 and a receive buffer 942 of the buffer circuit 940, respectively. The second packet transmission circuit 932 receives a transfer packet and an all-gather packet from the first packet transmission circuit 931. When the transfer packet is input to the input terminal of the second packet transmission circuit 932, the second packet transmission circuit 932 transmits the transfer packet from the first output terminal to the input terminal of the third packet transmission circuit 933. When the all-gather packet is input to the input terminal of the second packet transmission circuit 932, the second packet transmission circuit 932 transmits the all-gather packet from the second output terminal to the receive buffer 942 of the buffer circuit 940.

An input terminal of the third packet transmission circuit 933 is connected to a first output terminal of the second packet transmission circuit 932. A first output terminal and a second output terminal of the third packet transmission circuit 933 are connected to a sender buffer 921 of the sender 920 and to a receive buffer 942 of the buffer circuit 940, respectively. The third packet transmission circuit 933 receives a transfer packet from the second packet transmission circuit 932. When a transfer pass packet is input to the input terminal of the third packet transmission circuit 933, the third packet transmission circuit 933 transmits the transfer pass packet from the first output terminal to the sender buffer 921 of the sender 920. When a transfer target packet is input to the input terminal of the third packet transmission circuit 933, the third packet transmission circuit 933 transmits the transfer target packet from the second output terminal to the receive buffer 942 of the buffer circuit 940.

The send buffer 941 of the buffer circuit 940 may receive packets from a scratch-pad coupled to the network router 900, a first demultiplexer 961 of the selective output circuit 960, and a third demultiplexer 963 of the selective output circuit 960. Specifically, the send buffer 941 may receive and store a transfer packet, an all-gather packet, and a reduce packet that are to be transmitted from the network router 900 to another network router in a first direction, from the scratch-pad. The send buffer 941 may transmit the stored transfer packet, all-gather packet, and reduce packet to a sender buffer 921 of the sender 920. The send buffer 941 may receive and store a partial sum pass packet, a reduce result pass packet, a reduce-scatter result pass packet, and an all-reduce result pass packet output from the reduce operation circuit 950, through the first demultiplexer 961 of the selective output circuit 960. The send buffer 941 may transmit the partial sum pass packet, the reduce result pass packet, the reduce-scatter result pass packet, and the all-reduce result pass packet, received from the first demultiplexer 961, to the sender buffer 921 of the sender 920. The send buffer 941 may receive and store an all-gather pass packet, which is to be transmitted in the first direction, from the third demultiplexer 963 of the selective output circuit 960. The send buffer 941 may transmit the all-gather pass packet, received from the third demultiplexer 963, to the sender buffer 921 of the sender 920.

The receive buffer 942 of the buffer circuit 940 may receive packets from a second packet transmission circuit 932 of the network controller 930, a third packet transmission circuit 933 of the network controller 930, and a first demultiplexer 961 of the selective output circuit 960. Specifically, the receive buffer 942 may receive and store an all-gather packet provided from another network router in a first direction, the all-gather packet being output from a second output terminal of the second packet transmission circuit 932. The receive buffer 942 may receive and store a transfer target packet provided from another network router in the first direction, the transfer target packet being output from a second output terminal of the third packet transmission circuit 933. The receive buffer 942 may receive and store a partial sum target packet, a reduce result target packet, a reduce-scatter result target packet, and an all-reduce result target packet, the packets being output from the reduce operation circuit 950 and transferred through the first demultiplexer 961 of the selective output circuit 960. The receive buffer 942 may, in response to a receive command transmitted from the network controller 930 to the receive buffer 942, transmit the stored all-gather packet, transfer target packet, partial sum target packet, reduce result target packet, reduce-scatter result target packet, and all-reduce result target packet to a second demultiplexer 962 of the selective output circuit 960.

The partial buffer 943 and the reduce buffer 944 of the buffer circuit 940 store reduce packets that are used as operands in a reduce operation. Specifically, the partial buffer 943 may receive and store a reduce packet from a scratch pad, the reduce packet being used as a first operand in the reduce operation. The reduce packet transferred from the scratch pad to the partial buffer 943 may include a partial sum packet generated by a previous reduce operation and stored in the scratch pad. The partial buffer 943 may transmit the reduce packet used as the first operand in the reduce operation to a first input terminal of the reduce operation circuit 950. The reduce buffer 944 may receive and store a reduce packet from a first packet transmission circuit 931 of the network controller 930, the reduce packet being used as a second operand in the reduce operation. The reduce packet transferred from the first packet transmission circuit 931 to the reduce buffer 944 may include a partial sum pass packet that is generated by a reduce operation in another network router and transferred to the network router 900. The reduce buffer 944 may transmit the reduce packet used as the second operand in the reduce operation to a second input terminal of the reduce operation circuit 950.

The reduce operation circuit 950 performs a collective operation, such as a reduce operation. In one example, the reduce operation circuit 950 may be an adder that performs an addition operation. However, this is merely one example, and the reduce operation circuit 950 may be an arithmetic unit that performs an operation other than an addition operation, such as a multiplication operation, a division operation, a maximum value operation, or a minimum value operation. The reduce operation circuit 950 includes a plurality of input terminals, such as a first input terminal and a second input terminal, and at least one output terminal. The first input terminal of the reduce operation circuit 950 is coupled to the partial buffer 943 of the buffer circuit 940. The second input terminal of the reduce operation circuit 950 is coupled to the reduce buffer 944 of the buffer circuit 940. The output terminal of the reduce operation circuit 950 is coupled to an input terminal of the first demultiplexer 961 included in the selective output circuit 960. The reduce operation circuit 950 may receive, through the first input terminal, a reduce packet used as a first operand in the reduce operation from the partial buffer 943. The reduce operation circuit 950 may receive, through the second input terminal, a reduce packet used as a second operand in the reduce operation from the reduce buffer 944. The reduce operation circuit 950 may perform the reduce operation, such as an addition operation, on the reduce packet used as the first operand and the reduce packet used as the second operand, and may generate a partial sum packet, a reduce result packet, a reduce-scatter result packet, and an all-reduce result packet. The partial sum packet may be generated by the reduce operation in a reduce operation, a reduce-scatter operation, or an all-reduce operation. The reduce result packet may be generated by the reduce operation in the reduce operation. The reduce-scatter result packet may be generated by the reduce operation in the reduce-scatter operation. The all-reduce result packet may be generated by the reduce operation in the all-reduce operation. The reduce operation circuit 950 may transmit the partial sum packet, the reduce result packet, the reduce-scatter result packet, and the all-reduce result packet from the output terminal to the input terminal of the first demultiplexer 961.

Each of a first demultiplexer 961, a second demultiplexer 962, and a third demultiplexer 963 included in the selective output circuit 960 may be a 1-to-2 demultiplexer including one input terminal and two output terminals. An input terminal of the first demultiplexer 961 is coupled to an output terminal of the reduce operation circuit 950. A first output terminal of the first demultiplexer 961 is coupled to the send buffer 941 of the buffer circuit 940. A second output terminal of the first demultiplexer 961 is coupled to the receive buffer 942 of the buffer circuit 940. An input terminal of the second demultiplexer 962 is coupled to the receive buffer 942 of the buffer circuit 940. A first output terminal of the second demultiplexer 962 is coupled to an input terminal of the third demultiplexer 963. A second output terminal of the second demultiplexer 962 is coupled to the scratch-pad. An input terminal of the third demultiplexer 963 is coupled to the first output terminal of the second demultiplexer 962. A first output terminal of the third demultiplexer 963 is commonly coupled to the scratch-pad and the send buffer 941 of the buffer circuit 940. A second output terminal of the third demultiplexer 963 is coupled to the scratch-pad.

The first demultiplexer 961 receives, through the input terminal, a partial sum packet, a reduce result packet, a reduce-scatter result packet, and an all-reduce result packet output from the reduce operation circuit 950. When the partial sum packet, the reduce result packet, the reduce-scatter result packet, and the all-reduce result packet input to the input terminal of the first demultiplexer 961 correspond to a partial sum pass packet, a reduce result pass packet, a reduce-scatter result pass packet, and an all-reduce result pass packet, respectively, the first demultiplexer 961 transmits the partial sum pass packet, the reduce result pass packet, the reduce-scatter result pass packet, and the all-reduce result pass packet to the send buffer 941 of the buffer circuit 940 through the first output terminal. When the partial sum packet, the reduce result packet, the reduce-scatter result packet, and the all-reduce result packet input to the input terminal of the first demultiplexer 961 correspond to a partial sum target packet, a reduce result target packet, a reduce-scatter result target packet, and an all-reduce result target packet, respectively, the first demultiplexer 961 transmits the partial sum target packet, the reduce result target packet, the reduce-scatter result target packet, and the all-reduce result target packet to the receive buffer 942 of the buffer circuit 940 through the second output terminal.

The second demultiplexer 962 receives, through an input terminal, an all-gather packet, a transfer target packet, a partial sum target packet, a reduce result target packet, a reduce-scatter result target packet, and an all-reduce result target packet output from the receive buffer 942 of the buffer circuit 940. When the all-gather packet is received from the receive buffer 942, the second demultiplexer 962 transmits the all-gather packet to an input terminal of the third demultiplexer 963 through a first output terminal. When the transfer target packet, the partial sum target packet, the reduce result target packet, the reduce-scatter result target packet, and the all-reduce result target packet are transmitted from the receive buffer 942, the second demultiplexer 962 transmits the transfer target packet, the partial sum target packet, the reduce result target packet, the reduce-scatter result target packet, and the all-reduce result target packet to the scratch-pad through a second output terminal.

The third demultiplexer 963 receives, through an input terminal, an all-gather packet output from a first output terminal of the second demultiplexer 962. When the all-gather packet input from the second demultiplexer 962 is an all-gather pass packet, the third demultiplexer 963 transmits the all-gather pass packet to the send buffer 941 of the buffer circuit 940 and to the scratch-pad together through a first output terminal. On the other hand, when the all-gather packet input from the second demultiplexer 962 is an all-gather target packet, the third demultiplexer 963 transmits the all-gather target packet to the scratch-pad through a second output terminal.

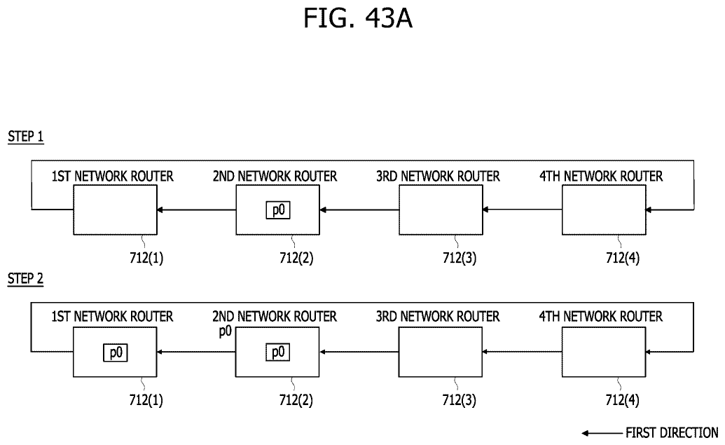

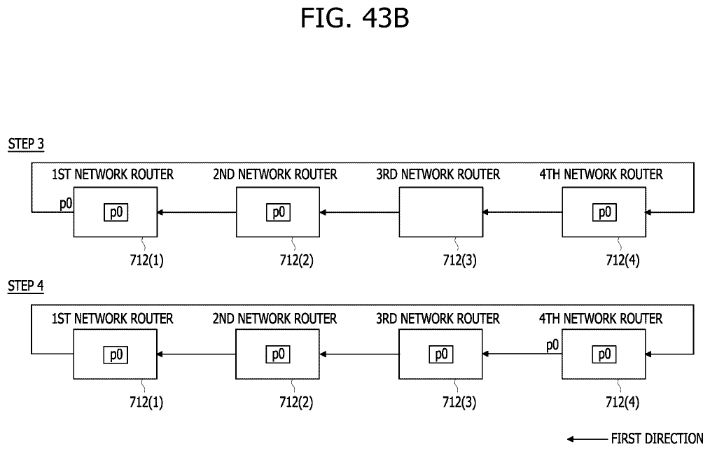

FIGS. 43A and 43B are diagrams illustrating a broadcast operation in the accelerator system of FIG. 40 including the network router of FIG. 42. In the following various examples, as described with reference to FIG. 41, it is assumed that a first through a fourth network router 712(1)-712(4) are respectively included in a first through a fourth accelerator, and that the first through the fourth accelerators are coupled in a one-dimensional torus topology. In the following various examples, it is also assumed that the first through the fourth accelerators respectively include a first through a fourth scratch-pad coupled to the first through the fourth network routers 712(1)-712(4). For convenience, only the first through the fourth network routers 712(1)-712(4) are illustrated in the drawings, and illustration of the first through the fourth scratch-pads has been omitted.

Referring to FIG. 43A, in a first step (STEP 1) of a broadcast operation in the accelerator system 700 of FIG. 41, it is assumed that a first packet p0 is stored in a second scratch-pad coupled to a second network router 712(2), and that the first packet p0 is not stored in a first scratch-pad coupled to a first network router 712(1), a third scratch-pad coupled to a third network router 712(3), or a fourth scratch-pad coupled to a fourth network router 712(4). The broadcast operation may be performed by transmitting the first packet p0, held by the second network router 712(2), to the first network router 712(1), the third network router 712(3), and the fourth network router 712(4). During the broadcast operation, a packet type of a broadcast packet transmitted among the network routers is set as a transmission packet. According to a destination setting of the broadcast packet transmitted among the network routers, the broadcast packet may be handled either as a transmission pass packet or as a transmission target packet.

In a second step (STEP 2) of the broadcast operation, the second network router 712(2) transmits the first packet p0, which is stored in the second scratch-pad, in a first direction to a receiver of the first network router 712(1). A destination of the first packet p0 transmitted from the second network router 712(2) to the first network router 712(1) is set to the first network router 712(1). The first network router 712(1) processes the first packet p0 received from the second network router 712(2) as a transmission target packet. Accordingly, the first network router 712(1) stores the first packet p0, received from the second network router 712(2), in the first scratch-pad.

Referring to FIG. 43B, in a third step (STEP 3) of the broadcast operation, the first network router 712(1) transmits the first packet p0, stored in the first scratch-pad, in a first direction to a receiver of the fourth network router 712(4). A destination of the first packet p0 transmitted from the first network router 712(1) to the fourth network router 712(4) is set to the fourth network router 712(4). The fourth network router 712(4) processes the first packet p0 received from the first network router 712(1) as a transmission target packet. Accordingly, the fourth network router 712(4) stores the first packet p0, received from the first network router 712(1), in the fourth scratch-pad.

In a fourth step (STEP 4) of the broadcast operation, the fourth network router 712(4) transmits the first packet p0, stored in the fourth scratch-pad, in a first direction to a receiver of the third network router 712(3). A destination of the first packet p0 transmitted from the fourth network router 712(4) to the third network router 712(3) is set to the third network router 712(3). The third network router 712(3) processes the first packet p0 received from the fourth network router 712(4) as a transmission target packet. Accordingly, the third network router 712(3) stores the first packet p0, received from the fourth network router 712(4), in the third scratch-pad.

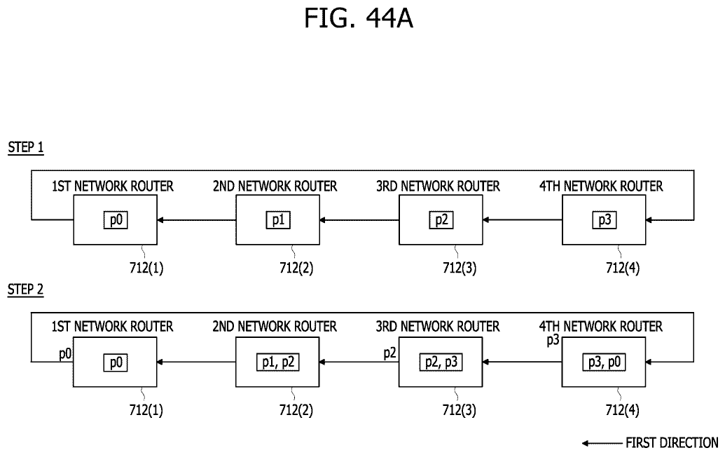

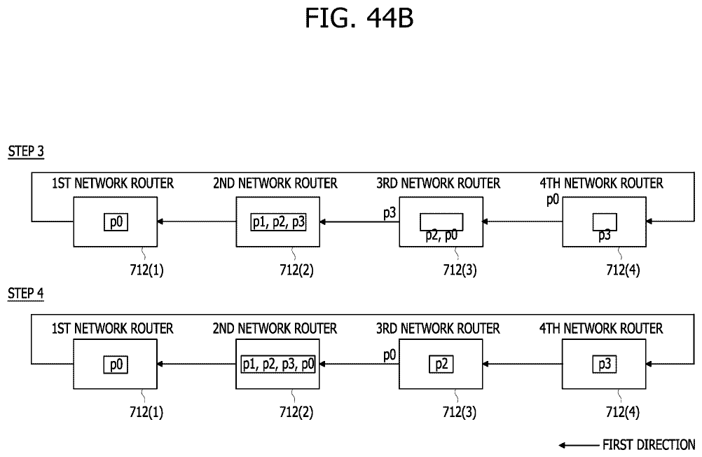

FIGS. 44A and 44B are diagrams illustrating a gather operation in the accelerator system of FIG. 40 including the network router of FIG. 42.

Referring to FIG. 44A, in a first step (STEP 1) of a gather operation in the accelerator system (700) of FIG. 41, it is assumed that a first packet p0 is stored in a first scratch-pad coupled to a first network router 712(1), a second packet p1 is stored in a second scratch-pad coupled to a second network router 712(2), a third packet p2 is stored in a third scratch-pad coupled to a third network router 712(3), and a fourth packet p3 is stored in a fourth scratch-pad coupled to a fourth network router 712(4). The gather operation may be performed by storing the first packet p0 from the first scratch-pad, the second packet p1 from the second scratch-pad, the third packet p2 from the third scratch-pad, and the fourth packet p3 from the fourth scratch-pad, all into the second scratch-pad. During the gather operation, the packet type of the gather packets transmitted between the network routers is set as a transmission packet. Depending on the destination configuration, the gather packet may be processed as a transmission path packet or a transmission target packet.

In a second step (STEP 2) of the gather operation, the first network router 712(1) transmits the first packet p0, which is stored in the first scratch-pad, to the receiver of the fourth network router 712(4) in the first direction. The fourth network router 712(4) transmits the fourth packet p3, which is stored in the fourth scratch-pad, to the receiver of the third network router 712(3) in the first direction. The third network router 712(3) transmits the third packet p2, which is stored in the third scratch-pad, to the receiver of the second network router 712(2) in the first direction. The destination of each of the packets p0, p2, and p3 is set to the second network router 712(2).

The fourth network router 712(4), which receives the first packet p0 from the first network router 712(1) with the destination set to the second network router 712(2), processes the first packet p0 as a transmission pass packet. Accordingly, the fourth network router 712(4) stores the first packet p0 in the sender of the fourth network router 712(4). The third network router 712(3), which receives the fourth packet p3 from the fourth network router 712(4) with the destination set to the second network router 712(2), processes the fourth packet p3 as a transmission pass packet. Accordingly, the third network router 712(3) stores the fourth packet p3 in the sender of the third network router 712(3). The second network router 712(2), which receives the third packet p2 from the third network router 712(3) with the destination set to the second network router 712(2), processes the third packet p2 as a transmission target packet. Accordingly, the second network router 712(2) transmits the third packet p2 to the second scratch-pad.

In the third step (STEP 3) of the gather operation, as illustrated in FIG. 44B, the fourth network router 712(4) transmits the first packet p0, which is stored in the sender, to the receiver of the third network router 712(3) in the first direction. The third network router 712(3) transmits the fourth packet p3, which is stored in the sender, to the receiver of the second network router 712(2) in the first direction. The third network router 712(3), which receives the first packet p0 from the fourth network router 712(4), with the destination set to the second network router 712(2), processes the first packet p0 as a transmission pass packet. Accordingly, the third network router 712(3) stores the first packet p0 in the sender of the third network router 712(3). The second network router 712(2), which receives the fourth packet p3 from the third network router 712(3), with the destination set to the second network router 712(2), processes the fourth packet p3 as a transmission target packet. Accordingly, the second network router 712(2) transmits the fourth packet p3 to the second scratch-pad.

In the fourth step (STEP 4) of the gather operation, the third network router 712(3) transmits the first packet p0, which is stored in the sender, to the receiver of the second network router 712(2) in the first direction. The second network router 712(2), which receives the first packet p0 from the third network router 712(3) with the destination set to the second network router 712(2), processes the first packet p0 as a transmission target packet. Accordingly, the second network router 712(2) transmits the first packet p0 to the second scratch-pad. By performing the second through fourth steps (STEP 2 to STEP 4) of the gather operation as described above, the second scratch-pad coupled to the second network router 712(2) reaches a state in which the first packet p0, the second packet p1, the third packet p2, and the fourth packet p3 are all stored.

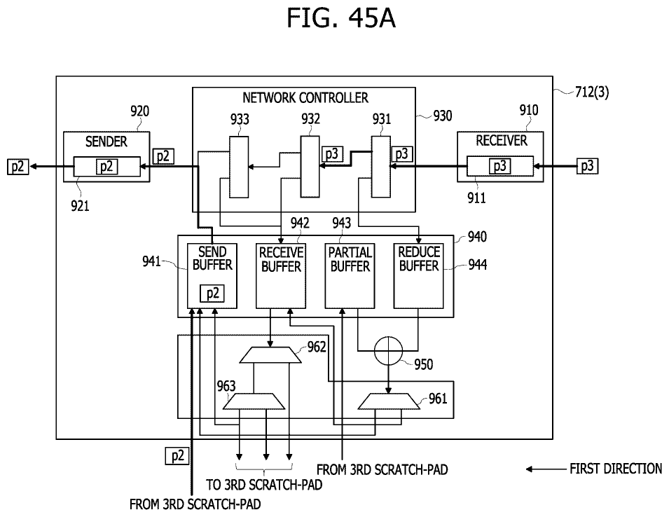

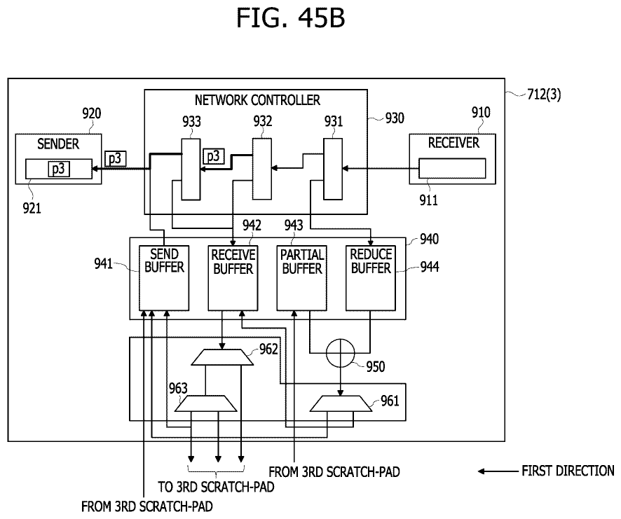

FIGS. 45A and 45B are diagrams illustrating the operation of a third network router in a second step of the gather operation shown in FIG. 44A.

Referring to FIG. 45A in conjunction with FIG. 44A, in the second step (STEP 2) of the gather operation, the third network router 712(3) transmits the third packet p2, which is stored in the third scratch-pad, to the second network router 712(2) in the first direction, and simultaneously receives the fourth packet p3 from the fourth network router 712(4) in the first direction. To transmit the third packet p2 to the second network router 712(2), the third network router 712(3) reads the third packet p2 from the third scratch-pad and stores it in the send buffer 941 of the buffer circuit 940. The third network router 712(3) transfers the third packet p2 stored in the send buffer 941 to the sender buffer 921 of the sender 920. The sender 920 transmits the third packet p2 stored in the sender buffer 921 to the second network router 712(2) in the first direction. As described with reference to FIG. 44A, the destination of the third packet p2 transmitted from the third network router 712(3) to the second network router 712(2) is set to the second network router 712(2).

Meanwhile, as the fourth packet p3 is transmitted in the first direction from the fourth network router 712(4), the third network router 712(3) stores the fourth packet p3, transmitted from the fourth network router 712(4), in the receiver buffer 911 of the receiver 910. The receiver 910 transfers the fourth packet p3, stored in the receiver buffer 911, to the input terminal of the first packet transmission circuit 931 of the network controller 930. Since the fourth packet p3 is a transmission packet, the first packet transmission circuit 931 transmits the fourth packet p3 to the input terminal of the second packet transmission circuit 932 through the first output terminal.

Referring to FIG. 45B in conjunction with FIG. 44A, the second packet transmission circuit 932 transmits the fourth packet p3 to the input terminal of the third packet transmission circuit 933 via its first output terminal. Since the fourth packet p3 is a transfer-pass packet whose destination is the second network router 712(2), and not the third network router 712(3), the third packet transmission circuit 933 transmits the fourth packet p3 to the sender buffer 921 of the sender 920 via its first output terminal. As previously described with reference to FIG. 44B, the sender 920 of the third network router 712(3) transmits the fourth packet p3, stored in the sender buffer 921, to the second network router 712(2) in the third step (STEP 3) of the gather operation.

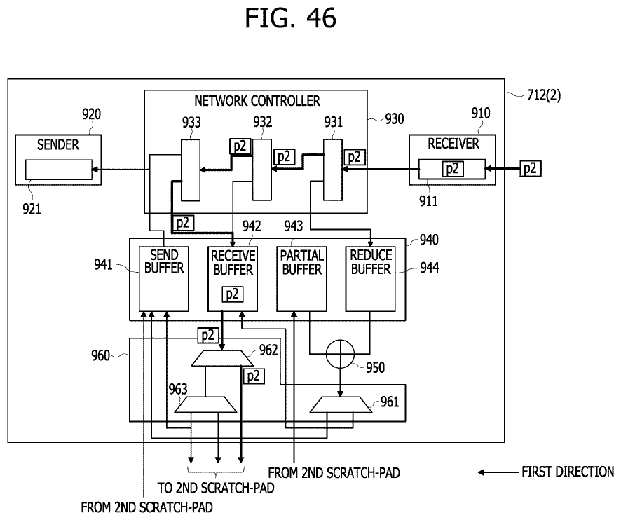

FIG. 46 is a diagram illustrating the operation of a second network router in a second step of the gather operation shown in FIG. 44A.

Referring to FIG. 46 in conjunction with FIG. 44A, in a second step (STEP 2) of the gather operation, the second network router 712(2) receives a third packet p2 from the third network router 712(3) along a first direction. The receiver 910 of the second network router 712(2) stores the third packet p2 in a receiver buffer 911. The receiver 910 transmits the third packet p2 stored in the receiver buffer 911 to an input terminal of a first packet transmission circuit 931 included in a network controller 930. As described with reference to FIG. 44A, since a destination of the third packet p2 transferred from the third network router 712(3) is designated as the second network router 712(2), the second network router 712(2) processes the third packet p2 as a transfer-target packet. Accordingly, the first packet transmission circuit 931 transmits the third packet p2 from the first output terminal to an input terminal of a second packet transmission circuit 932. The second packet transmission circuit 932 transmits the third packet p2 from a first output terminal to an input terminal of a third packet transmission circuit 933. The third packet transmission circuit 933 transmits the third packet p2 from a second output terminal to a receive buffer 942 included in a buffer circuit 940. Although not illustrated in FIG. 46, upon reception of the third packet p2 by the receive buffer 942, the network controller 930 may transmit a receive command to the receive buffer 942. In response to the receive command, the receive buffer 942 transmits the third packet p2 to an input terminal of a second demultiplexer 962 included in a selective output circuit 960. Since the third packet p2 corresponds to the transfer-target packet, the second demultiplexer 962 transmits the third packet p2 to a second scratch-pad through a second output terminal.

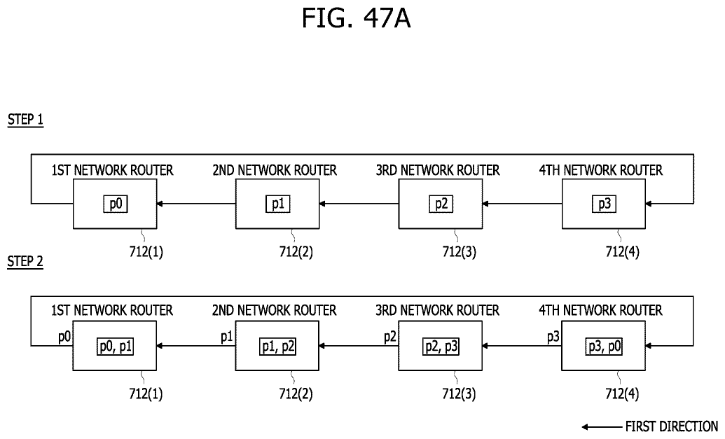

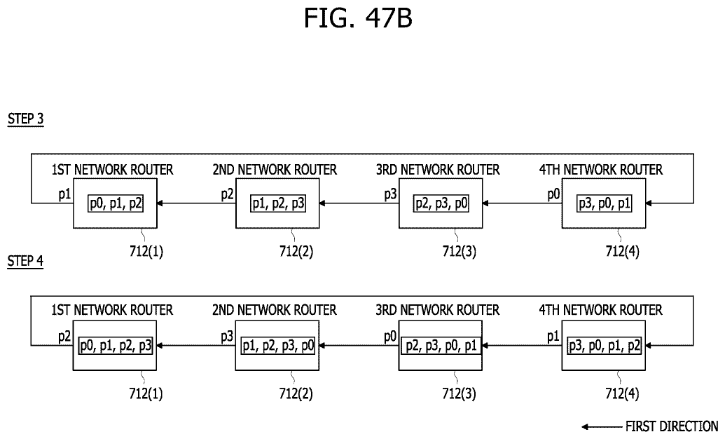

FIGS. 47A and 47B are diagrams illustrating an all-gather operation in the accelerator system of FIG. 40 including the network router of FIG. 42.

Referring to FIG. 47A, in a first step (STEP 1) of the all-gather operation, a first packet p0 is stored in a first scratch-pad coupled to a first network router 712(1), a second packet p1 is stored in a second scratch-pad coupled to a second network router 712(2), a third packet p2 is stored in a third scratch-pad coupled to a third network router 712(3), and a fourth packet p3 is stored in a fourth scratch-pad coupled to a fourth network router 712(4). The all-gather operation may be performed by collecting all four packets, namely, the first packet p0, the second packet p1, the third packet p2, and the fourth packet p3, into each of the first, second, third, and fourth scratch-pads respectively. During the all-gather operation, the packet type of each packet transmitted between network routers is set as an all-gather packet. Depending on the destination setting, an all-gather packet may be handled as either an all-gather pass packet or an all-gather target packet.

In a second step (STEP 2) of the all-gather operation, the first network router 712(1) transmits the first packet p0, which is stored in the first scratch-pad, to the fourth network router 712(4) along a first direction. The destination of the first packet p0 is set to the second network router 712(2), which is the nearest network router to the first network router 712(1) in a direction opposite to the first direction. The second network router 712(2) transmits the second packet p1, which is stored in the second scratch-pad, to the first network router 712(1) along the first direction. The destination of the second packet p1 is set to the third network router 712(3), which is the nearest network router to the second network router 712(2) in a direction opposite to the first direction. The third network router 712(3) transmits the third packet p2, which is stored in the third scratch-pad, to the second network router 712(2) along the first direction. The destination of the third packet p2 is set to the fourth network router 712(4), which is the nearest network router to the third network router 712(3) in a direction opposite to the first direction. The fourth network router 712(4) transmits the fourth packet p3, which is stored in the fourth scratch-pad, to the third network router 712(3) along the first direction. The destination of the fourth packet p3 is set to the first network router 712(1), which is the nearest network router to the fourth network router 712(4) in a direction opposite to the first direction.

Since the destination of the second packet p1 is set to the third network router 712(3), the first network router 712(1) processes the second packet p1, which is received from the second network router 712(2), as an all-gather pass packet. Specifically, the first network router 712(1) stores the second packet p1 in a send buffer of a sender included in the first network router 712(1), and also transfers the second packet p1 to the first scratch-pad. Since the destination of the third packet p2 is set to the fourth network router 712(4), the second network router 712(2) processes the third packet p2, which is received from the third network router 712(3), as an all-gather pass packet. Specifically, the second network router 712(2) stores the third packet p2 in a send buffer of a sender included in the second network router 712(2), and also transfers the third packet p2 to the second scratch-pad. Since the destination of the fourth packet p3 is set to the first network router 712(1), the third network router 712(3) processes the fourth packet p3, which is received from the fourth network router 712(4), as an all-gather pass packet. Specifically, the third network router 712(3) stores the fourth packet p3 in a send buffer of a sender included in the third network router 712(3), and also transfers the fourth packet p3 to the third scratch-pad. Since the destination of the first packet p0 is set to the second network router 712(2), the fourth network router 712(4) processes the first packet p0, which is received from the first network router 712(1), as an all-gather pass packet. Specifically, the fourth network router 712(4) stores the first packet p0 in a send buffer of a sender included in the fourth network router 712(4), and also transfers the first packet p0 to the fourth scratch-pad.

In the third step (STEP 3) of the all-gather operation, as illustrated in FIG. 47B, the first network router 712(1) transmits the second packet p1, which is stored in the send buffer of a sender included in the first network router 712(1), to the fourth network router 712(4) along a first direction. The second network router 712(2) transmits the third packet p2, which is stored in the send buffer of a sender included in the second network router 712(2), to the first network router 712(1) along the first direction. The third network router 712(3) transmits the fourth packet p3, which is stored in the send buffer of a sender included in the third network router 712(3), to the second network router 712(2) along the first direction. The fourth network router 712(4) transmits the first packet p0, which is stored in the send buffer of a sender included in the fourth network router 712(4), to the third network router 712(3) along the first direction.

Since a destination of the third packet p2 is the fourth network router 712(4), the first network router 712(1) processes the third packet p2, which is received from the second network router 712(2), as an all-gather pass packet. Specifically, the first network router 712(1) stores the third packet p2 in a send buffer of a sender included in the first network router 712(1) and also transmits the third packet p2 to a first scratch-pad coupled to the first network router 712(1). Since a destination of the fourth packet p3 is the first network router 712(1), the second network router 712(2) processes the fourth packet p3, which is received from the third network router 712(3), as an all-gather pass packet. Specifically, the second network router 712(2) stores the fourth packet p3 in a send buffer of a sender included in the second network router 712(2) and also transmits the fourth packet p3 to a second scratch-pad coupled to the second network router 712(2). Since a destination of the first packet p0 is the second network router 712(2), the third network router 712(3) processes the first packet p0, which is received from the fourth network router 712(4), as an all-gather pass packet. Specifically, the third network router 712(3) stores the first packet p0 in a send buffer of a sender included in the third network router 712(3) and also transmits the first packet p0 to a third scratch-pad coupled to the third network router 712(3). Since a destination of the second packet p1 is the third network router 712(3), the fourth network router 712(4) processes the second packet p1, which is received from the first network router 712(1), as an all-gather pass packet. Specifically, the fourth network router 712(4) stores the second packet p1 in a send buffer of a sender included in the fourth network router 712(4) and also transmits the second packet p1 to a fourth scratch-pad coupled to the fourth network router 712(4).

In a fourth step (STEP 4) of the all-gather operation, the first network router 712(1) transmits a third packet p2, which is stored in a send buffer of a sender included in the first network router 712(1), to the fourth network router 712(4) in a first direction. The second network router 712(2) transmits a fourth packet p3, which is stored in a send buffer of a sender included in the second network router 712(2), to the first network router 712(1) in the first direction. The third network router 712(3) transmits a first packet p0, which is stored in a send buffer of a sender included in the third network router 712(3), to the second network router 712(2) in the first direction. The fourth network router 712(4) transmits a second packet p1, which is stored in a send buffer of a sender included in the fourth network router 712(4), to the third network router 712(3) in the first direction.

Since a destination of the fourth packet p3 is the first network router 712(1), the first network router 712(1) processes the fourth packet p3, which is received from the second network router 712(2), as an all-gather target packet. Specifically, the first network router 712(1) transmits the fourth packet p3 to a first scratch-pad coupled to the first network router 712(1). Since a destination of the first packet p0 is the second network router 712(2), the second network router 712(2) processes the first packet p0, which is received from the third network router 712(3), as an all-gather target packet. Specifically, the second network router 712(2) transmits the first packet p0 to a second scratch-pad coupled to the second network router 712(2). Since a destination of the second packet p1 is the third network router 712(3), the third network router 712(3) processes the second packet p1, which is received from the fourth network router 712(4), as an all-gather target packet. Specifically, the third network router 712(3) transmits the second packet p1 to a third scratch-pad coupled to the third network router 712(3). Since a destination of the third packet p2 is the fourth network router 712(4), the fourth network router 712(4) processes the third packet p2, which is received from the first network router 712(1), as an all-gather target packet. Specifically, the fourth network router 712(4) transmits the third packet p2 to a fourth scratch-pad coupled to the fourth network router 712(4).

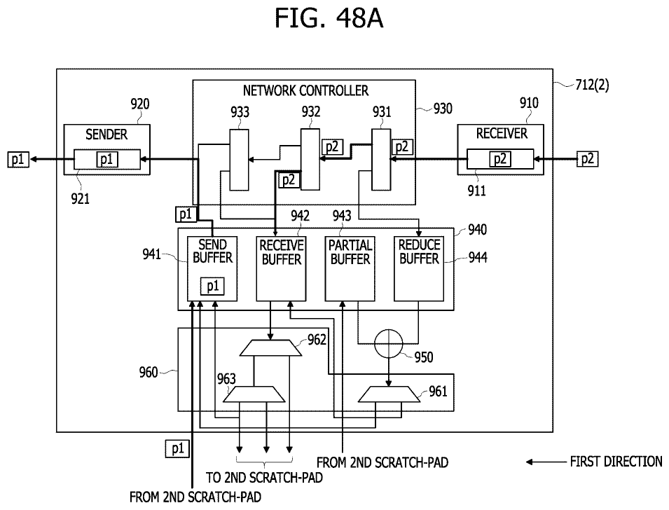

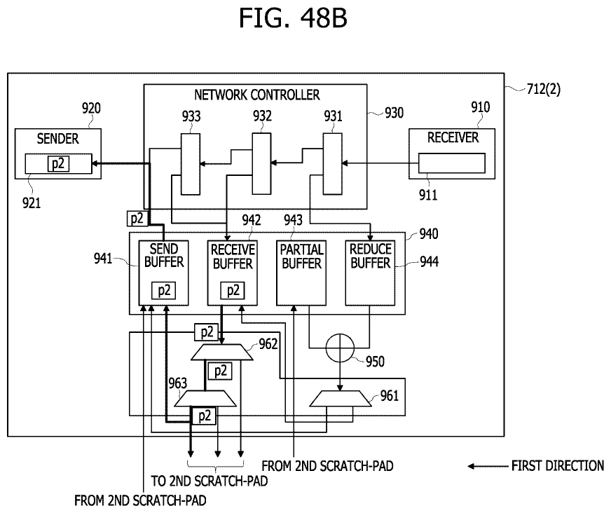

FIGS. 48A and 48B are diagrams illustrating the operation of a second network router in a second step of the all-gather operation shown in FIG. 47A. The description of the operation of the second network router in the present example is also applicable, in the same manner, to the operations of a first network router, a third network router, and a fourth network router in the second step of the all-gather operation.

Referring to FIG. 48A in conjunction with FIG. 47A, in a second step (STEP 2) of the all-gather operation, the second network router 712(2) transmits a second packet p1, stored in a second scratch-pad, in a first direction to the first network router 712(1), and receives a third packet p2 from the third network router 712(3) in the first direction. For transmission of the second packet p1 to the first network router 712(1), the second network router 712(2) reads the second packet p1 from the second scratch-pad and stores the second packet p1 in a send buffer 941 of a buffer circuit 940. The send buffer 941 transmits the second packet p1 to a sender buffer 921 of a sender 920. The sender 920 outputs the second packet p1 stored in the sender buffer 921 in the first direction and transmits the second packet p1 to the first network router 712(1).

Meanwhile, a receiver 910 of the second network router 712(2) stores a third packet p2, received from the third network router 712(3) in the first direction, in a receiver buffer 911. The receiver 910 transmits the third packet p2 to an input terminal of a first packet transmission circuit 931 of a network controller 930. Since the third packet p2 is an all-gather packet, the first packet transmission circuit 931 transfers the third packet p2 to an input terminal of a second packet transmission circuit 932 via a first output terminal. The second packet transmission circuit 932 transfers the third packet p2 to a receive buffer 942 of a buffer circuit 940 via a second output terminal. Although not explicitly illustrated in the figure, when the third packet p2 is transferred to the receive buffer 942, the network controller 930 of the second network router 712(2) transmits a receive command to the receive buffer 942.

Referring to FIG. 48B in conjunction with FIG. 47A, a receive buffer 942, in response to a receive command, transmits a third packet p2 to an input terminal of a second demultiplexer 962. Since the third packet p2 is an all-gather packet, the second demultiplexer 962 transmits the third packet p2 to an input terminal of a third demultiplexer 963 via a first output terminal. Because a destination of the third packet p2 is set to the fourth network router 712(4), the third packet p2 corresponds to an all-gather pass packet. Accordingly, the third demultiplexer 963 transmits the third packet p2 to both a second scratch-pad and a send buffer 941 of a buffer circuit 940 via a first output terminal. The send buffer 941 transfers the third packet p2 to a sender buffer 921 of a sender 920.

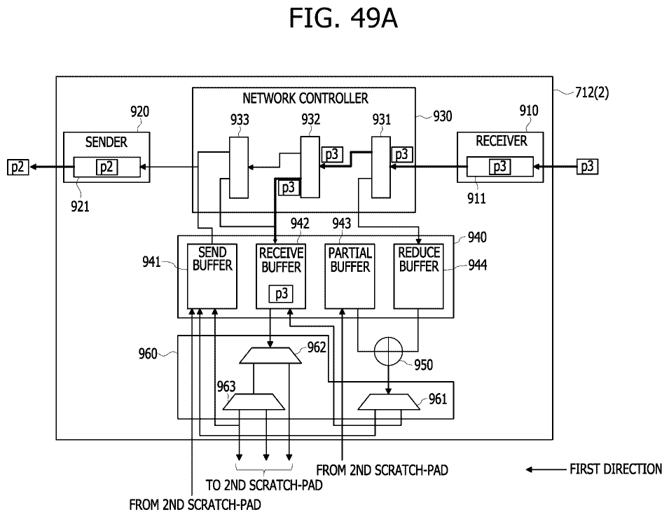

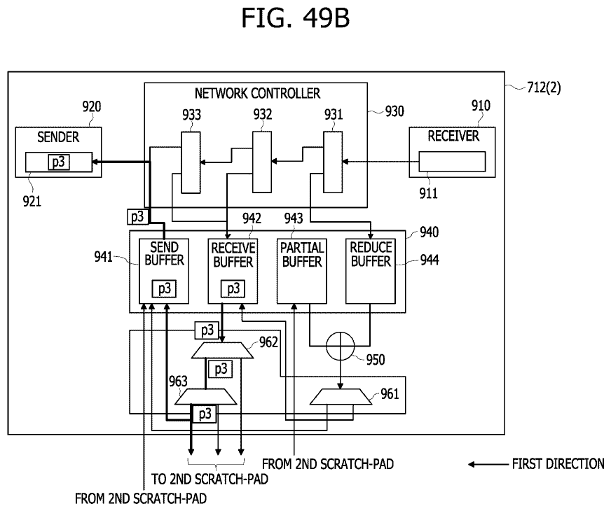

FIGS. 49A and 49B are diagrams illustrating the operation of a second network router in a third step of the all-gather operation shown in FIG. 47B. The description of the second network router's operation in this example may also be applied in the same manner to the operations of the first, third, and fourth network routers during the third step of the all-gather operation.

Referring to FIG. 49A in conjunction with FIG. 47B, in the third step (STEP 3) of the all-gather operation, the second network router 712(2) transmits the third packet p2, stored in the sender buffer 921 of the sender 920, to the first network router 712(1) in a first direction, and also receives the fourth packet p3 from the third network router 712(3) in the first direction. As described with reference to FIGS. 48A and 48B, the third packet p2 is stored in the sender buffer 921 of the sender 920 of the second network router 712(2) during the second step (STEP 2) of the all-gather operation. The sender 920 of the second network router 712(2) outputs the third packet p2 stored in the sender buffer 921 and transmits the third packet p2 in the first direction to the first network router 712(1).

Meanwhile, as the fourth packet p3 is transmitted from the third network router 712(3) in the first direction, the receiver 910 of the second network router 712(2) stores the fourth packet p3 in the receiver buffer 911. The receiver 910 transmits the fourth packet p3 to the input terminal of the first packet transmission circuit 931 of the network controller 930. Since the fourth packet p3 is an all-gather packet, the first packet transmission circuit 931 transmits the fourth packet p3 through the first output terminal to the input terminal of the second packet transmission circuit 932. The second packet transmission circuit 932 transmits the fourth packet p3 through the second output terminal to the receive buffer 942 of the buffer circuit 940. Although not illustrated in the drawing, once the fourth packet p3 is transmitted to the receive buffer 942, the network controller 930 of the second network router 712(2) transmits a receive command to the receive buffer 942.

Referring to FIG. 49B in conjunction with FIG. 47B, the receive buffer 942 responds to a receive command by transmitting the fourth packet p3 to an input terminal of the second demultiplexer 962. Since the fourth packet p3 is an all-gather packet, the second demultiplexer 962 transmits the fourth packet p3 through the first output terminal to an input terminal of the third demultiplexer 963. Given that the destination of the fourth packet p3 is set to the first network router 712(1), the fourth packet p3 corresponds to an all-gather pass packet. Accordingly, the third demultiplexer 963 transmits the fourth packet p3 through the first output terminal to both the second scratch-pad and the send buffer 941 of the buffer circuit 940. The send buffer 941 then transmits the fourth packet p3 to the sender buffer 921 of the sender 920.

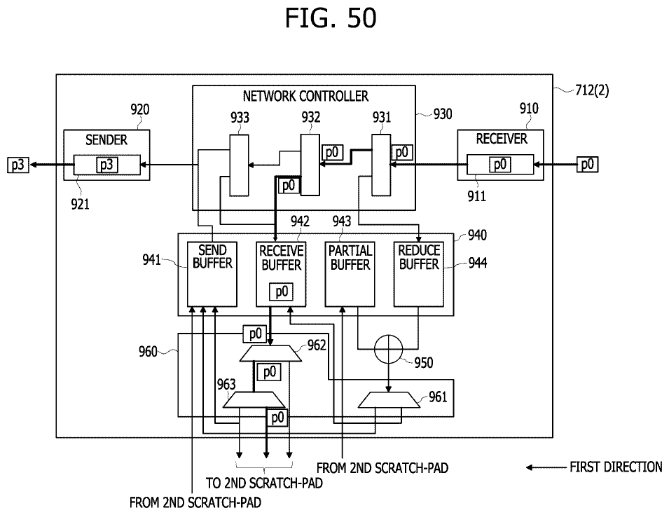

FIG. 50 is a diagram illustrating the operation of a second network router in a fourth step of the all-gather operation shown in FIG. 47B. The explanation provided for the operation of the second network router 712(2) in this example may also be equally applied to the operations of the first, third, and fourth network routers 712(1), 712(3), and 712(4), respectively, during the fourth step of the all-gather operation.

Referring to FIG. 50 in conjunction with FIG. 47B, in the fourth step (STEP 4) of the all-gather operation, the second network router 712(2) transmits the fourth packet p3, which is stored in the sender buffer 921 of the sender 920, to the first network router 712(1) in the first direction, and receives the first packet p0 from the third network router 712(3) in the same direction. As previously described with reference to FIGS. 49A and 49B, the fourth packet p3 is stored in the sender buffer 921 of the sender 920 within the second network router 712(2) during the third step (STEP 3) of the all-gather operation. The sender 920 of the second network router 712(2) outputs the fourth packet p3 stored in the sender buffer 921 and transmits the packet to the first network router 712(1) along the first direction.

Meanwhile, as the first packet p0 is transmitted from the third network router 712(3) along the first direction, the receiver 910 of the second network router 712(2) stores the first packet p0 in the receiver buffer 911. The receiver 910 transmits the first packet p0 to the input terminal of the first packet transmission circuit 931 of the network controller 930. Since the first packet p0 is an all-gather packet, the first packet transmission circuit 931 transmits the first packet p0 through the first output terminal to the input terminal of the second packet transmission circuit 932. The second packet transmission circuit 932 transmits the first packet p0 through the second output terminal to the receive buffer 942 of the buffer circuit 940. Although not explicitly illustrated in the drawing, when the first packet p0 is transferred to the receive buffer 942, the network controller 930 of the second network router 712(2) transmits a receive command to the receive buffer 942.

The receive buffer 942, in response to a receive command, transmits the first packet p0 to an input terminal of the second demultiplexer 962. Since the first packet p0 is classified as an all-gather packet, the second demultiplexer 962 transmits the first packet p0 through the first output terminal to an input terminal of the third demultiplexer 963. Because the destination of the first packet p0 is set to the second network router 712(2), the first packet p0 corresponds to an all-gather target packet. Accordingly, the third demultiplexer 963 transmits the first packet p0 through the second output terminal to the second scratch-pad.

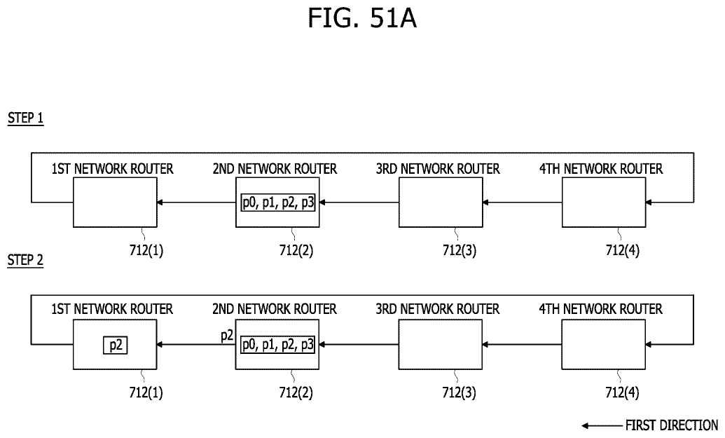

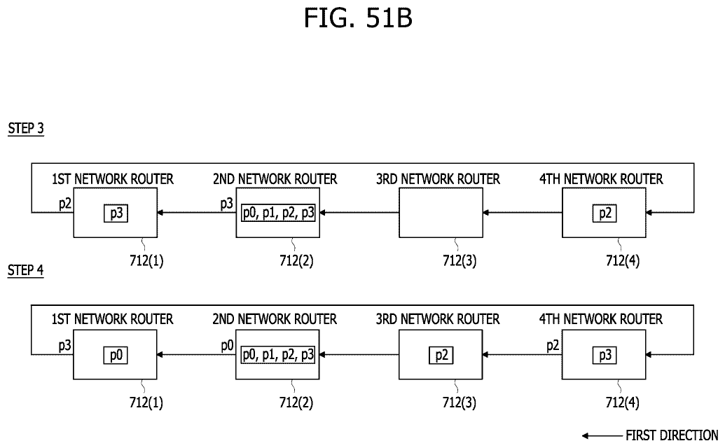

FIGS. 51A and 51B are diagrams illustrating a scatter operation in the accelerator system of FIG. 40 including the network router of FIG. 42.

Referring to FIG. 51A, in a first step (STEP 1) of a scatter operation, a second scratch-pad coupled to a second network router 712(2) stores a first packet p0, a second packet p1, a third packet p2, and a fourth packet p3. It is assumed that a first scratch-pad coupled to a first network router 712(1), a third scratch-pad coupled to a third network router 712(3), and a fourth scratch-pad coupled to a fourth network router 712(4) do not store the first packet p0, the third packet p2, or the fourth packet p3, respectively. The scatter operation may be performed such that the first packet p0, the third packet p2, and the fourth packet p3 stored in the second scratch-pad are distributed and stored respectively in the first scratch-pad, the third scratch-pad, and the fourth scratch-pad. During the scatter operation, the packet type of a packet transmitted between the network routers is set as a transmission packet. Depending on the destination setting, the scatter packet may be handled either as a transmission pass packet or a transmission target packet.

In a second step (STEP 2) of the scatter operation, the second network router 712(2) transmits a third packet p2, stored in the second scratch-pad, in a first direction to the first network router 712(1). A destination of the third packet p2 is set to a third network router 712(3) that is coupled to a third scratch-pad in which the third packet p2 is to be stored. Accordingly, the first network router 712(1) processes the third packet p2, received from the second network router 712(2), as a transmission pass packet. That is, the first network router 712(1) stores the third packet p2 in a send buffer of a sender included in the first network router 712(1). This process may be performed in the same manner as the process in which the third network router 712(3) handles a fourth packet p3 as a transmission pass packet, as previously described with reference to FIGS. 45A and 45B.

Referring to FIG. 51B, in a third step (STEP 3) of the scatter operation, the first network router 712(1) transmits a third packet p2, stored in a send buffer of a sender, in a first direction to the fourth network router 712(4). The second network router 712(2) transmits a fourth packet p3, stored in a second scratch-pad, in the first direction to the first network router 712(1). A destination of the fourth packet p3 is set to the fourth network router 712(4), which is coupled to a fourth scratch-pad in which the fourth packet p3 is to be stored. Since a destination of the third packet p2, transmitted from the first network router 712(1), is set to the third network router 712(3), the fourth network router 712(4) processes the third packet p2, received from the first network router 712(1), as a transmission pass packet. That is, the fourth network router 712(4) stores the third packet p2 in a send buffer of a sender included in the fourth network router 712(4). This process may also be performed in the same manner as the process in which the third network router 712(3) handles the fourth packet p3 as a transmission pass packet, as previously described with reference to FIGS. 45A and 45B. Since a destination of the fourth packet p3, transmitted from the second network router 712(2) to the first network router 712(1), is set to the fourth network router 712(4), the first network router 712(1) processes the fourth packet p3, received from the second network router 712(2), as a transmission pass packet. That is, the first network router 712(1) stores the fourth packet p3 in a send buffer of a sender included in the fourth network router 712(4). This process may also be performed in the same manner as the process in which the third network router 712(3) handles the fourth packet p3 as a transmission pass packet, as previously described with reference to FIGS. 45A and 45B.

In a fourth step (STEP 4) of the scatter operation, the first network router 712(1) transmits a fourth packet p3, stored in a send buffer of a sender, in a first direction to the fourth network router 712(4). The second network router 712(2) transmits a first packet p0, stored in a second scratch-pad, in the first direction to the first network router 712(1). The fourth network router 712(4) transmits a third packet p2, stored in a send buffer of a sender, in the first direction to the third network router 712(3). A destination of the first packet p0, transmitted from the second network router 712(2) to the first network router 712(1), is set to the first network router 712(1), which is coupled to a first scratch-pad where the first packet p0 is to be stored.

Since the destination of the fourth packet p3, transmitted from the first network router 712(1) to the fourth network router 712(4), is set to the fourth network router 712(4), the fourth network router 712(4) processes the fourth packet p3, transmitted from the first network router 712(1), as a transmission target packet. That is, the fourth network router 712(4) transmits the fourth packet p3 to a fourth scratch-pad. This process may be performed in the same manner as the process described with reference to FIG. 46, in which the second network router 712(2) processes the third packet p2 as a transmission target packet.

Similarly, since the destination of the third packet p2, transmitted from the fourth network router 712(4) to the third network router 712(3), is set to the third network router 712(3), the third network router 712(3) processes the third packet p2, transmitted from the fourth network router 712(4), as a transmission target packet. That is, the third network router 712(3) transmits the third packet p2 to a third scratch-pad. This process may also be performed in the same manner as the process described with reference to FIG. 46, in which the second network router 712(2) processes the third packet p2 as a transmission target packet.

Similarly, since the destination of the first packet p0, transmitted from the second network router 712(2) to the first network router 712(1), is set to the first network router 712(1), the first network router 712(1) processes the first packet p0, transmitted from the second network router 712(2), as a transmission target packet. That is, the first network router 712(1) transmits the first packet p0 to a first scratch-pad. This process may also be performed in the same manner as the process described with reference to FIG. 46, in which the second network router 712(2) processes the third packet p2 as a transmission target packet.

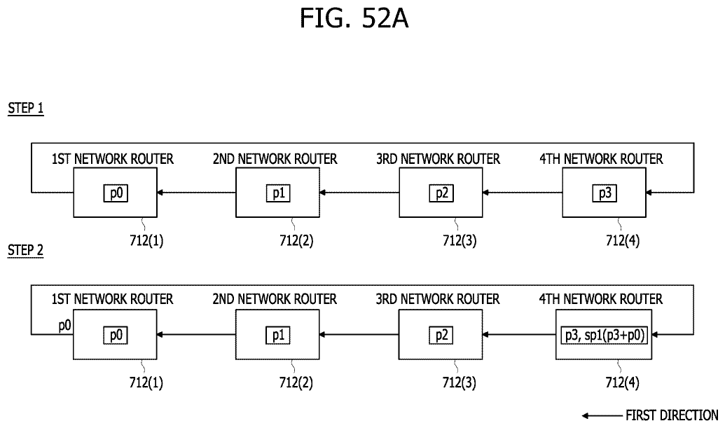

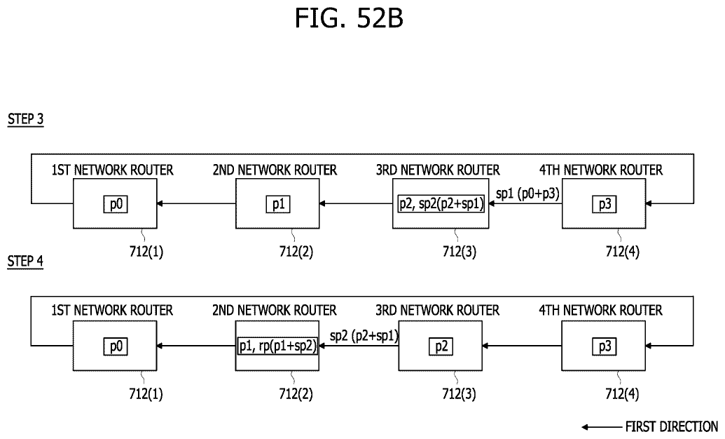

FIGS. 52A and 52B are diagrams illustrating a reduce operation in the accelerator system of FIG. 40 including the network router of FIG. 42.

Referring to FIG. 52A, in a first step (STEP 1) of a reduce operation, it is assumed that a first packet p0 is stored in a first scratch-pad coupled to a first network router 712(1), a second packet p1 is stored in a second scratch-pad coupled to a second network router 712(2), a third packet p2 is stored in a third scratch-pad coupled to a third network router 712(3), and a fourth packet p3 is stored in a fourth scratch-pad coupled to a fourth network router 712(4). In the reduce operation process, the packet type of each packet transmitted among network routers and used as an operand in a reduce operation is set as a reduce packet. Accordingly, a partial sum packet generated during the reduce operation process is also set as a reduce packet in terms of packet type. In the reduce operation process, a final result packet of the reduce operation is set as a transmission packet in terms of packet type. Depending on the destination configuration, a reduce packet or a partial sum packet may be processed as a reduce pass packet or a reduce target packet. In addition, a reduce result packet may be processed as a reduce result pass packet or a reduce result target packet.

In a second step (STEP 2) of the reduce operation, the first network router 712(1) transmits a first packet p0, stored in a first scratch-pad, in a first direction toward a fourth network router 712(4). A destination of the first packet p0 is set to the second network router 712(2), which is coupled to a second scratch-pad in which a reduce result packet is to be stored. The fourth network router 712(4) processes the first packet p0 as a reduce pass packet. Specifically, the fourth network router 712(4) performs a reduce operation, such as an addition operation, on the first packet p0 received from the first network router 712(1) and a fourth packet p3 stored in the fourth scratch-pad, thereby generating a first partial sum packet sp1. Since the first packet p0 is classified as a reduce pass packet, the fourth network router 712(4) processes the first partial sum packet sp1 also as a reduce pass packet. That is, the fourth network router 712(4) stores the first partial sum packet sp1 in a send buffer of a sender provided in the fourth network router 712(4).

Referring to FIG. 52B, in a third step (STEP 3) of the reduce operation, the fourth network router 712(4) transmits a first partial sum packet sp1, which was generated in the second step (STEP 2) and stored in a send buffer of a sender, in a first direction to the third network router 712(3). The third network router 712(3) performs an addition operation between a third packet p2 stored in a third scratch-pad and the first partial sum packet sp1 received from the fourth network router 712(4), thereby generating a second partial sum packet sp2. Since the first partial sum packet sp1 is classified as a reduce pass packet, the third network router 712(3) processes the second partial sum packet sp2 also as a reduce pass packet. That is, the third network router 712(3) stores the second partial sum packet sp2 in a send buffer of a sender provided in the third network router 712(3).

In a fourth step (STEP 4) of the reduce operation, the third network router 712(3) transmits the second partial sum packet sp2, which was generated in the third step (STEP 3) and stored in the send buffer of the sender, in the first direction to the second network router 712(2). The second network router 712(2) performs an addition operation between a second packet p1 stored in a second scratch-pad and the second partial sum packet sp2 received from the third network router 712(3), thereby generating a reduce result packet rp. Given that the first partial sum packet sp1 represents a summation of the first packet p0 and the fourth packet p3, and that the second partial sum packet sp2 represents a summation of the third packet p2 and the intermediate result, the reduce result packet rp becomes a final result of summing the first packet p0, the second packet p1, the third packet p2, and the fourth packet p3. Since a destination of the second partial sum packet sp2 is set to the second network router 712(2), the second network router 712(2) processes the reduce result packet rp as a reduce result target packet, i.e., a transmission target packet. That is, the second network router 712(2) transfers the reduce result packet rp to the second scratch-pad.

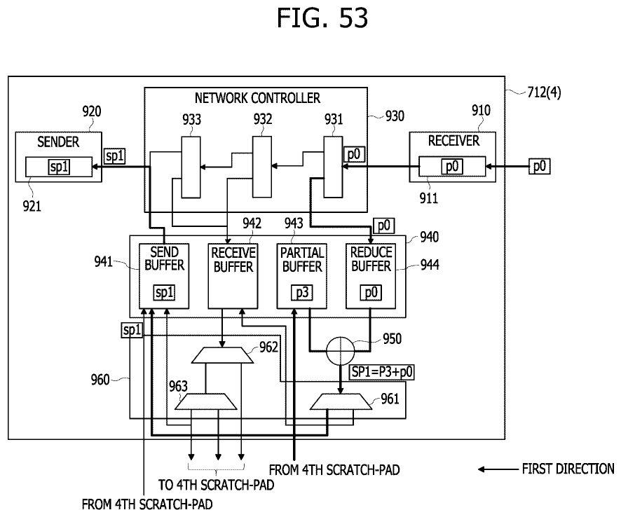

FIG. 53 is a diagram illustrating the operation of a fourth network router in a second step of the reduce operation shown in FIG. 52A.

Referring to FIG. 53 in conjunction with FIG. 52A, the fourth network router 712(4) receives a first packet p0 from the first network router 712(1) in a first direction. As previously described with reference to FIG. 52A, a destination of the first packet p0 is set to the second network router 712(2). Accordingly, the fourth network router 712(4) processes the first packet p0 as a reduce pass packet. Specifically, the fourth network router 712(4) stores the first packet p0 received from the first network router 712(1) in a receiver buffer 911 of a receiver 910. The receiver 910 of the fourth network router 712(4) outputs the first packet p0 stored in the receiver buffer 911 and transmits the first packet p0 to an input terminal of a first packet transmission circuit 931 included in a network controller 930. Since the first packet p0 is a reduce packet, the first packet transmission circuit 931 outputs the first packet p0 through a second output terminal and transmits the first packet p0 to a reduce buffer 944 of a buffer circuit 940.

As the first packet p0 is transferred to the reduce buffer 944, the fourth network router 712(4) transfers a fourth packet p3, which is used as an operand of the reduce operation along with the first packet p0, from the fourth scratch-pad to a partial buffer 943 of a buffer circuit 940. The partial buffer 943 transmits the fourth packet p3 to a first input terminal of a reduce operation circuit 950, and the reduce buffer 944 transmits the first packet p0 to a second input terminal of the reduce operation circuit 950. The reduce operation circuit 950 performs a reduce operation, specifically an addition operation, on the fourth packet p3 and the first packet p0, and generates a first partial sum packet sp1, wherein sp1=p3+p0.

The reduce operation circuit 950 outputs the first partial sum packet sp1 and transmits it to an input terminal of a first demultiplexer 961 of a selective output circuit 960. Since the destination of the first packet p0 is set to the second network router 712(2), the destination of the first partial sum packet sp1 is also set to the second network router 712(2). Accordingly, the fourth network router 712(4) processes the first partial sum packet sp1 as a partial sum pass packet. That is, the first demultiplexer 961 transmits the first partial sum packet sp1 to a send buffer 941 of the buffer circuit 940 via a first output terminal. The send buffer 941 transmits the first partial sum packet sp1 to a sender buffer 921 of a sender 920.

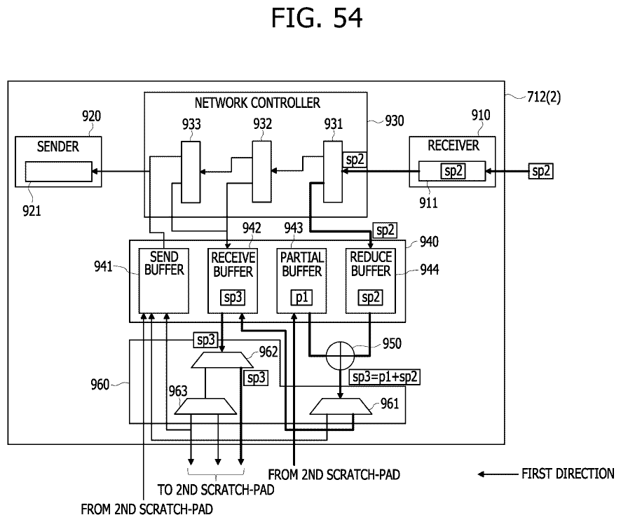

FIG. 54 is a diagram illustrating the operation of a second network router in a fourth step of the reduce operation shown in FIG. 52B.

Referring to FIG. 54 in conjunction with FIG. 52B, a second network router 712(2) receives a second partial sum packet sp2 from a third network router 712(3) in a first direction. The second network router 712(2) stores the received second partial sum packet sp2 from the third network router 712(3) in a receiver buffer 911 of a receiver 910. The receiver 910 of the second network router 712(2) outputs the second partial sum packet sp2 stored in the receiver buffer 911 and transfers it to an input terminal of a first packet transmission circuit 931 of a network controller 930. Since the second partial sum packet sp2 is a reduce packet, the first packet transmission circuit 931 transmits the second partial sum packet sp2 via a second output terminal to a reduce buffer 944 of a buffer circuit 940.

As the second partial sum packet sp2 is transferred to the reduce buffer 944, the second network router 712(2) transfers a second packet p1, which is to be used as an operand in a reduce operation together with the second partial sum packet sp2, from a second scratch-pad to a partial buffer 943 of a buffer circuit 940. The partial buffer 943 transfers the second packet p1 to a first input terminal of a reduce operation circuit 950, and the reduce buffer 944 transfers the second partial sum packet sp2 to a second input terminal of the reduce operation circuit 950. The reduce operation circuit 950 performs a reduce operation, specifically an addition operation, on the second packet p1 and the second partial sum packet sp2, thereby generating a reduce result packet sp3=p1+sp2.

The reduce operation circuit 950 outputs the reduce result packet sp3 and transmits it to an input terminal of a first demultiplexer 961 of a selective output circuit 960. As previously described with reference to FIG. 52B, the destination of the second partial sum packet sp2 is set to the second network router 712(2). Accordingly, the second network router 712(2) processes the reduce result packet sp3 as a reduce result target packet. That is, the first demultiplexer 961 transmits the reduce result packet sp3 to a receive buffer 942 of the buffer circuit 940 through a second output terminal. The receive buffer 942 transmits the reduce result packet sp3 to an input terminal of a second demultiplexer 962 of the selective output circuit 960. The second demultiplexer 962 outputs the reduce result packet sp3 through a second output terminal and transfers it to the second scratch-pad.

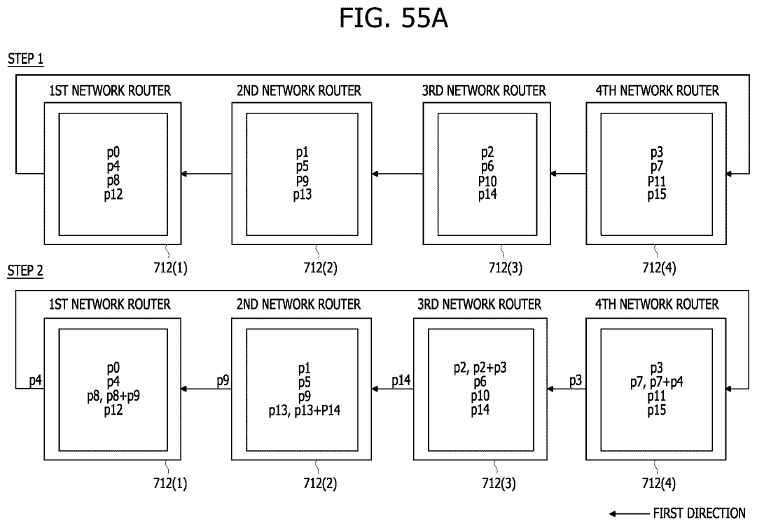

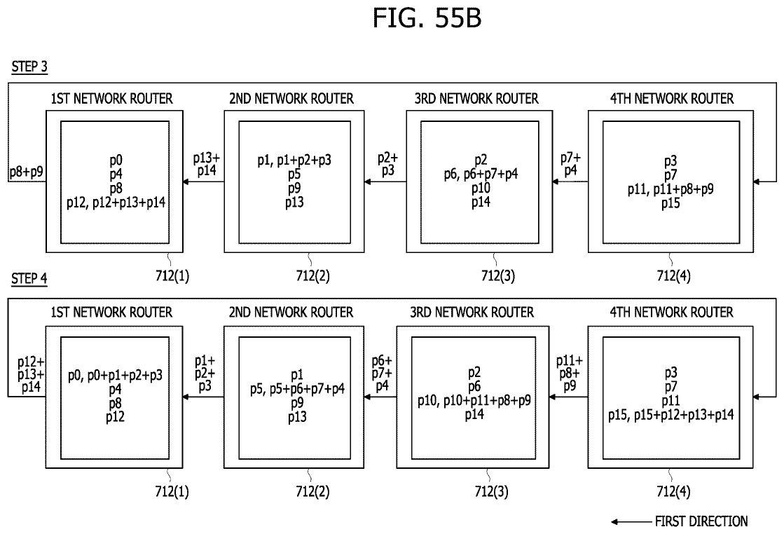

FIGS. 55A and 55B are diagrams illustrating a reduce-scatter operation in the accelerator system of FIG. 40 including the network router of FIG. 42.

Referring to FIG. 55A, in the first step (STEP 1) of a reduce-scatter operation, a first group of packets, p0, p4, p8, and p12, is stored in a first scratch-pad coupled to a first network router 712-1. A second group of packets, p1, p5, p9, and p13, is stored in a second scratch-pad coupled to a second network router 712-2. A third group of packets, p2, p6, p10, and p14, is stored in a third scratch-pad coupled to a third network router 712-3. A fourth group of packets, p3, p7, p11, and p15, is stored in a fourth scratch-pad coupled to a fourth network router 712-4. In one example, the first group of packets, p0, p4, p8, and p12, may correspond to the elements of rows one through four of a first input vector. The second group of packets, p1, p5, p9, and p13, may correspond to the elements of rows one through four of a second input vector. The third group of packets, p2, p6, p10, and p14, may correspond to the elements of rows one through four of a third input vector. The fourth group of packets, p3, p7, p11, and p15, may correspond to the elements of rows one through four of a fourth input vector.

In this example, the reduce-scatter operation is performed such that the first reduce result packet, corresponding to the elements of the first row of the first through fourth input vectors p0, p1, p2, and p3, is p0+p1+p2+p3, and the result is returned to the first network router 712(1). The second reduce result packet, corresponding to the elements of the second row of the first through fourth input vectors p4, p5, p6, and p7, is p5+p6+p7+p4, and the result is returned to the second network router 712(2). The third reduce result packet, corresponding to the elements of the third row of the first through fourth input vectors p8, p9, p10, and p11, is p10+p11+p8+p9, and the result is returned to the third network router 712(3). The fourth reduce result packet, corresponding to the elements of the fourth row of the first through fourth input vectors p12, p13, p14, and p15, is p15+p12+p13+p14, and the result is returned to the fourth network router 712(4).

During the reduce-scatter operation, packets transmitted among the network routers and used for the reduce operation are designated as reduce packets. A reduce-scatter result packet is designated as a transmission packet. Partial sum packets generated through the reduce operation performed during the reduce-scatter operation are designated as reduce packets. Depending on the destination setting, a reduce packet may be treated as a reduce pass packet or a reduce target packet. A reduce-scatter result packet may be treated as a transmission pass packet or a transmission target packet.

In the second step (STEP 2) of the reduce-scatter operation, the first network router 712(1) receives the tenth packet p9 from the second network router 712(2) along the first direction. The second network router 712(2) receives the fifteenth packet p14 from the third network router 712(3) along the first direction. The third network router 712(3) receives the fourth packet p3 from the fourth network router 712(4) along the first direction. The fourth network router 712(4) receives the fifth packet p4 from the first network router 712(1) along the first direction.

The destination of each packet is set to the network router that is nearest in the direction opposite to the packet transmission direction, which is the first direction. Accordingly, the destination of the fifth packet p4, transmitted from the first network router 712(1) along the first direction, is set to the second network router 712(2). The destination of the tenth packet p9, transmitted from the second network router 712(2) along the first direction, is set to the third network router 712(3). The destination of the fifteenth packet p14, transmitted from the third network router 712(3) along the first direction, is set to the fourth network router 712(4). The destination of the fourth packet p3, transmitted from the fourth network router 712(4) along the first direction, is set to the first network router 712(1).

The first network router 712(1) performs a reduce operation, for example, an addition operation, on the ninth packet p8 stored in the first scratch-pad and the tenth packet p9 received from the second network router 712(2), and generates a first partial sum packet p8+p9. Since the destination of the tenth packet p9 is set to the third network router 712(3), the destination of the first partial sum packet p8+p9 is also set to the third network router 712(3). Accordingly, the first network router 712(1) processes the first partial sum packet p8+p9 as a reduce pass packet. That is, the first network router 712(1) stores the first partial sum packet p8+p9 in the send buffer of the sender of the first network router 712(1).

The second network router 712(2) performs an addition operation on the fourteenth packet p13 stored in the second scratch-pad and the fifteenth packet p14 received from the third network router 712(3), and generates a second partial sum packet p13+p14. Since the destination of the fifteenth packet p14 is set to the fourth network router 712(4), the destination of the second partial sum packet p13+p14 is also set to the fourth network router 712(4). Accordingly, the second network router 712(2) processes the second partial sum packet p13+p14 as a reduce pass packet. That is, the second network router 712(2) stores the second partial sum packet p13+p14 in the send buffer of the sender of the second network router 712(2).

The third network router 712(3) performs an addition operation on the third packet p2 stored in the third scratch-pad and the fourth packet p3 received from the fourth network router 712(4), and generates a third partial sum packet p2+p3. Since the destination of the fourth packet p3 is set to the first network router 712(1), the destination of the third partial sum packet p2+p3 is also set to the first network router 712(1). Accordingly, the third network router 712(3) processes the third partial sum packet p2+p3 as a reduce pass packet. That is, the third network router 712(3) stores the third partial sum packet p2+p3 in the send buffer of the sender of the third network router 712(3).

The fourth network router 712(4) performs a reduce operation, specifically an addition operation, on the eighth packet p7 stored in the fourth scratch-pad and the fifth packet p4 received from the first network router 712(1), and generates a fourth partial sum packet p7+p4. Since the destination of the fifth packet p4 is set to the second network router 712(2), the destination of the fourth partial sum packet p7+p4 is also set to the second network router 712(2). Accordingly, the fourth network router 712(4) processes the fourth partial sum packet p7+p4 as a reduce pass packet. That is, the fourth network router 712(4) stores the fourth partial sum packet p7+p4 in the send buffer of the sender of the fourth network router 712(4).

Referring to FIG. 55B, in the third step (STEP 3) of the reduce-scatter operation, the first network router 712(1) receives the second partial sum packet p13+p14 from the second network router 712(2) in the first direction. The second network router 712(2) receives the third partial sum packet p2+p3 from the third network router 712(3) in the first direction. The third network router 712(3) receives the fourth partial sum packet p7+p4 from the fourth network router 712(4) in the first direction. The fourth network router 712(4) receives the first partial sum packet p8+p9 from the first network router 712(1) in the first direction.

The first network router 712(1) performs an addition operation between the thirteenth packet p12 stored in the first scratch-pad and the second partial sum packet p13+p14 received from the second network router 712(2), thereby generating a fifth partial sum packet p12+p13+p14. Since the destination of the second partial sum packet p13+p14 is set to the fourth network router 712(4), the fifth partial sum packet p12+p13+p14 also has the fourth network router 712(4) as its destination. Accordingly, the first network router 712(1) processes the fifth partial sum packet p12+p13+p14 as a reduce pass packet. That is, the first network router 712(1) stores the fifth partial sum packet p12+p13+p14 in the send buffer of the sender.

The second network router 712(2) performs an addition operation between the second packet p1 stored in the second scratch-pad and the third partial sum packet p2+p3 received from the third network router 712(3), thereby generating a sixth partial sum packet p1+p2+p3. Since the destination of the third partial sum packet p2+p3 is set to the first network router 712(1), the sixth partial sum packet p1+p2+p3 also has the first network router 712(1) as its destination. Accordingly, the second network router 712(2) processes the sixth partial sum packet p1+p2+p3 as a reduce pass packet. That is, the second network router 712(2) stores the sixth partial sum packet p1+p2+p3 in the send buffer of the sender.

The third network router 712(3) performs an addition operation between the seventh packet p6 stored in the third scratch-pad and the fourth partial sum packet p7+p4 received from the fourth network router 712(4), thereby generating a seventh partial sum packet p6+p7+p4. Since the destination of the fourth partial sum packet p7+p4 is set to the second network router 712(2), the seventh partial sum packet p6+p7+p4 also has the second network router 712(2) as its destination. Accordingly, the third network router 712(3) processes the seventh partial sum packet p6+p7+p4 as a reduce pass packet. That is, the third network router 712(3) stores the seventh partial sum packet p6+p7+p4 in the send buffer of the sender.

The fourth network router 712(4) performs an addition operation between the twelfth packet p11 stored in the fourth scratch-pad and the first partial sum packet p8+p9 received from the first network router 712(1), thereby generating an eighth partial sum packet p11+p8+p9. Since the destination of the first partial sum packet p8+p9 is set to the third network router 712(3), the eighth partial sum packet p11+p8+p9 also has the third network router 712(3) as its destination. Accordingly, the fourth network router 712(4) processes the eighth partial sum packet p11+p8+p9 as a reduce pass packet. That is, the fourth network router 712(4) stores the eighth partial sum packet p11+p8+p9 in the send buffer of the sender.

In a fourth step (STEP 4) of the reduce-scatter operation, the first network router 712(1) receives, in a first direction, a sixth partial sum packet p1+p2+p3 from the second network router 712(2). The second network router 712(2) receives, in the first direction, a seventh partial sum packet p6+p4+p7 from the third network router 712(3). The third network router 712(3) receives, in the first direction, an eighth partial sum packet p11+p8+p9 from the fourth network router 712(4). Additionally, the fourth network router 712(4) receives, in the first direction, a fifth partial sum packet p12+p13+p14 from the first network router 712(1).

The first network router 712(1) performs an addition operation on a first packet p0 stored in the first scratch-pad and a sixth partial sum packet p1+p2+p3 received from the second network router 712(2), and generates a first reduce result packet p0+p1+p2+p3. Since the sixth partial sum packet p1+p2+p3 has the first network router 712(1) designated as the destination, the first reduce result packet p0+p1+p2+p3 also has the first network router 712(1) designated as the destination. Accordingly, the first network router 712(1) processes the first reduce result packet p0+p1+p2+p3 as a transmission target packet. That is, the first network router 712(1) transmits the first reduce result packet p0+p1+p2+p3 to the first scratch-pad.

The second network router 712(2) performs an addition operation on the sixth packet p5 stored in the second scratch-pad and the seventh partial sum packet p6+p4+p7 received from the third network router 712(3), and generates the second reduce result packet p5+p6+p4+p7. Since the seventh partial sum packet p6+p4+p7 has the second network router 712(2) designated as the destination, the second reduce result packet p5+p6+p4+p7 also has the second network router 712(2) designated as the destination. Accordingly, the second network router 712(2) processes the second reduce result packet p5+p6+p4+p7 as a transmission target packet. That is, the second network router 712(2) transmits the second reduce result packet p5+p6+p4+p7 to the second scratch-pad.

The third network router 712(3) performs an addition operation on the eleventh packet p10 stored in the third scratch-pad and the eighth partial sum packet p11+p8+p9 received from the fourth network router 712(4), and generates the third reduce result packet p10+p11+p8+p9. Since the destination of the eighth partial sum packet p11+p8+p9 is set to the third network router 712(3), the third reduce result packet p10+p11+p8+p9 is also designated for the third network router 712(3). Accordingly, the third network router 712(3) processes the third reduce result packet p10+p11+p8+p9 as a transmission target packet. That is, the third network router 712(3) transmits the third reduce result packet p10+p11+p8+p9 to the third scratch-pad.

The fourth network router 712(4) performs an addition operation on the sixteenth packet p15 stored in the fourth scratch-pad and the fifth partial sum packet p12+p13+p14 received from the first network router 712(1), and generates the fourth reduce result packet p15+p12+p13+p14. Since the destination of the fifth partial sum packet p12+p13+p14 is set to the fourth network router 712(4), the fourth reduce result packet p15+p12+p13+p14 is also designated for the fourth network router 712(4). Accordingly, the fourth network router 712(4) processes the fourth reduce result packet p15+p12+p13+p14 as a transmission target packet. That is, the fourth network router 712(4) transmits the fourth reduce result packet p15+p12+p13+p14 to the fourth scratch-pad.

When the above steps are performed, the first reduce result packet p0+p1+p2+p3, which is the result of the reduce operation on the first through fourth packets p0, p1, p2, and p3 corresponding to the first row elements of the first through fourth input vectors, is returned to the first scratch-pad coupled to the first network router 712(1). The second reduce result packet p5+p6+p4+p7, which is the result of the reduce operation on the fifth through cighth packets p4, p5, p6, and p7 corresponding to the second row elements of the first through fourth input vectors, is returned to the second scratch-pad coupled to the second network router 712(2). The third reduce result packet p10+p11+p8+p9, which is the result of the reduce operation on the ninth through twelfth packets p8, p9, p10, and p11 corresponding to the third row elements of the first through fourth input vectors, is returned to the third scratch-pad coupled to the third network router 712(3). The fourth reduce result packet p15+p12+p13+p14, which is the result of the reduce operation on the thirteenth through sixteenth packets p12, p13, p14, and p15 corresponding to the fourth row elements of the first through fourth input vectors, is returned to the fourth scratch-pad coupled to the fourth network router 712(4).

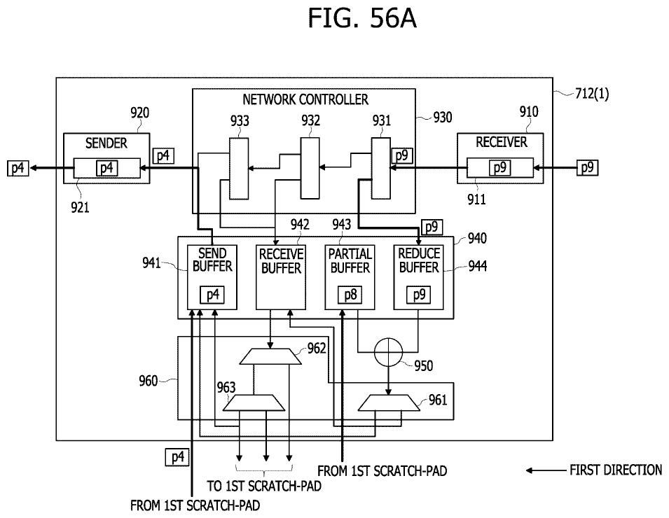

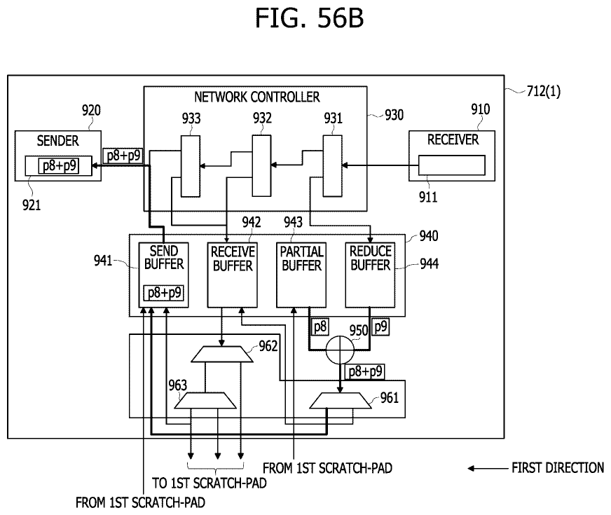

FIGS. 56A and 56B are diagrams illustrating the operation of a first network router in a second step of the reduce-scatter operation shown in FIG. 55A.

Referring to FIG. 56A together with FIG. 55A, in a second step (STEP 2) of the reduce-scatter operation, the first network router 712(1) transmits a fifth packet p4, which is stored in the first scratch-pad, in a first direction to the fourth network router 712(4), and also receives a tenth packet p9 in the first direction from the second network router 712(2). For transmission of the fifth packet p4 to the fourth network router 712(4), the first network router 712(1) reads the fifth packet p4 from the first scratch-pad and stores it in a send buffer 941 of a buffer circuit 940. The first network router 712(1) transmits the fifth packet p4 stored in the send buffer 941 to a sender buffer 921 of a sender 920. The sender 920 outputs the fifth packet p4 stored in the sender buffer 921 in the first direction, and transmits the packet to the fourth network router 712(4). As described with reference to FIG. 55A, a destination of the fifth packet p4 transmitted from the first network router 712(1) is set to the second network router 712(2).

Meanwhile, as the tenth packet p9 is transmitted from the second network router 712(2) in the first direction, the first network router 712(1) stores the tenth packet p9 transmitted from the second network router 712(2) in a receiver buffer 911 of a receiver 910. The receiver 910 transmits the tenth packet p9 stored in the receiver buffer 911 to an input terminal of a first packet transmission circuit 931 of a network controller 930. Since the tenth packet p9 is a reduce packet, the first packet transmission circuit 931 transmits the tenth packet p9 through a second output terminal to a reduce buffer 944 of the buffer circuit 940. With the tenth packet p9 being transmitted to the reduce buffer 944, the first network router 712(1) transmits an eighth packet p8, which is used as an operand together with the tenth packet p9 for a reduce operation, from the first scratch-pad to a partial buffer 943 of the buffer circuit 940.

Referring to FIG. 56B together with FIG. 55A, the partial buffer 943 transmits a ninth packet p8 to a first input terminal of a reduce operation circuit 950, and the reduce buffer 944 transmits a tenth packet p9 to a second input terminal of the reduce operation circuit 950. The reduce operation circuit 950 performs a reduce operation, namely, an addition operation, on the ninth packet p8 and the tenth packet p9 to generate a first partial sum packet p8+p9. The reduce operation circuit 950 outputs the first partial sum packet p8+p9 and transmits it to an input terminal of a first demultiplexer 961 of a selective output circuit 960. As described with reference to FIG. 55A, a destination of the tenth packet p9 is set to the third network router 712(3), and accordingly, the first partial sum packet p8+p9 is also set to have the third network router 712(3) as the destination. Therefore, the first network router 712(1) processes the first partial sum packet p8+p9 as a partial sum pass packet. Specifically, the first demultiplexer 961 of the first network router 712(1) transmits the first partial sum packet p8+p9 to a send buffer 941 of a buffer circuit 940 through a first output terminal. The send buffer 941 then transmits the first partial sum packet p8+p9 to a sender buffer 921 of a sender 920.

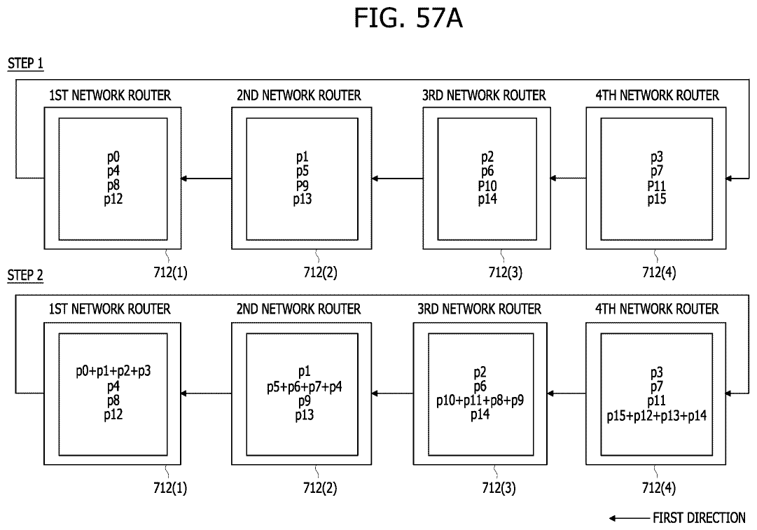

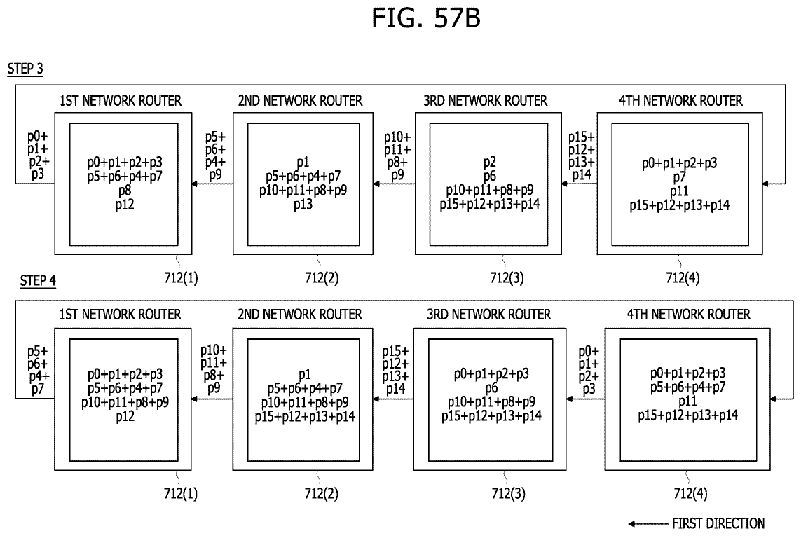

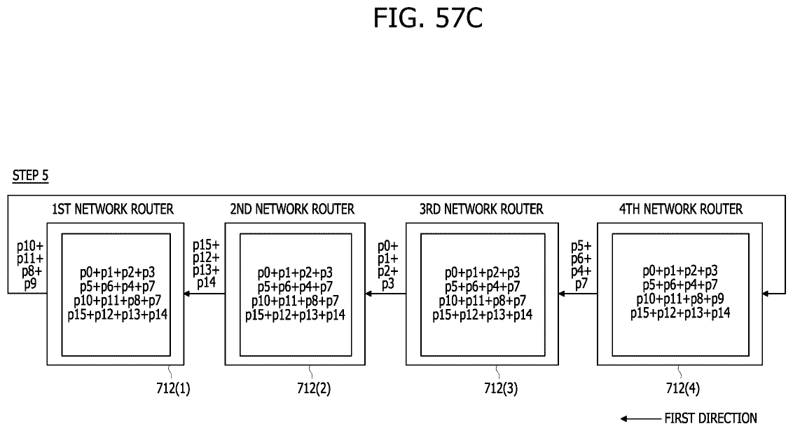

FIGS. 57A to 57C are diagrams illustrating an all-reduce operation in the accelerator system of FIG. 40 including the network router of FIG. 42.

Referring to FIG. 57A, in a first step (STEP 1) of an all-reduce operation, it is assumed that a first group of packets p0, p4, p8, and p12 is stored in a first scratch-pad coupled to a first network router 712(1); a second group of packets p1, p5, p9, and p13 is stored in a second scratch-pad coupled to a second network router 712(2); a third group of packets p2, p6, p10, and p14 is stored in a third scratch-pad coupled to a third network router 712(3); and a fourth group of packets p3, p7, p11, and p15 is stored in a fourth scratch-pad coupled to a fourth network router 712(4). In one embodiment, the first group of packets p0, p4, p8, and p12 may correspond to elements in first through fourth rows of a first input vector. The second group of packets p1, p5, p9, and p13 may correspond to elements in first through fourth rows of a second input vector. The third group of packets p2, p6, p10, and p14 may correspond to elements in first through fourth rows of a third input vector. The fourth group of packets p3, p7, p11, and p15 may correspond to elements in first through fourth rows of a fourth input vector.

The all-reduce operation may be performed by first executing a reduce-scatter operation and then aggregating the resulting packets across all network routers. Specifically, after performing the reduce-scatter operation such that each network router receives a corresponding reduce result packet, an all-gather operation is executed on the returned reduce result packets, so that all the reduce result packets are collected at each of the network routers. During the all-reduce operation, packets transmitted between the network routers and used in the reduce operation are classified as reduce packets. The packets generated as results of the all-reduce operation are classified as all-gather packets. Partial sum packets generated during the reduce operation are also classified as reduce packets. Depending on the destination setting, a reduce packet may be handled as either a reduce pass packet or a reduce target packet. Likewise, an all-reduce result packet may be processed either as an all-gather pass packet or an all-gather target packet.

In a second step (STEP 2) of the all-reduce operation, a reduce-scatter operation is performed in the same manner as described with reference to FIGS. 55A and 55B. Upon completion of the reduce-scatter operation, a first all-reduce result packet, representing the result of the reduce operation performed on the first through fourth packets p0, p1, p2, and p3, is stored in the first scratch-pad coupled to the first network router 712(1). A second all-reduce result packet, corresponding to the result of the reduce operation performed on the fifth through eighth packets p4, p5, p6, and p7, is stored in the second scratch-pad coupled to the second network router 712(2). A third all-reduce result packet, corresponding to the result of the reduce operation performed on the ninth through twelfth packets p8, p9, p10, and p11, is stored in the third scratch-pad coupled to the third network router 712(3). A fourth all-reduce result packet, corresponding to the result of the reduce operation performed on the thirteenth through sixteenth packets p12, p13, p14, and p15, is stored in the fourth scratch-pad coupled to the fourth network router 712(4).

In a third step (STEP 3) of the all-reduce operation, a first stage of an all-gather operation for the all-reduce result packets generated by the reduce-scatter operation is performed, as illustrated in FIG. 57B. Specifically, the first network router 712(1) transmits a first all-reduce result packet p0+p1+p2+p3 in a first direction to the fourth network router 712(4). The second network router 712(2) transmits a second all-reduce result packet p5+p6+p4+p7 in the first direction to the first network router 712(1). The third network router 712(3) transmits a third all-reduce result packet p10+p11+p8+p9 in the first direction to the second network router 712(2). The fourth network router 712(4) transmits a fourth all-reduce result packet p15+p12+p13+p14 in the first direction to the third network router 712(3).

The destination of each packet is set to the network router that is nearest in a direction opposite to the first direction from the network router that outputs the packet. Specifically, the destination of the first all-reduce result packet p0+p1+p2+p3 is set to the second network router 712(2). The destination of the second all-reduce result packet p5+p6+p4+p7 is set to the third network router 712(3). The destination of the third all-reduce result packet p10+p11+p8+p9 is set to the fourth network router 712(4). The destination of the fourth all-reduce result packet p15+p12+p13+p14 is set to the first network router 712(1).

The first network router 712(1) processes the second all-reduce result packet p5+p6+p4+p7, received from the second network router 712(2), as an all-gather pass packet. That is, the first network router 712(1) stores the second all-reduce result packet p5+p6+p4+p7 in the send buffer of the sender, and also transfers the second all-reduce result packet p5+p6+p4+p7 to the first scratch-pad. The second network router 712(2) processes the third all-reduce result packet p10+p11+p8+p9, received from the third network router 712(3), as an all-gather pass packet. That is, the second network router 712(2) stores the third all-reduce result packet p10+p11+p8+p9 in the send buffer of the sender, and also transfers the third all-reduce result packet p10+p11+p8+p9 to the second scratch-pad. The third network router 712(3) processes the fourth all-reduce result packet p15+p12+p13+p14, received from the fourth network router 712(4), as an all-gather pass packet. That is, the third network router 712(3) stores the fourth all-reduce result packet p15+p12+p13+p14 in the send buffer of the sender, and also transfers the fourth all-reduce result packet p15+p12+p13+p14 to the third scratch-pad. The fourth network router 712(4) processes the first all-reduce result packet p0+p1+p2+p3, received from the first network router 712(1), as an all-gather pass packet. That is, the fourth network router 712(4) stores the first all-reduce result packet p0+p1+p2+p3 in the send buffer of the sender, and also transfers the first all-reduce result packet p0+p1+p2+p3 to the fourth scratch-pad.

In a fourth step (STEP 4) of the all-reduce operation, a second phase of the all-gather operation is performed. Specifically, the first network router 712(1) transmits a second all-reduce result packet p5+p6+p4+p7 to the fourth network router 712(4) along the first direction. The second network router 712(2) transmits a third all-reduce result packet p10+p11+p8+p9 to the first network router 712(1) along the first direction. The third network router 712(3) transmits a fourth all-reduce result packet p15+p12+p13+p14 to the second network router 712(2) along the first direction. The fourth network router 712(4) transmits a first all-reduce result packet p0+p1+p2+p3 to the third network router 712(3) along the first direction.

Since the destination of the third all-reduce result packet p10+p11+p8+p9 is set to the fourth network router 712(4), the first network router 712(1) processes the third all-reduce result packet p10+p11+p8+p9 as an all-gather pass packet. Specifically, the first network router 712(1) stores the third all-reduce result packet p10+p11+p8+p9 in a send buffer of the sender and also transmits the packet to the first scratch-pad.

Since the destination of the fourth all-reduce result packet p15+p12+p13+p14 is set to the first network router 712(1), the second network router 712(2) processes the fourth all-reduce result packet p15+p12+p13+p14 as an all-gather pass packet. Specifically, the second network router 712(2) stores the fourth all-reduce result packet p15+p12+p13+p14 in a send buffer of the sender and also transmits the packet to the second scratch-pad.

Since the destination of the first all-reduce result packet p0+p1+p2+p3 is set to the second network router 712(2), the third network router 712(3) processes the first all-reduce result packet p0+p1+p2+p3 as an all-gather pass packet. Specifically, the third network router 712(3) stores the first all-reduce result packet p0+p1+p2+p3 in a send buffer of the sender and also transmits the packet to the third scratch-pad.

Since the destination of the second all-reduce result packet p5+p6+p4+p7 is set to the third network router 712(3), the fourth network router 712(4) processes the second all-reduce result packet p5+p6+p4+p7 as an all-gather pass packet. Specifically, the fourth network router 712(4) stores the second all-reduce result packet p5+p6+p4+p7 in a send buffer of the sender and also transmits the packet to the fourth scratch-pad.

Referring to FIG. 57C, in step 5 of the all-reduce operation, a third phase of the all-gather operation is performed. The first network router 712(1) transmits the third all-reduce result packet p10+p11+p8+p9 to the fourth network router 712(4) in the first direction. The second network router 712(2) transmits the fourth all-reduce result packet p15+p12+p13+p14 to the first network router 712(1) in the first direction. The third network router 712(3) transmits the first all-reduce result packet p0+p1+p2+p3 to the second network router 712(2) in the first direction. The fourth network router 712(4) transmits the second all-reduce result packet p5+p6+p4+p7 to the third network router 712(3) in the first direction.

Since the destination of the fourth all-reduce result packet p15+p12+p13+p14 is set to the first network router 712(1), the first network router 712(1) processes the fourth all-reduce result packet p15+p12+p13+p14 as an all-gather target packet. That is, the first network router 712(1) transmits the fourth all-reduce result packet p15+p12+p13+p14 to the first scratch-pad.

Since the destination of the first all-reduce result packet p0+p1+p2+p3 is set to the second network router 712(2), the second network router 712(2) processes the first all-reduce result packet p0+p1+p2+p3 as an all-gather target packet. That is, the second network router 712(2) transmits the first all-reduce result packet p0+p1+p2+p3 to the second scratch-pad.

Since the destination of the second all-reduce result packet p5+p6+p4+p7 is set to the third network router 712(3), the third network router 712(3) processes the second all-reduce result packet p5+p6+p4+p7 as an all-gather target packet. That is, the third network router 712(3) transmits the second all-reduce result packet p5+p6+p4+p7 to the third scratch-pad.

Since the destination of the third all-reduce result packet p10+p11+p8+p9 is set to the fourth network router 712(4), the fourth network router 712(4) processes the third all-reduce result packet p10+p11+p8+p9 as an all-gather target packet. That is, the fourth network router 712(4) transmits the third all-reduce result packet p10+p11+p8+p9 to the fourth scratch-pad.

As a result of performing the aforementioned steps, the first to fourth scratch-pads, which are coupled respectively to the first to fourth network routers 712(1), 712(2), 712(3), and 712(4), are brought into a state in which the first to fourth all-reduce result packets, which are the results of the reduce operation (i.e., addition operation) on the respective rows of the first to fourth input vectors, are stored. The operations of the first to fourth network routers 712(1), 712(2), 712(3), and 712(4) in the third step (STEP 3) of FIG. 57B are performed in the same manner as the operation of the second network router 712(2) described with reference to FIGS. 48A and 48B. The operations of the first to fourth network routers 712(1), 712(2), 712(3), and 712(4) in the fourth step (STEP 4) of FIG. 57B are performed in the same manner as the operation of the second network router 712(2) described with reference to FIGS. 49A and 49B. The operations of the first to fourth network routers 712(1), 712(2), 712(3), and 712(4) in the fifth step (STEP 5) of FIG. 57B are performed in the same manner as the operation of the second network router 712(2) described with reference to FIG. 50.

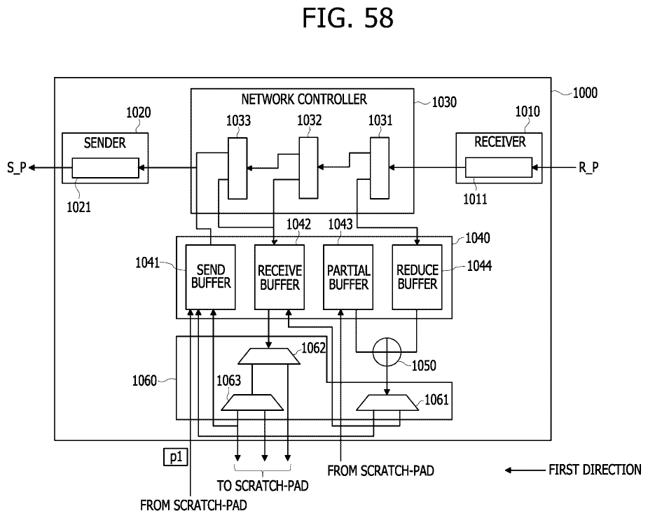

FIG. 58 is a block diagram illustrating another example of a network router according to the present disclosure. The description of the network router according to this example may be equally applied to the first to N-th network routers 712(1)-712(N) included in the accelerator system 700 of FIG. 40, as well as to the network router 820 included in the accelerator 800 of FIG. 41.

Referring to FIG. 58, a network router 1000 may include a receiver 1010, a sender 1020, a network controller 1030, a buffer circuit 1040, a reduce operation circuit 1050, and a selective output circuit 1060. The network controller 1030 may include a first packet transmission circuit 1031, a second packet transmission circuit 1032, and a third packet transmission circuit 1033. The buffer circuit 1040 may include a send buffer 1041, a receive buffer 1042, a partial buffer 1043, and a reduce buffer 1044. The selective output circuit 1060 may include a first demultiplexer 1061, a second demultiplexer 1062, and a third demultiplexer 1063. The receiver 1010, sender 1020, and reduce operation circuit 1050 of the network router 1000 may be configured in the same manner as the receiver 510, sender 520, and reduce operation circuit 550 of the network router 500 described with reference to FIG. 34. The partial buffer 1043 and the reduce buffer 1044 of the buffer circuit 1040 may also be configured identically to the partial buffer 543 and the reduce buffer 544 of the buffer circuit 540 included in the network router 500 of FIG. 34. In addition, the first demultiplexer 1061 of the selective output circuit 1060 may be configured in the same manner as the first demultiplexer 561 of the selective output circuit 560 included in the network router 500 described with reference to FIG. 34. Therefore, redundant explanations will be omitted below.

Each of the first packet transmission circuit 1031, the second packet transmission circuit 1032, and the third packet transmission circuit 1033 of the network controller 1030 may include one input terminal, a first output terminal, and a second output terminal. The input terminal of the first packet transmission circuit 1031 is coupled to an output terminal of a receive buffer 1011 of a receiver 1010. The first and second output terminals of the first packet transmission circuit 1031 are coupled to an input terminal of the second packet transmission circuit 1032 and to a reduce buffer 1044 of a buffer circuit 1040, respectively. The first and second output terminals of the second packet transmission circuit 1032 are coupled to an input terminal of the third packet transmission circuit 1033 and to a receive buffer 1042 of the buffer circuit 1040, respectively. The first and second output terminals of the third packet transmission circuit 1033 are coupled to a send buffer 1021 of a sender 1020 and to the receive buffer 1042 of the buffer circuit 1040, respectively.

The first packet transmission circuit 1031 may receive a receive packet R_P from the receive buffer 1011 via the input terminal. When a transfer packet, a broadcast packet, or an all-gather packet is input to the input terminal of the first packet transmission circuit 1031, the first packet transmission circuit 1031 transfers the transfer packet, the broadcast packet, or the all-gather packet to the input terminal of a second packet transmission circuit 1032 via the first output terminal. When a reduce packet is input to the input terminal of the first packet transmission circuit 1031, the first packet transmission circuit 1031 transfers the reduce packet to a reduce buffer 1044 of a buffer circuit 1040 via the second output terminal.

The second packet transmission circuit 1032 receives the transfer packet, the broadcast packet, or the all-gather packet from the first packet transmission circuit 1031. When a transfer packet is input to the input terminal of the second packet transmission circuit 1032, the second packet transmission circuit 1032 transfers the transfer packet to the input terminal of a third packet transmission circuit 1033 via the first output terminal. When a broadcast packet or an all-gather packet is input to the input terminal of the second packet transmission circuit 1032, the second packet transmission circuit 1032 transfers the broadcast packet or the all-gather packet to a receive buffer 1042 of the buffer circuit 1040 via the second output terminal.

The third packet transmission circuit 1033 receives the transfer packet from the second packet transmission circuit 1032. When a transfer pass packet is input to the input terminal of the third packet transmission circuit 1033, the third packet transmission circuit 1033 transfers the transfer pass packet to a send buffer 1021 of a sender 1020 via the first output terminal. When a transfer target packet is input to the input terminal of the third packet transmission circuit 1033, the third packet transmission circuit 1033 transfers the transfer target packet to the receive buffer 1042 of the buffer circuit 1040 via the second output terminal.

The send buffer 1041 of the buffer circuit 1040 may receive packets from a scratch-pad coupled to the network router 1000, from a first demultiplexer 1061, and from a third demultiplexer 1063 of a selective output circuit 1060. Specifically, the send buffer 1041 may receive and store a transfer packet, a broadcast packet, an all-gather packet, and a reduce packet from the scratch-pad, which are to be transmitted from the network router 1000 to another network router in a first direction. The send buffer 1041 may transmit the stored transfer packet, broadcast packet, all-gather packet, and reduce packet to a send buffer 1021 of a sender. The send buffer 1041 may also receive and store a partial sum pass packet, a reduce result pass packet, a reduce-scatter result pass packet, and an all-reduce result pass packet, which are output from a reduce operation circuit 1050 and transferred via the first demultiplexer 1061 of the selective output circuit 1060. The send buffer 1041 may transmit the partial sum pass packet, reduce result pass packet, reduce-scatter result pass packet, and all-reduce result pass packet received from the first demultiplexer 1061 to the send buffer 1021 of the sender 1020. In addition, the send buffer 1041 may receive and store a broadcast pass packet and an all-gather pass packet, which have a transmission direction corresponding to the first direction, from the third demultiplexer 1063 of the selective output circuit 1060. The send buffer 1041 may transmit the broadcast pass packet and the all-gather pass packet received from the third demultiplexer 1063 to the send buffer 1021 of the sender 1020.

The receive buffer 1042 of the buffer circuit 1040 may receive packets from a second packet transmission circuit 1032 and a third packet transmission circuit 1033 of a network controller 1030, and from a first demultiplexer 1061 of a selective output circuit 1060. Specifically, the receive buffer 1042 may receive broadcast packets and all-gather packets provided from another network router in a first direction and output through a second output terminal of the second packet transmission circuit 1032. The receive buffer 1042 may receive and store a transfer target packet provided from another network router in the first direction and output through a second output terminal of the third packet transmission circuit 1033. The receive buffer 1042 may also receive and store a partial sum target packet, a reduce result target packet, a reduce-scatter result target packet, and an all-reduce result target packet output from a reduce operation circuit 1050 and transferred via the first demultiplexer 1061 of the selective output circuit 1060. The receive buffer 1042 may, in response to a receive command transmitted from the network controller 1030 to the receive buffer 1042, transmit the stored broadcast packet, all-gather packet, transfer target packet, partial sum target packet, reduce result target packet, reduce-scatter result target packet, and all-reduce result target packet to a second demultiplexer 1062 of the selective output circuit 1060.

An input terminal of a second demultiplexer 1062 included in the selective output circuit 1060 may be coupled to a receive buffer 1042 of the buffer circuit 1040. A first output terminal of the second demultiplexer 1062 may be coupled to an input terminal of a third demultiplexer 1063. A second output terminal of the second demultiplexer 1062 may be coupled to a scratch-pad. A first output terminal of the third demultiplexer 1063 may be commonly coupled to the scratch-pad and a send buffer 1041 of the buffer circuit 1040. A second output terminal of the third demultiplexer 1063 may be coupled to the scratch-pad.

The second demultiplexer 1062 receives, via an input terminal, one or more of the following packets output from a receive buffer 1042 of the buffer circuit 1040: a broadcast packet, an all-gather packet, a transmit target packet, a partial-sum target packet, a reduce-result target packet, a reduce-scatter result target packet, and an all-reduce result target packet. When the broadcast packet or the all-gather packet is input from the receive buffer 1042, the second demultiplexer 1062 transmits the broadcast packet or the all-gather packet to an input terminal of a third demultiplexer 1063 via a first output terminal. When the transmit target packet, partial-sum target packet, reduce-result target packet, reduce-scatter result target packet, or all-reduce result target packet is input from the receive buffer 1042, the second demultiplexer 1062 transmits the respective packet to a scratch-pad via a second output terminal.

The third demultiplexer 1063 receives, via an input terminal, the broadcast packet or the all-gather packet output from the first output terminal of the second demultiplexer 1062. When the broadcast packet or the all-gather packet is a broadcast-pass packet or an all-gather-pass packet, the third demultiplexer 1063 transmits the corresponding pass packet to both a send buffer 1041 of the buffer circuit 1040 and the scratch-pad via a first output terminal. On the other hand, when the broadcast packet or the all-gather packet is a broadcast-target packet or an all-gather-target packet, the third demultiplexer 1063 transmits the corresponding target packet to the scratch-pad via a second output terminal.

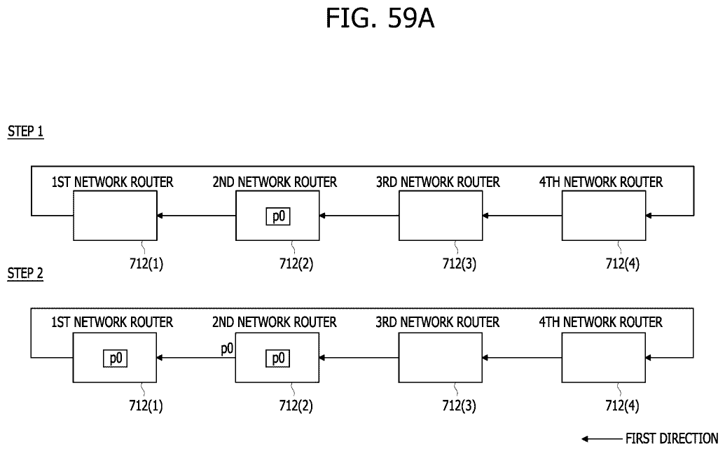

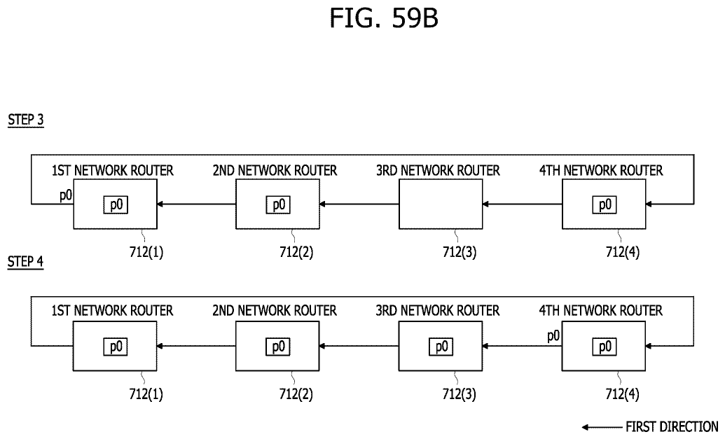

FIGS. 59A and 59B are diagrams illustrating a broadcast operation in the accelerator system of FIG. 40 including the network router of FIG. 58.

Referring to FIG. 59A, in a first step (STEP 1) of the broadcast operation, it is assumed that a first packet p0 is stored in a second scratch-pad coupled to a second network router 712(2), while the first network router 712(1), third network router 712(3), and fourth network router 712(4) do not have the first packet p0 stored in their respective scratch-pads. The broadcast operation may be performed by transmitting the first packet p0, which resides in the second network router 712(2), to all other routers, namely, the first network router 712(1), the third network router 712(3), and the fourth network router 712(4). In accordance with the destination setting of the broadcast packet being transmitted among the network routers, the broadcast packet may be treated as either a broadcast pass packet or a broadcast target packet. In a second step (STEP 2) of the broadcast operation, the second network router 712(2) transmits a first packet p0, which is stored in a second scratch-pad, to a receiver of the first network router 712(1) in a first direction. A destination of the first packet p0, which is transmitted from the second network router 712(2) to the first network router 712(1), is set to be a third network router 712(3), which is closest to the second network router 712(2) in a direction opposite to the transmission direction of the first packet p0. The first network router 712(1) processes the first packet p0, which is transmitted from the second network router 712(2), as a broadcast pass packet, and stores the first packet p0 in a send buffer of the sender and a first scratch-pad of the first network router 712(1).

Referring to FIG. 59B, in a third step (STEP 3) of the broadcast operation, the first network router 712(1) transmits a first packet p0, which is stored in a sender of the first network router 712(1), to a receiver of the fourth network router 712(4) in a first direction. Since a destination of the first packet p0 is set to the third network router 712(3), the fourth network router 712(4) processes the first packet p0, which is transmitted from the first network router 712(1), as a broadcast pass packet, and stores the first packet p0 in a sender and a fourth scratch-pad of the fourth network router 712(4).

In a fourth step (STEP 4) of the broadcast operation, the fourth network router 712(4) transmits a first packet p0, which is stored in a sender of the first network router 712(1), to a receiver of the third network router 712(3) in a first direction. Since a destination of the first packet p0 is set to the third network router 712(3), the third network router 712(3) processes the first packet p0, which is transmitted from the fourth network router 712(4), as a broadcast target packet, and stores the first packet p0 in a fourth scratch-pad of the third network router 712(3). As such, by performing the second through fourth steps (STEP 2 to STEP 4) of the broadcast operation, the first packet p0, which is stored in a second scratch-pad of the second network router 712(2), is stored in the first scratch-pad coupled to the first network router 712(1), the second scratch-pad coupled to the second network router 712(2), and the fourth scratch-pad coupled to the fourth network router 712(4).

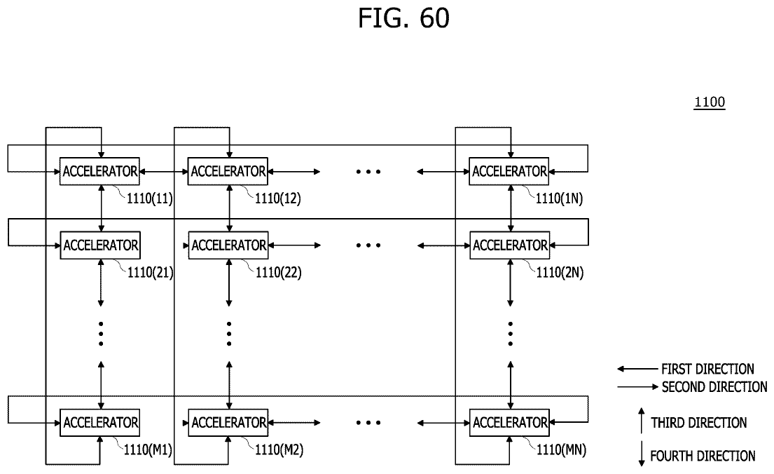

FIG. 60 is a block diagram illustrating another example of an accelerator system according to the present disclosure.

Referring to FIG. 60, an accelerator system 1100 is configured such that a plurality of accelerators are arranged in a 2-D torus topology. That is, the plurality of accelerators are arranged in an M×N array at the intersections of M (where M is a natural number equal to or greater than 2) rows and N (where N is a natural number equal to or greater than 2) columns. As illustrated in the drawing, a first group of accelerators 1110(11)-1110(1N) is arranged in the first row and the first through N-th columns of the M×N array. A second group of accelerators 1110(21)-1110(2N) is arranged in the second row and the first through N-th columns of the M×N array. Likewise, an M-th group of accelerators 1110(M1)-1110(MN) is arranged in the M-th row and the first through N-th columns of the M×N array. Each of the first through M-th groups of accelerators, i.e., 1110(11)-1110(1N) through 1110(M1)-1110(MN), may be configured in the same manner as the accelerator 200 described with reference to FIG. 2. That is, each accelerator may include a core comprising PIM devices and scratch-pads, and a network router.

Communication between the first group of accelerators 1110-11 to 1100-1N and the M-th group of accelerators 1110-M1 to 1100-MN may be performed via network routers included in each accelerator. Communication between the network routers may be carried out bidirectionally in a first direction (leftward arrow in the drawing) and a second direction (rightward arrow in the drawing), which are horizontal directions in the drawing. Additionally, communication between the network routers may also be performed in a third direction (upward arrow in the drawing) and a fourth direction (downward arrow in the drawing), which are vertical directions in the drawing. In one embodiment, each network router included in the first through M-th groups of accelerators 1110-11 to 1100-1N and 1110-M1 to 1100-MN may be configured similarly to the network router 300 described with reference to FIG. 3, network router 400 described with reference to FIG. 30, network router 500 described with reference to FIG. 34, or network router 600 described with reference to FIG. 38.

Specifically, in the case of the first group of accelerators 1110-11 to 1110-1N, the network router of the accelerator 1110-11 located at the first row and first column may communicate, along the first direction and second direction, with the network router of the accelerator 1110-1N at the first row and Nth column, and with the network router of the accelerator 1110-12 at the first row and second column. The network router of the accelerator 1110-12 at the first row and second column may communicate, along the first direction and second direction, with the network router of the accelerator (not shown) at the first row and third column, and with the network router of the accelerator 1110-11 at the first row and first column. Similarly, the network router of the accelerator 1110-1N at the first row and N-th column may communicate, along the first direction and second direction, with the network router of the accelerator (not shown) at the first row and (N−1)-th column, and with the network router of the accelerator 1110-11 at the first row and first column.

In the case of the second group of accelerators 1110-21 to 1110-2N, the network router of the accelerator 1110-21 located at the second row and first column may communicate, along the first direction and second direction, with the network router of the accelerator 1110-2N at the second row and N-th column, and with the network router of the accelerator 1110-22 at the second row and second column. The network router of the accelerator 1110-22 at the second row and second column may communicate, along the first direction and second direction, with the network router of the accelerator (not shown) at the second row and third column, and with the network router of the accelerator 1110-21 at the second row and first column. Similarly, the network router of the accelerator 1110-2N at the second row and N-th column may communicate, along the first direction and second direction, with the network router of the accelerator (not shown) at the second row and (N−1)-th column, and with the network router of the accelerator 1110-21 at the second row and first column.

In a similar manner, in the case of the M-th group of accelerators 1110-M1 to 1110-MN, the network router of the accelerator 1110-M1 at the M-th row and first column may communicate, along the first direction and second direction, with the network router of the accelerator 1110-MN at the M-th row and Nth column, and with the network router of the accelerator 1110-M2 at the M-th row and second column. The network router of the accelerator 1110-M2 at the M-th row and second column may communicate, along the first direction and second direction, with the network router of the accelerator (not shown) at the M-th row and third column, and with the network router of the accelerator 1110-M1 at the M-th row and first column. Similarly, the network router of the accelerator 1110-MN at the M-th row and Nth column may communicate, along the first direction and second direction, with the network router of the accelerator (not shown) at the M-th row and (N−1)th column, and with the network router of the accelerator 1110-M1 at the M-th row and first column.

In the case of the accelerators 1110-11 to 1110-M1 located in the first column of the first to M-th rows, the network router of the accelerator 1110-11 at the first row and first column may communicate, along the third direction and fourth direction, with the network router of the accelerator 1110-M1 at the M-th row and first column, and with the network router of the accelerator 1110-21 at the second row and first column. The network router of the accelerator 1110-21 at the second row and first column may communicate, along the third direction and fourth direction, with the network router of the accelerator (not shown) at the third row and first column, and with the network router of the accelerator 1110-11 at the first row and first column. Similarly, the network router of the accelerator 1110-M1 at the M-th row and first column may communicate, along the third direction and fourth direction, with the network router of the accelerator 1110-11 at the first row and first column, and with the network router of the accelerator (not shown) at the (M−1)-th row and first column.

In the case of the accelerators 1110-12 to 1110-M2 located in the second column of the first to M-th rows, the network router of the accelerator 1110-12 at the first row and second column may communicate, along the third direction and fourth direction, with the network router of the accelerator 1110-M2 at the M-th row and second column, and with the network router of the accelerator 1110-22 at the second row and second column. The network router of the accelerator 1110-22 at the second row and second column may communicate, along the third direction and fourth direction, with the network router of the accelerator (not shown) at the third row and second column, and with the network router of the accelerator 1110-12 at the first row and second column. Similarly, the network router of the accelerator 1110-M2 at the M-th row and second column may communicate, along the third direction and fourth direction, with the network router of the accelerator 1110-12 at the first row and second column, and with the network router of the accelerator (not shown) at the (M−1)th row and second column.

Similarly, in the case of the accelerators 1110-1N to 1110-MN located in the N-th column of the first to M-th rows, the network router of the accelerator 1110-1N at the first row and N-th column may communicate, along the third direction and fourth direction, with the network router of the accelerator 1110-MN at the M-th row and N-th column, and with the network router of the accelerator 1110-2N at the second row and N-th column. The network router of the accelerator 1110-2N at the second row and N-th column may communicate, along the third direction and fourth direction, with the network router of the accelerator (not shown) at the third row and N-th column, and with the network router of the accelerator 1110-1N at the first row and N-th column. The network router of the accelerator 1110-MN at the M-th row and N-th column may communicate, along the third direction and fourth direction, with the network router of the accelerator 1110-1N at the first row and N-th column, and with the network router of the accelerator (not shown) at the (M−1)th row and N-th column.

Accordingly, taking the accelerator 1110-11 located at the first row and first column as an example, the network router of the accelerator 1110-11 may exchange packets in the first direction and second direction with the network router of the accelerator 1110-1N located at the first row and N-th column. The network router of the accelerator 1110-11 may also exchange packets in the first direction and second direction with the network router of the accelerator 1110-12 located at the first row and second column. In addition, the network router of the accelerator 1110-11 may exchange packets in the third direction and fourth direction with the network router of the accelerator 1110-M1 located at the M-th row and first column. The network router of the accelerator 1110-11 may also exchange packets in the third direction and fourth direction with the network router of the accelerator 1110-21 located at the second row and first column.

In one embodiment, the collective operations in the network routers of the accelerator system 1100 according to the present example may be selectively performed with respect to either rows or columns. For example, the collective operation may be performed through communication in the first and second directions for the first to M-th rows, or through communication in the third and fourth directions for the first to N-th columns. In one embodiment, the collective operation in the network routers of the accelerator system 1100 may be carried out first with respect to either the rows or the columns, and then subsequently with respect to the other. For instance, the collective operation may be performed through communication in the first and second directions for the first to M-th rows, followed by a collective operation through communication in the third and fourth directions for the first to N-th columns. The collective operation methods described with reference to FIGS. 4A to 29C, FIGS. 32A to 33D, and FIGS. 35A to 37 can be applied in the same manner to the network routers of the accelerator system 1100, with only a difference in the packet transmission direction.

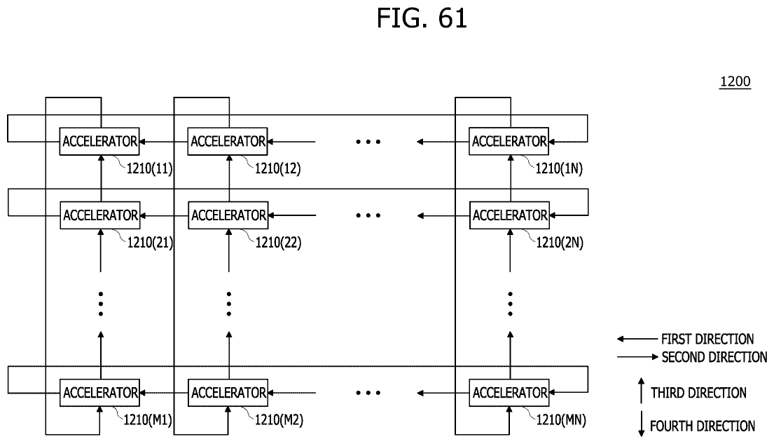

FIG. 61 is a block diagram illustrating yet another example of an accelerator system according to the present disclosure.

Referring to FIG. 61, an accelerator system 1200 is configured such that a plurality of accelerators are arranged in a two-dimensional torus topology. That is, the plurality of accelerators are arranged in an M×N array at the intersections of M rows and N columns, where “M” and “N” are natural numbers greater than or equal to 2. As illustrated in the drawing, a first group of accelerators 1210(11) to 1210(1N) is arranged along the first row and the first to N-th columns of the M×N array. A second group of accelerators 1210 (21) to 1210 (2N) is arranged along the second row and the first to N-th columns of the M×N array. Similarly, an M-th group of accelerators 1210 (M1) to 1210 (MN) is arranged along the M-th row and the first to N-th columns of the M×N array. The accelerators of the first group 1210(11) to 1210(1N) through the M-th group 1210 (M1) to 1210 (MN) may be configured in the same manner as the accelerator 800 described with reference to FIG. 41. That is, each of the accelerators of the first through M-th groups may include a core that comprises PIM devices and scratch pads, and may also include a network router.

Communication between the first group of accelerators 1210(11) through 1210(1N) and the M-th group of accelerators 1210 (M1) through 1210 (MN) may be performed via network routers included in the accelerators. Communication between the network routers may be performed in one of the horizontal directions in the drawing-either a first direction (leftward in the drawing) or a second direction (rightward in the drawing), for example, in the unidirectional first direction. Additionally, communication between the network routers may be performed in one of the vertical directions in the drawing-cither a third direction (upward in the drawing) or a fourth direction (downward in the drawing), for example, in the unidirectional third direction. In one embodiment, the network routers included in each of the first through M-th groups of accelerators 1210(11) through 1210(1N) to 1210 (M1) through 1210 (MN) may be configured similarly to the network router 900 described with reference to FIG. 42 or the network router 1000 described with reference to FIG. 58.

Specifically, in the case of the first group of accelerators 1210-11 through 1210-1N, the network router of the accelerator 1210-11 located at the first row and the first column may receive a packet from the network router of the accelerator 1210-1N located at the first row and the N-th column in the first direction, and may transmit a packet to the network router of the accelerator 1210-12 located at the first row and the second column. The network router of the accelerator 1210-12 located at the first row and the second column may transmit a packet in the first direction to the network router of the accelerator 1210-11 located at the first row and the first column, and may receive a packet from the network router of an accelerator (not shown) located at the first row and the third column. Similarly, the network router of the accelerator 1210-1N located at the first row and the N-th column may transmit a packet in the first direction to the network router of an accelerator (not shown) located at the first row and the (N−1)-th column, and may receive a packet from the network router of the accelerator 1210-11 located at the first row and the first column.

In the case of the second group of accelerators 1210-21 through 1210-2N, the network router of the accelerator 1210-21 located at the second row and the first column may transmit a packet in the first direction to the network router of the accelerator 1210-2N located at the second row and the N-th column, and may receive a packet from the network router of the accelerator 1210-22 located at the second row and the second column. The network router of the accelerator 1210-22 located at the second row and the second column may transmit a packet in the first direction to the network router of the accelerator 1210-21 located at the second row and the first column, and may receive a packet from the network router of an accelerator (not shown) located at the second row and the third column. Similarly, the network router of the accelerator 1210-2N located at the second row and the N-th column may transmit a packet in the first direction to the network router of an accelerator (not shown) located at the second row and the (N−1)-th column, and may receive a packet from the network router of the accelerator 1210-21 located at the second row and the first column.

In the same manner, in the case of the M-th group of accelerators 1210-M1 through 1210-MN, the network router of the accelerator 1210-M1 located at the M-th row and the first column may transmit a packet in the first direction to the network router of the accelerator 1210-MN located at the M-th row and the N-th column, and may receive a packet from the network router of the accelerator 1210-M2 located at the M-th row and the second column. The network router of the accelerator 1210-M2 located at the M-th row and the second column may transmit a packet in the first direction to the network router of the accelerator 1210-M1 located at the M-th row and the first column, and may receive a packet from the network router of an accelerator (not shown) located at the M-th row and the third column. Similarly, the network router of the accelerator 1210-MN located at the M-th row and the N-th column may transmit a packet in the first direction to the network router of an accelerator (not shown) located at the M-th row and the (N−1)-th column, and may receive a packet from the network router of the accelerator 1210-M1 located at the M-th row and the first column.

In the case of the accelerators located in the first column of the first through M-th rows 1210-11 through 1210-M1, the network router of the accelerator 1210-11 located at the first row and the first column may transmit a packet in the third direction to the network router of the accelerator 1210-M1 located at the M-th row and the first column, and may receive a packet from the network router of the accelerator 1210-21 located at the second row and the first column. The network router of the accelerator 1210-21 located at the second row and the first column may transmit a packet in the third direction to the network router of an accelerator (not shown) located at the third row and the first column, and may receive a packet from the network router of the accelerator 1210-11 located at the first row and the first column. Similarly, the network router of the accelerator 1210-M1 located at the M-th row and the first column may transmit a packet in the third direction to the network router of an accelerator (not shown) located at the (M−1)-th row and the first column, and may receive a packet from the network router of the accelerator 1210-11 located at the first row and the first column.

In the case of the accelerators located in the second column of the first through M-th rows 1210-12 through 1210-M2, the network router of the accelerator 1210-12 located at the first row and the second column may transmit a packet in the third direction to the network router of the accelerator 1210-M2 located at the M-th row and the second column, and may receive a packet from the network router of the accelerator 1210-22 located at the second row and the second column. The network router of the accelerator 1210-22 located at the second row and the second column may transmit a packet in the third direction to the network router of the accelerator 1210-12 located at the first row and the second column, and may receive a packet from the network router of an accelerator (not shown) located at the third row and the first column. Similarly, the network router of the accelerator 1210-M2 located at the M-th row and the second column may transmit a packet in the third direction to the network router of an accelerator (not shown) located at the (M−1)-th row and the second column, and may receive a packet from the network router of the accelerator 1210-12 located at the first row and the second column.

Similarly, in the case of the accelerators located in the N-th column of the first through M-th rows 1210-1N through 1210-MN, the network router of the accelerator 1210-1N located at the first row and the N-th column may transmit a packet in the third direction to the network router of the accelerator 1210-MN located at the M-th row and the N-th column, and may receive a packet from the network router of the accelerator 1210-2N located at the second row and the N-th column. The network router of the accelerator 1210-2N located at the second row and the N-th column may transmit a packet in the third direction to the network router of the accelerator 1210-1N located at the first row and the N-th column, and may receive a packet from the network router of an accelerator (not shown) located at the third row and the N-th column. The network router of the accelerator 1210-MN located at the M-th row and the N-th column may transmit a packet in the third direction to the network router of an accelerator (not shown) located at the (M−1)-th row and the N-th column, and may receive a packet from the network router of the accelerator 1210-1N located at the first row and the N-th column.

In one embodiment, the collective operation in the network routers of the accelerator system 1200 according to the present example may be selectively performed with respect to only one of the rows or columns. For example, a collective operation may be performed through communication in the first direction for the first through M-th rows, or a collective operation may be performed through communication in the third direction for the first through N-th columns. In one embodiment, the collective operation in the network routers of the accelerator system 1200 according to the present example may be performed first with respect to one of the rows or columns and then with respect to the other. For example, a collective operation may be performed through communication in the first direction for the first through M-th rows, followed by a collective operation through communication in the third direction for the first through N-th columns. The collective operation method described with reference to FIGS. 43A through 57C, and FIGS. 59A and 59B, may be equally applied to the network routers of the accelerator system 1200 according to the present example, except for differences in the transmission direction of the packets.

A limited number of possible embodiments for the present teachings have been presented above for illustrative purposes. Those of ordinary skill in the art will appreciate that various modifications, additions, and substitutions are possible. While this patent document contains many specifics, these should not be construed as limitations on the scope of the present teachings or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A plurality of network routers comprising:
a first network router; and
a second network router comprising
a receiver configured to receive a collective packet in a first direction from the first network router;
a network controller configured to receive the collective packet from the receiver, and to output the collective packet through a first path or a second path based on a packet type of the collective packet;
a buffer circuit configured to receive the collective packet transmitted through the second path from the network controller and to store the collective packet in one or more distinct buffers according to the packet type;
a reduce operation circuit configured to receive the collective packet from the buffer circuit and to perform a reduce operation using the received collective packet; and
a sender configured to output a first output packet in a first direction,
wherein the first network router and the second network router are interconnected in a one-dimensional torus topology.

2. The plurality of network routers of claim 1,
wherein the receiver is configured to receive a first collective packet in the first direction from the first network router and to receive a second collective packet in a second direction from a third network router, and to output one of the first collective packet or the second collective packet as the collective packet sent to the network controller,
wherein the sender is further configured to output a second output packet in the second direction, and
wherein the first network router, the second network router and the third network router are interconnected in a one-dimensional torus topology.

3. The plurality of network routers of claim 2,
wherein the receiver, the network controller, the buffer circuit, the reduce operation circuit and the sender of the second network router is distributed between a first router circuit and a second router circuit,
wherein the first router circuit comprises:
a first receiver configured to receive and output the first collective packet;
a first network controller configured to receive the first collective packet output from the first receiver and to output the first collective packet through a first path or a second path based on a packet type of the first collective packet;
a first buffer circuit configured to receive and store the first collective packet transmitted via the second path from the first network controller in one or more distinct buffers according to the packet type of the first collective packet;
a first reduce operation circuit configured to receive the first collective packet stored in the first buffer circuit and perform a first reduce operation using the received first collective packet, and
a first sender configured to output the first output packet in the first direction,
and wherein the second router circuit comprises:
a second receiver configured to receive and output the second collective packet;
a second network controller configured to receive the second collective packet output from the second receiver and to output the second collective packet through a third path or a fourth path based on a packet type of the second collective packet;
a second buffer circuit configured to receive and store the second collective packet transmitted via the fourth path from the second network controller in one or more distinct buffers according to the packet type of the second collective packet; and
a second reduce operation circuit configured to receive the second collective packet stored in the second buffer circuit and perform a second reduce operation using the received second collective packet, and
a second sender configured to output the second output packet in the first direction.

4. The plurality of network routers of claim 2,
wherein the buffer circuit comprises:
a send buffer configured to store a collective packet to be output from the sender;
a receive buffer configured to store the first collective packet and the second collective packet transmitted from the first network router and the second network router, and a collective packet output from the reduce operation circuit;
a partial buffer configured to store a collective packet, transmitted from a local memory coupled to the second network router, that is used as a first operand of a reduce operation; and
a reduce buffer configured to store the first collective packet and the second collective packet used as a second operand of the reduce operation.

5. The plurality of network routers of claim 4,
wherein the network controller comprises a first packet transmission circuit, a second packet transmission circuit, a third packet transmission circuit, and a fourth packet transmission circuit sequentially arranged between the receiver and the sender,
wherein the first packet transmission circuit, the second packet transmission circuit, the third packet transmission circuit, and the fourth packet transmission circuit each include one input terminal, a first output terminal, and a second output terminal,
wherein the input terminal, the first output terminal, and the second output terminal of the first packet transmission circuit are respectively connected to the receiver, the input terminal of the second packet transmission circuit, and the reduce buffer,
wherein the first output terminal and the second output terminal of the second packet transmission circuit are respectively connected to the input terminal of the third packet transmission circuit and the receive buffer,
wherein the first output terminal and the second output terminal of the third packet transmission circuit are respectively connected to the input terminal of the fourth packet transmission circuit and the receive buffer,
and wherein the first output terminal and the second output terminal of the fourth packet transmission circuit are respectively connected to a first sender buffer and a second sender buffer of the sender.

6. The plurality of network routers of claim 5, wherein an input terminal of the fourth packet transmission circuit is connected to the send buffer.

7. The plurality of network routers of claim 6, further comprising a selective output circuit configured to receive the collective packet from the receive buffer of the buffer circuit and the reduce operation circuit, and to transmit the collective packet to at least one of the local memory, the send buffer, and the receive buffer.

8. The plurality of network routers of claim 7,
wherein the packet type of the collective packet is set to one of a transmit packet, an all-gather packet, or a reduce packet,
wherein the first collective packet and the second collective packet are each processed as a transmit packet when used in a send process, in a broadcast process, in a gather process, in a scatter process, as a reduce result packet generated through a first reduce operation in a reduce process, and as a reduce-scatter result packet generated through a second reduce operation in a reduce-scatter process,
wherein the first collective packet and the second collective packet are each processed as an all-gather packet when used in an all-gather process and as an all-reduce result packet generated through a third reduce operation in an all-reduce process, and
wherein the first collective packet and the second collective packet are each processed as a reduce packet when used as an operand in the first reduce operation, the second reduce operation, and the third reduce operation, and as a partial sum packet generated in the first reduce operation, the second reduce operation, and the third reduce operation.

9. The plurality of network routers of claim 8,
wherein the first packet transmission circuit is configured to:
output the transmit packet and the all-gather packet through a first output terminal when the collective packet input to an input terminal corresponds to the transmit packet or the all-gather packet; and
output the reduce packet through a second output terminal when the collective packet input to the input terminal corresponds to the reduce packet,
wherein the second packet transmission circuit is configured to:
output the transmit packet through a first output terminal when the collective packet input to an input terminal corresponds to the transmit packet; and
output the all-gather packet through a second output terminal when the collective packet input to the input terminal corresponds to the all-gather packet,
wherein the third packet transmission circuit is configured to:
output the transmit pass packet through a first output terminal when a collective packet input to an input terminal corresponds to the transmit packet and the transmit packet corresponds to a transmit pass packet having a destination different from the network router; and
output the transmit pass packet through a second output terminal when the collective packet input to the input terminal corresponds to the transmit packet and the transmit packet corresponds to a transmit target packet having the network router as a destination,
wherein the fourth packet transmission circuit is configured to:
output the transmit pass packet through a first output terminal when an output transmission direction of the transmit pass packet, which is input from the third packet transmission circuit through an input terminal, corresponds to a first direction; and
output the transmit pass packet through a second output terminal when the output transmission direction of the transmit pass packet corresponds to a second direction, and
wherein the fourth packet transmission circuit is configured to:
output the collective packet through a first output terminal when an output transmission direction of the collective packet, which is input from the buffer circuit through an input terminal, corresponds to a first direction; and
output the collective packet through a second output terminal when the output transmission direction of the collective packet corresponds to a second direction.

10. The plurality of network routers of claim 9,
wherein the send buffer is configured to:
receive and store the transmit packet, the all-gather packet, and the reduce packet from the local memory;
transmit the stored transmit packet, all-gather packet, and reduce packet to an input terminal of the fourth packet transmission circuit;
store an all-gather packet received from the first or third network router when the all-gather packet corresponds to an all-gather pass packet having a destination other than the second network router, and transmit the all-gather pass packet to the input terminal of the fourth packet transmission circuit; and
transmit a reduce packet generated by a reduce operation performed by the reduce operation circuit to the input terminal of the fourth packet transmission circuit when the reduce packet corresponds to a reduce pass packet having a destination other than the second network router.

11. The plurality of network routers of claim 10,
wherein the receive buffer is configured to:
receive and store the all-gather packet, which is input to the network router from another network router and output from a second output terminal of the second packet transmission circuit;
receive and store the transmit target packet, which corresponds to a transmit packet input to the network router from the first or third network router and output from a second output terminal of the third packet transmission circuit, when the transmit packet corresponds to a transmit target packet having the second network router as a destination; and
receive and store a reduce target packet and a transmit target packet, when a reduce packet and a transmit packet generated by a reduce operation of the reduce operation circuit correspond to the reduce target packet and the transmit target packet, respectively, having the second network router as a destination.

12. The plurality of network routers of claim 11,
wherein the partial buffer is configured to receive and store the reduce packet, which is used as a first operand of the reduce operation, from the local memory and to transmit the stored reduce packet to the reduce operation circuit,
wherein the reduce buffer is configured to receive and store the reduce packet, which is used as a second operand of the reduce operation, from the second output terminal of the first packet transmission circuit, and to transmit the stored reduce packet to the reduce operation circuit, and
wherein the reduce operation circuit is configured to respectively receive a first reduce packet used as a first operand of the reduce operation from the partial buffer, and a second reduce packet used as a second operand of the reduce operation from the reduce buffer, and to perform the reduce operation on the first reduce packet and the second reduce packet to generate a partial sum packet, a reduce result packet, a reduce-scatter result packet, and an all-reduce result packet.

13. The plurality of network routers of claim 12,
wherein the selective output circuit includes a first demultiplexer, a second demultiplexer, and a third demultiplexer, and the first demultiplexer, the second demultiplexer, and the third demultiplexer each have an input terminal, a first output terminal, and a second output terminal, and
wherein
the input terminal, the first output terminal, and the second output terminal of the first demultiplexer are respectively coupled to an output terminal of the reduce operation circuit, the send buffer, and the receive buffer;
the input terminal, the first output terminal, and the second output terminal of the second demultiplexer are respectively coupled to the receive buffer, an input terminal of the third demultiplexer, and the local memory;
a first output terminal of the third demultiplexer is commonly coupled to the send buffer and the local memory; and
a second output terminal of the third demultiplexer is coupled to the local memory.

14. The plurality of network routers of claim 13,
wherein the selective output circuit is configured to:
process the partial sum packet transmitted from the reduce operation circuit as the reduce packet;
process the reduce result packet and the reduce-scatter result packet transmitted from the reduce operation circuit as the transmit packet; and
process the all-reduce result packet output from the reduce operation circuit as the all-gather packet.

15. The plurality of network routers of claim 14,
wherein the first demultiplexer is configured to receive the partial sum packet, the reduce result packet, the reduce-scatter result packet, and the all-reduce result packet from the reduce operation circuit, and to transmit the reduce result packet, the reduce-scatter result packet, and the all-reduce result packet to the send buffer or the receive buffer, and
wherein the first demultiplexer is configured to,
when the partial sum packet, the reduce result packet, the reduce-scatter result packet, and the all-reduce result packet are a partial sum pass packet, a reduce result pass packet, a reduce-scatter result pass packet, and an all-reduce result pass packet respectively, which are destined for a network router other than the network router, transmit the partial sum pass packet, the reduce result pass packet, the reduce-scatter result pass packet, and the all-reduce result pass packet to the send buffer, and
when the partial sum packet, the reduce result packet, the reduce-scatter result packet, and the all-reduce result packet are a partial sum target packet, a reduce result target packet, a reduce-scatter result target packet, and an all-reduce result target packet respectively, which are destined for the network router, transmit the partial sum target packet, the reduce result target packet, the reduce-scatter result target packet, and the all-reduce result target packet to the receive buffer.

16. The plurality of network routers of claim 15,
wherein the second demultiplexer is configured to:
when the all-gather packet and the all-reduce result target packet are input from the receive buffer, transmit the all-gather packet and the all-reduce result target packet to the input terminal of the third demultiplexer; and
when the transmit target packet, the partial sum target packet, the reduce result target packet, and the reduce-scatter result target packet are input from the receive buffer, transmit the transmit target packet, the partial sum target packet, the reduce result target packet, and the reduce-scatter result target packet to the local memory.

17. The plurality of network routers of claim 16,
wherein the third demultiplexer is configured to:
when the all-gather pass packet and the all-reduce result pass packet are input from the second demultiplexer, transmit the all-gather pass packet and the all-reduce result pass packet to the send buffer and the local memory; and
when an all-gather target packet and the all-reduce result target packet are input from the second demultiplexer, transmit the all-gather target packet and the all-reduce result target packet to the local memory.

18. The plurality of network routers of claim 17,
wherein the receiver includes:
a first receive buffer configured to store the first collective packet and a second receive buffer configured to store the second collective packet, and
wherein the receiver is configured to output a collective packet having a higher output priority order among the first collective packet stored in the first receive buffer and the second collective packet stored in the second receive buffer.

19. An accelerator system comprising:
a plurality of accelerators, each of which includes a network router configured to perform a collective operation,
wherein each network router comprises:
a receiver configured to receive a first input packet from a first network router along a first direction, to receive a second input packet from a second network router along a second direction, and to output one of the first input packet and the second input packet as a collective packet;
a network controller configured to receive the collective packet output from the receiver and to output the collective packet through a first path or a second path based on a packet type of the collective packet;
a buffer circuit configured to receive the collective packet transmitted through the second path from the network controller and to store the collective packet in a manner distinguishable according to the packet type of the collective packet; and
a reduce operation circuit configured to receive the collective packet stored in the buffer circuit and to perform a reduce operation using the received collective packet,
wherein the plurality of accelerators are interconnected in a one-dimensional torus topology.

20. An accelerator system of claim 19, wherein the plurality of accelerators are interconnected in a two-dimensional torus topology and wherein each network router sends and receives collective packets in the first direction and the second direction or in a third direction and a fourth direction.

21. A network router comprising:
a receiver configured to receive a first input packet in a first direction, to receive a second input packet in a second direction, and to output one of the first input packet or the second input packet as a collective packet;
a network controller configured to receive the collective packet from the receiver and to output the collective packet through a first path or a second path based on a packet type of the collective packet;
a buffer circuit configured to receive the collective packet transmitted through the second path from the network controller and to store the collective packet in one or more distinct buffers according to the packet type; and
a reduce operation circuit configured to receive the collective packet stored in the buffer circuit and perform a reduce operation using the received collective packet.

22. A network router comprising:
a first router circuit configured to receive a first input packet along a first direction and output a first output packet along the first direction; and
a second router circuit configured to receive a second input packet along a second direction and output a second output packet along the second direction,
wherein the first router circuit comprises:
a first receiver configured to receive the first input packet and output the first input packet as a first collective packet;
a first network controller configured to receive the first collective packet output from the first receiver and to output the first collective packet through a first path or a second path based on a packet type of the first collective packet;
a first buffer circuit configured to receive and store the first collective packet transmitted through the second path from the first network controller in one or more distinct first buffers according to the packet type of the first collective packet; and
a first reduce operation circuit configured to receive the first collective packet stored in the first buffer circuit and perform a first reduce operation using the received first collective packet, and
wherein the second router circuit comprises:
a second receiver configured to receive the second input packet and output the second input packet as a second collective packet;
a second network controller configured to receive the second collective packet output from the second receiver and to output the second collective packet through a third path or a fourth path based on a packet type of the second collective packet;
a second buffer circuit configured to receive and store the second collective packet transmitted through the fourth path from the second network controller in one or more distinct second buffers according to the packet type of the second collective packet; and
a second reduce operation circuit configured to receive the second collective packet stored in the second buffer circuit and perform a second reduce operation using the received second collective packet.
